(19) United States
(12) Patent Application Publication
(10) Pub. No.: US 2014/0066290 A1
(43) Pub. Date: Mar. 6, 2014

(54) CATHODE CATALYST FOR AIR SECONDARY BATTERY AND AIR SECONDARY BATTERY

(71) Applicants: Nobuyoshi Koshino, Tsukuba-shi (JP); Hideyuki Higashimura, Tsukuba-shi (JP)

(72) Inventors: Nobuyoshi Koshino, Tsukuba-shi (JP); Hideyuki Higashimura, Tsukuba-shi (JP)

(73) Assignee: SUMITOMO CHEMICAL COMPANY, LIMITED, Chuo-ku, Tokyo (JP)

(21) Appl. No.: 14/113,758

(22) PCT Filed: Apr. 27, 2012
(86) PCT No.: PCT/JP2012/061459

§ 371 Date: Oct. 24, 2013

(30) Foreign Application Priority Data
Apr. 27, 2011 (JP) 2011-100165
Apr. 27, 2011 (JP) 2011-100166

(51) Int. Cl. H01M 4/90; H01M 12/08

(52) U.S. Cl. CPC H01M 4/9008; H01M 12/08
USPC 502/159; 502/167; 546/6; 548/403; 556/150; 544/225

(57) ABSTRACT

The present invention provides a cathode catalyst for an air secondary cell having both excellent oxygen reduction activity and excellent water oxidation activity, and an air secondary cell that uses the catalyst. The present invention relates to a cathode catalyst for an air secondary cell in which the catalyst contains a polynuclear metal complex.

### TECHNICAL FIELD

The present invention relates to a cathode catalyst for an air secondary cell, and to an air secondary cell that uses the catalyst.

Priority is claimed on Japanese Patent Application No. 2011-100165 and Japanese Patent Application No. 2011-100166, both filed Apr. 27, 2011, the contents of which are incorporated herein by reference.

### BACKGROUND ART

Air cells which use the oxygen in the air as an active material can achieve high energy densities, and therefore hold great promise for application in a variety of fields such as electric vehicles.

An air cell is a cell that uses a cathode catalyst having an oxygen reduction ability, and an active material such as zinc, iron, aluminum, magnesium, lithium or hydrogen as an anode active material. For example, when the anode active material is zinc, the discharge reaction for the air cell under alkaline conditions is represented by the following equations.

Cathode: O₂+2H₂O+4e⁻→4OH⁻

Anode: Zn+2OH⁻→ZnO+H₂O+2e⁻

Overall reaction: 2Zn+O₂→2ZnO

As a conventional air cell, a cell which uses manganese dioxide as the cathode catalyst has been disclosed (see Non-Patent Document 1).

### DOCUMENTS OF RELATED ART

Non-Patent Document
Non-Patent Document 1: Journal of Power Sources, volume 91, 2000, pages 83 to 85.

### SUMMARY OF THE INVENTION

### Problems to be Solved by the Invention

Cells which can store electricity by charging and can be used repeatedly (secondary cells, rechargeable cells, and storage cells) are already known, and development is also progressing for cells such as the aforementioned air cells, which use the oxygen in the air as an active material. In the following description, cells which use the oxygen in the air as an active material, and can be repeatedly charged and discharged are referred to as “air secondary cells” in order to distinguish them from the air cells mentioned above.

In addition to the oxygen reduction activity required for a cathode catalyst of an air cell that performs only discharge (primary cell), the cathode catalyst for an air secondary cell also requires water oxidation activity during charging. If the cathode catalysts of conventional air cells are considered from this viewpoint, then for example, although the manganese dioxide mentioned above has catalytic activity in the oxygen reduction reaction, its activity in the oxidation reaction of water (oxygen generation) is poor. As a result, use of manganese dioxide as the cathode catalyst for an air secondary cell has proven difficult.

The present invention takes these types of circumstances into consideration, and has an object of providing a cathode catalyst for an air secondary cell that exhibits both excellent oxygen reduction activity and excellent water oxidation activity. Further, the invention also has an object of providing an air secondary cell that uses this type of cathode catalyst for an air secondary cell.

### Means to Solve the Problems

In order to achieve the above objects, one aspect of the present invention provides a cathode catalyst for an air secondary cell comprising a polynuclear metal complex.

In one aspect of the present invention, it is preferable that the polynuclear metal complex comprises 2 or more central metals and a ligand that bonds to the central metals by means of a coordination bond, and

the ligand is an organic compound including 2 or more structures within the molecule, each structure having a space surrounded by 4 or more atoms being able to coordinate with the central metal, in which the 4 or more atoms are at least one type of atom selected from the group consisting of a nitrogen atom, an oxygen atom and a sulfur atom, and being able to accommodate the central metal in the space, and the 2 or more structures may be the same or different from each other.

In one aspect of the present invention, the number of the central metals of the polynuclear metal complex is preferably 2 to 6.

In one aspect of the present invention, the central metal of the polynuclear metal complex is preferably a transition metal atom belonging to the 4th period to the 6th period of the periodic table, or an ion thereof, is more preferably one or more metals or ions selected from the group consisting of vanadium, chromium, manganese, iron, cobalt, nickel, copper, and ions thereof, and is still more preferably one or more metals selected from the group consisting of vanadium, chromium, manganese, iron, cobalt, nickel and copper.

In one aspect of the present invention, the polynuclear metal complex is preferably a polynuclear metal complex represented by general formula (A-1) shown below:

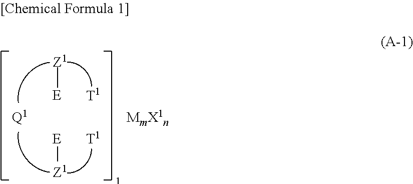

wherein Z¹ represents a trivalent organic group, 2 or more Z¹ may be the same or different from each other; E represents an oxygen atom or a sulfur atom, where 2 or more E may be the same or different from each other; Q¹ represents a divalent organic group having at least 2 nitrogen atoms; T¹ represents an organic group having a nitrogen atom, 2 or more T¹ may be the same or different from each other, and 2 or more T¹ may be mutually bonded; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other.

In one aspect of the present invention, the aforementioned T¹ preferably represents an organic group having a nitrogen-containing aromatic hetero ring.

In one aspect of the present invention, it is preferable that the polynuclear metal complex represented by general formula (A-1) is a polynuclear metal complex represented by general formula (A-2) shown below:

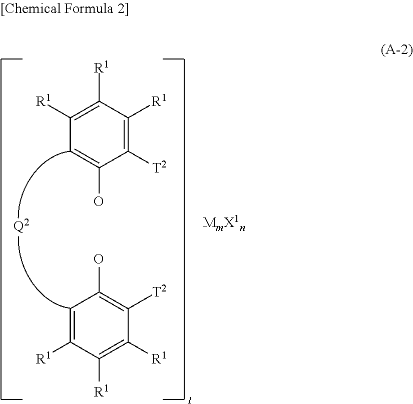

wherein R¹ represents a hydrogen atom or a substituent, 2 or more R¹ may be the same or different from each other, and adjacent R¹ substituents may be mutually bonded together to form a ring with the carbon atoms bonded thereto; Q² represents a divalent organic group having at least 2 nitrogen atoms; T² represents an organic group having a nitrogen atom, 2 or more T² may be the same or different from each other, and 2 or more T² may be mutually bonded; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other.

Further, T² preferably represents an organic group having a nitrogen-containing aromatic hetero ring.

In one aspect of the present invention, it is preferable that the polynuclear metal complex represented by general formula (A-2) is a polynuclear metal complex represented by general formula (A-3) shown below:

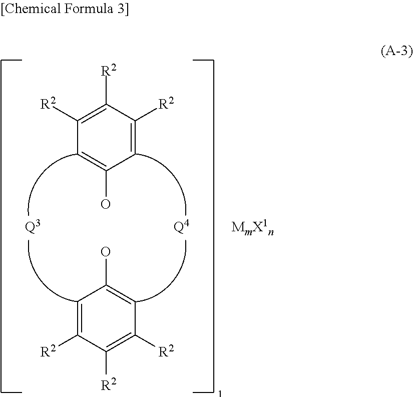

wherein R² represents a hydrogen atom or a substituent, 2 or more R² may be the same or different from each other, and adjacent R² substituents may be mutually bonded together to form a ring with the carbon atoms bonded thereto; each of Q³ and Q⁴ independently represents a divalent group represented by general formula (A-3-1), (A-3-2), (A-3-3), (A-3-4), (A-3-5) or (A-3-6) shown below; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other;

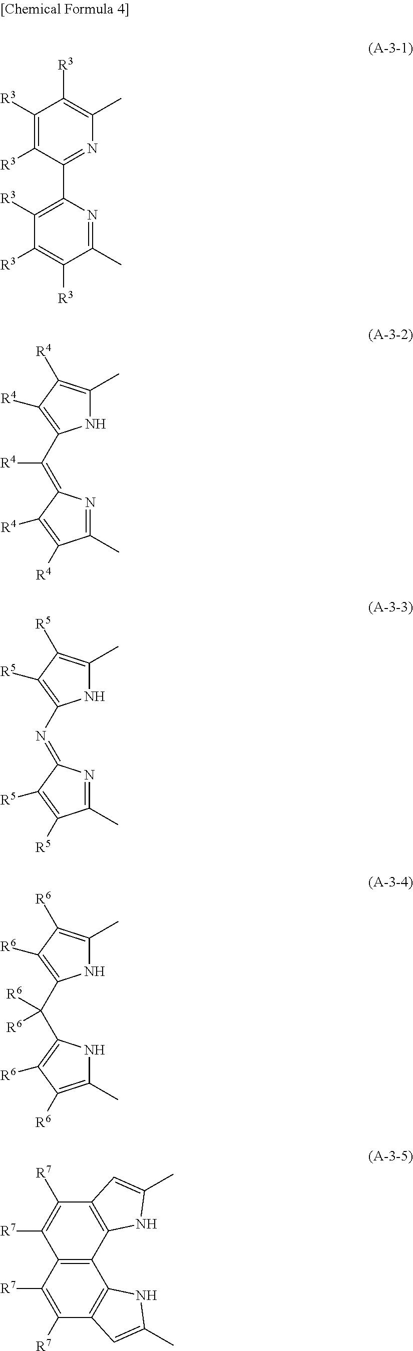

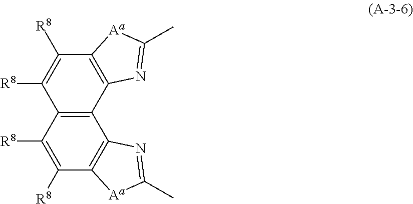

wherein each of R³, R⁴, R⁵, R⁶, R⁷ and R⁸ independently represents a hydrogen atom or a substituent, each 2 or more R³, R⁴, R⁵, R⁶, R⁷ and R⁸ may be the same or different from each other, and each 2 or more R³, R⁴, R⁵, R⁶, R⁷ and R⁸ may be mutually bonded together to form a ring with the carbon atom(s) bonded thereto; A^{a} represents a divalent group represented by formula (A-3-a) or (A-3-b) shown below, or general formula (A-3-c) shown below, and 2 or more A^{a} may be the same or different from each other;

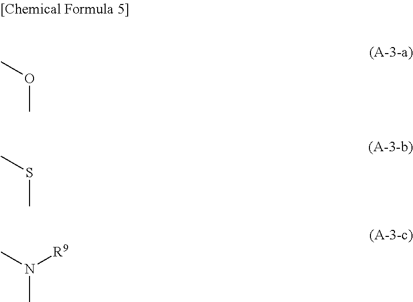

wherein R⁹ represents a hydrogen atom or a hydrocarbyl group.

In one aspect of the present invention, M preferably represents one or more selected from the group consisting of vanadium, chromium, manganese, iron, cobalt, nickel and copper.

In one aspect of the present invention, the aforementioned m is preferably 2.

Further, in one aspect of the present invention, it is preferable that the polynuclear metal complex comprises 2 or more central metals and a ligand that bonds to the central metals by means of a coordination bond, and

the ligand is an aromatic compound satisfying the requirements of (a) and (b) shown below:

(a) the aromatic compound has two or more structures within the molecule, each structure having a space surrounded by 4 or more nitrogen atoms being able to coordinate with the central metal, and being able to accommodate the central metal in the space, and the 2 or more structures may be the same or different from each other, and

(b) at least one nitrogen atom constituting the structure is a nitrogen atom contained in a nitrogen-containing hetero 6-membered ring.

In one aspect of the present invention, the aforementioned structure preferably satisfies the requirement represented by equation (A) shown below, with respect to the number “n” of nitrogen atoms constituting the structure, and the average distance “r” (A) between the center of the space and the center of each nitrogen atom constituting the structure.

0<r/n≦0.7 (A)

In one aspect of the present invention, it is preferable that the relationship between the aforementioned number “n” of nitrogen atoms constituting the structure and the aforementioned average distance “r” satisfies the requirement represented by equation (B) shown below.

0.2≦r/n≦0.6 (B)

In one aspect of the present invention, the aforementioned structure is preferably a structure in which the number “n” of nitrogen atoms constituting the structure is 4 or more and 6 or less.

In one aspect of the present invention, it is preferable that the relationship between the weight “W_{C}” of all the carbon atoms constituting the aforementioned ligand and the weight “W_{N}” of all the nitrogen atoms constituting the ligand satisfies the requirement represented by equation (C) shown below.

0<W_{N}/W_{C}≦1.1 (C)

In one aspect of the present invention, it is preferable that the aforementioned structure having a space surrounded by 4 or more nitrogen atoms being able to coordinate with the central metal, and being able to accommodate the central metal in the space is an aromatic compound represented by general formula (B-1) shown below:

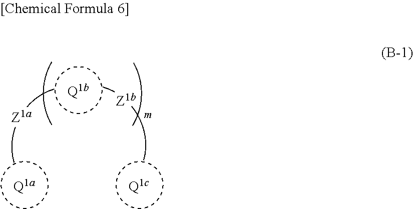

wherein m represents an integer of 1 or more; each of Q^{1a}, Q^{1b} and Q^{1c} independently represents a nitrogen-containing aromatic hetero ring which may have a substituent, Q^{1a}, Q^{1b} and Q^{1c} contain the aforementioned 4 or more nitrogen atoms being able to coordinate with the central metal, in the case of 2 or more Q^{1b}, these Q^{1b} may be the same or different from each other, and at least one of Q^{1a}, Q^{1b} and Q^{1c} represents a nitrogen-containing hetero 6-membered ring; each of Z^{1a} and Z^{1b} independently represents a direct bond or a linking group, and in the case of 2 or more Z^{1b}, these Z^{1b} may be the same or different from each other; each of Q^{1a} and Q^{1b}, and Q^{1b} and Q^{1c} may be combined together to form a polycyclic aromatic hetero ring; when m represents an integer of 2 or more and Z^{1b} represents a direct bond, 2 adjacent Q^{1b} may be combined together to form a polycyclic aromatic hetero ring; Q^{1a} and Q^{1c} may be directly bonded, may be mutually bonded via a linking group, or may be combined together to form a polycyclic aromatic hetero ring.

In one aspect of the present invention, in formula (B-1), m preferably represents 2 or 4.

In one aspect of the present invention, it is preferable that each of Q^{1a}, Q^{1b} and Q^{1c} independently represents a ring selected from the group consisting of a pyridine ring, pyrazine ring, pyrimidine ring, pyridazine ring, 1,3,5-triazine ring, 1,2,4-triazine ring, 1,2,4,5-tetrazine ring, 1H-pyrrole ring, 2H-pyrrole ring, 3H-pyrrole ring, imidazole ring, pyrazole ring, 1,2,3-triazole ring, 1,2,4-triazole ring, oxazole ring, isoxazole ring, thiazole ring, isothiazole ring, 1,3,4-oxadiazole ring, 1,2,5-oxadiazole ring, 1,3,4-thiadiazole ring, 1,2,5-thiadiazole ring, and polycyclic aromatic hetero rings having any of these ring structures, and the ring may have a substituent.

In one aspect of the present invention, it is preferable that the organic group consisting of Q^{1a} and Q^{1b}, which are two nitrogen-containing aromatic hetero rings, or Q^{1b} and Q^{1c}, which are two nitrogen-containing aromatic hetero rings, and a direct bond or a linking group mutually bonding the two nitrogen-containing aromatic hetero rings is a divalent organic group represented by any one of general formulas (B-4-a) to (B-4-c), (B-5-a) to (B-5-d), and (B-6-a) to (B-6-d) shown below:

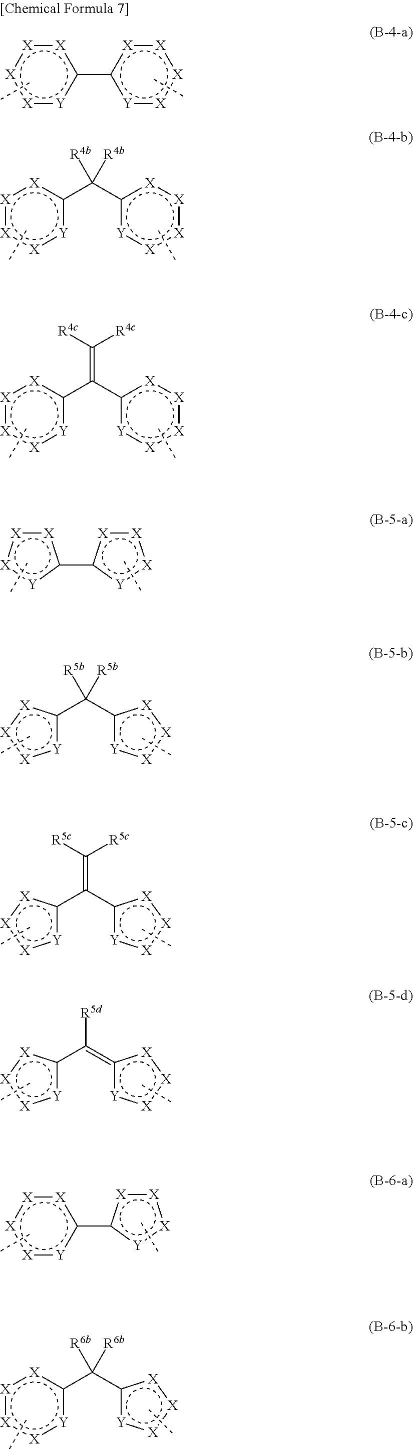

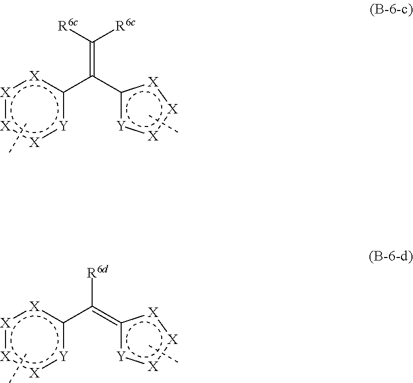

wherein X represents) ═C(R^{α}), —N(R^{β})—, ═N—, —O—, —S— or —Se—; Y represents —N(H)— or ═N—; each of R^{4b}, R^{4c}, R^{5b}, R^{5c}, R^{5d}, R^{6b}, R^{6c}, R^{6d}, R^{α} and R^{β} independently represents a hydrogen atom or a substituent, and mutually adjacent substituents may be mutually bonded together to form a ring with the carbon atom(s) bonded thereto; and each 2 or more X, Y, R^{4b}, R^{4c}, R^{5b}, R^{5c}, R^{6b} and R^{6c} may be the same or different from each other.

In one aspect of the present invention, it is preferable that the organic group consisting of Q^{1a} and Q^{1b}, which are two nitrogen-containing aromatic hetero rings, or Q^{1b} and Q^{1c}, which are two nitrogen-containing aromatic hetero rings, and a direct bond or a linking group mutually bonding the two nitrogen-containing aromatic hetero rings is a divalent organic group represented by any one of general formulas (B-7-a) to (B-7-e), (B-8-a) to (B-8-e), (B-9-a) to (B-9-e) and (B-10-a) to (B-10-e) shown below:

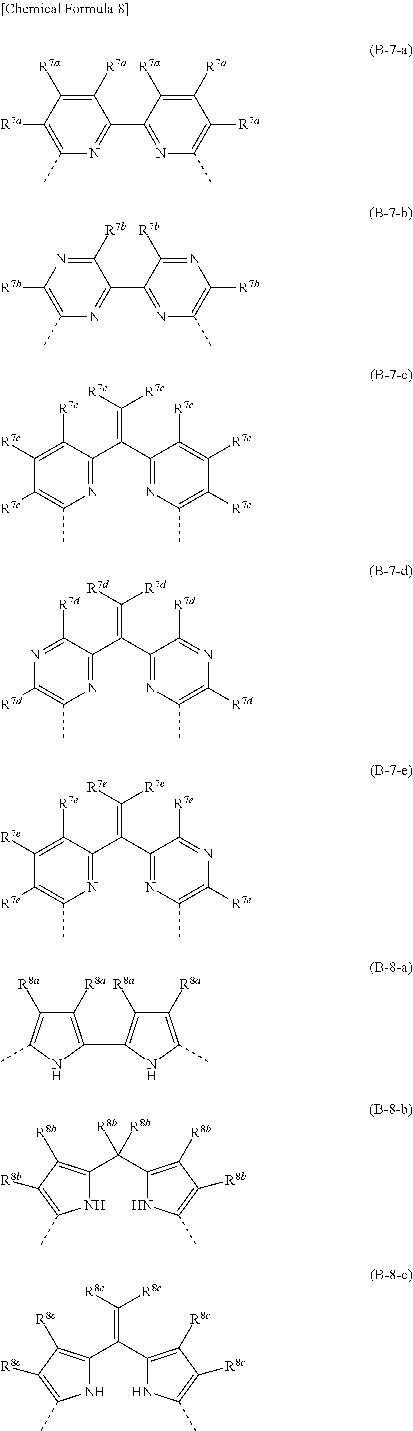

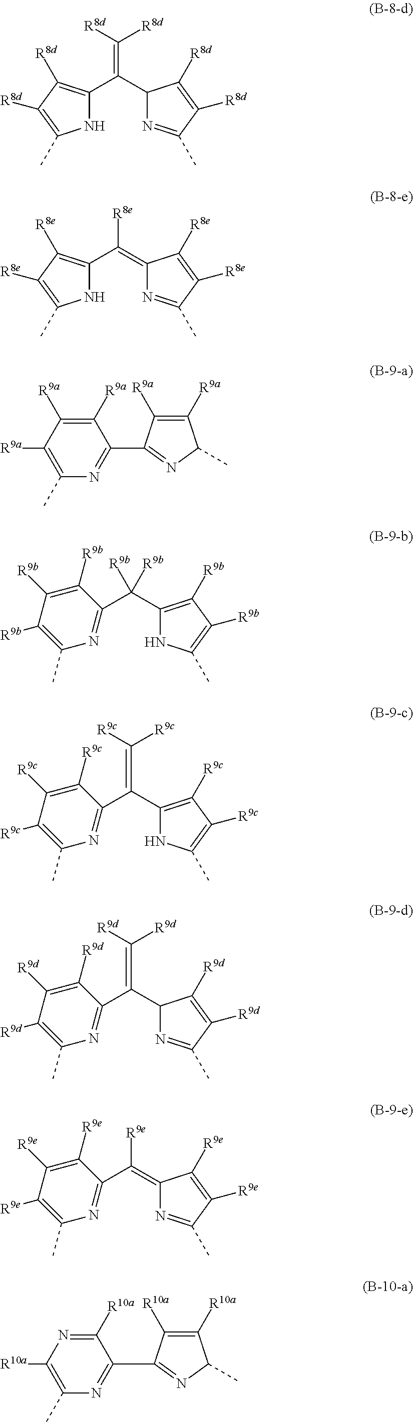

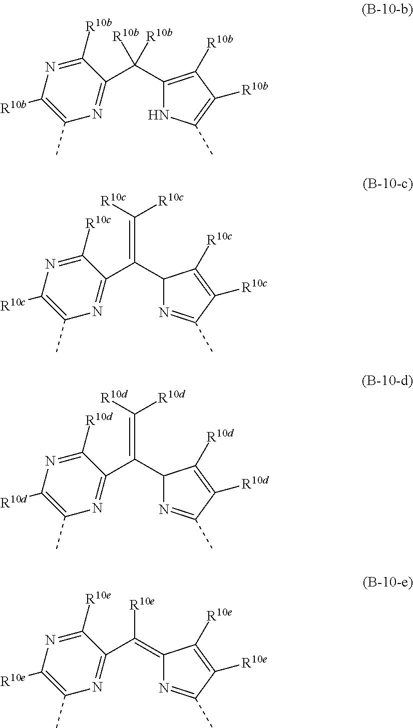

wherein each of R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} independently represents a hydrogen atom or a substituent, and mutually adjacent substituents may be mutually bonded together to form a ring with the carbon atom(s) bonded thereto; and each 2 or more R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} may be the same or different from each other.

In one aspect of the present invention, the ligand is preferably an aromatic compound represented by general formula (XI) shown below:

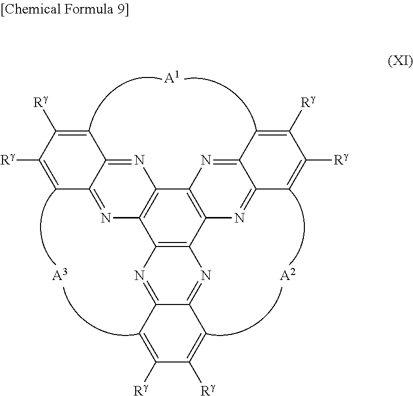

wherein R^{γ} represents a hydrogen atom or a substituent, each 2 or more R^{γ} may be the same or different from each other, when 2 or more R^{γ} represent substituents, each R^{γ} may be the same or different from each other, and adjacent substituents may be mutually bonded to form a ring with the carbon atoms bonded thereto; and each of A¹, A² and A³ independently represents a divalent organic group represented by any one of general formulas (B-7-a) to (B-7-e), (B-8-a) to (B-8-e), (B-9-a) to (B-9-e) and (B-10-a) to (B-10-e) shown below:

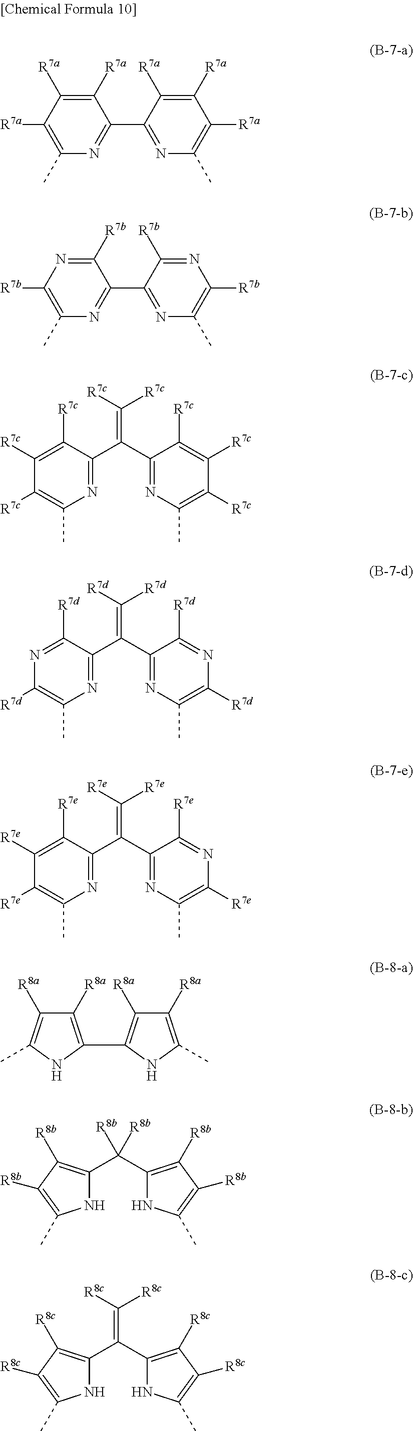

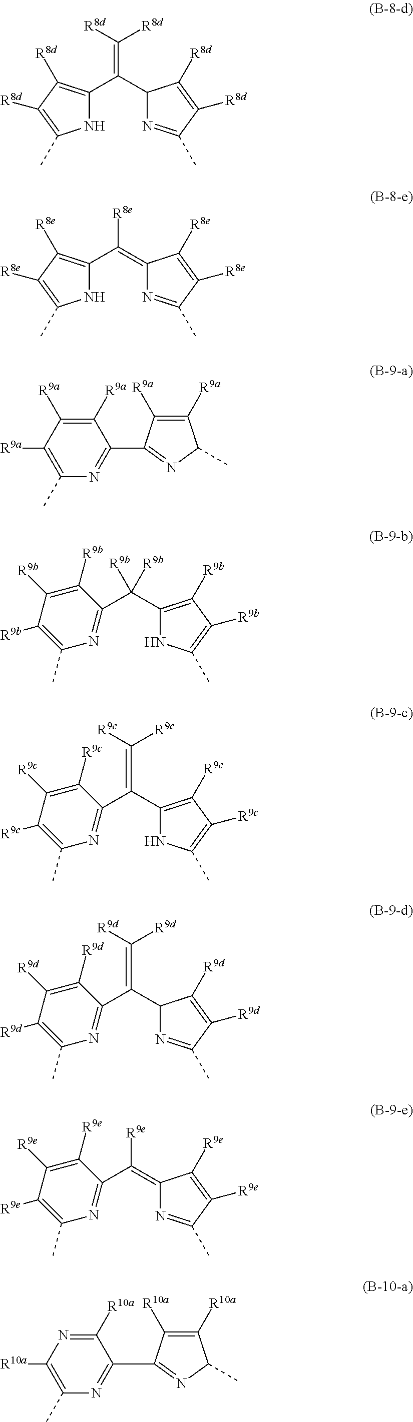

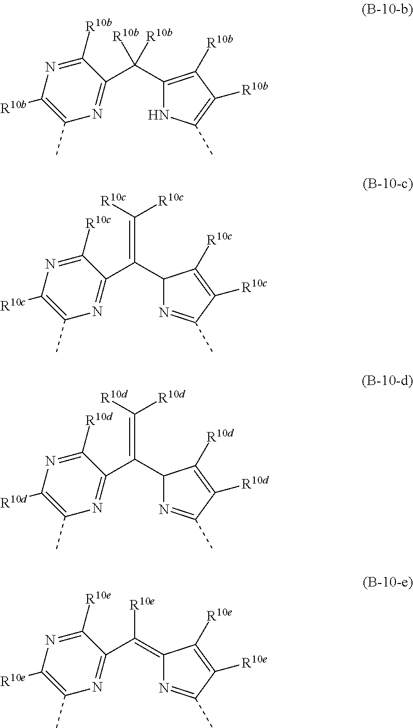

wherein each of R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} independently represents a hydrogen atom or a substituent, and mutually adjacent substituents may be mutually bonded together to form a ring with the carbon atom(s) bonded thereto; and each 2 or more R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} may be the same or different from each other.

In one aspect of the present invention, the central metal is preferably a transition metal atom belonging to the 4th period to the 6th period of the periodic table, or an ion thereof.

In one aspect of the present invention, the number of the central metals is preferably 2 to 4.

In one aspect of the present invention, the cathode catalyst preferably comprises a composition containing the aforementioned polynuclear metal complex and carbon.

In one aspect of the present invention, the cathode catalyst preferably comprises a composition containing a polymer having a residue of the polynuclear metal complex and carbon.

In one aspect of the present invention, it is preferable that the material that forms the cathode catalyst is a modified material obtained by heating the polynuclear metal complex, the composition containing the polynuclear metal complex and carbon, or the composition containing the polymer having a residue of the polynuclear metal complex and carbon at 300° C. or more and 1,200° C. or less.

Further, one aspect of the present invention provides an air secondary cell comprising the aforementioned cathode catalyst for an air secondary cell in a cathode catalyst layer, and comprising at least one material selected from the group consisting of zinc, iron, aluminum, magnesium, lithium, hydrogen, and ions thereof as an anode active material.

### Effects of the Invention

The present invention can provide a cathode catalyst for an air secondary cell that exhibits both excellent oxygen reduction activity and excellent water oxidation activity, and an air secondary cell that uses the catalyst.

### BRIEF DESCRIPTION OF THE DRAWINGS

FIG. 1 is a schematic cross-sectional view illustrating an embodiment of an air secondary cell according to an embodiment of the present invention.

FIG. 2 is a graph illustrating the results of a charge-discharge cycle test of an air secondary cell in Example 7.

FIG. 3 is a graph illustrating the results of a charge-discharge cycle test of an air secondary cell in Example 8.

FIG. 4 is a graph illustrating the results of a charge-discharge cycle test of an air secondary cell in Example 16.

FIG. 5 is a graph illustrating the results of a charge-discharge cycle test of an air secondary cell in Example 17.

FIG. 6 is a graph illustrating the results of a charge-discharge cycle test of an air secondary cell in Example 18.

FIG. 7 is a graph illustrating the results of a charge-discharge cycle test of an air secondary cell in Example 19.

### MODES FOR CARRYING OUT THE INVENTION

A detailed description of embodiments of the present invention is presented below. In the embodiments of the present invention, unless specifically stated otherwise, “have a substituent” means that, in the target group, “at least one hydrogen atom has been substituted with a group other than a hydrogen atom (a substituent)”, and also means that “there are no limitations on the number of substituents or the position of each substituent, and all of the hydrogen atoms may be substituted with substituents”.

### <Cathode Catalyst for Air Secondary Cell>

A cathode catalyst for an air secondary cell (hereinafter sometimes referred to as simply “the cathode catalyst”) according to the present embodiment comprises a polynuclear metal complex. Here, a polynuclear metal complex is a metal complex having 2 or more metal atoms or metal ions, and may have only metal atoms, only metal ions, or metal atoms and metal ions. The metal atoms or metal ions form the aforementioned polynuclear metal complex together with a ligand containing at least one of nitrogen atoms, oxygen atoms and sulfur atoms as atoms that can bond via coordination bonding. The polynuclear metal complex exhibits both excellent oxygen reduction activity and excellent water oxidation activity, and is useful for application in an air secondary cell.

### (Polynuclear Metal Complex)

In the cathode catalyst for an air secondary cell of the present embodiment, the aforementioned polynuclear metal complex has 2 or more central metals, and a ligand that bonds to the central metals by means of coordination bonds, and the ligand includes 2 or more structures within the molecule, each structure having a space surrounded by 4 or more atoms being able to coordinate with the central metal, in which the 4 or more atoms are at least one type of atom selected from the group consisting of a nitrogen atom, an oxygen atom and a sulfur atom, and being able to accommodate the central metal in the space (wherein the 2 or more structures may be the same or different from each other).

The number of atoms that surround the space and are able to coordinate with the central metal is preferably 4 to 8, and more preferably 4 to 6. The number of the aforementioned structures within the molecule is preferably 2 to 6, more preferably 2 to 5, and still more preferably 2 to 4.

The 4 or more atoms being able to coordinate with the central metal form a “space” within the molecule that is able to accommodate the central metal. The molecular structure positioned adjacent to this type of space and forming the outer edge around the space is a “structure having a space surrounded by 4 or more atoms being able to coordinate with the central metal, in which the 4 or more atoms are at least one type of atom selected from the group consisting of a nitrogen atom, an oxygen atom and a sulfur atom, and being able to accommodate the central metal in the space”. The ligand used in the polynuclear metal complex of the present embodiment has 2 or more of these structures within the molecule.

The polynuclear metal complex may be a polynuclear metal complex formed by the bonding (typically coordination bonding) of the 2 or more metal atoms or metal ions to the ligand, but also having a structure in which one metal atom or metal ion and another metal atom or metal ion are bridged. In the case where the total number of metal atoms or metal ions is 2, examples of this partial structure include the following (A-i) to (A-vi).

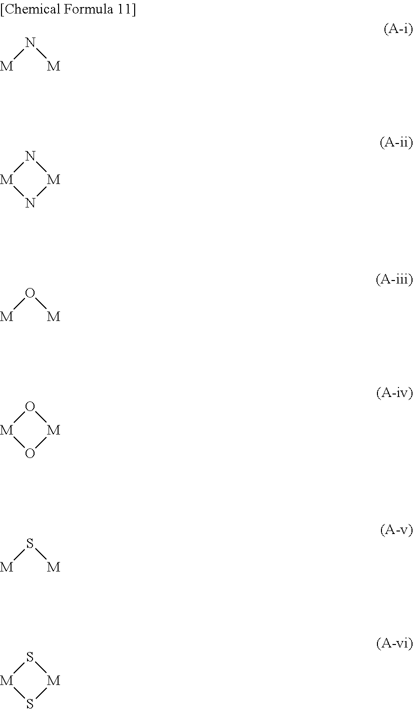

M represents a metal atom or a metal ion, and the two M may be the same or different from each other.

In the polynuclear metal complex, the number of central metals is preferably 2 to 6. In the polynuclear metal complex, the number of central metals is more preferably 2 to 5, and still more preferably 2 to 4.

Further, each of the central metals of the polynuclear metal complex is preferably a transition metal atom belonging to the 4th period to the 6th period of the periodic table, or an ion thereof, is more preferably one or more metals or ions selected from the group consisting of vanadium, chromium, manganese, iron, cobalt, nickel, copper, and ions thereof, and is still more preferably one or more metals selected from the group consisting of vanadium, chromium, manganese, iron, cobalt, nickel and copper.

Examples of polynuclear metal complexes bridged with nitrogen atoms include the polynuclear metal complexes represented by general formula (A-a) shown below. The electrical charge of the polynuclear metal complex is omitted.

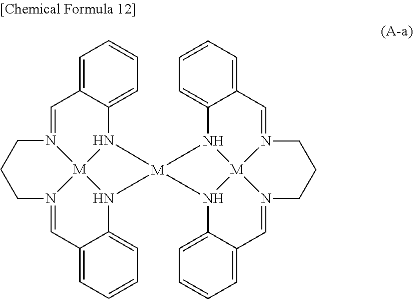

Examples of polynuclear metal complexes bridged with oxygen atoms include the polynuclear metal complexes represented by general formulas (A-b) to (A-h) shown below. The electrical charge of each polynuclear metal complex is omitted.

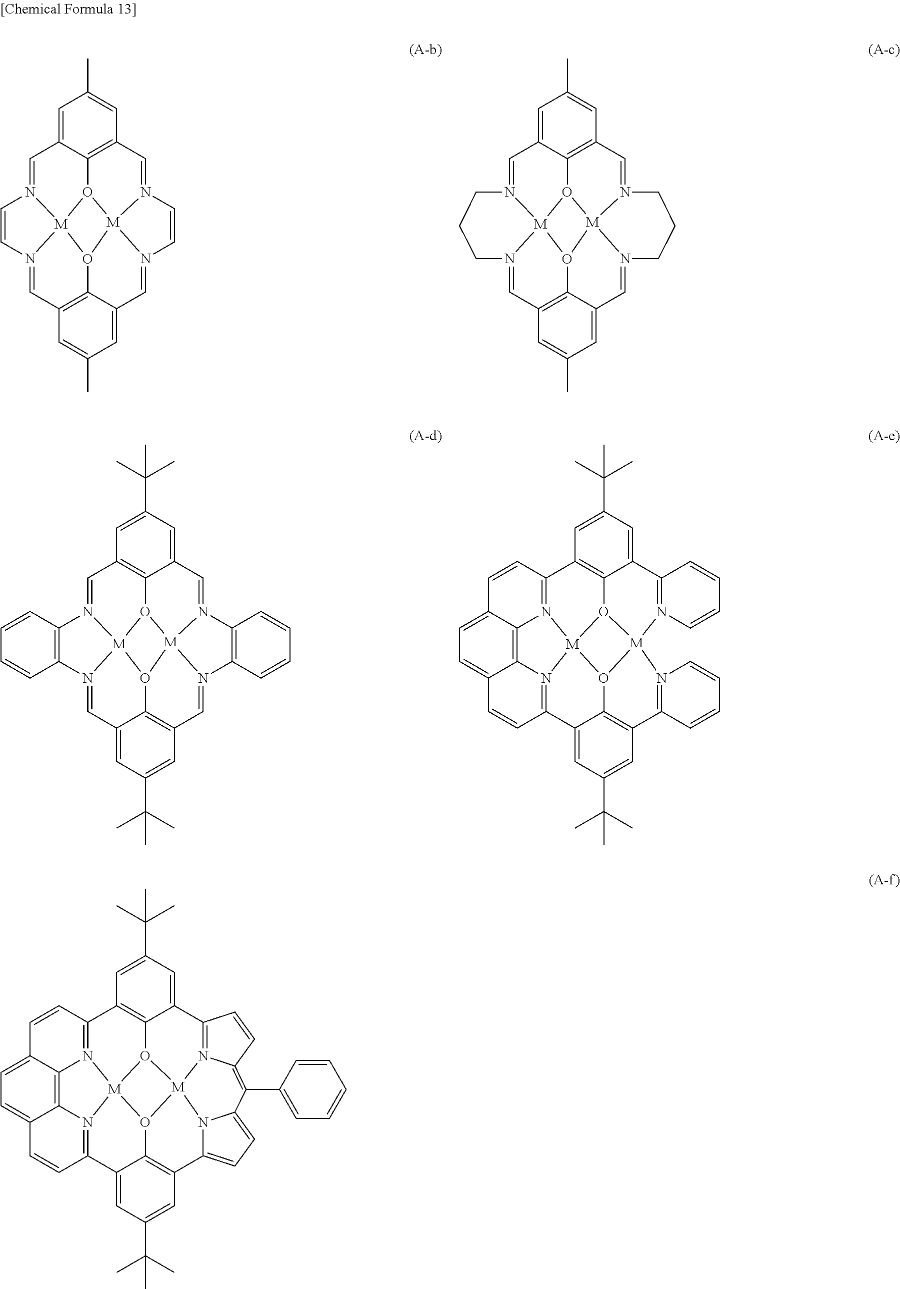

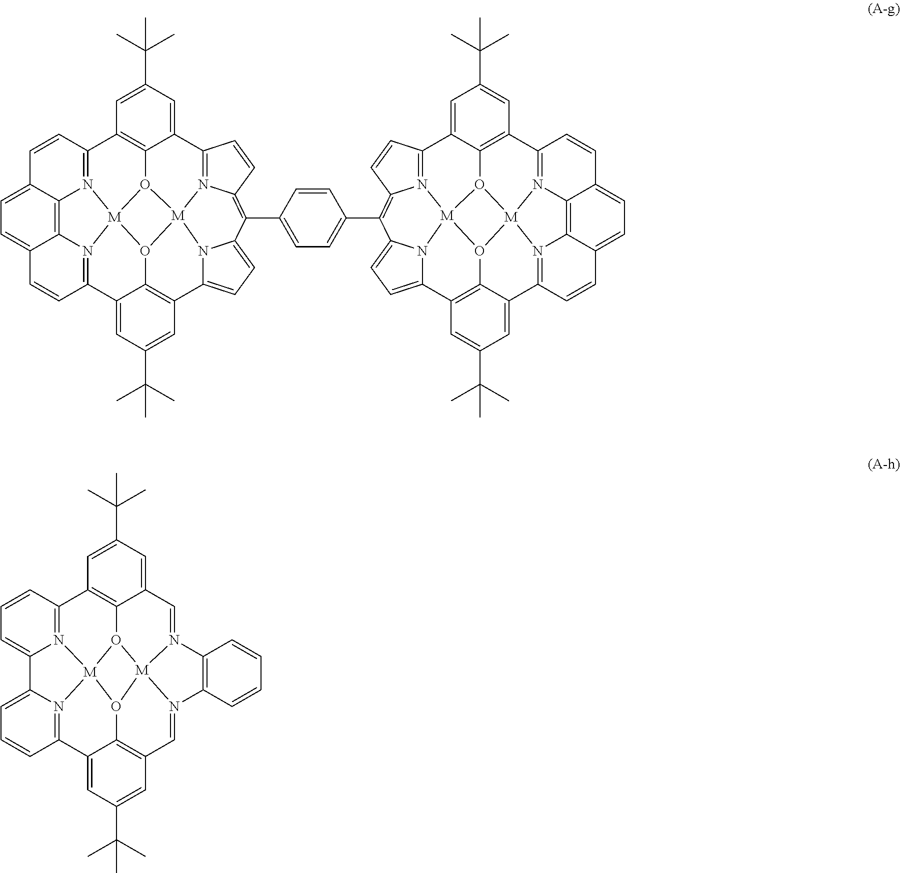

Examples of polynuclear metal complexes bridged with sulfur atoms include the polynuclear metal complexes represented by general formulas (A-i) to (A-l) shown below. The electrical charge of each polynuclear metal complex is omitted.

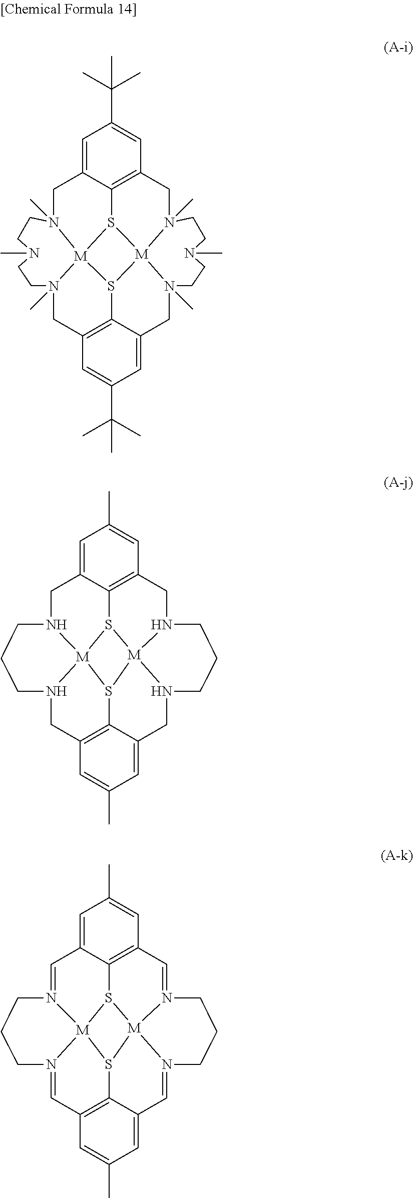

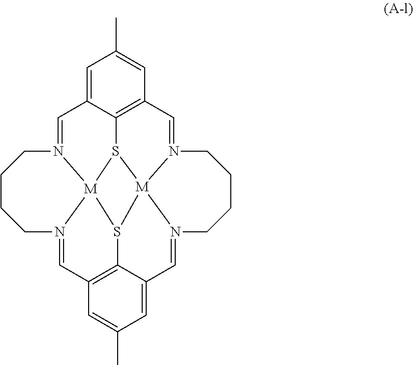

Furthermore, the ligand of the polynuclear metal complex of the present embodiment may include 2 or more structures within the molecule wherein each structure has a space surrounded by 2 nitrogen atoms and 2 oxygen atoms being able to coordinate with the central metal, and is able to accommodate the central metal in the space (and wherein the 2 or more structures may be the same or different from each other). Examples of polynuclear metal complexes having such a ligand include the polynuclear metal complexes represented by general formulas (A-m) to (A-n) shown below. The electrical charge of each polynuclear metal complex is omitted.

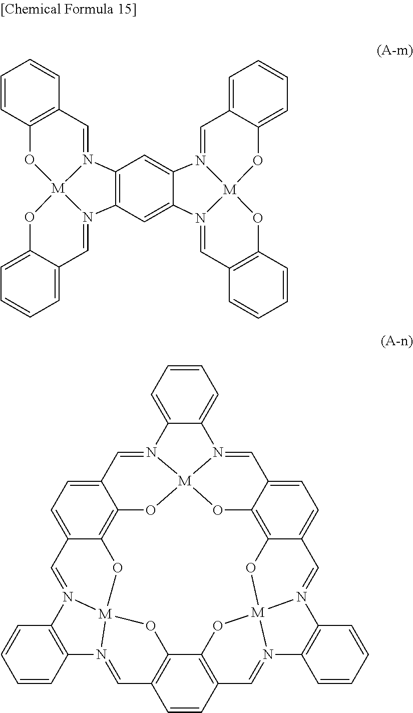

Furthermore, the ligand of the polynuclear metal complex of the present embodiment may include 2 or more structures within the molecule wherein each structure has a space surrounded by 4 nitrogen atoms being able to coordinate with the central metal, and is able to accommodate the central metal in the space (and wherein the 2 or more structures may be the same or different from each other). Examples of polynuclear metal complexes having such a ligand include the polynuclear metal complexes represented by general formulas (A-o) to (A-s) shown below. The electrical charge of each polynuclear metal complex is omitted.

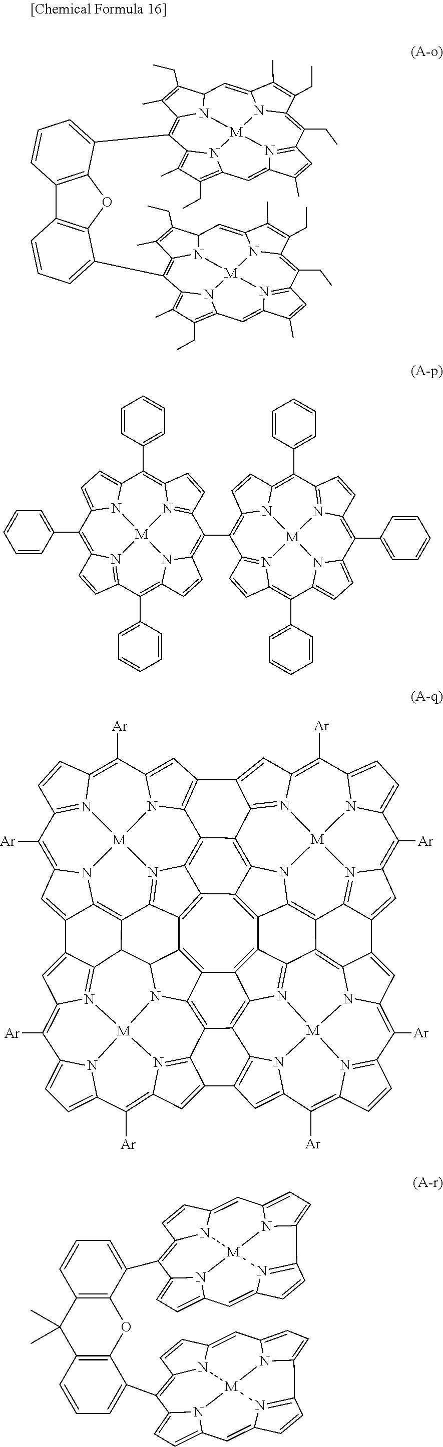

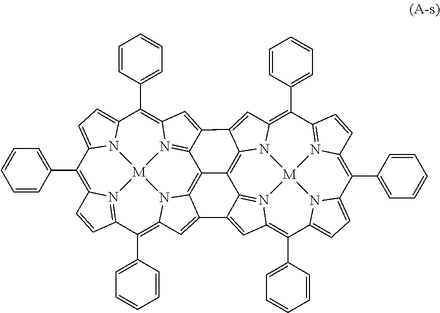

### (First Polynuclear Metal Complex)

In the present embodiment, the polynuclear metal complex is preferably represented by general formula (A-1) shown below. In the following description, a polynuclear metal complex represented by general formula (A-1) below is sometimes referred to as the “first polynuclear metal complex”.

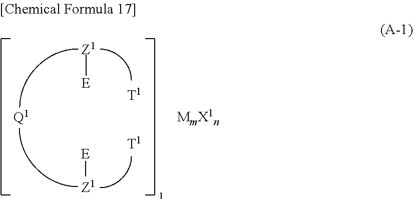

In the formula, Z¹ represents a trivalent organic group, and 2 or more Z¹ may be the same or different from each other; E represents an oxygen atom or a sulfur atom, where 2 or more E may be the same or different from each other; Q¹ represents a divalent organic group having at least 2 nitrogen atoms; T¹ represents an organic group having a nitrogen atom, 2 or more T¹ may be the same or different from each other, and 2 or more T¹ may be mutually bonded; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other.

In general formula (A-1), Z¹ represents a trivalent organic group, and 2 or more Z¹ (the two Z¹ within the general formula to which 1 is appended) may be the same or different from each other.

Examples of the trivalent organic group include aromatic groups which may have a substituent.

The aromatic group for Z¹ is a trivalent group formed by removing 3 hydrogen atoms from an aromatic compound (and preferably from the carbon atoms that constitute the ring(s) of the aromatic compound). Examples of the aromatic compound include aromatic compounds in which the total number of carbon atoms is preferably 3 to 60, and more preferably 3 to 40, such as benzene, naphthalene, anthracene, tetracene, biphenyl, binaphthyl, phenanthrene, dibenzofuran, thiophene, benzothiophene, dibenzothiophene, pyridine, pyrazine and pyrrole, and the compound may be either monocyclic or polycyclic.

The substituent which the aromatic group may have (hereinafter referred to as “substituent G”) is a group other than a hydrogen atom, and in the case of 2 or more substituents G, these 2 or more substituents G may be the same or different from each other, and mutually adjacent substituents G may be mutually bonded to form a ring together with the atoms bonded thereto.

Examples of preferred substituents G include a hydroxyl group, amino group, nitro group, cyano group, carboxyl group, formyl group, hydroxysulfonyl group, halogen atom, hydrocarbyl group which may have a substituent (monovalent hydrocarbon group which may have a substituent), hydrocarbyloxy group which may have a substituent (hydrocarbon oxy group which may have a substituent), hydrocarbylmercapto group which may have a substituent (hydrocarbon mercapto group which may have a substituent), hydrocarbylcarbonyl group which may have a substituent (hydrocarbon carbonyl group which may have a substituent), hydrocarbyloxycarbonyl group which may have a substituent (hydrocarbon oxy carbonyl group which may have a substituent), hydrocarbyloxysulfonyl group which may have a substituent (hydrocarbon sulfonyl group which may have a substituent), amino group substituted with 2 hydrocarbyl groups which may each have a substituent (namely, hydrocarbon-disubstituted amino group which may have a substituent, hereinafter sometimes referred to as a “substituted amino group”), and aminocarbonyl group substituted with 2 hydrocarbyl groups which may each have a substituent (namely, hydrocarbon-disubstituted aminocarbonyl group which may have a substituent, hereinafter sometimes referred to as a “substituted aminocarbonyl group”).

Among these, the substituent G is more preferably a hydrocarbyl group which may have a substituent, hydrocarbyloxy group which may have a substituent, amino group substituted with 2 hydrocarbyl groups which may each have a substituent, hydrocarbylmercapto group which may have a substituent, hydrocarbylcarbonyl group which may have a substituent, or hydrocarbyloxycarbonyl group which may have a substituent, is still more preferably a hydrocarbyl group which may have a substituent, hydrocarbyloxy group which may have a substituent, or amino group substituted with 2 hydrocarbyl groups which may each have a substituent, and is particularly preferably a hydrocarbyl group which may have a substituent or a hydrocarbyloxy group which may have a substituent.

In the substituent G, when a nitrogen atom having a hydrogen atom bonded thereto exists, the hydrogen atom is preferably substituted with a hydrocarbyl group. Further, when the substituent G has 2 or more substituents, these 2 or more substituents may be the same or different from each other, and adjacent substituents may be mutually bonded to form a ring with the atoms bonded thereto.

Examples of the hydrocarbyl group for the substituent G include linear and branched alkyl groups, preferably of 1 to 50 carbon atoms and more preferably 1 to 20 carbon atoms, such as a methyl group, ethyl group, n-propyl group, isopropyl group, n-butyl group, isobutyl group, tert-butyl group, pentyl group, hexyl group, heptyl group, octyl group, nonyl group, decyl group, undecyl group, dodecyl group, pentadecyl group, octadecyl group and docosyl group; monocyclic and polycyclic cycloalkyl groups, preferably of 3 to 50 carbon atoms and more preferably 3 to 20 carbon atoms, such as a cyclopropyl group, cyclobutyl group, cyclobutyl group, cyclopentyl group, cyclohexyl group, cyclononyl group, cyclododecyl group, norbornyl group and adamantyl group; linear, branched and cyclic (in the case of a cyclic group, either monocyclic or polycyclic) alkenyl groups, preferably of 2 to 50 carbon atoms, and more preferably 2 to 20 carbon atoms, such as an ethenyl group, propenyl group, 3-butenyl group, 2-butenyl group, 2-pentenyl group, 2-hexenyl group, 2-noneyl group and 2-dodecenyl group; monocyclic and polycyclic aryl groups, preferably of 6 to 50 carbon atoms and more preferably 6 to 20 carbon atoms, such as a phenyl group, 1-naphthyl group, 2-naphthyl group, 2-methylphenyl group, 3-methylphenyl group, 4-methylphenyl group, 4-ethylphenyl group, 4-propylphenyl group, 4-isopropylphenyl group, 4-butylphenyl group, 4-tert-butylphenyl group, 4-hexylphenyl group, 4-cyclohexylphenyl group, 4-adamantylphenyl group and 4-phenylphenyl group; and aralkyl groups, preferably of 7 to 50 carbon atoms and more preferably 7 to 20 carbon atoms, such as a phenylmethyl group, 1-phenylethyl group, 2-phenylethyl group, 1-phenyl-1-propyl group, 1-phenyl-2-propyl group, 2-phenyl-2-propyl group, 3-phenyl-1-propyl group, 4-phenyl-1-butyl group, 5-phenyl-1-pentyl group and 6-phenyl-1-hexyl group. Alkyl groups of 3 to 10 carbon atoms are preferable.

The hydrocarbyl group for the substituent G is preferably a group of 1 to 20 carbon atoms, more preferably 2 to 12 carbon atoms, and still more preferably 3 to 10 carbon atoms.

The hydrocarbyloxy group, hydrocarbylmercapto group, hydrocarbylcarbonyl group, hydrocarbyloxycarbonyl group or hydrocarbylsulfonyl group for the substituent G is a monovalent group in which one aforementioned hydrocarbyl group is bonded to an oxy group, mercapto group, carbonyl group, oxycarbonyl group or sulfonyl group respectively.

The substituted amino group or substituted aminocarbonyl group for the substituent G is a group in which the two hydrogen atoms in an amino group (—NH₂) or an aminocarbonyl group (—C(═O)—NH₂) respectively have each been substituted with an aforementioned hydrocarbyl group. This hydrocarbyl group is the same as the hydrocarbyl described above as the substituent G.

Examples of the substituent which the hydrocarbyloxy group, hydrocarbylmercapto group, hydrocarbylcarbonyl group, hydrocarbyloxycarbonyl group, hydrocarbylsulfonyl group, substituted amino group or substituted aminocarbonyl group for the substituent G may have include a halogen atom, hydroxyl group, amino group, nitro group, cyano group, hydrocarbyl group which may have a substituent, hydrocarbyloxy group which may have a substituent, hydrocarbylmercapto group which may have a substituent, hydrocarbylcarbonyl group which may have a substituent, hydrocarbyloxycarbonyl group which may have a substituent, and hydrocarbylsulfonyl group which may have a substituent.

Examples of the halogen atom include a fluorine atom, chlorine atom, bromine atom and iodine atom.

The hydrocarbyl group which may have a substituent, hydrocarbyloxy group which may have a substituent, hydrocarbylmercapto group which may have a substituent, hydrocarbylcarbonyl group which may have a substituent, hydrocarbyloxycarbonyl group which may have a substituent, and hydrocarbylsulfonyl group which may have a substituent are the same as those groups described above as the substituent G.

Among the above options, the substituent G is particularly preferably a methyl group, ethyl group, n-propyl group, isopropyl group, n-butyl group, isobutyl group, tert-butyl group, phenyl group, methylphenyl group, 1-naphthyl group, 2-naphthyl group or pyridyl group.

When adjacent substituents G are mutually bonded to form a ring with the atoms bonded thereto, preferred examples of this type of ring include a benzene ring, cyclohexane ring, pyridine ring and naphthalene ring. Further, this type of ring may have the substituent G described above as a substituent.

In the above general formula (A-1), E represents an oxygen atom or a sulfur atom, and 2 or more E (the two E within the general formula to which 1 is appended) may be the same or different from each other.

E is preferably an oxygen atom.

In general formula (A-1), Q¹ represents a divalent organic group having at least 2 nitrogen atoms, and is preferably a group represented by general formula (A-4-1), (A-4-2) or (A-4-3) shown below:

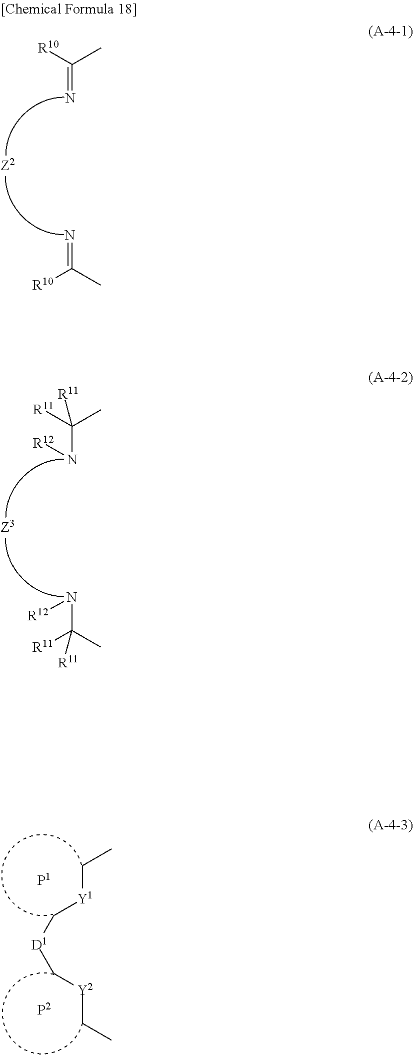

wherein each of R¹⁰ and R¹¹ independently represents a hydrogen atom or a substituent, and each 2 or more R¹⁰ and R¹¹ may be the same or different from each other; R¹² represents a hydrogen atom or a hydrocarbyl group of 1 to 12 carbon atoms; each of Z² and Z³ independently represents a divalent organic group; each of Y¹ and Y² independently represents a group represented by a formula —N═ or —NH—; P¹ represents a group of atoms that forms a hetero ring in combination with Y¹ and the 2 carbon atoms adjacent to Y¹; P² represents a group of atoms that forms a hetero ring in combination with Y² and the 2 carbon atoms adjacent to Y²; and D¹ represents a single bond, a double bond or a divalent linking group.

In general formulas (A-4-1) and (A-4-2), each of R¹⁰ and R¹¹ independently represents a hydrogen atom or a substituent, and each 2 or more R¹⁰ and R¹¹ may be the same or different from each other.

Examples of the substituent for R¹⁰ and R¹¹ include the same substituents as those described above for the substituent G.

In general formula (A-4-2), R¹² represents a hydrogen atom or a hydrocarbyl group of 1 to 12 carbon atoms.

With the exception of having 1 to 12 carbon atoms, the hydrocarbyl group for R¹² is the same as the hydrocarbyl group described above for the substituent G.

In general formulas (A-4-1) and (A-4-2), each of Z² and Z³ independently represents a divalent organic group. Examples of preferred groups for Z² and Z³ include an alkylene group or divalent aromatic group which may be substituted with a substituent.

The alkylene group for Z² and Z³ is a divalent group formed by removing 2 hydrogen atoms from a saturated hydrocarbon, and may be linear, branched or cyclic. Specific examples include linear and branched alkylene groups having a total number of carbon atoms that is preferably 1 to 20, more preferably 1 to 10, and still more preferably 2 to 10, and cyclic alkylene groups preferably having a total of 3 to 20 carbon atoms, such as a methylene group, ethylene group, 1,1-propylene group, 1,2-propylene group, 1,3-propylene group, 2,4-butylene group, 2,4-dimethyl-2,4-butylene group, 1,2-cyclopentylene group and 1,2-cyclohexylene group.

The alkylene group for Z² and Z³ may have a substituent the same as the substituent G described above.

The divalent aromatic group for Z² and Z³ is a divalent group formed by removing 2 hydrogen atoms from an aromatic compound (preferably from the carbon atoms that constitute the ring of the aromatic compound), and may be either monocyclic or polycyclic. Examples of the aromatic compound include aromatic compounds in which the total number of carbon atoms is preferably 3 to 60 and more preferably 3 to 40, such as benzene, naphthalene, anthracene, tetracene, biphenyl, binaphthyl, phenanthrene, dibenzofuran, thiophene, benzothiophene, dibenzothiophene, pyridine and pyrazine.

The aromatic group for Z² and Z³ may have a substituent the same as the substituent G described above.

Q¹ represented by the above general formula (A-4-1) is preferably a group represented by one of formulas (A-4-1-1) to (A-4-1-11) shown below, and is more preferably a group represented by one of formulas (A-4-1-1) to (A-4-1-6) shown below. Q¹ represented by one of formulas (A-4-1-1) to (A-4-1-11) shown below may have a substituent the same as the substituent G described above.

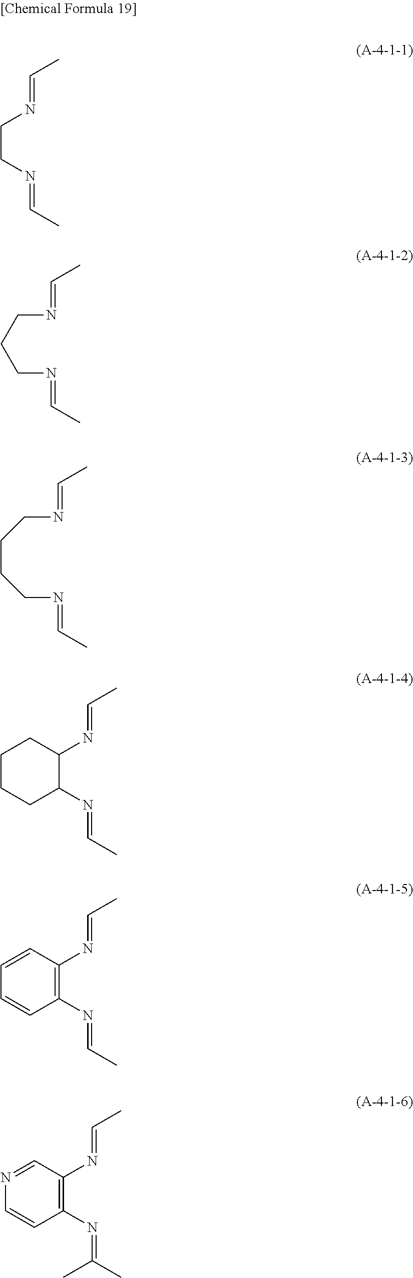

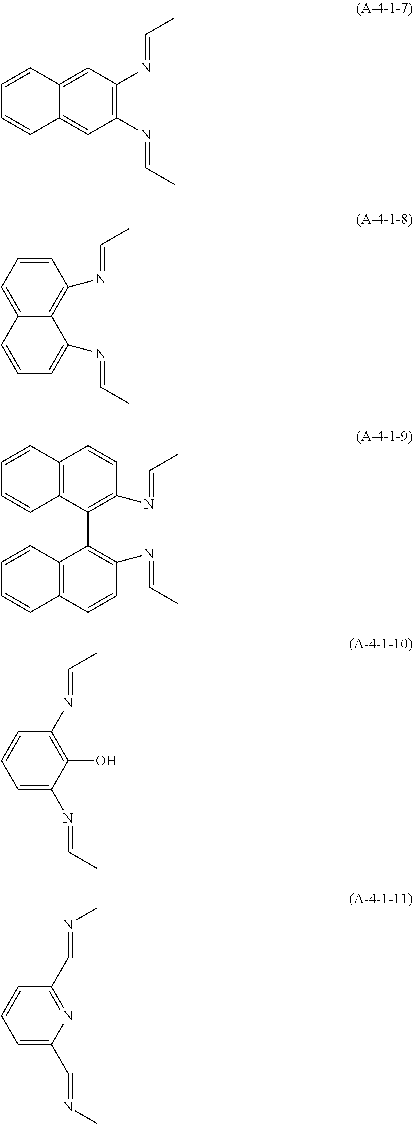

Q¹ represented by the above general formula (A-4-2) is preferably a group represented by one of general formulas (A-4-2-1) to (A-4-2-11) shown below, and is more preferably a group represented by one of general formulas (A-4-2-1) to (A-4-2-6) shown below. Q¹ represented by one of general formulas (A-4-2-1) to (A-4-2-11) shown below may have a substituent the same as the substituent G described above.

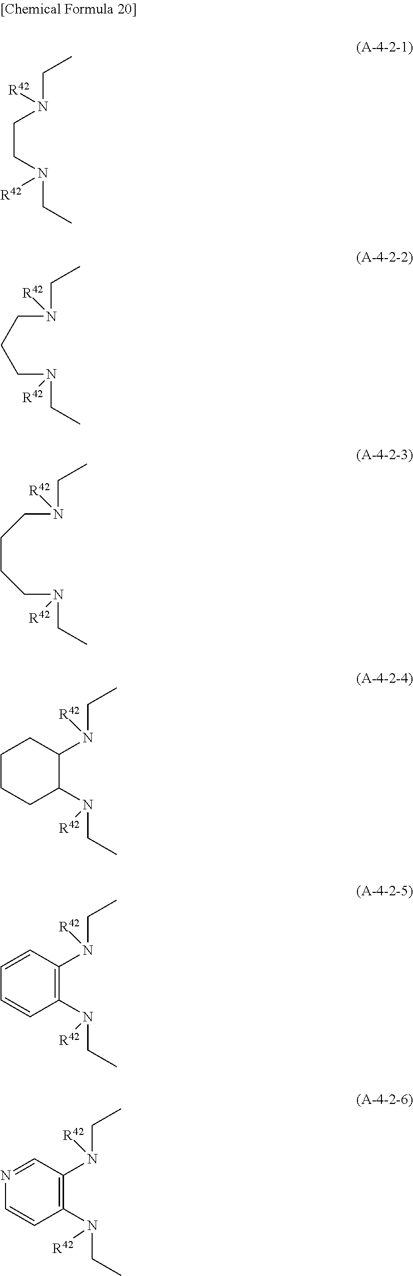

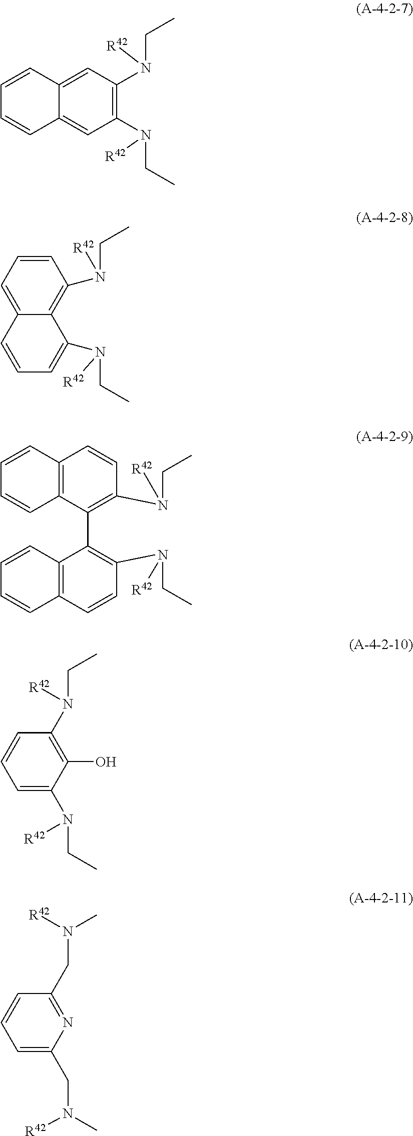

In the formulas, R⁴² represents a hydrogen atom or a hydrocarbyl group of 1 to 12 carbon atoms, and in the case of 2 or more R⁴², these 2 or more R⁴² may be the same or different from each other.

In the above formulas, R⁴² represents a hydrogen atom or a hydrocarbyl group of 1 to 12 carbon atoms, and the hydrocarbyl group is the same as the hydrocarbyl group described above for R¹².

Further, in the case of 2 or more R⁴², these 2 or more R⁴² may be the same or different from each other.

In the above general formula (A-4-3), each of Y¹ and Y² independently represents a group represented by a formula —N═ or —NH—. In the case of a group represented by the formula —N═, there are no limitations on the position of the double bond, namely no limitations on which of the 2 carbon atoms positioned adjacent to Y¹ or Y² constitutes part of the double bond.

In general formula (A-4-3), P¹ represents a group of atoms that forms a hetero ring in combination with Y¹ and the 2 carbon atoms adjacent to Y¹.

In general formula (A-4-3), P² represents a group of atoms that forms a hetero ring in combination with Y² and the 2 carbon atoms adjacent to Y².

The hetero ring formed from P¹ and the other atoms, and the hetero ring formed from P² and the other atoms may be monocyclic or polycyclic, are preferably aromatic hetero rings, and are more preferably nitrogen-containing aromatic hetero rings. Specific examples of such hetero rings include pyrrole, pyridine, pyrazine, pyrimidine, pyridazine, thiazole, imidazole, oxazole, triazole and indole, and pyrrole, pyridine, thiazole, imidazole and oxazole are particularly preferable.

The hetero ring formed from P¹ and the other atoms, and the hetero ring formed from P² and the other atoms may have a substituent the same as the substituent G described above. In the case of 2 or more substituents, adjacent substituents may be mutually bonded together to form a ring with the atoms bonded thereto. When these substituents, P¹, P² and D¹ form a ring, examples of preferred rings include a benzene ring, cyclohexane ring, pyridine ring and naphthalene ring. Further, this type of ring may have the substituent G described above as a substituent.

In the above general formula (A-4-3), D¹ represents a single bond, a double bond or a divalent linking group.

The linking group for D¹ is preferably an alkylene group, examples of which include the same groups as those described above for the alkylene group for Z² and Z³, and this alkylene group may have a substituent the same as the substituent G described above.

The aforementioned hetero ring formed from P¹ and the other atoms, and the aforementioned hetero ring formed from P² and the other atoms may be mutually bonded together via a bond or linking group other than D¹ to form a polycyclic hetero ring.

Q¹ represented by the above general formula (A-4-3) is preferably a group represented by one of general formulas (A-4-3-1) to (A-4-3-13) shown below, and is more preferably a group represented by one of general formulas (A-4-3-1) to (A-4-3-6) shown below. Q¹ represented by one of general formulas (A-4-3-1) to (A-4-3-13) shown below may have a substituent the same as the substituent G described above.

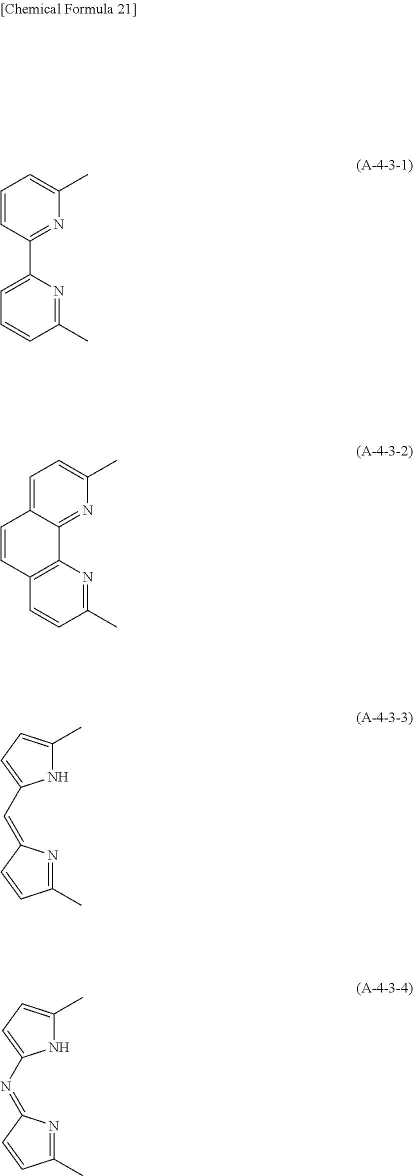

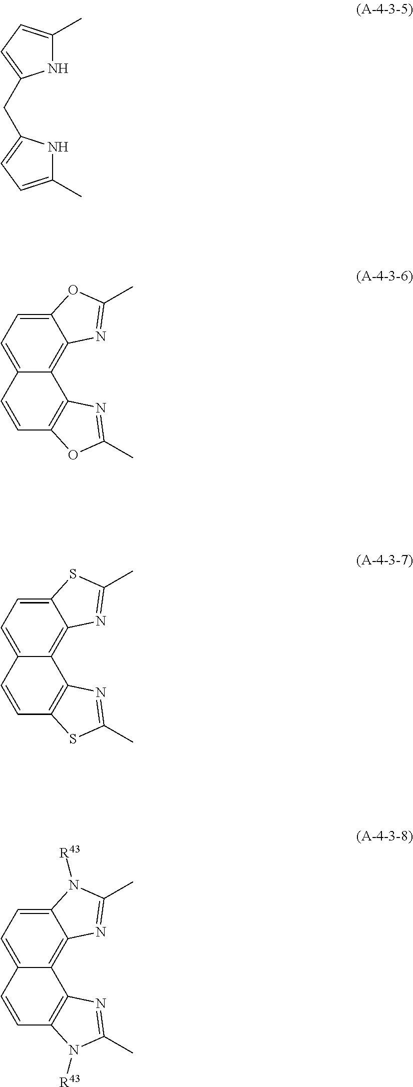

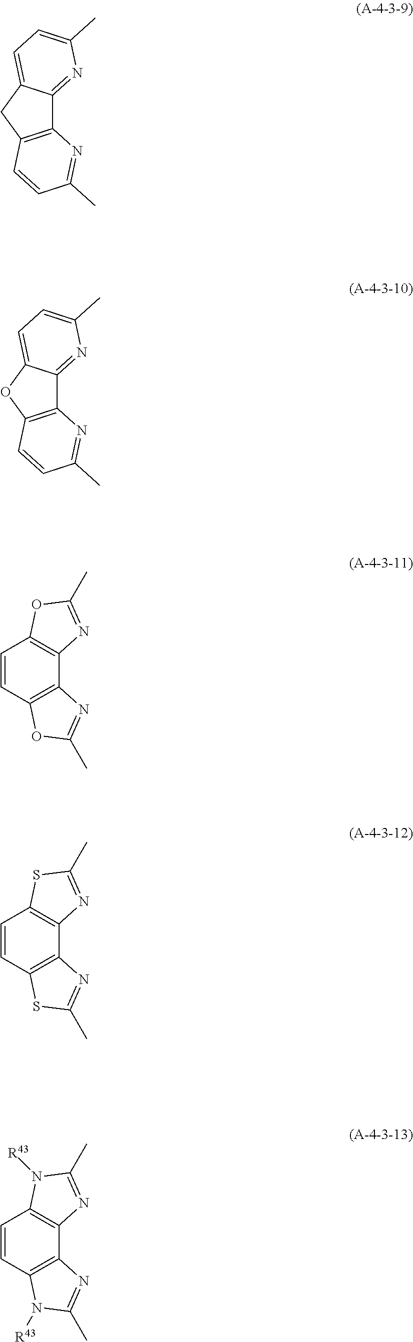

In the formulas, R⁴³ represents a hydrogen atom or a hydrocarbyl group of 1 to 12 carbon atoms, and 2 or more R⁴³ may be the same or different from each other.

In the formulas, R⁴³ is the same as R⁴² described above.

In the above general formula (A-1), T¹ represents an organic group having a nitrogen atom, 2 or more T¹ (the two T¹ within the general formula to which 1 is appended) may be the same or different from each other, and 2 or more T¹ may be mutually bonded.

Examples of preferred T¹ include groups represented by general formulas (A-5-a), (A-5-b) and (A-5-c) shown below:

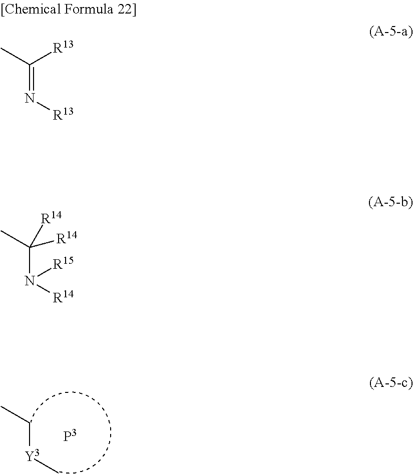

wherein each of R¹³ and R¹⁴ independently represents a hydrogen atom or a substituent, and each 2 or more R¹³ and R¹⁴ may be the same or different from each other; R¹⁵ represents a hydrogen atom or a hydrocarbyl group of 1 to 12 carbon atoms; Y³ represents a group represented by a formula —N═ or —NH—; and P³ represents a group of atoms that forms a nitrogen-containing aromatic hetero ring in combination with Y³ and the 2 carbon atoms adjacent to Y³.

In general formulas (A-5-a) and (A-5-b), each of R¹³ and R¹⁴ independently represents a hydrogen atom or a substituent, and examples of the substituent include the same substituents as those described above for the substituent G. Each 2 or more R¹³ and R¹⁴ may be the same or different from each other.

In general formula (A-5-b), R¹⁵ represents a hydrogen atom or a hydrocarbyl group of 1 to 12 carbon atoms, and is the same as R⁴² described above.

In general formula (A-5-c), Y³ represents a group represented by a formula —N═ or —NH—, and is the same as Y¹ and Y² in the above general formula (A-4-3). Accordingly, when Y³ is a group represented by the formula —N═, there are no limitations on the position of the double bond, namely no limitations on which of the 2 carbon atoms positioned adjacent to Y³ constitutes part of the double bond.

The nitrogen-containing aromatic hetero ring formed from P³ and the other atoms may be monocyclic or polycyclic, and specific examples of preferred rings include pyridine, pyrrole, pyrazine, pyrimidine, pyridazine, thiazole, imidazole, oxazole, triazole, indole, benzimidazole, quinoline, isoquinoline, cinnoline, phthalazine, quinazoline, quinoxaline and benzodiazine. Pyridine, pyrrole, pyrazine, pyrimidine, pyridazine, thiazole, imidazole, oxazole, triazole, indole, benzimidazole and pyrrole are more preferable, and pyridine pyrrole, thiazole, imidazole and oxazole are even more preferable. The nitrogen-containing aromatic hetero ring may have a substituent the same as the substituent G described above.

Preferred examples of the divalent organic group formed when two T¹ are mutually bonded include organic groups represented by formulas (A-5-1) to (A-5-35) shown below. The organic groups represented by formulas (A-5-1) to (A-5-35) shown below may have a substituent the same as the substituent G described above.

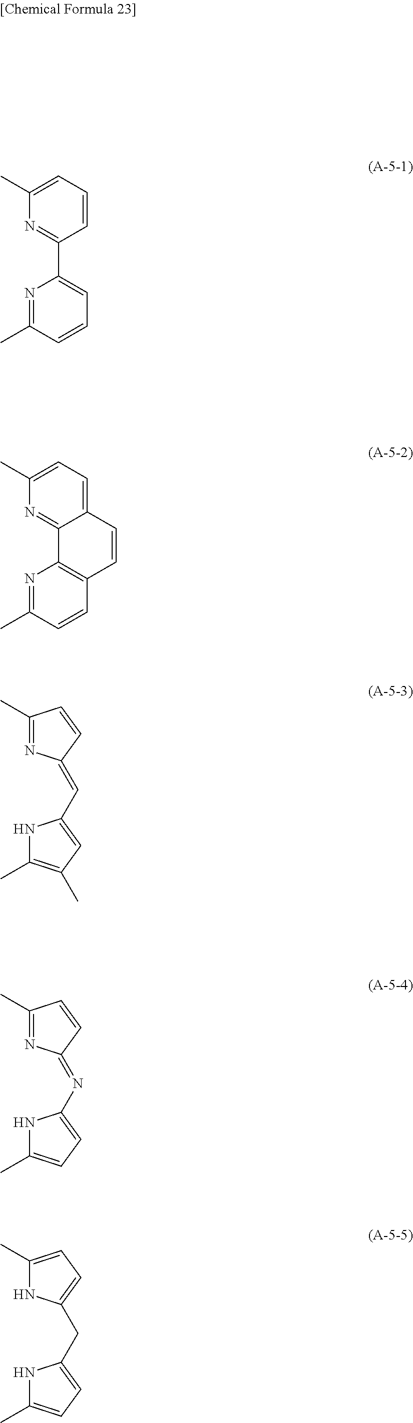

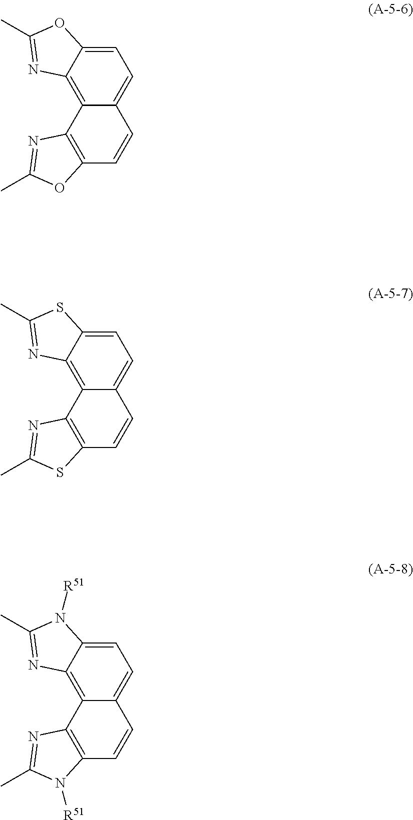

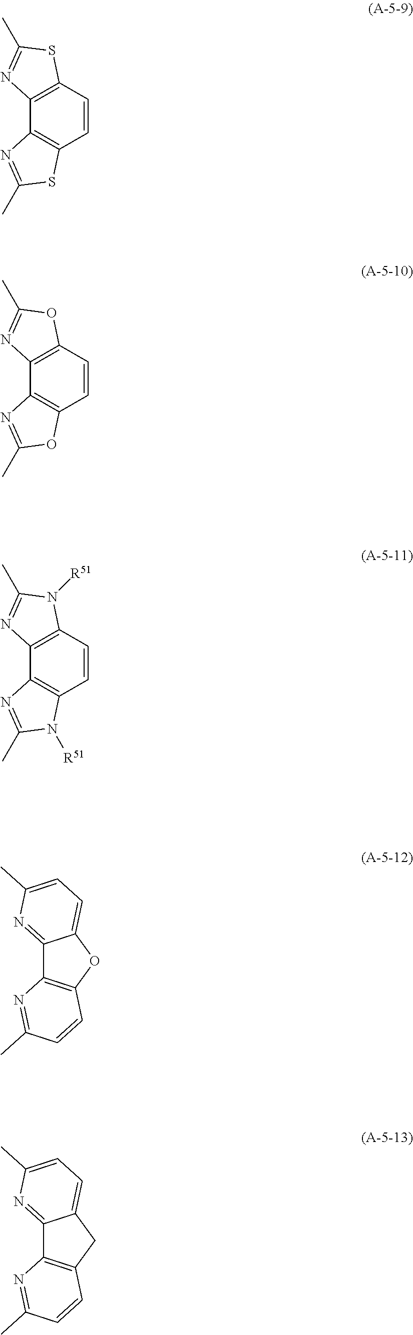

In the formulas, R⁵¹ represents a hydrogen atom or a hydrocarbyl group of 1 to 12 carbon atoms, and 2 or more R⁵¹ may be the same or different from each other.

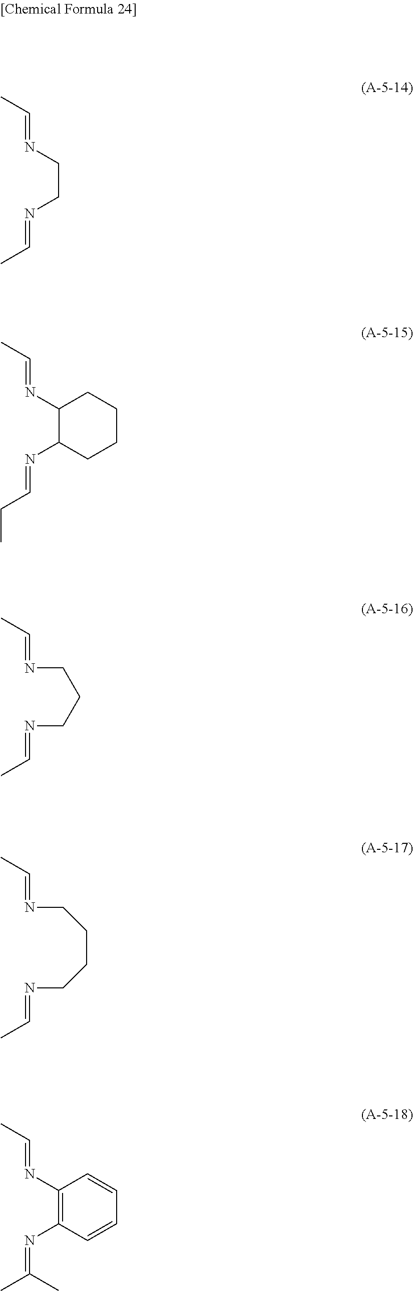

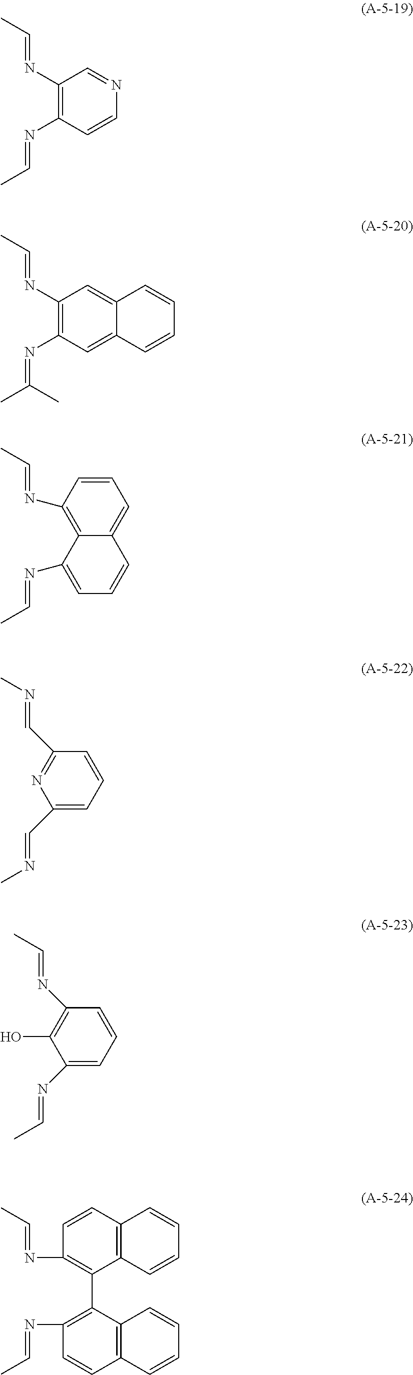

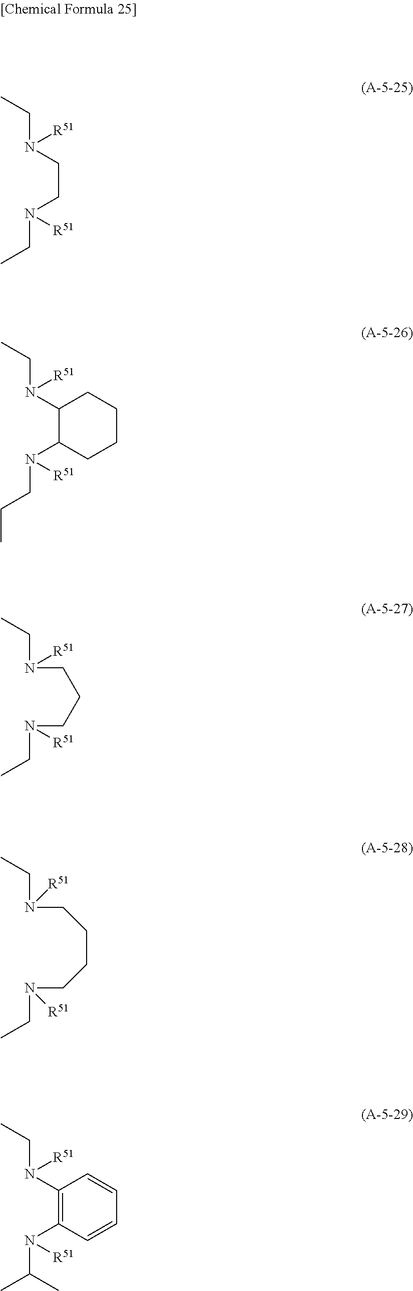

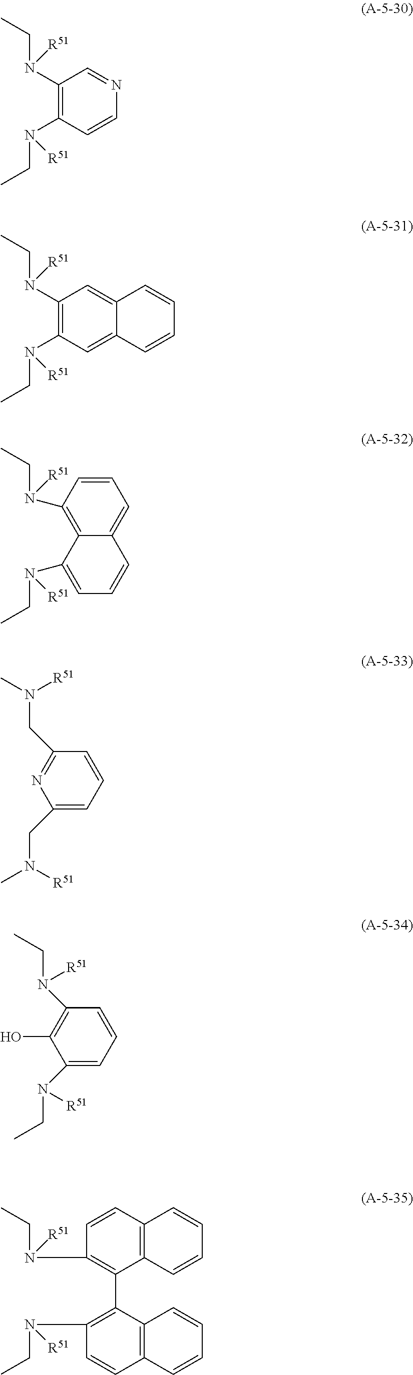

In the formulas, R⁵¹ represents a hydrogen atom or a hydrocarbyl group of 1 to 12 carbon atoms, and 2 or more R⁵¹ may be the same or different from each other.

In the above formulas, R⁵¹ represents a hydrogen atom or a hydrocarbyl group of 1 to 12 carbon atoms, and is the same as R⁴² described above.

In the above general formula (A-1), 1 represents an integer of 1 or more, and represents the number of ligands that constitute the polynuclear metal complex, and is preferably 1 to 4, more preferably 1 or 2, and most preferably 1.

When 1 represents 2 or more, the 2 or more of the general formula to which 1 is appended (the general formula that represents the ligand containing Z¹, E, Q¹ and T¹) may be the same or different from each other.

In general formula (A-1), M represents a transition metal atom or a transition metal ion, and in the polynuclear metal complex, M is bonded to at least E by means of coordination bonding or ionic bonding. Further, one M is also bonded by coordination bonds to the 2 or more nitrogen atoms of Q¹ in general formula (A-1), so that including E, this M is bonded by coordination bonding to 4 or more atoms. Moreover, one M is bonded by coordination bonds to nitrogen atoms of T¹ in general formula (A-1), so that including E, this M is bonded by coordination bonding to 4 or more atoms.

In other words, the ligand in general formula (A-1) (the ligand containing Z¹, E, Q¹ and T¹) has, within the molecule, 2 or more structures each having a space surrounded by 4 or more atoms being able to coordinate with M (the space surrounded by two E and the 2 or more nitrogen atoms of Q¹, and the space surrounded by two E and the nitrogen atoms of two T¹) and being able to accommodate the central metal in the space (namely, the structure that constitutes the space surrounded by two E and the 2 or more nitrogen atoms of Q¹, and the structure that constitutes the space surrounded by two E and the nitrogen atoms of two T¹).

The aforementioned transition metal atom is preferably a transition metal atom belonging to the 4th period to the 6th period of the periodic table.

Specific examples include scandium, titanium, vanadium, chromium, manganese, iron, cobalt, nickel, copper, yttrium, zirconium, niobium, molybdenum, ruthenium, rhodium, palladium, silver, lanthanum, cerium, praseodymium, neodymium, samarium, europium, gadolinium, terbium, dysprosium, holmium, erbium, thulium, ytterbium, lutetium, hafnium, tantalum, tungsten, rhenium, osmium, iridium, platinum and gold.

Among these, preferred metals include one or more metals selected from the group consisting of scandium, titanium, vanadium, chromium, manganese, iron, cobalt, nickel, copper, yttrium, zirconium, niobium, molybdenum, silver, lanthanum, cerium, praseodymium, neodymium, samarium, europium, gadolinium, terbium, dysprosium, holmium, erbium, thulium, ytterbium, lutetium, hafnium, tantalum and tungsten, one or more metals selected from the group consisting of scandium, titanium, vanadium, chromium, manganese, iron, cobalt, nickel, copper, zirconium, niobium, molybdenum, tantalum and tungsten is more preferable, one or more metals selected from the group consisting of vanadium, chromium, manganese, iron, cobalt, nickel and copper is still more preferable, and one or more metals selected from the group consisting of manganese, iron, cobalt, nickel and copper is particularly desirable.

The aforementioned transition metal ion is preferably an ion of a transition metal atom belonging to the 4th period to the 6th period of the periodic table.

In the above general formula (A-1), m represents an integer of 2 or more, which indicates the total number of transition metal atoms and transition metal ions constituting the polynuclear metal complex, and is preferably 2 to 6, more preferably 2 to 4, still more preferably 2 or 3, and most preferably 2.

The 2 or more M may be the same or different from each other, and may consist only of transition metal atoms, consist only of transition metal ions, or be a combination containing a transition metal atom and a transition metal ion. Two or more M may be bonded via bridging coordination.

In the present embodiment, at least one M is preferably a cobalt atom or a cobalt ion, because the catalytic activity improves further. All of M may be cobalt atoms or cobalt ions.

In general formula (A-1), X¹ represents a counter ion or a neutral molecule, wherein the counter ion renders the polynuclear metal complex electrically neutral, whereas the neutral molecule is a molecule that is itself electrically neutral.

Among the options for X¹, examples of the neutral molecule (neutral compound) include nitrogen atom-containing compounds such as ammonia, pyridine, pyrrole, pyridazine, pyrimidine, pyrazine, 1,2,4-triazine, pyrazole, imidazole, 1,2,3-triazole, oxazole, isoxazole, 1,3,4-oxadiazole, thiazole, isothiazole, indole, indazole, quinoline, isoquinoline, phenanthridine, cinnoline, phthalazine, quinazoline, quinoxaline, 1,8-naphthylidine, acridine, 2,2′-bipyridine, 4,4′-bipyridine, 1,10-phenanthroline, ethylenediamine, propylenediamine, phenylenediamine, cyclohexanediamine, pyridine N-oxide, 2,2′-bipyridine N,N′-dioxide, oxamide, dimethylglyoxime and o-aminophenol; oxygen atom-containing compounds such as water, methanol, ethanol, 1-propanol, 2-propanol, n-butyl alcohol, isobutyl alcohol, sec-butyl alcohol, tert-butyl alcohol, 2-methoxyethanol, phenol, oxalic acid, catechol, salicylic acid, phthalic acid, 2,4-pentanedione, 1,1,1-trifluoro-2,4-pentanedione, hexafluoropentanedione, 1,3-diphenyl-1,3-propanedione and 2,2′-binaphthol; sulfur atom-containing compounds such as dimethyl sulfoxide and urea; and phosphorus atom-containing compounds such as 1,2-bis(dimethylphosphino)ethane and 1,2-phenylenebis(dimethylphosphine).

Among these compounds, preferred neutral molecules include ammonia, pyridine, pyrrole, pyridazine, pyrimidine, pyrazine, 1,2,4-triazine, pyrazole, imidazole, 1,2,3-triazole, oxazole, isoxazole, 1,3,4-oxadiazole, indole, indazole, quinoline, isoquinoline, phenanthridine, cinnoline, phthalazine, quinazoline, quinoxaline, 1,8-naphthylidine, acridine, 2,2′-bipyridine, 4,4′-bipyridine, 1,10-phenanthroline, ethylenediamine, propylenediamine, phenylenediamine, cyclohexanediamine, pyridine N-oxide, 2,2′-bipyridine N,N′-dioxide, oxamide, dimethylglyoxime, o-aminophenol, water, phenol, oxalic acid, catechol, salicylic acid, phthalic acid, 2,4-pentanedione, 1,1,1-trifluoro-2,4-pentanedione, hexafluoropentanedione, 1,3-diphenyl-1,3-propanedione and 2,2′-binaphthol, more preferred neutral molecules include ammonia, pyridine, pyrrole, pyridazine, pyrimidine, pyrazine, 1,2,4-triazine, pyrazole, imidazole, 1,2,3-triazole, oxazole, isoxazole, 1,3,4-oxadiazole, indole, indazole, quinoline, isoquinoline, phenanthridine, cinnoline, phthalazine, quinazoline, quinoxaline, 1,8-naphthylidine, acridine, 2,2′-bipyridine, 4,4′-bipyridine, 1,10-phenanthroline, ethylenediamine, propylenediamine, phenylenediamine, cyclohexanediamine, pyridine N-oxide, 2,2′-bipyridine N,N′-dioxide, o-aminophenol, phenol, catechol, salicylic acid, phthalic acid, 1,3-diphenyl-1,3-propanedione and 2,2′-binaphthol, and pyridine, pyrrole, pyridazine, pyrimidine, pyrazine, pyrazole, imidazole, oxazole, indole, indazole, quinoline, isoquinoline, acridine, 2,2′-bipyridine, 4,4′-bipyridine, 1,10-phenanthroline, phenylenediamine, pyridine N-oxide, 2,2′-bipyridine N,N′-dioxide, o-aminophenol and phenol are still more preferable.

Among the options for X¹, the counter ion may be either a counter ion having anionicity or a counter ion having cationicity.

Examples of the counter ion having anionicity include a hydroxide ion, peroxide, superoxide, cyanide ion, thiocyanate ion, halide ions such as a fluoride ion, chloride ion, bromide ion and iodide ion, sulfate ion, nitrate ion, carbonate ion, perchlorate ion, tetrafluoroborate ion, tetraarylborate ions such as a tetraphenylborate ion, hexafluorophosphate ion, methanesulfonate ion, trifluoromethanesulfonate ion, p-toluenesulfonate ion, benzenesulfonate ion, phosphate ion, phosphite ion, acetate ion, trifluoroacetate ion, propionate ion, benzoate ion, metal oxide ions, methoxide ion and ethoxide ion.

Among these, preferred ions include a hydroxide ion, sulfate ion, nitrate ion, carbonate ion, perchlorate ion, tetrafluoroborate ion, tetraphenylborate ion, hexafluorophosphate ion, methanesulfonate ion, trifluoromethanesulfonate ion, p-toluenesulfonate ion, benzenesulfonate ion, phosphate ion, acetate ion and trifluoroacetate ion, and of these, a hydroxide ion, sulfate ion, nitrate ion, carbonate ion, tetraphenylborate ion, trifluoromethanesulfonate ion, p-toluenesulfonate ion, acetate ion and trifluoroacetate ion are more preferable.

Examples of the counter ion having cationicity include alkali metal ions, alkaline earth metal ions, tetraalkylammonium ions such as a tetra(n-butyl)ammonium ion and tetraethylammonium ion, and tetraarylphosphonium ions such as a tetraphenylphosphonium ion.

Among these, preferred ions include a lithium ion, sodium ion, potassium ion, rubidium ion, cesium ion, magnesium ion, calcium ion, strontium ion, barium ion, tetra(n-butyl)ammonium ion, tetraethylammonium ion and tetraphenylphosphonium ion, and of these, a tetra(n-butyl)ammonium ion, tetraethylammonium ion and tetraphenylphosphonium ion are more preferable, and a tetra(n-butyl)ammonium ion and tetraethylammonium ion are still more preferable.

In the above general formula (A-1), n represents an integer of 0 or more, and indicates the number of X¹ constituting the polynuclear metal complex.

When n represents 2 or more, the 2 or more X¹ may be the same or different from each other. Further, the 2 or more X¹ may consist only of counter ions, consist only of neutral molecules, or be a combination containing a counter ion and a neutral molecule.

The polynuclear metal complex represented by general formula (A-1) is preferably a polynuclear metal complex represented by general formula (A-2) shown below:

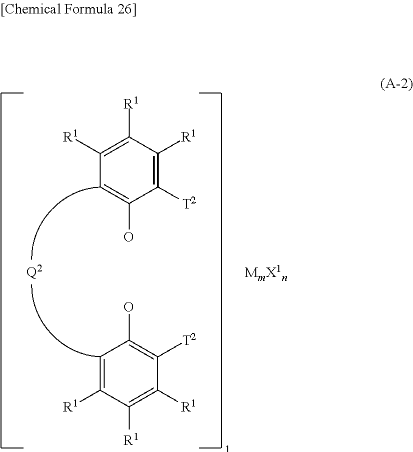

wherein R¹ represents a hydrogen atom or a substituent, 2 or more R¹ may be the same or different from each other, and adjacent R¹ substituents may be mutually bonded together to form a ring with the carbon atoms bonded thereto; Q² represents a divalent organic group having at least 2 nitrogen atoms; T² represents an organic group having a nitrogen atom, 2 or more T² may be the same or different from each other, and 2 or more T² may be mutually bonded; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other.

In general formula (A-2), M, X¹, l, m and n are the same as M, X¹, l, m and n in the above general formula (A-1). For example, when 1 represents 2 or more, the 2 or more of the general formula to which 1 is appended (the general formula that represents the ligand containing R¹, Q² and T²) may be the same or different from each other.

In general formula (A-2), Q² represents a divalent organic group having at least 2 nitrogen atoms, and is the same as Q¹ in the above general formula (A-1).

In general formula (A-2), T² represents an organic group having a nitrogen atom, and is the same as T¹ in general formula (A-1). Accordingly, 2 or more T² may be the same or different from each other, and 2 or more T² may be mutually bonded.

In general formula (A-2), R¹ represents a hydrogen atom or a substituent, 2 or more R¹ may be the same or different from each other, and adjacent R¹ substituents may be mutually bonded together to form a ring with the carbon atoms bonded thereto. With the exception that R¹ may also be a hydrogen atom, R¹ is the same as the substituent G described above. In other words, the substituent for R¹ is the same as the substituent G.

R¹ is preferably a hydrogen atom, methyl group, ethyl group, n-propyl group, isopropyl group, n-butyl group, isobutyl group, tert-butyl group, phenyl group, methylphenyl group, 1-naphthyl group, 2-naphthyl group or pyridyl group.

In general formula (A-2), one M is bonded by coordination bonds to the 2 or more nitrogen atoms of Q² and the 2 oxygen atoms in general formula (A-2), so that this M is bonded by coordination bonding to a total of 4 or more atoms. Moreover, one M is bonded by coordination bonds to the nitrogen atoms of T² and the 2 oxygen atoms in general formula (A-2), so that this M is bonded by coordination bonding to 4 or more atoms.

In other words, the ligand in general formula (A-2) has, within the molecule, 2 or more structures each having a space surrounded by 4 or more atoms being able to coordinate with M (the space surrounded by the 2 oxygen atoms and the 2 or more nitrogen atoms of Q², and the space surrounded by the 2 oxygen atoms and the nitrogen atoms of two T²) and being able to accommodate the central metal in the space (namely, the structure that constitutes the space surrounded by the 2 oxygen atoms and the 2 or more nitrogen atoms of Q², and the structure that constitutes the space surrounded by the 2 oxygen atoms and the nitrogen atoms of two T²).

The polynuclear metal complex represented by general formula (A-2) is preferably a polynuclear metal complex represented by general formula (A-3) shown below:

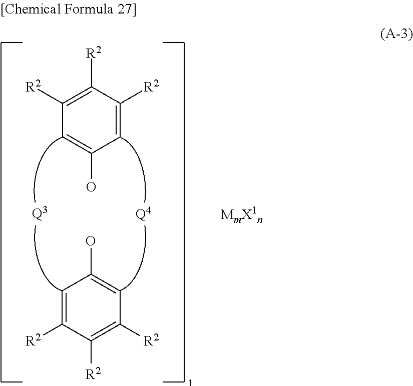

wherein R² represents a hydrogen atom or a substituent, 2 or more R² may be the same or different from each other, and adjacent R² substituents may be mutually bonded together to form a ring with the carbon atoms bonded thereto; each of Q³ and Q⁴ independently represents a divalent group represented by general formula (A-3-1), (A-3-2), (A-3-3), (A-3-4), (A-3-5) or (A-3-6) shown below; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other;

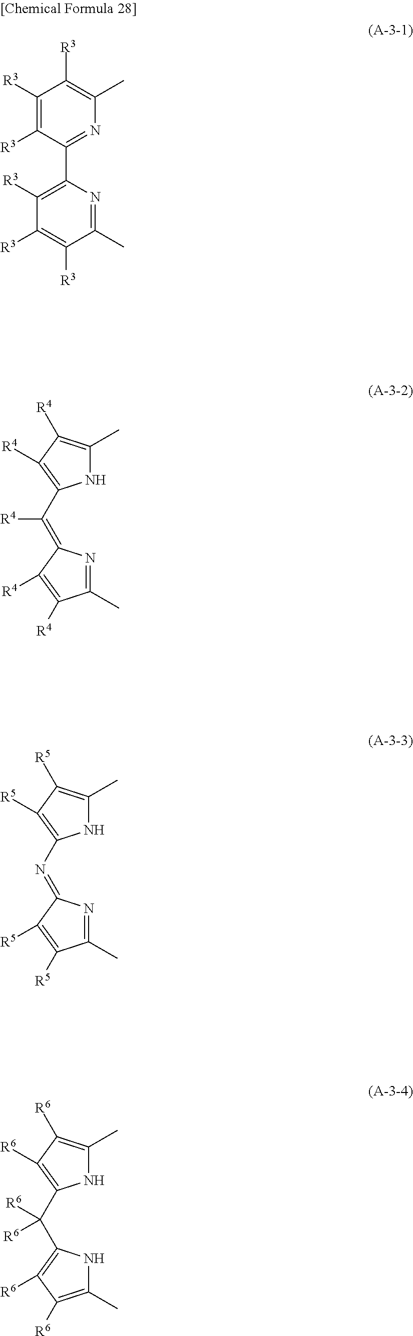

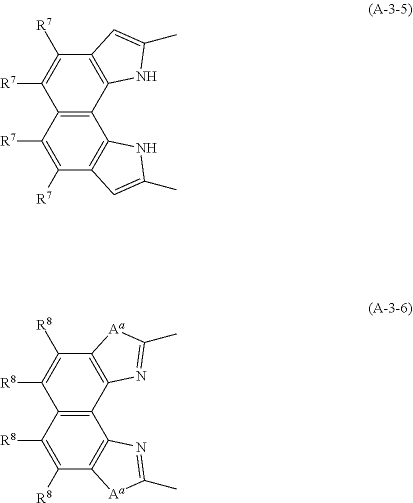

wherein each of R³, R⁴, R⁵, R⁶, R⁷ and R⁸ independently represents a hydrogen atom or a substituent, each 2 or more R³, R⁴, R⁵, R⁶, R⁷ and R⁸ may be the same or different from each other, and each 2 or more R³, R⁴, R⁵, R⁶, R⁷ and R⁸ may be mutually bonded together to form a ring with the carbon atom(s) bonded thereto; A^{a} represents a divalent group represented by formula (A-3-a) or (A-3-b) shown below, or general formula (A-3-c) shown below, and 2 or more A^{a} may be the same or different from each other;

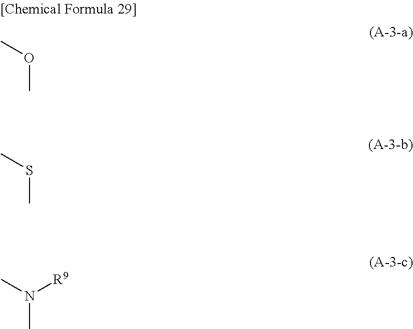

wherein R⁹ represents a hydrogen atom or a hydrocarbyl group.

In general formula (A-3), M, X¹, l, m and n are the same as M, X¹, l, m and n in the above general formula (A-1). For example, when l represents 2 or more, the 2 or more of the general formula to which l is appended (the general formula that represents the ligand containing R², Q³ and Q⁴) may be the same or different from each other.

In general formula (A-3), R² represents a hydrogen atom or a substituent, and is the same as R¹ in the above general formula (A-2). Accordingly, 2 or more R² may be the same or different from each other, and adjacent R² substituents may be mutually bonded together to form a ring with the carbon atoms bonded thereto.

In general formula (A-3), each of Q³ and Q⁴ independently represents a divalent group represented by general formula (A-3-1), (A-3-2), (A-3-3), (A-3-4), (A-3-5) or (A-3-6) shown above.

In general formulas (A-3-1) to (A-3-6), each of R³, R⁴, R⁵, R⁶, R⁷ and R⁸ independently represents a hydrogen atom or a substituent, and is the same as R¹ in the above general formula (A-2). Accordingly, each 2 or more R³, R⁴, R⁵, R⁶, R⁷ and R⁸ may be the same or different from each other, and each 2 or more R³, R⁴, R⁵, R⁶, R⁷ and R⁸ may be mutually bonded together to form a ring with the carbon atom(s) bonded thereto.

In general formula (A-3-6), A^{a} represents a divalent group represented by formula (A-3-a) or (A-3-b) shown above, or general formula (A-3-c) shown above, and 2 or more A^{a} may be the same or different from each other.

In general formula (A-3-c), R⁹ represents a hydrogen atom or a hydrocarbyl group.

The hydrocarbyl group for R⁹ is the same as the hydrocarbyl group described above for the substituent G.

In the polynuclear metal complex represented by the above general formula (A-3), the ligand represented by the general formula containing R², Q³ and Q⁴ is preferably a ligand represented by one of formulas (A-6-7) to (A-6-14) shown below, and is more preferably a ligand represented by one of formulas (A-6-7) to (A-6-9).

In general formula (A-3), one M is bonded by coordination bonds to the 2 nitrogen atoms of Q³ and the 2 oxygen atoms in general formula (A-3), so that this M is bonded by coordination bonding to a total of 4 atoms. Moreover, one M is bonded by coordination bonds to the 2 nitrogen atoms of Q⁴ and the 2 oxygen atoms in general formula (A-3), so that this M is bonded by coordination bonding to 4 atoms.

In other words, the ligand in general formula (A-3) has, within the molecule, 2 structures each having a space surrounded by 4 atoms being able to coordinate with M (the space surrounded by the 2 oxygen atoms and the 2 nitrogen atoms of Q³, and the space surrounded by the 2 oxygen atoms and the 2 nitrogen atoms of Q⁴) and being able to accommodate the central metal in the space (namely, the structure that constitutes the space surrounded by the 2 oxygen atoms and the 2 nitrogen atoms of Q³, and the structure that constitutes the space surrounded by the 2 oxygen atoms and the 2 nitrogen atoms of Q⁴).

In the present embodiment, examples of preferred ligands for constituting the polynuclear metal complex include ligands represented by formulas (A-6-1) to (A-6-34) shown below, and of these, ligands represented by formulas (A-6-1) to (A-6-22) are more preferable, and ligands represented by formulas (A-6-1) to (A-6-14) are particularly preferable. In the following formulas (A-6-1) to (A-6-34), the electrical charge is omitted.

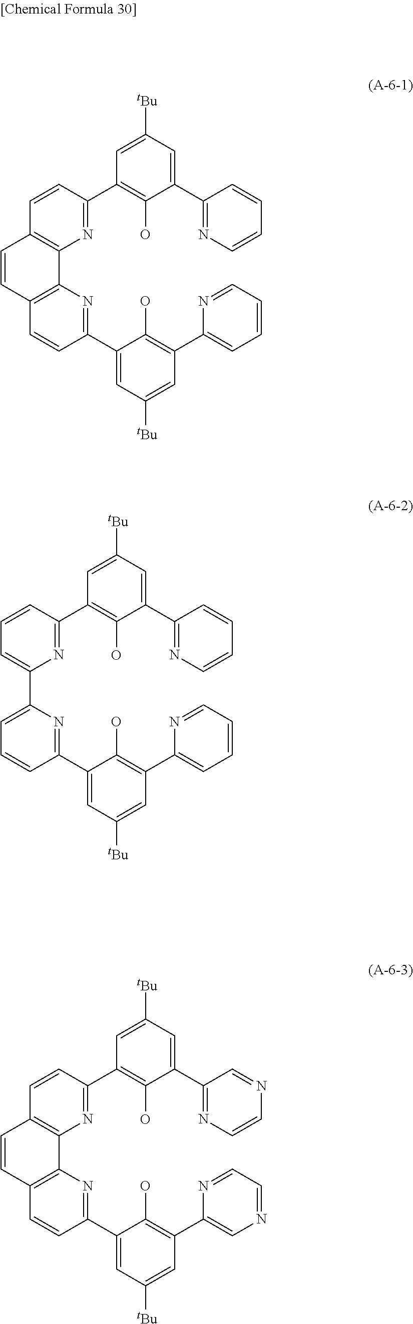

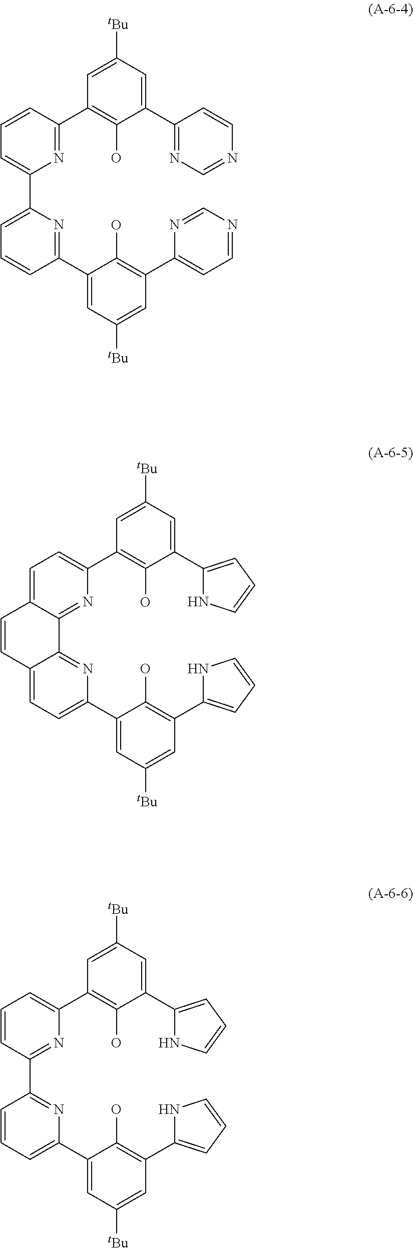

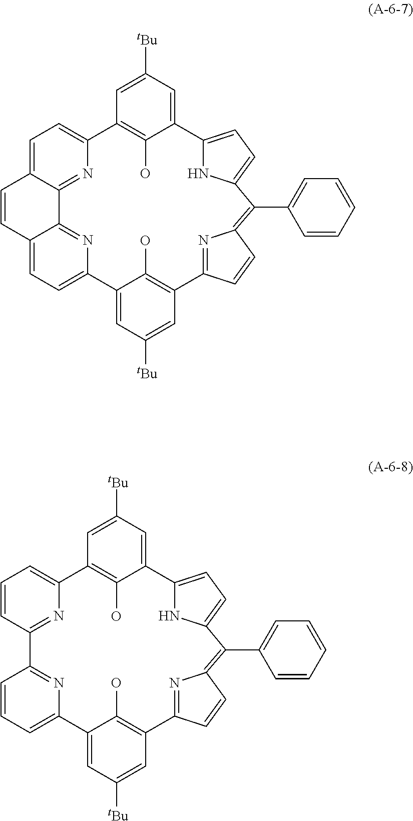

In the formulas, ^{t}Bu represents a tert-butyl group.

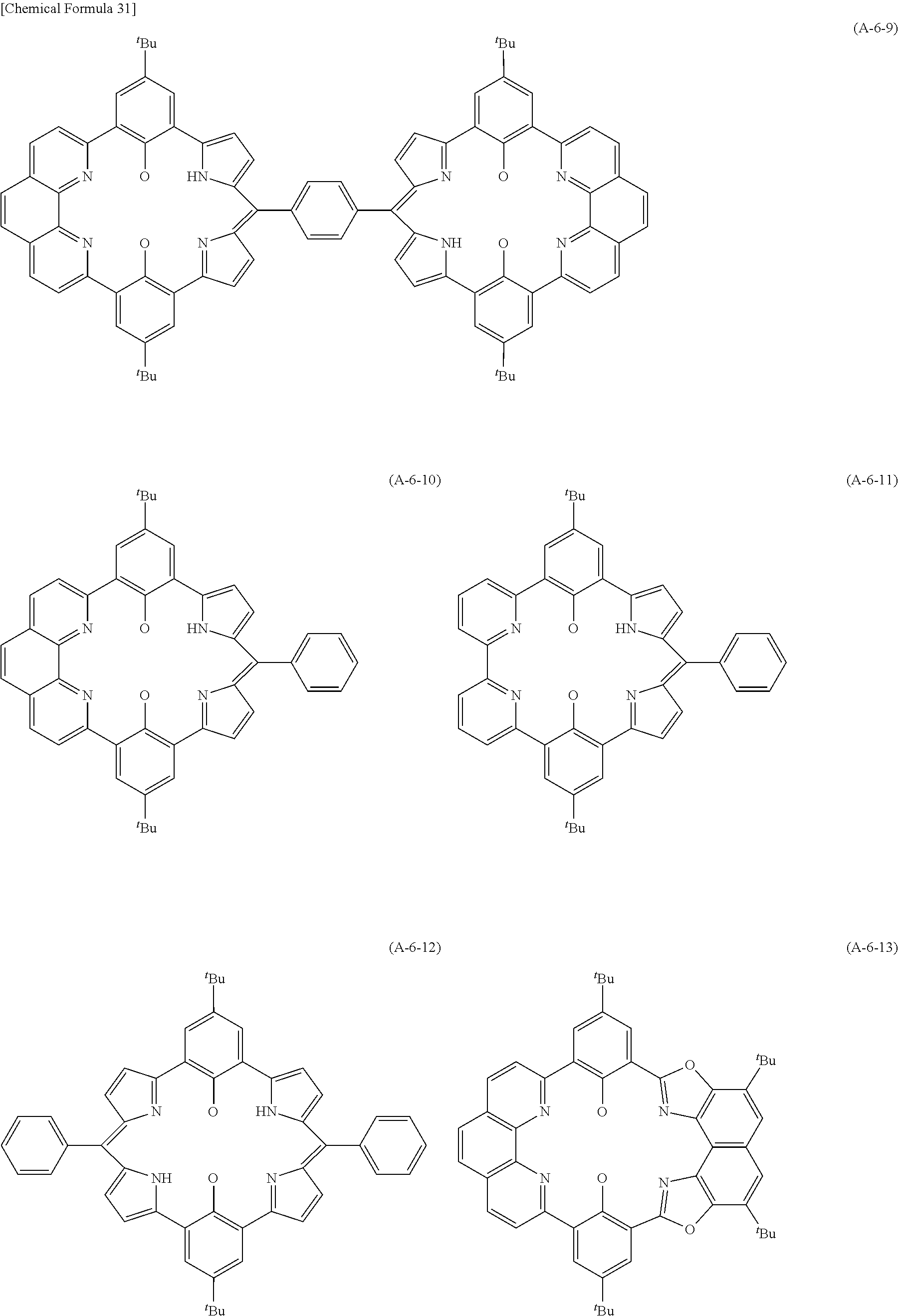

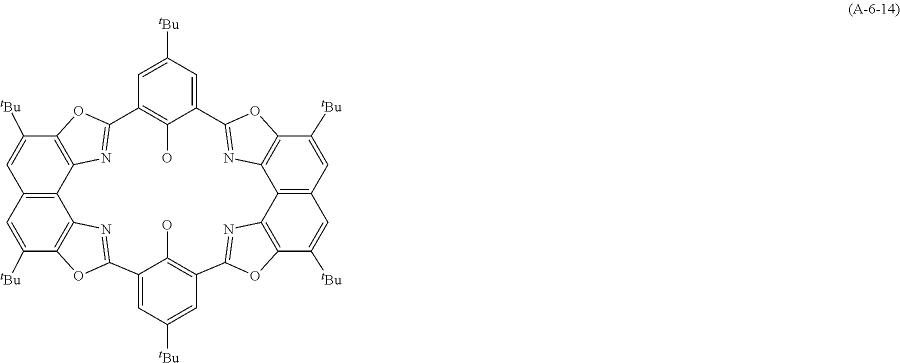

In the formulas, Me represents a methyl group, and ^{t}Bu represents a tert-butyl group.

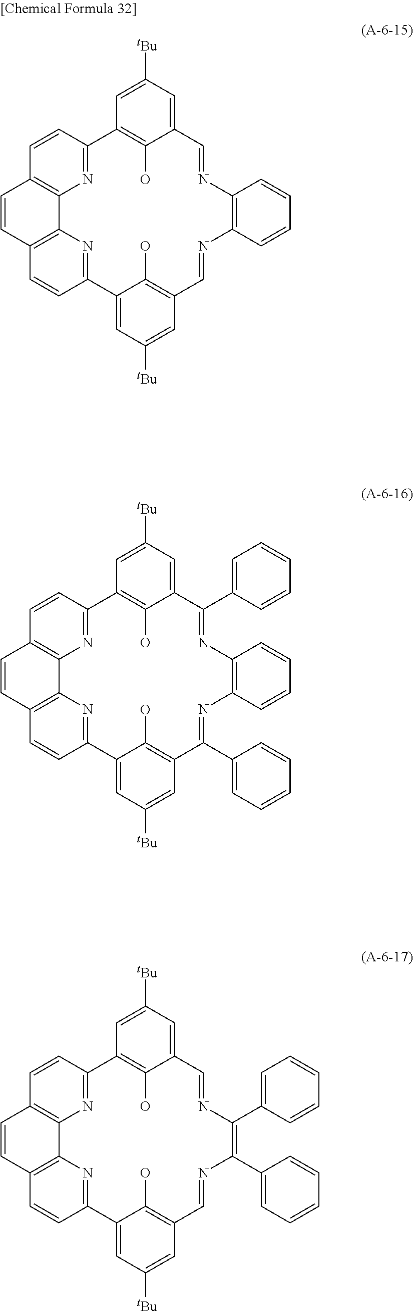

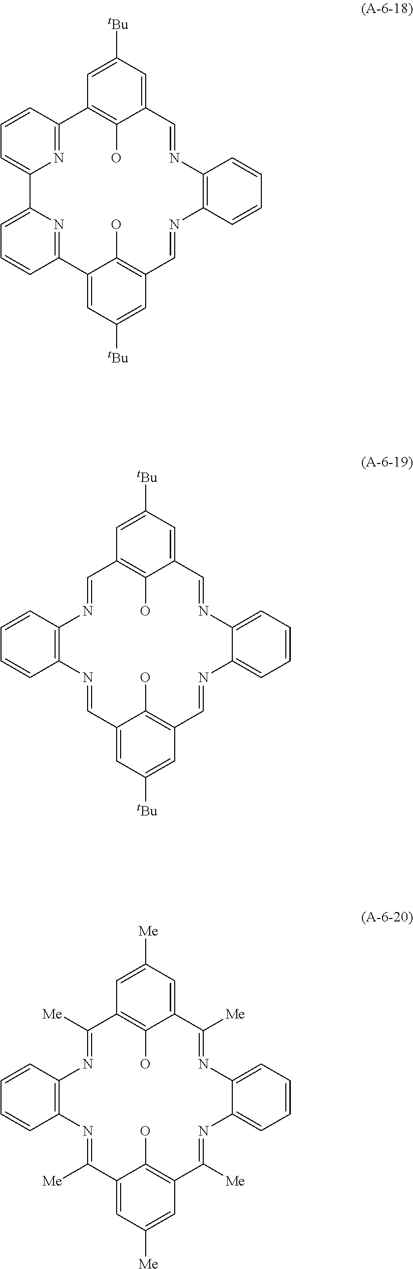

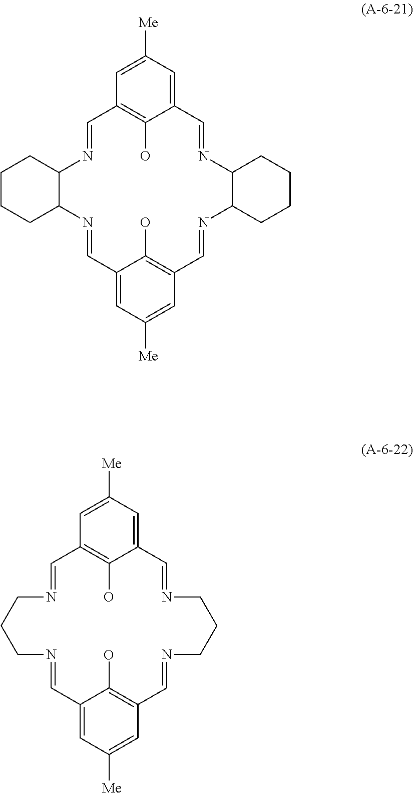

In the formulas, Me represents a methyl group, and ^{t}Bu represents a tert-butyl group.

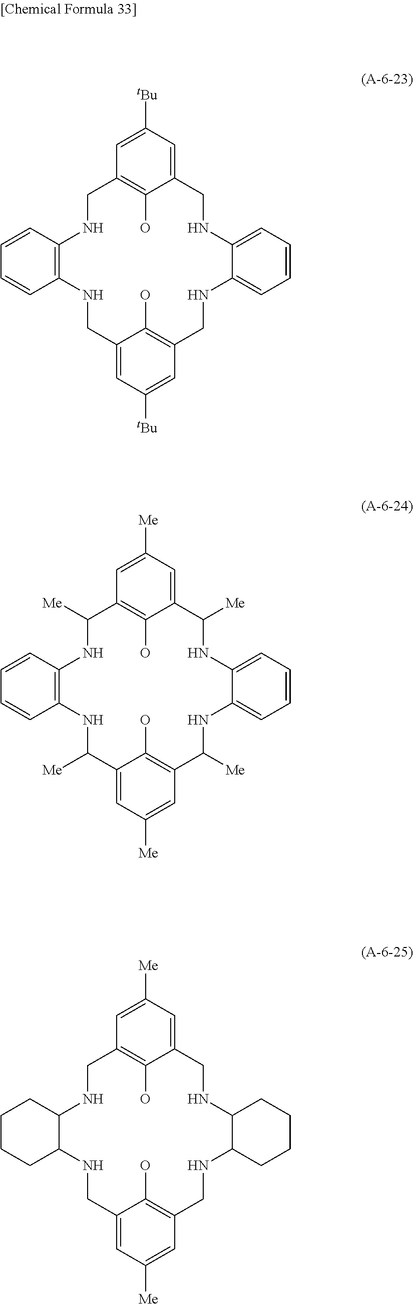

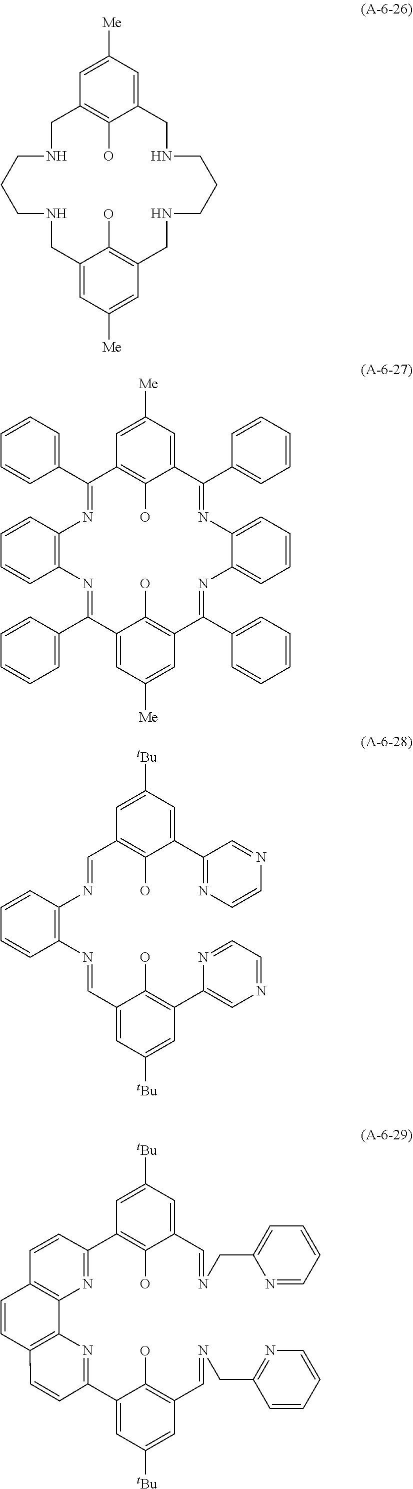

In the formulas, Me represents a methyl group, and ^{t}Bu represents a tert-butyl group.

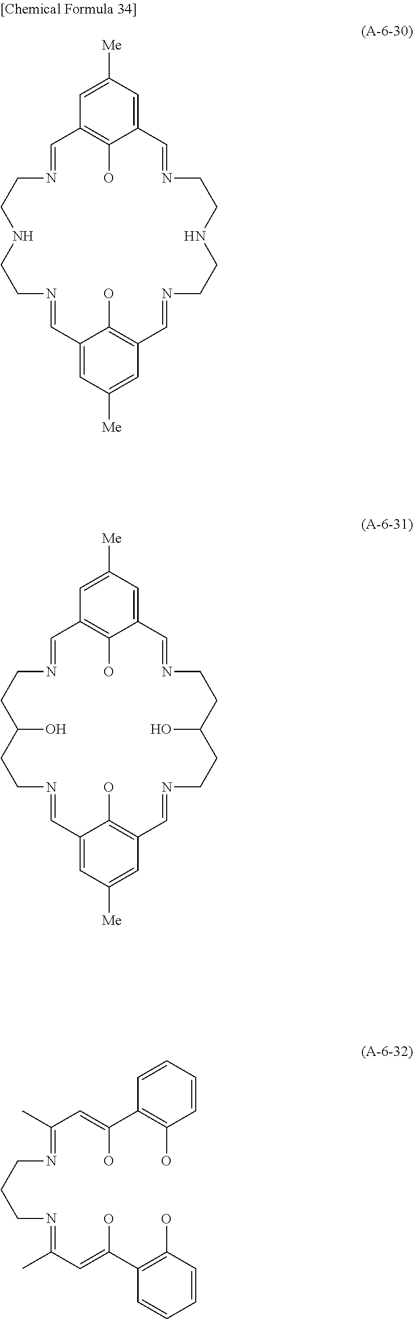

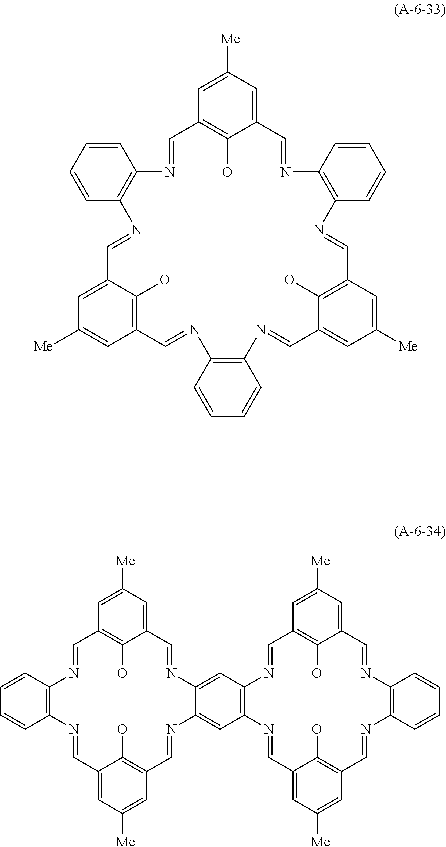

In the formulas, Me represents a methyl group.

In the present embodiment, examples of preferred polynuclear metal complexes include polynuclear metal complexes represented by general formulas (A-7-1) to (A-7-34) shown below. In the following general formulas (A-7-1) to (A-7-34), the electrical charge, and the counter ions and neutral molecules (X¹) are omitted.

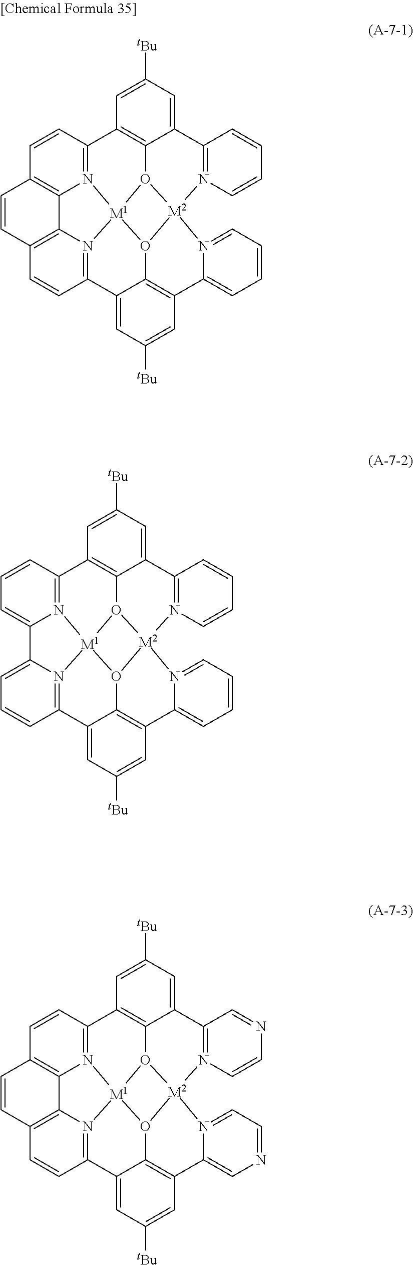

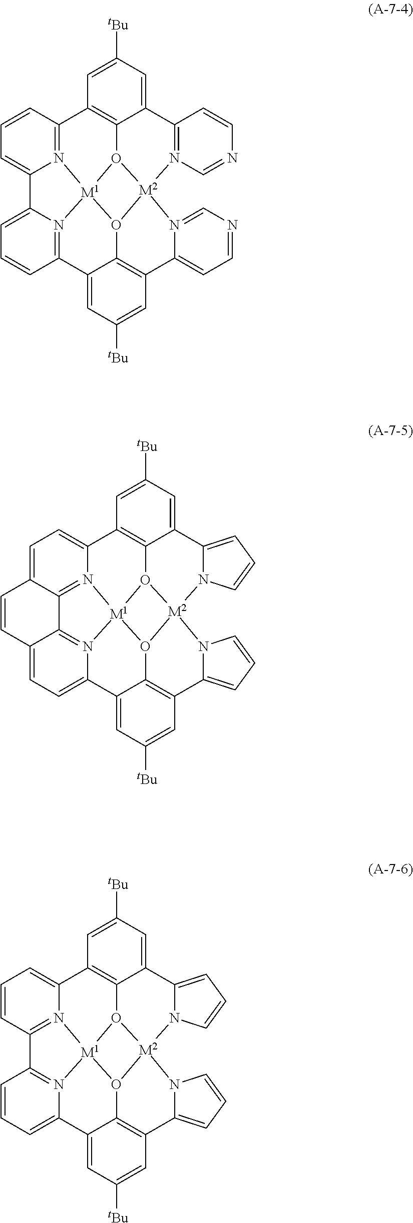

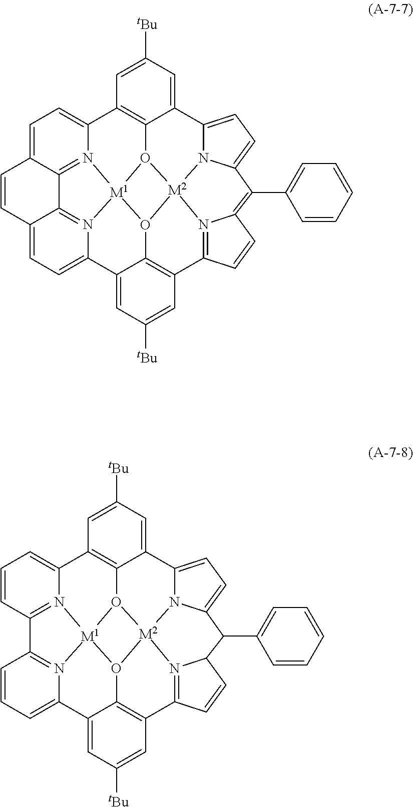

In the formulas, each of M¹ and M² independently represents a transition metal atom or a transition metal ion, and ^{t}Bu represents a tert-butyl group.

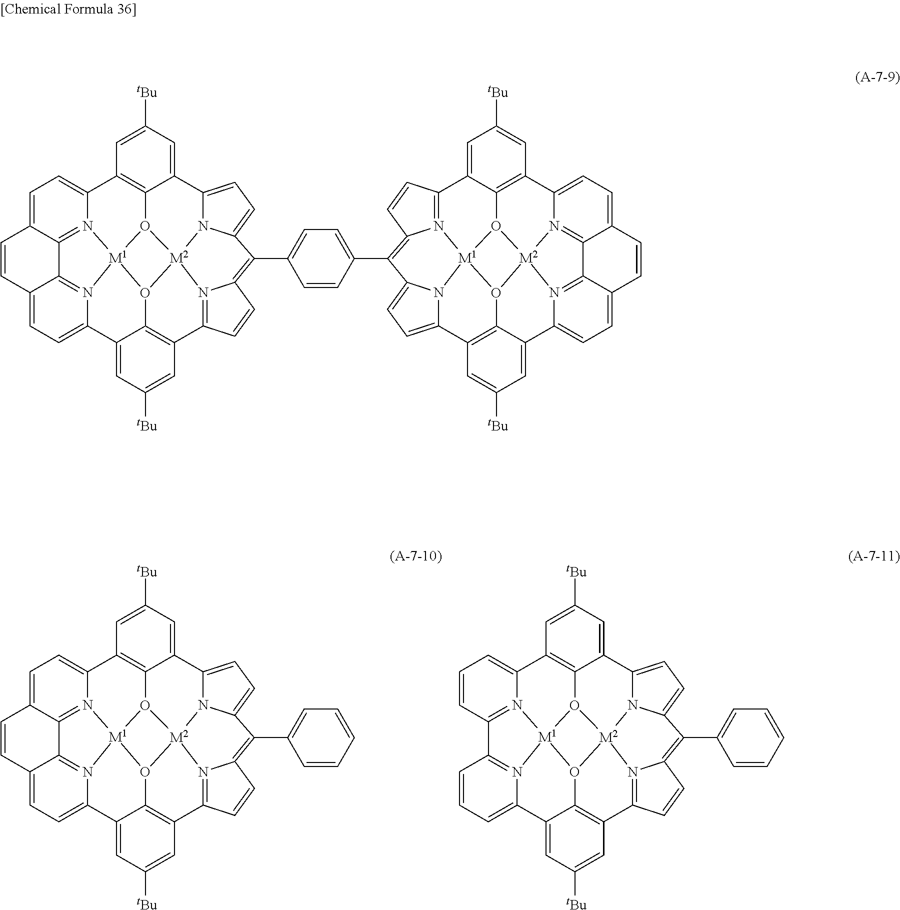

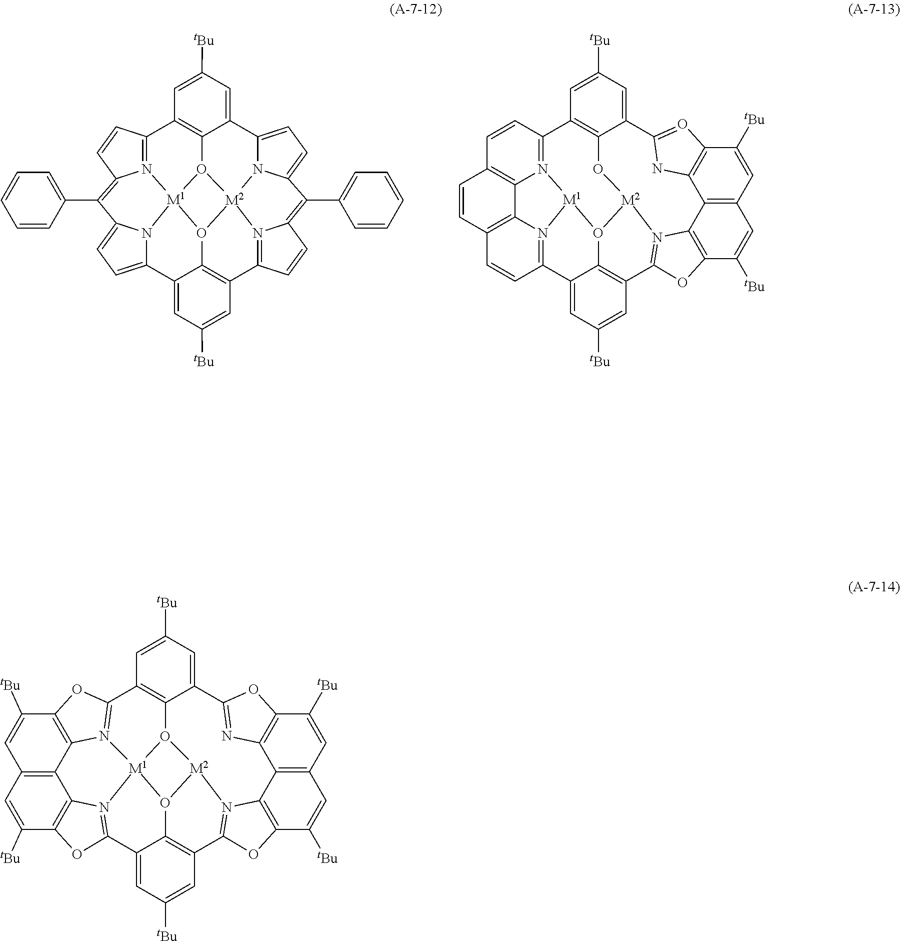

In the formulas, each of M¹ and M² independently represents a transition metal atom or a transition metal ion, and ^{t}Bu represents a tert-butyl group.

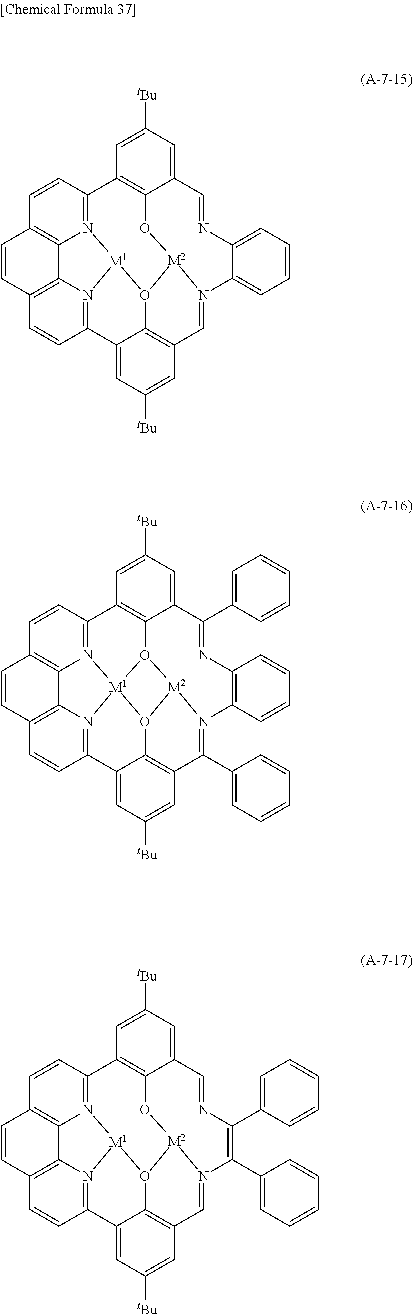

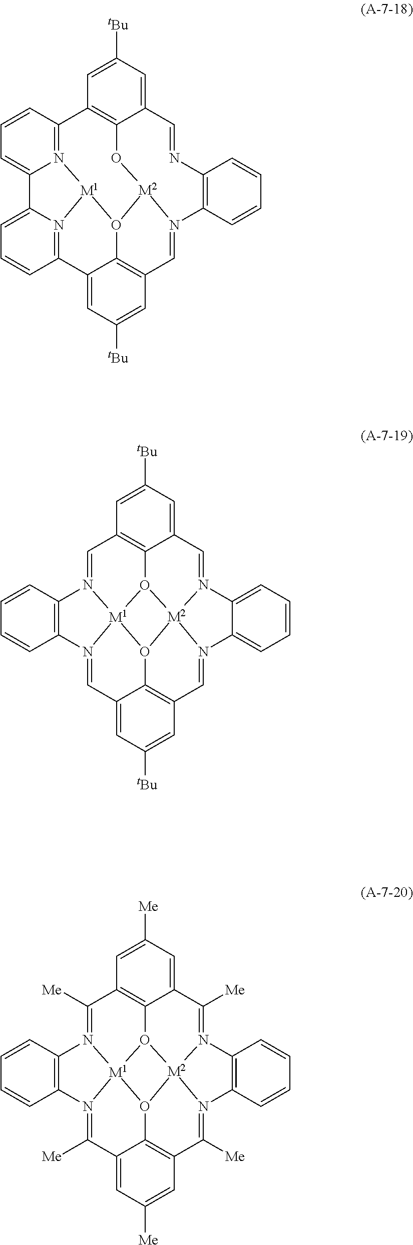

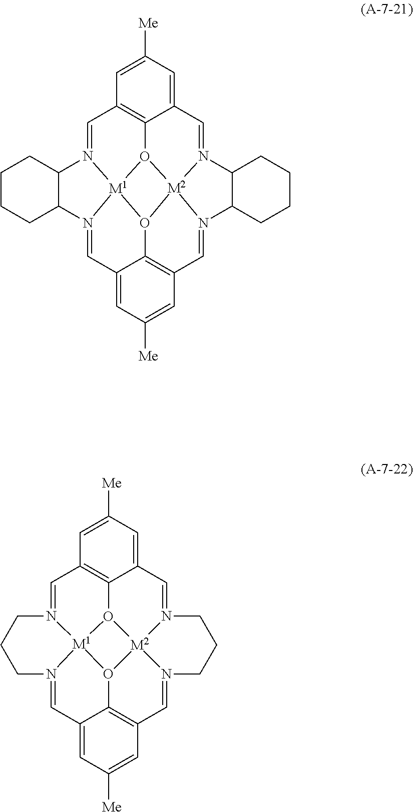

In the formulas, each of M¹, M², M³ and M⁴ independently represents a transition metal atom or a transition metal ion, Me represents a methyl group, and ^{t}Bu represents a tert-butyl group.

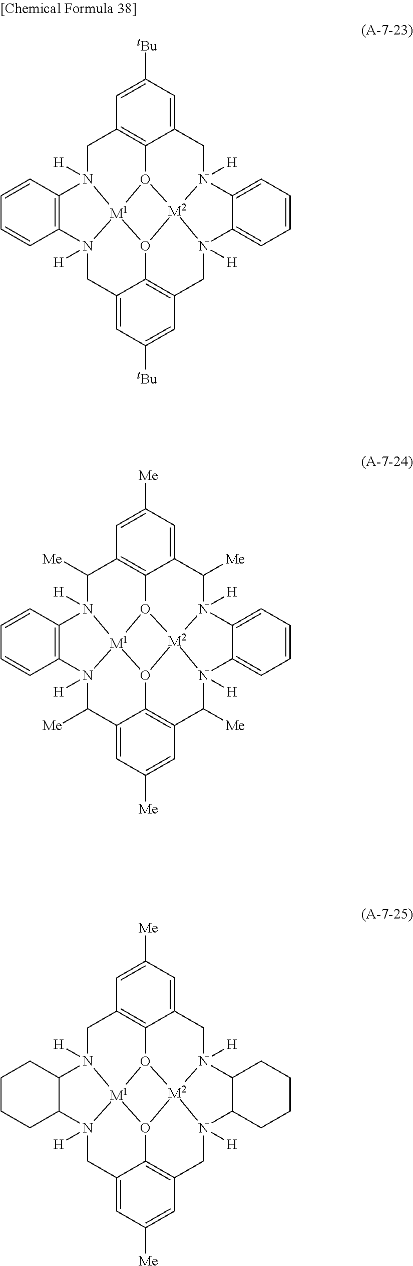

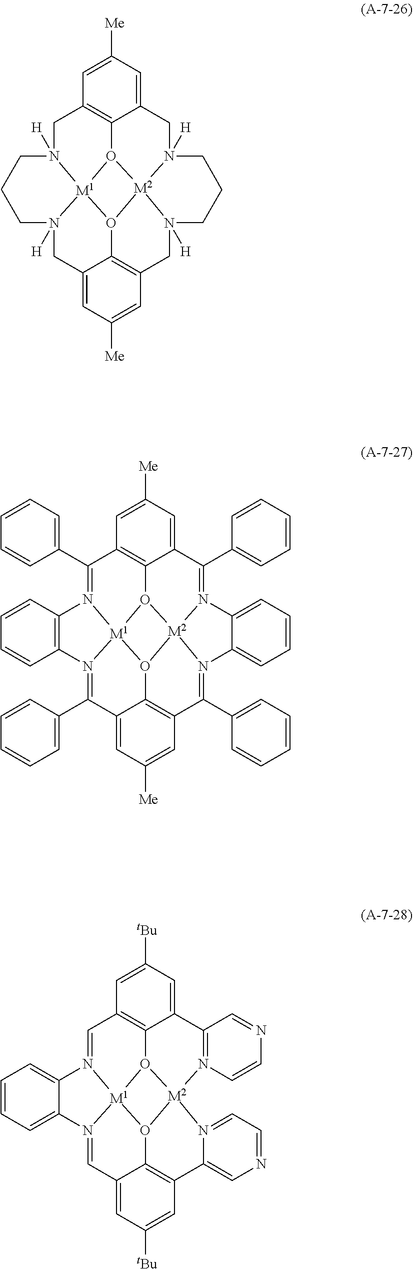

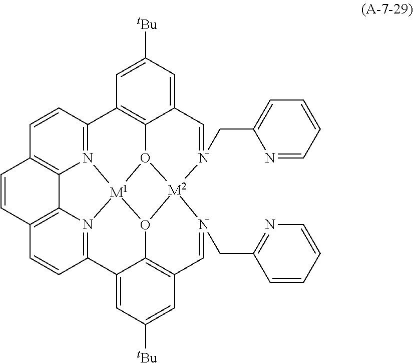

In the formulas, each of M¹ and M² independently represents a transition metal atom or a transition metal ion, Me represents a methyl group, and ^{t}Bu represents a tert-butyl group.

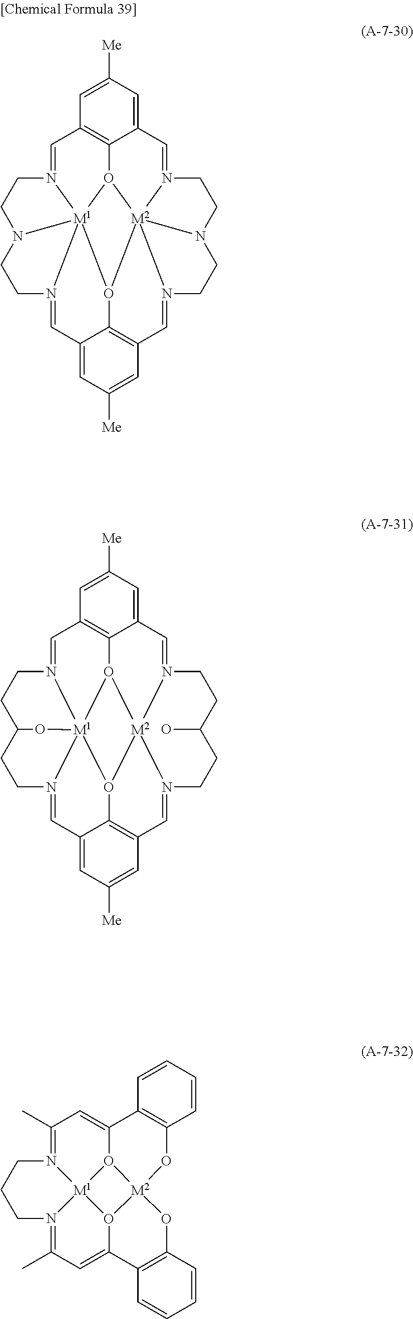

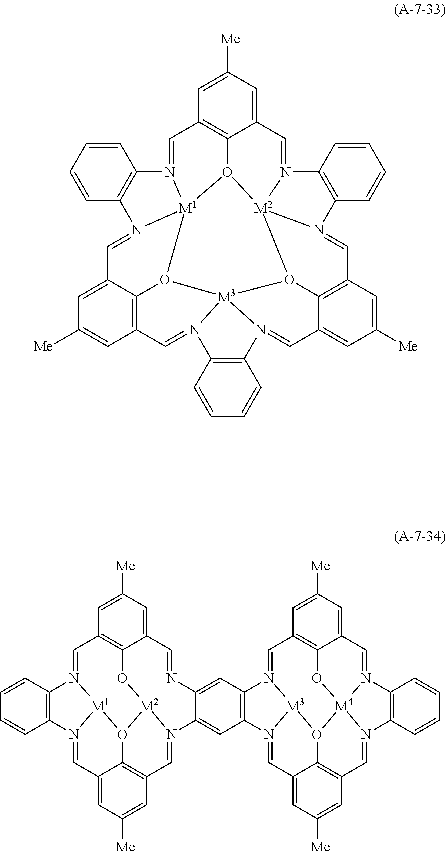

In the formulas, each of M¹, M², M³ and M⁴ independently represents a transition metal atom or a transition metal ion, and Me represents a methyl group.

In the above general formulas (A-7-1) to (A-7-34), each of M¹, M², M³ and M⁴ independently represents a transition metal atom or a transition metal ion, and is the same as M in the above general formula (A-1).

The ligands in the polynuclear metal complexes described above can be produced, for example, by a method having a step of reacting a phenol compound having an aldehyde group and a compound having an amino group in a solvent such as an alcohol, as disclosed in Journal of Organic Chemistry, 69, 5419 (2004). Further, the target polynuclear metal complex can be produced directly, for example, by a method in which a metal salt is added during the reaction, as disclosed in Australian Journal of Chemistry, 23, 2225 (1970). Furthermore, as disclosed in Tetrahedron, 1999, 55, 8377, the polynuclear metal complex can also be produced by a method having the steps of performing addition and oxidation reactions on a hetero ring of an organometallic reagent, performing a halogenation reaction, and then performing a cross-coupling reaction using a transition metal catalyst. Furthermore, production can also be achieved by a method having a step of performing stepwise cross-coupling reactions using a halogenated hetero ring.

### (Second Polynuclear Metal Complex)

Further, the ligand used in the aforementioned polynuclear metal complex may be an aromatic compound satisfying the requirements of (a) and (b) described below.

(a) The aromatic compound has two or more structures within the molecule, each structure having a space surrounded by 4 or more nitrogen atoms being able to coordinate with the central metal, and being able to accommodate the central metal in the space (wherein the 2 or more structures may be the same or different from each other).

(b) At least one nitrogen atom constituting the aforementioned structure is a nitrogen atom contained in a nitrogen-containing hetero 6-membered ring.

In the following description, a polynuclear metal complex having a ligand satisfying the above conditions (a) and (b) is sometimes referred to as the “second polynuclear metal complex”.

The nitrogen atoms “being able to coordinate with the central metal” mentioned in condition (a) are nitrogen atoms having one lone pair of electrons capable of forming a coordination bond with the central metal (metal atom or metal ion). Prior to coordination with the metal atom or metal ion, the lone pair of electrons of each nitrogen atom may be donated to a proton to form an N—H bond.

The 4 or more nitrogen atoms being able to coordinate with the central metal form a space within the molecule that is able to accommodate the central metal. The molecular structure positioned adjacent to this type of space and forming the outer edge around the space is the “structure having a space surrounded by 4 or more atoms being able to coordinate with the central metal, and being able to accommodate the central metal in the space” mentioned in condition (a). The ligand used in the polynuclear metal complex of this embodiment has 2 or more of these structures within the molecule.

Each structure (namely, the space within each structure) can preferably accommodate 1 to 3 central metals, more preferably 1 or 2 central metals, and most preferably 1 central metal.

This type of structure can be confirmed by performing a structural analysis such as an X-ray crystal structural analysis of a crystal, which can be obtained by a commonly known method such as recrystallization following the formation of the polynuclear metal complex having a compound containing the structure as a ligand.

Examples of the nitrogen-containing hetero 6-membered ring mentioned in the condition (b) include a pyridine ring, pyrazine ring, pyrimidine ring, pyridazine ring, 1,3,5-triazine ring, 1,2,4-triazine ring, 1,2,4,5-tetrazine ring, piperidine ring, piperazine ring and morpholine ring, and a pyridine ring, pyrazine ring, pyrimidine ring, pyridazine ring, 1,3,5-triazine ring, 1,2,4-triazine ring or 1,2,4,5-tetrazine ring is preferable, and a pyridine ring, pyrazine ring, pyrimidine ring or pyridazine ring is more preferable.

It is preferable that all of the nitrogen-containing hetero 6-membered rings contained in the ligand molecule contain only 1 or 2 nitrogen atoms as the hetero atoms, as this enables a greater improvement in the catalytic activity.

In this type of ligand, the “structures” which form the spaces that accommodate the central metals preferably have symmetry which is any one of axial symmetry, point symmetry and rotational symmetry. Here, “symmetry” refers to symmetry when attention is focused only on the “molecular structure forming the outer edge around the space in which the central metal is accommodated”, and does not consider substituents of the aromatic rings and the like that constitute the molecular structure. Further, the symmetry of the structures is investigated for the molecular structures in which the hydrogen atoms (protons) bonded to the nitrogen atoms that form the structure have been removed from the nitrogen atoms.

When the structure has rotational symmetry, the symmetry is 2-fold symmetry (C₂ symmetry) or more, preferably 2- to 12-fold symmetry, and more preferably 2- to 6-fold symmetry.

Examples of aromatic compounds (ligands) having one structure with this type of symmetry within the molecule include compounds represented by general formulas (B-a) to (B-x) shown below. The ligand contained in the polynuclear metal complex of the present embodiment has 2 or more of this type of structure within the molecule.

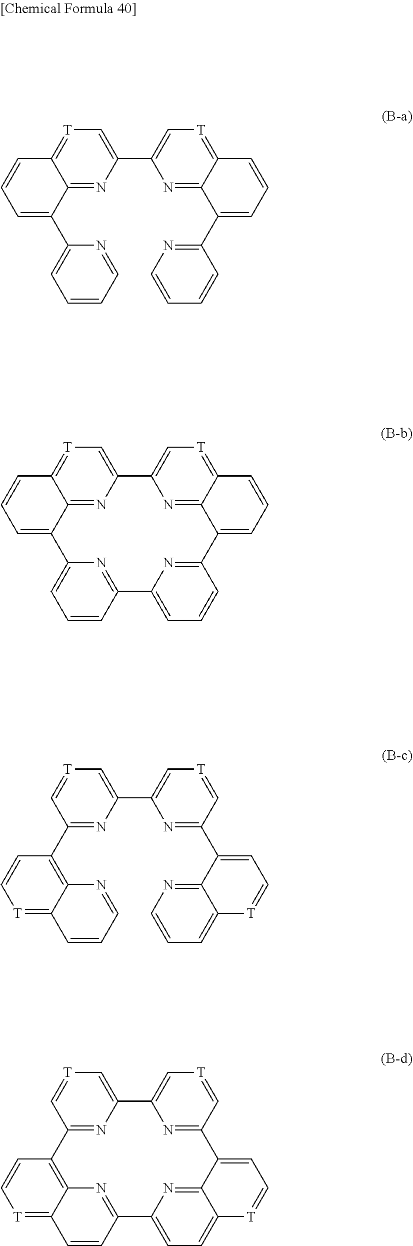

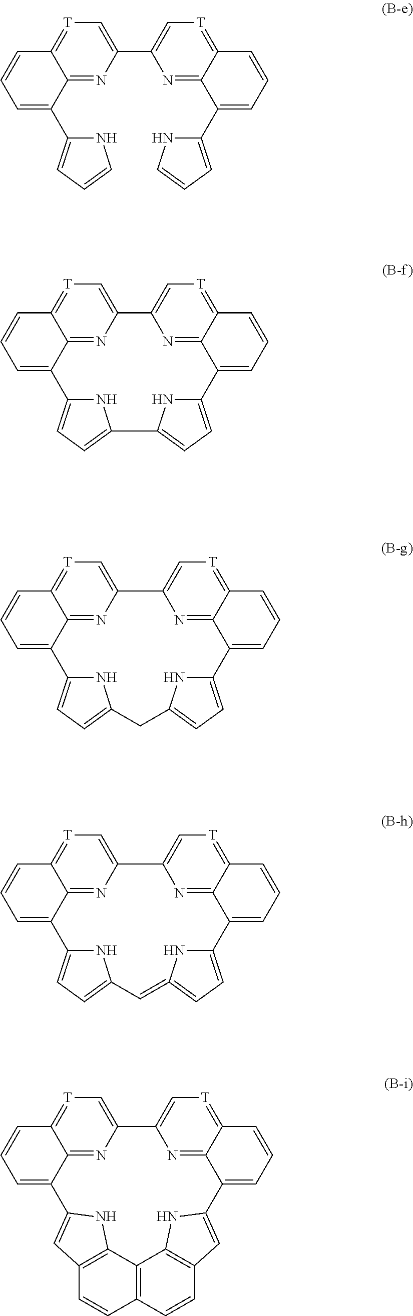

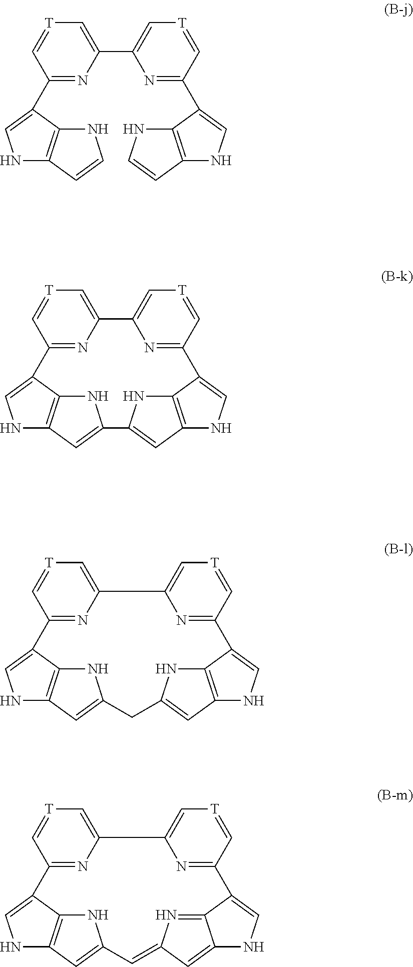

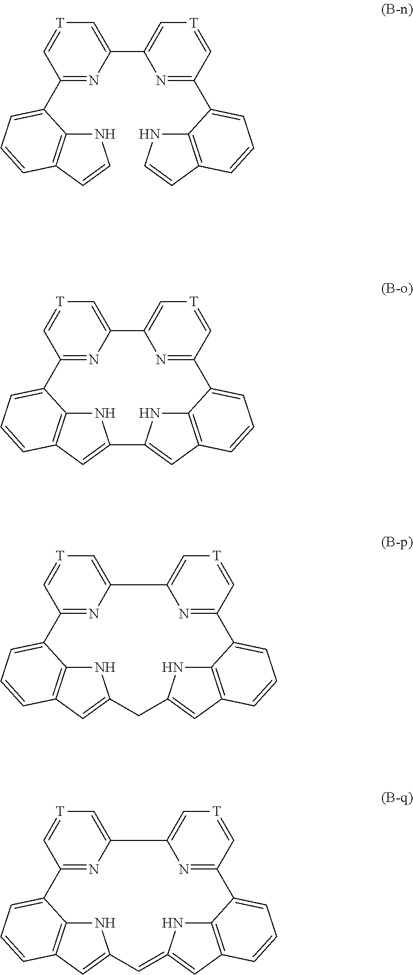

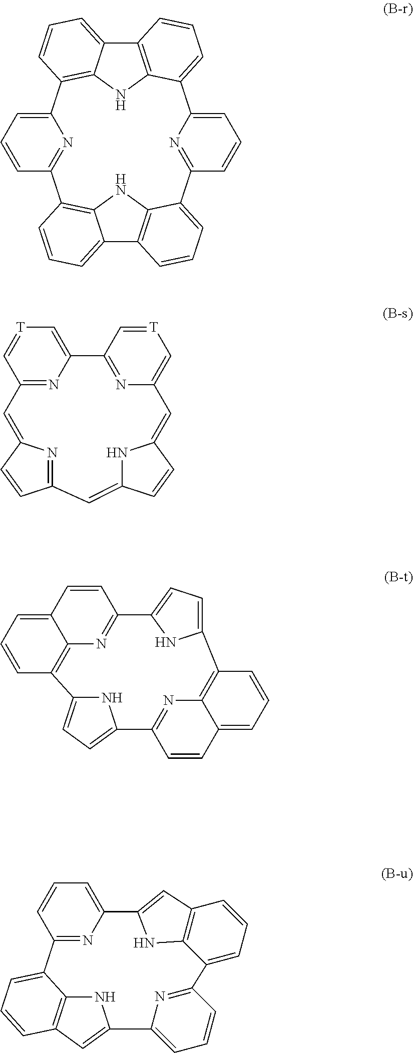

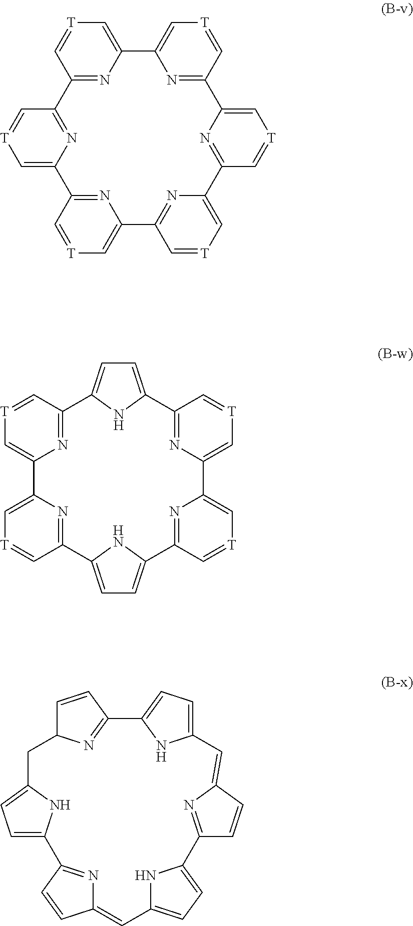

In the formulas, T represents —C(H)═ or —N═.

In the aromatic compound that can be used as the ligand of the polynuclear metal complex of the present embodiment, it is preferable that the ratio of the weight W_{N} of all the nitrogen atoms constituting the aromatic compound relative to the weight Wₑ of all the carbon atoms constituting the aromatic compound (W_{N}/W_{C}) is greater than 0 and 1.1 or less (0<W_{N}/W_{C}≦1.1). The value of W_{N}/W_{C} is more preferably 0.05 or more, and still more preferably 0.1 or more. Further, the value of W_{N}/W_{C} is more preferably 1.0 or less, and still more preferably 0.9 or less. The upper limit value and lower limit value can be combined as appropriate.

In the aromatic compound that can be used as the ligand of the polynuclear metal complex of the present embodiment, it is preferable that the relationship between the number n of nitrogen atoms constituting each structure, and the average distance r (Å) between the center of the space formed by the structure and the center of each nitrogen atom constituting the structure is such that the value of r/n is greater than 0 and 0.7 or less (0<r/n≦0.7). The value of r/n is more preferably 0.1 or more, and still more preferably 0.2 or more. Further, the value of r/n is more preferably 0.65 or less, and still more preferably 0.6 or less. The upper limit value and lower limit value can be combined as appropriate.

The center of the space surrounded by the 4 or more nitrogen atoms that are capable of coordination is defined in the following manner.

In other words, when the structure has axial symmetry, the aforementioned center is on the symmetry axis, and is the point at which the average distance from each of the nitrogen atoms is the shortest.

When the structure has point symmetry, the center is the point of symmetry.

When the structure has rotational symmetry, the center is on the axis of rotational symmetry, and is the point at which the average distance from each of the nitrogen atoms is the shortest.

The aforementioned n is preferably 4 to 10, more preferably 4 to 8, and particularly preferably 4 to 6.

The lower limit for r is preferably 1.5 Å, more preferably 1.7 Å, and still more preferably 1.9 Å, whereas the upper limit is preferably 3.5 Å, more preferably 3.3 Å, and still more preferably 3.1 Å.

The aromatic compounds that can be used as the ligand of the polynuclear metal complex of the present embodiment preferably have a polycyclic aromatic hetero ring, as such compounds are able to better improve the catalytic activity.

Aromatic compounds that can be used as the ligand of the polynuclear metal complex of the present embodiment are described below, with illustrations of the molecular structure.

In the present embodiment, it is preferable that the structure having a space surrounded by 4 or more nitrogen atoms being able to coordinate with the central metal, and being able to accommodate the central metal in the space is represented by general formula (B-1) shown below. The number of nitrogen atoms surrounding the space and being able to coordinate with the central metal is preferably 4 to 8, and more preferably 4 to 6.

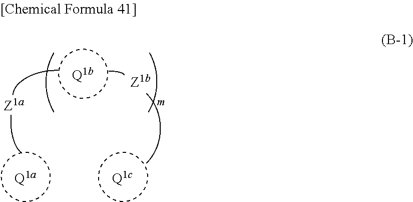

In the formula, m represents an integer of 1 or more; each of Q^{1a}, Q^{1b} and Q^{1c} independently represents a nitrogen-containing aromatic hetero ring which may have a substituent, Q^{1a}, Q^{1b} and Q^{1c} contain the aforementioned 4 or more nitrogen atoms being able to coordinate with the central metal, in the case of 2 or more Q^{1b}, these Q^{1b} may be the same or different from each other, and at least one of Q^{1a}, Q^{1b} and Q^{1c} represents a nitrogen-containing hetero 6-membered ring; each of Z^{1a} and Z^{1b} independently represents a direct bond or a linking group, and in the case of 2 or more Z^{1b}, these Z^{1b} may be the same or different from each other; each of Q^{1a} and Q^{1b}, and Q^{1b} and Q^{1c} may be combined together to form a polycyclic aromatic hetero ring; when m represents an integer of 2 or more and Z^{1b} represents a direct bond, 2 adjacent Q^{1b} may be combined together to form a polycyclic aromatic hetero ring; Q^{1a} and Q^{1c} may be directly bonded, may be mutually bonded via a linking group, or may be combined together to form a polycyclic aromatic hetero ring.

The value of m in general formula (B-1) is preferably an integer of 1 to 5, more preferably an integer of 2 to 4, and is most preferably 2 or 4.

In general formula (B-1), each of Q^{1a}, Q^{1b} and Q^{1c} independently represents a nitrogen-containing aromatic hetero ring which may have a substituent; is preferably a ring selected from the group consisting of a pyridine ring, pyrazine ring, pyrimidine ring, pyridazine ring, 1,3,5-triazine ring, 1,2,4-triazine ring, 1,2,4,5-tetrazine ring, 1H-pyrrole ring, 2H-pyrrole ring, 3H-pyrrole ring, imidazole ring, pyrazole ring, 1,2,3-triazole ring, 1,2,4-triazole ring, oxazole ring, isoxazole ring, thiazole ring, isothiazole ring, 1,3,4-oxadiazole ring, 1,2,5-oxadiazole ring, 1,3,4-thiadiazole ring and 1,2,5-thiadiazole ring, as represented by formulas (B-1-1) to (B-1-22) shown below, and polycyclic aromatic hetero rings having any of these ring structures; is more preferably a pyridine ring, pyrazine ring, pyrimidine ring, pyridazine ring, 1,3,5-triazine ring, 1,2,4-triazine ring, 1,2,4,5-tetrazine ring, 1H-pyrrole ring, 2H-pyrrole ring, 3H-pyrrole ring, imidazole ring, pyrazole ring, 1,2,3-triazole ring, 1,2,4-triazole ring, or a polycyclic aromatic hetero ring having any of these ring structures; and is particularly preferably a pyridine ring, pyrazine ring, pyrimidine ring, 1H-pyrrole ring, 2H-pyrrole ring, or a polycyclic aromatic hetero ring having any of these ring structures.

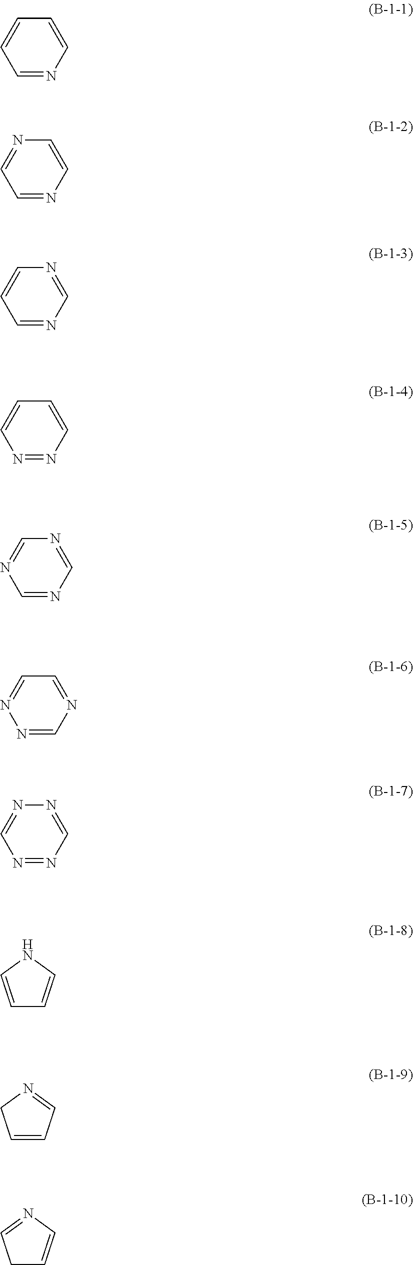

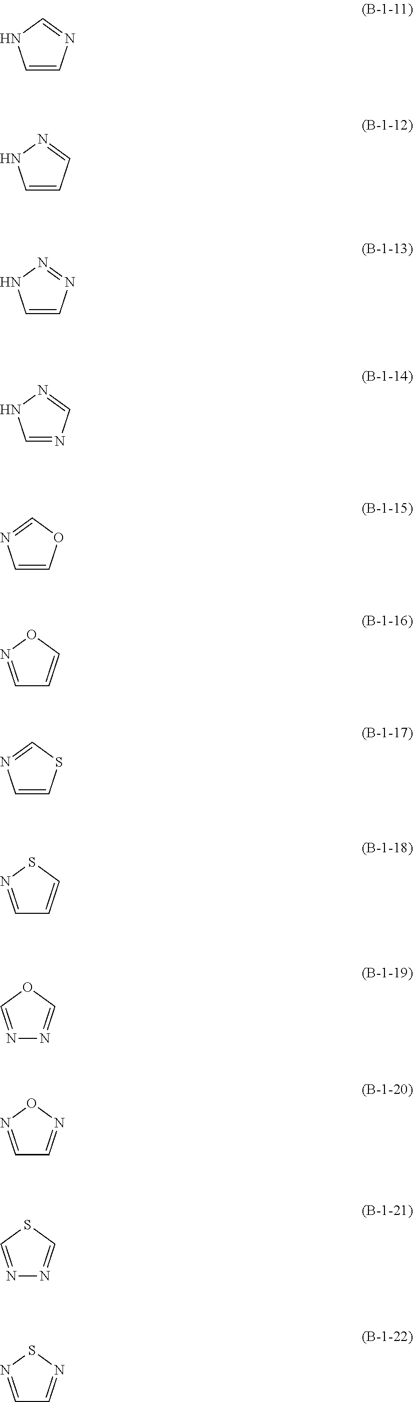

Each of Z^{1a} and Z^{1b} independently represents a direct bond or a linking group. Examples of the direct bond include a single bond and a double bond. Examples of the linking group include divalent and trivalent linking groups. Each of Z^{1a} and Z^{1b} is preferably a single bond, a double bond, or a linking group represented by —C(R^{γ})₂—, ═C(R^{δ})—, ═N(R^{ε})— or ═N-(the linking groups represented by formulas (B-1-a) to (B-1-d) shown below), and is particularly preferably a single bond, a double bond, or a linking group represented by —C(R^{γ})₂— or ═C(R^{δ})—.

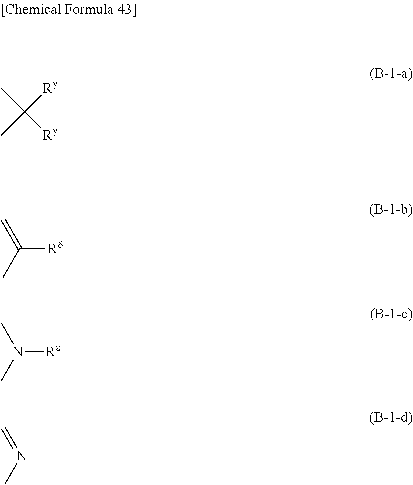

In the formulas, each of R^{γ}, R^{δ} and R^{ε} independently represents a hydrogen atom or a substituent, and mutually adjacent substituents may be mutually bonded together to form a ring with the carbon atom bonded thereto.

Examples of the above substituent include a halogeno group, hydroxyl group, carboxyl group, mercapto group, sulfonic acid group, nitro group, amino group, cyano group, phosphonic acid group, silyl group substituted with an alkyl group of 1 to 4 carbon atoms, linear or branched alkyl group of 1 to 50 carbon atoms, cyclic alkyl group of 3 to 50 carbon atoms, alkenyl group, alkynyl group, alkoxy group, aryl group of 6 to 60 carbon atoms, aralkyl group of 7 to 50 carbon atoms and monovalent heterocyclic group, and of these, a halogeno group, mercapto group, hydroxyl group, carboxyl group, linear or branched alkyl group of 1 to 20 carbon atoms, cyclic alkyl group of 3 to 20 carbon atoms, alkoxy group, aryl group of 6 to 30 carbon atoms, or monovalent heterocyclic group is preferable. In the present description, unless specifically stated otherwise, a substituent refers to the same groups as those mentioned above.

Examples of the halogeno group include a fluoro group, chloro group, bromo group and iodo group.

Examples of the silyl group substituted with an alkyl group of 1 to 4 carbon atoms include a trimethylsilyl group, triethylsilyl group, tert-butyldimethylsilyl group, and triisopropylsilyl group.

Examples of the linear or branched alkyl group include a methyl group, ethyl group, propyl group, isopropyl group, butyl group, isobutyl group, tert-butyl group, sec-butyl group, pentyl group, hexyl group, heptyl group, octyl group, nonyl group, decyl group, dodecyl group, pentadecyl group, octadecyl group and docosyl group.

Examples of the cyclic alkyl group include a cyclopropyl group, cyclobutyl group, cyclopentyl group, cyclohexyl group, cyclononyl group, cyclododecyl group, norbornyl group and adamantyl group.

Examples of the alkenyl group include groups in which any one of the single bonds between carbon atoms (C—C) in one of the aforementioned linear or branched alkyl groups has been substituted with a double bond, and there are no limitations on the position of the double bond. Preferred alkenyl groups include an ethenyl group, propenyl group, 3-butenyl group, 2-butenyl group, 2-pentenyl group, 2-hexenyl group, 2-nonenyl group and 2-dodecenyl group.

Examples of the alkynyl group include groups in which any one of the single bonds between carbon atoms (C—C) in one of the aforementioned linear or branched alkyl groups has been substituted with a triple bond, and there are no limitations on the position of the double bond. The alkynyl group is preferably an ethynyl group, 1-propynyl group, 2-propynyl group, 1-butynyl group, 2-butynyl group, 1-pentynyl group, 2-pentynyl group, 1-hexynyl group, 2-hexynyl group or 1-octynyl group, and is more preferably an ethynyl group.

Examples of the alkoxy group include monovalent groups in which one of the aforementioned linear or branched alkyl groups or cyclic alkyl groups is bonded to an oxygen atom. Preferred alkoxy groups include monovalent groups in which a methyl group, ethyl group, propyl group, isopropyl group, butyl group, isobutyl group, tert-butyl group, sec-butyl group, pentyl group, hexyl group, heptyl group, octyl group, nonyl group, decyl group, dodecyl group, pentadecyl group, octadecyl group, cyclopropyl group, cyclobutyl group, cyclopentyl group or cyclohexyl group is bonded to an oxygen atom.

Examples of the aryl group include a phenyl group, 1-naphthyl group, 2-naphthyl group, 1-anthracenyl group, 2-anthracenyl group, 9-anthracenyl group, 1-tetracenyl group, 2-tetracenyl group, 5-tetracenyl group, 1-pyrenyl group, 2-pyrenyl group, 4-pyrenyl group, 2-perylenyl group, 3-perylenyl group, 2-fluorenyl group, 3-fluorenyl group, 4-fluorenyl group, 1-biphenylenyl group, 2-biphenylenyl group, 2-phenanthrenyl group, 9-phenanthrenyl group, 6-chrysenyl group and 1-coronenyl group. One or more hydrogen atoms in the above aryl groups may be substituted with a halogeno group, hydroxyl group, carboxyl group, mercapto group, sulfonic acid group, nitro group, amino group, cyano group, phosphonic acid group, or an aforementioned alkyl group, alkenyl group, alkynyl group, alkoxy group, aryl group or aralkyl group or the like.

Examples of the monovalent heterocyclic group include a pyridyl group, pyrazyl group, pyrimidyl group, pyridazyl group, pyrrolyl group, furyl group, thienyl group, imidazolyl group, pyrazolyl group, thiazolyl group and oxazolyl group. A monovalent heterocyclic group describes the remaining group of atoms when one hydrogen atom is removed from a heterocyclic compound. The monovalent heterocyclic group is preferably a monovalent aromatic heterocyclic group.

Examples of the aralkyl group include a benzyl group, 1-phenylethyl group, 2-phenylethyl group, 1-phenyl-1-proyl group, 1-phenyl-2-proyl group, 2-phenylpropyl group and 3-phenyl-1-propyl group.

The aforementioned substituents represented by R^{γ}, R^{δ} and R^{ε} may be mutually bonded together, or combined with other bonds of the carbon atom or nitrogen atom to which the substituent is bonded, to form a ring. Examples of this ring include a cyclohexene ring, benzene ring, pyridine ring, pyrazine ring, pyrimidine ring, pyridazine ring, 1H-pyrrole ring, 2H-pyrrole ring, 3H-pyrrole ring, imidazole ring, pyrazole ring, 1,2,3-triazole ring, 1,2,4-triazole ring, oxazole ring, isoxazole ring, thiazole ring, isothiazole ring, 1,3,4-oxadiazole ring, 1,2,5-oxadiazole ring, 1,3,4-thiadiazole ring, 1,2,5-thiadiazole ring, furan ring and thiophene ring. Some or all of the hydrogen atoms that constitute these rings may have a substituent, and these substituents may be mutually bonded together to form another ring with the carbon atoms bonded thereto.

In the present embodiment, the structure having a space surrounded by 4 or more atoms being able to coordinate with the central metal, and being able to accommodate the central metal in the space is, as mentioned above, preferably an aromatic compound of the aforementioned general formula (B-1) in which m represents 2 or 4, namely an aromatic compound represented by general formula (B-2) shown below (m=2 in general formula (B-1)) or general formula (B-3) shown below (m=4 in general formula (B-1)).

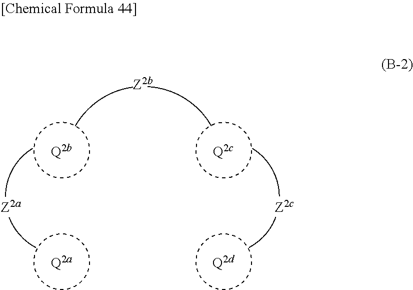

In the formula, each of Q^{2a}, Q^{2b}, Q^{2c} and Q^{2d} independently represents a nitrogen-containing aromatic hetero ring which may have a substituent, Q^{2a}, Q^{2b}, Q^{2c} and Q^{2d} contain the aforementioned 4 or more nitrogen atoms being able to coordinate with the central metal, and at least one of Q^{2a}, Q^{2b}, Q^{2c} and Q^{2d} represents a nitrogen-containing hetero 6-membered ring; each of Z^{2a}, Z^{2b} and Z^{2c} independently represents a direct bond or a linking group; each of Q^{2a} and Q^{2b}, Q^{2b} and Q^{2c}, and Q^{2C} and Q^{2d} may be combined together to form a polycyclic aromatic hetero ring; and Q^{2a} and Q^{2d} may be directly bonded, may be mutually bonded via a linking group, or may be combined together to form a polycyclic aromatic hetero ring.

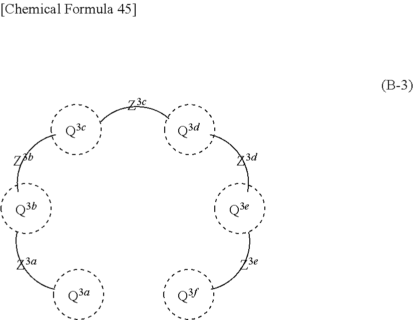

In the formula, each of Q^{3a}, Q^{3b}, Q^{3c}, Q^{3d}, Q^{3e} and Q^{3f} independently represents a nitrogen-containing aromatic hetero ring which may have a substituent, Q^{3a}, Q^{3b}, Q^{3c}, Q^{3d}, Q^{3e} and Q^{3f} contain the aforementioned 4 or more nitrogen atoms being able to coordinate with the central metal, and at least one of Q^{3a}, Q^{3b}, Q^{3c}, Q^{3d}, Q^{3e} and Q^{3f} represents a nitrogen-containing hetero 6-membered ring; each of Z^{3a}, Z^{3b}, Z^{3c}, Z^{3d} and Z^{3e} independently represents a direct bond or a linking group; each of Q^{3a} and Q^{3b}, Q^{3b} and Q^{3c}, Q^{3c} and Q^{3d}, Q^{3d} and Q^{3e}, and Q^{3e} and Q^{3f} may be combined together to form a polycyclic aromatic hetero ring; and Q^{3a} and Q^{3f} may be directly bonded, may be mutually bonded via a linking group, or may be combined together to form a polycyclic aromatic hetero ring.

Q^{2a} in general formula (B-2) corresponds with Q^{1a} in general formula (B-1), Q^{2b} and Q^{2c} in general formula (B-2) correspond with Q^{1b} in general formula (B-1), and Q^{2d} in general formula (B-2) corresponds with Q^{1c} in general formula (B-1). Further, Z^{2a} in general formula (B-2) corresponds with Z^{1a} in general formula (B-1), and Z^{2b} and Z^{2c} in general formula (B-2) correspond with Z^{1b} in general formula (B-1).

Similarly, Q^{3a} in general formula (B-3) corresponds with Q^{1a} in general formula (B-1), Q^{3b} to Q^{3e} in general formula (B-3) correspond with Q^{1b} in general formula (B-1), and Q^{3f} in general formula (B-3) corresponds with Q^{1c} in general formula (B-1). Further, Z^{3a} in general formula (B-3) corresponds with Z^{1a} in general formula (B-1), and Z^{3b} to Z^{3e} in general formula (B-3) correspond with Z^{1b} in general formula (B-1).

Each of Q^{2a}, Q^{2b}, Q^{2c} and Q^{2d} in general formula (B-2), and each of Q^{3a}, Q^{3b}, Q^{3c}, Q^{3d}, Q^{3e} and Q^{3f} in general formula (B-3) independently represents a nitrogen-containing aromatic ring which may have a substituent, and preferred examples include the same rings as those described above for Q^{1a}, Q^{1b} and Q^{1c} in the above general formula (B-1).

It is preferable that the organic group consisting of Q^{1a} and Q^{1b}, which are two nitrogen-containing aromatic hetero rings, or Q^{1b} and Q^{1c}, which are two nitrogen-containing aromatic hetero rings, or Q^{2a} and Q^{2b}, which are two nitrogen-containing aromatic hetero rings, or Q^{2b} and Q^{2c}, which are two nitrogen-containing aromatic hetero rings, or Q^{2c} and Q^{2d}, which are two nitrogen-containing aromatic hetero rings, or Q^{3a} and Q^{3b}, which are two nitrogen-containing aromatic hetero rings, or Q^{3b} and Q^{3c}, which are two nitrogen-containing aromatic hetero rings, or Q^{3c} and Q^{3d}, which are two nitrogen-containing aromatic hetero rings, or Q^{3d} and Q^{3e}, which are two nitrogen-containing aromatic hetero rings, or Q^{3e} and Q^{3f}, which are two nitrogen-containing aromatic hetero rings, and a direct bond or a linking group mutually bonding the two nitrogen-containing aromatic hetero rings is a divalent organic group represented by any one of general formulas (B-4-a) to (B-4-c), (B-5-a) to (B-5-d), and (B-6-a) to (B-6-d) shown below:

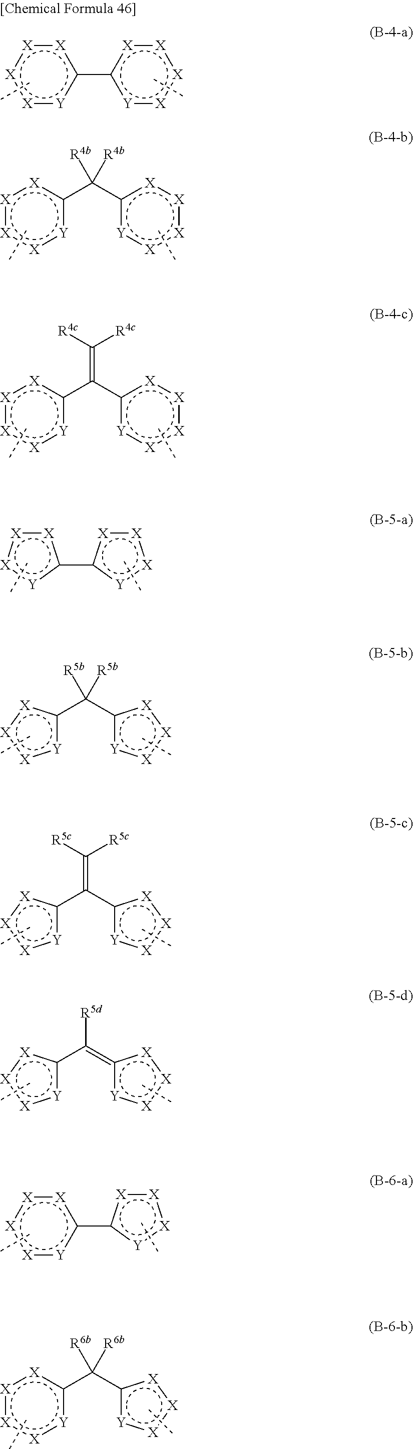

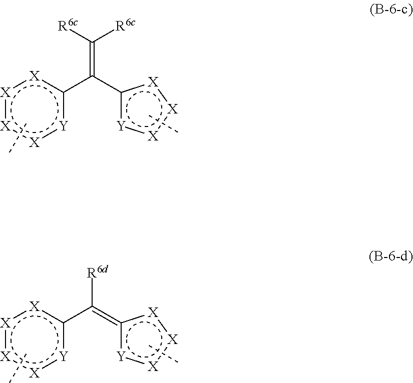

wherein X represents) ═C(R^{α}), —N(R^{β})—, ═N—, —O—, —S— or —Se—, preferably represents) ═C(R^{α}—), —N(R^{β})—, ═N—, —O— or —S—, and more preferably represents) ═C(R^{α}), —N(R^{β})— or ═N—; each 2 or more X, R^{4b}, R^{4c}, R^{5b}, R^{5c}, R^{6b} and R^{6c} may be the same or different from each other; Y represents —N(H)— or ═N—, and 2 or more Y may be the same or different from each other; and straight dashed lines in the formulas indicate bonding at the dashed line portion to Z^{1a} or the like in the aforementioned general formula (B-1), (B-2) or (B-3).

In the above formulas, each of R^{4b}, R^{4c}, R^{5b}, R^{5c}, R^{5d}, R^{6b}, R^{6c}, R^{6d}, R^{α} and R^{β} independently represents a hydrogen atom or a substituent. The substituent is the same as the substituent described above. Further, mutually adjacent substituents may be mutually bonded together to form a ring with the carbon atom(s) bonded thereto.

Moreover, it is more preferable that the organic group consisting of Q^{1a} and Q^{1b}, which are two nitrogen-containing aromatic hetero rings, or Q^{1b} and Q^{1c}, which are two nitrogen-containing aromatic hetero rings, or Q^{2a} and Q^{2b}, which are two nitrogen-containing aromatic hetero rings, or Q^{2b} and Q^{2c}, which are two nitrogen-containing aromatic hetero rings, or Q^{2c} and Q^{2d}, which are two nitrogen-containing aromatic hetero rings, or Q^{3a} and Q^{3b}, which are two nitrogen-containing aromatic hetero rings, or Q^{3b} and Q^{3c}, which are two nitrogen-containing aromatic hetero rings, or Q^{3c} and Q^{3d}, which are two nitrogen-containing aromatic hetero rings, or Q^{3d} and Q^{3e}, which are two nitrogen-containing aromatic hetero rings, or Q^{3e} and Q^{3f}, which are two nitrogen-containing aromatic hetero rings, and a direct bond or a linking group mutually bonding the two nitrogen-containing aromatic hetero rings is a divalent organic group represented by any one of general formulas (B-7-a) to (B-7-e), (B-8-a) to (B-8-e), (B-9-a) to (B-9-e) and (B-10-a) to (B-10-e) shown below:

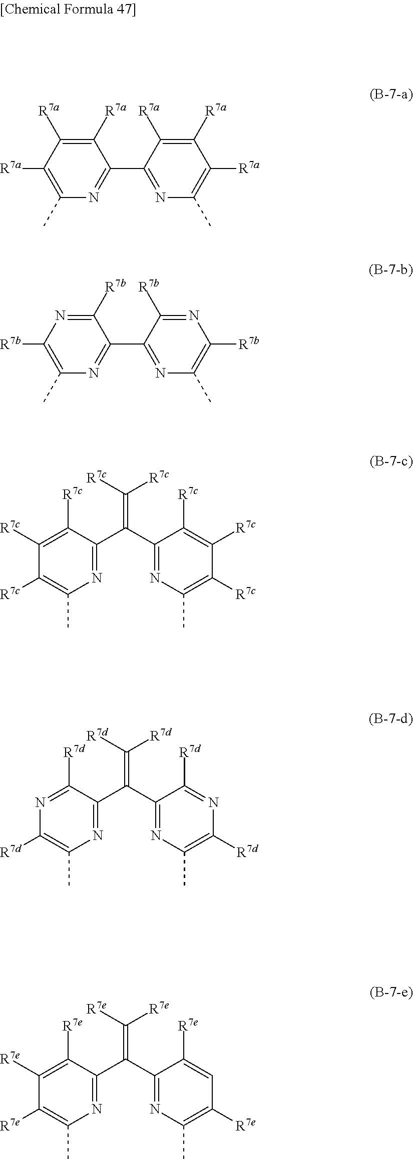

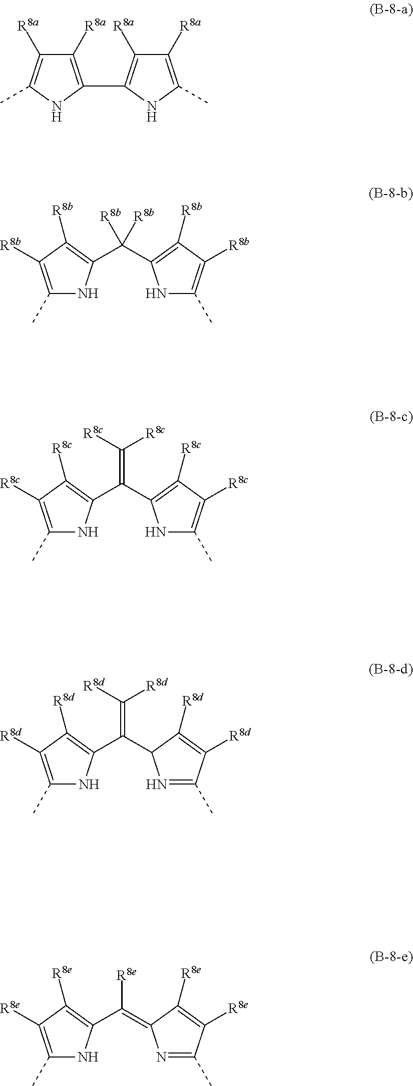

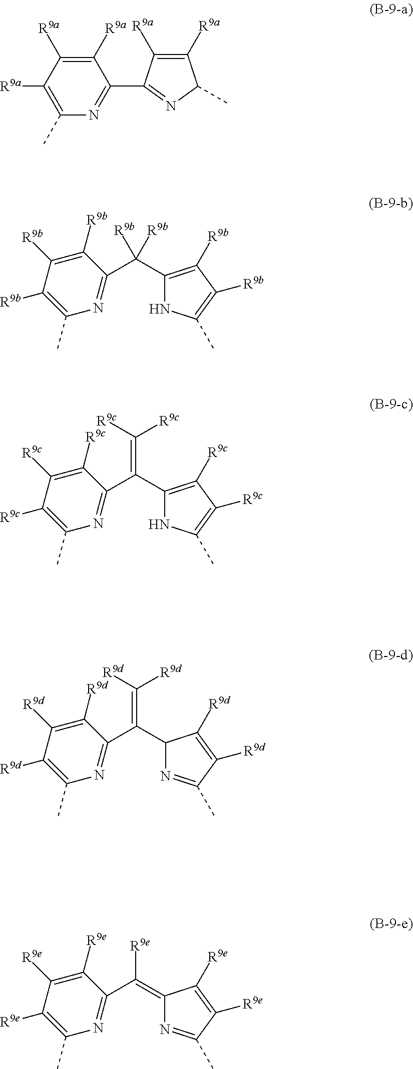

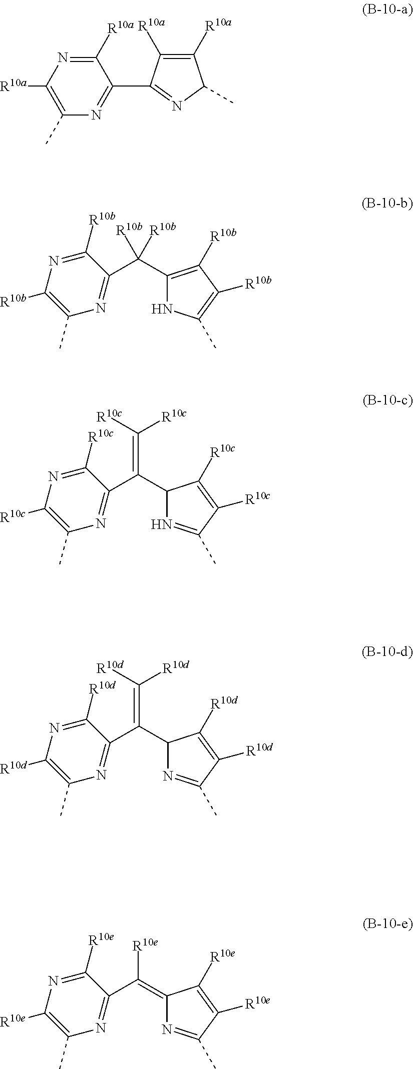

wherein each of R^{7a} to R^{10e} independently represents a hydrogen atom or a substituent, and mutually adjacent substituents may be mutually bonded together to form a ring with the carbon atom(s) bonded thereto; and each 2 or more of R^{7a} to R^{10e} may be the same or different from each other; the substituent is the same as the substituent described above; and straight dashed lines in the formulas indicate bonding at the dashed line portion to Z^{1a} or the like in the aforementioned general formula (B-1), (B-2) or (B-3).

Examples of the ligand of the polynuclear metal complex of the present embodiment include compounds represented by structural formulas represented by general formulas (B-I-1) to (B-I-41) shown below. Hydrogen atoms in the formulas may be substituted with the substituents described above.

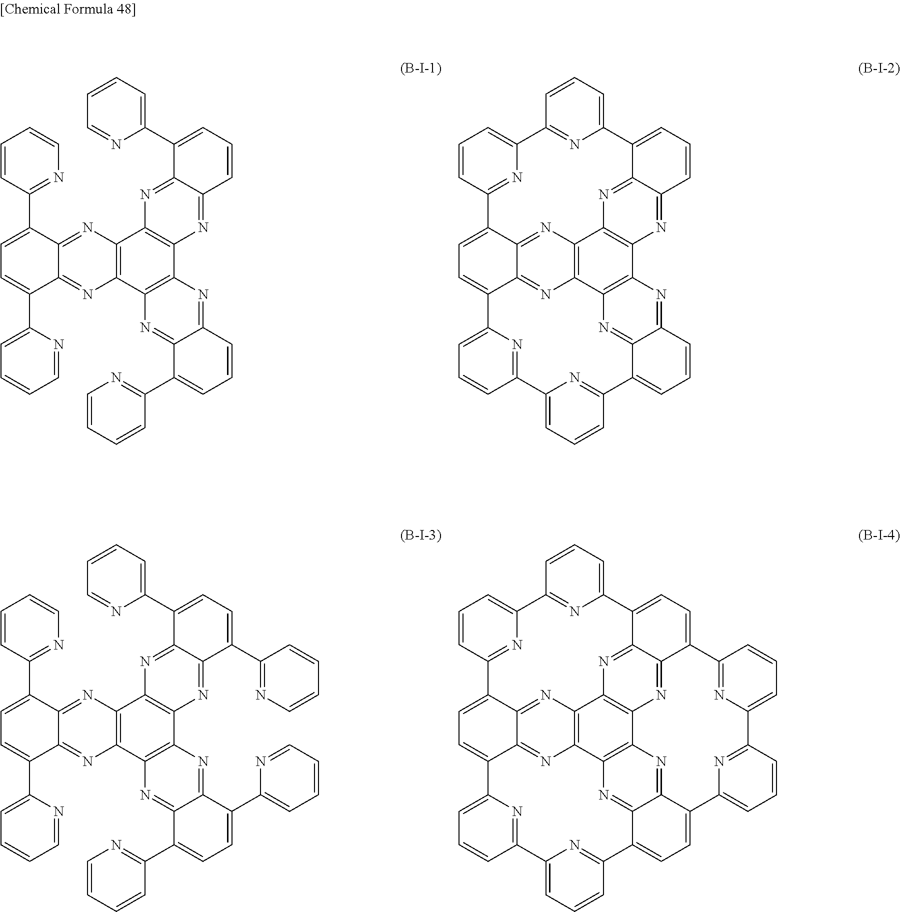

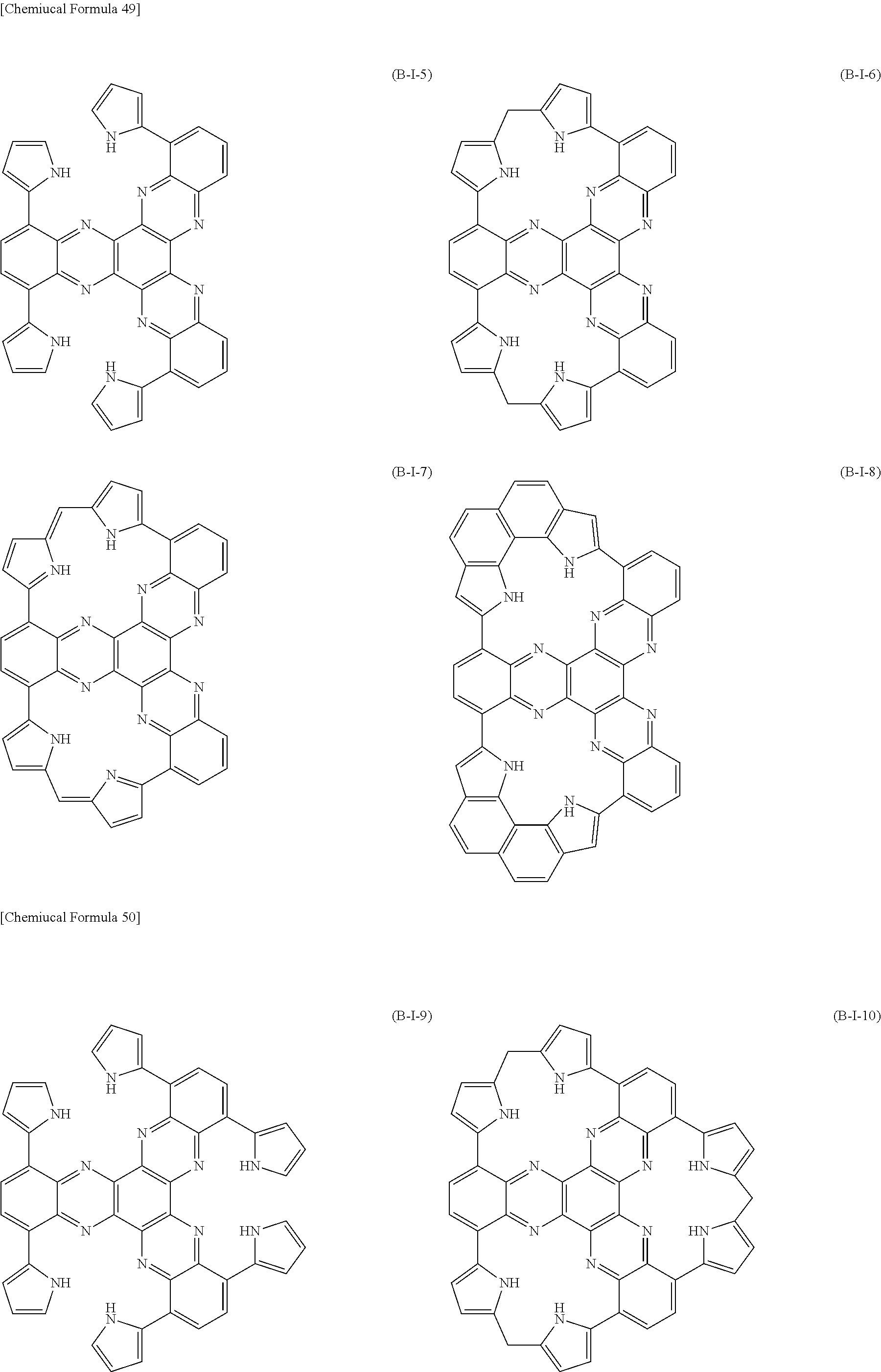

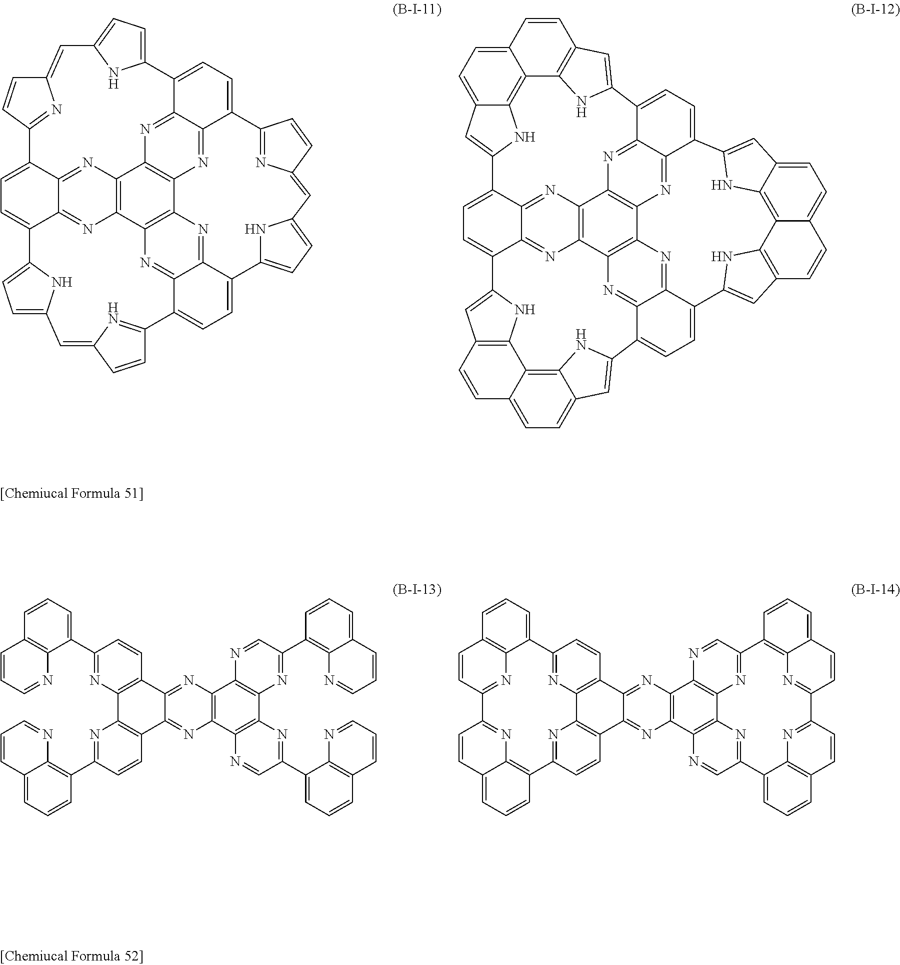

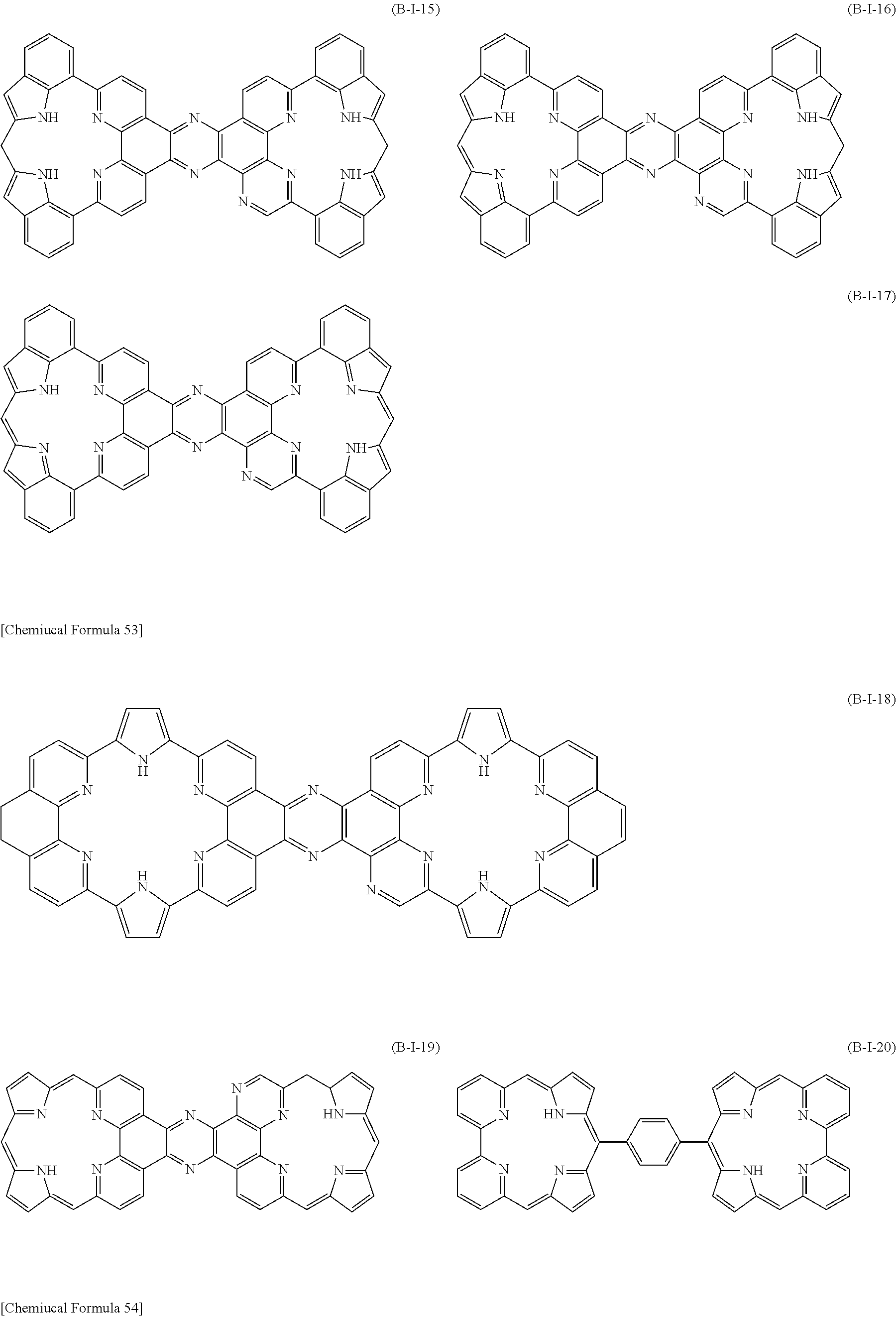

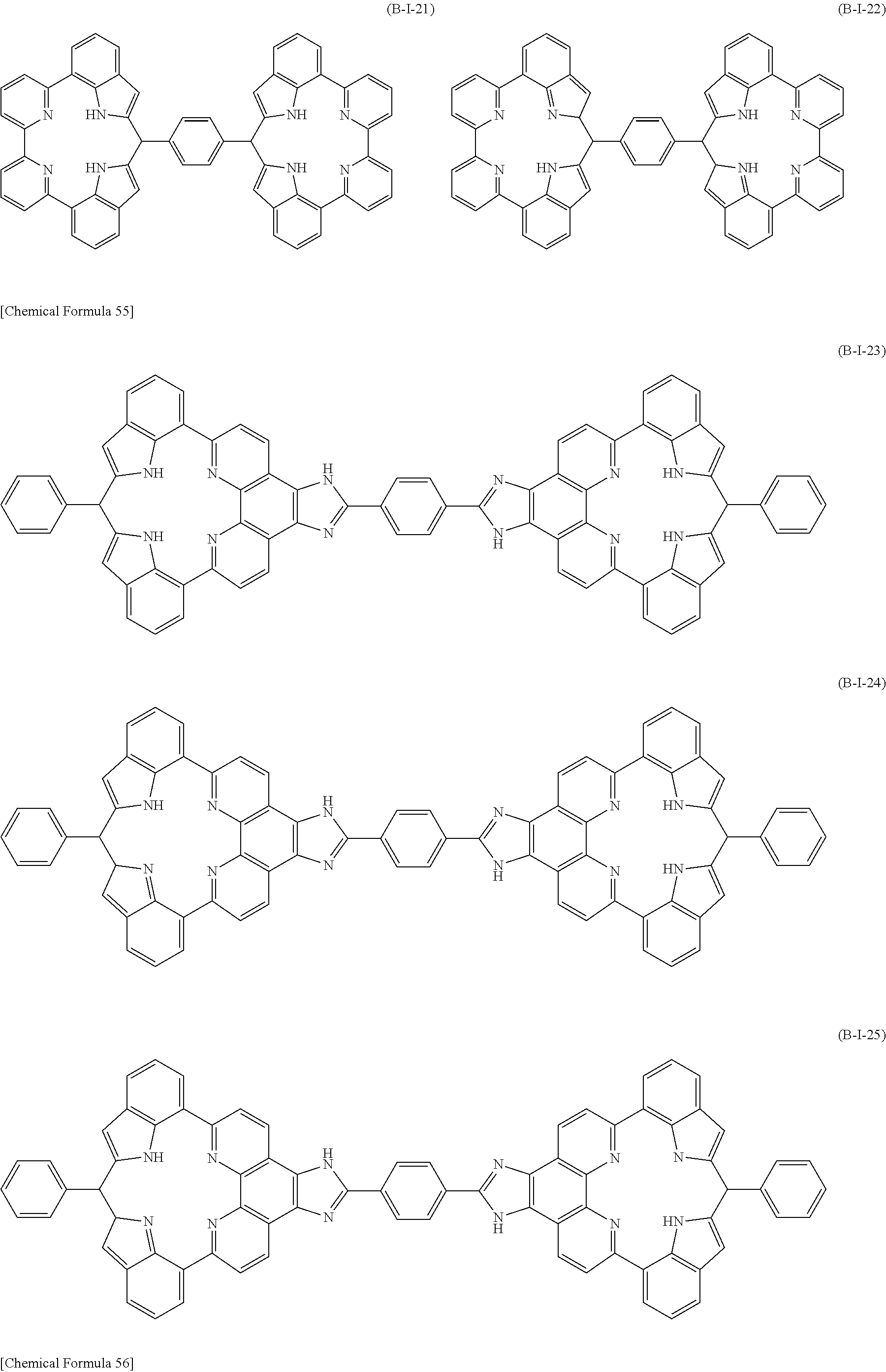

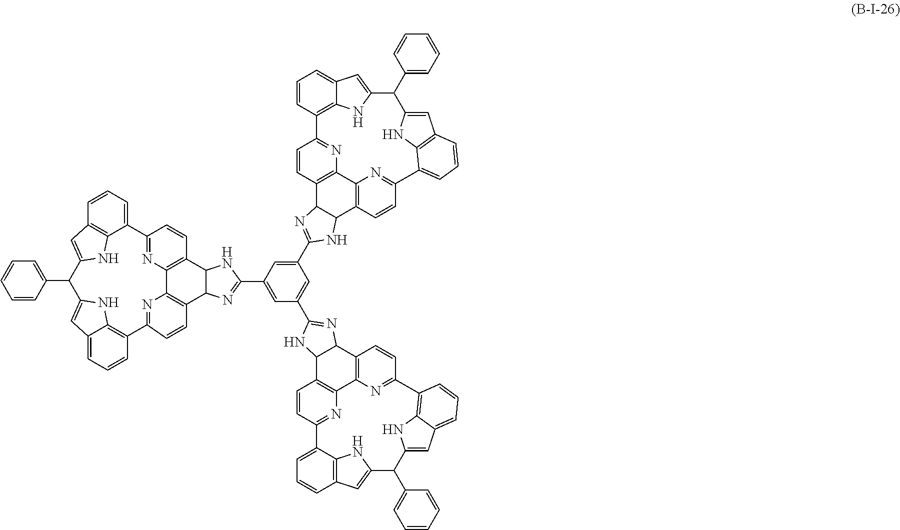

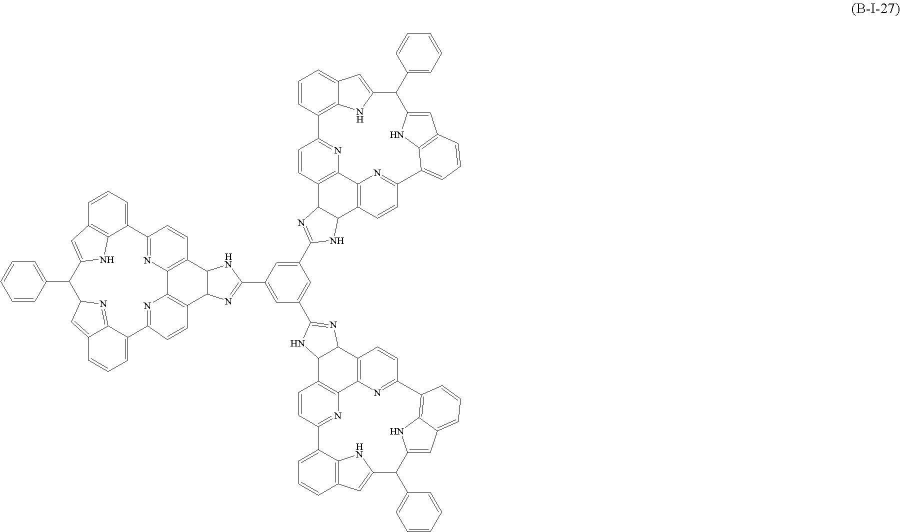

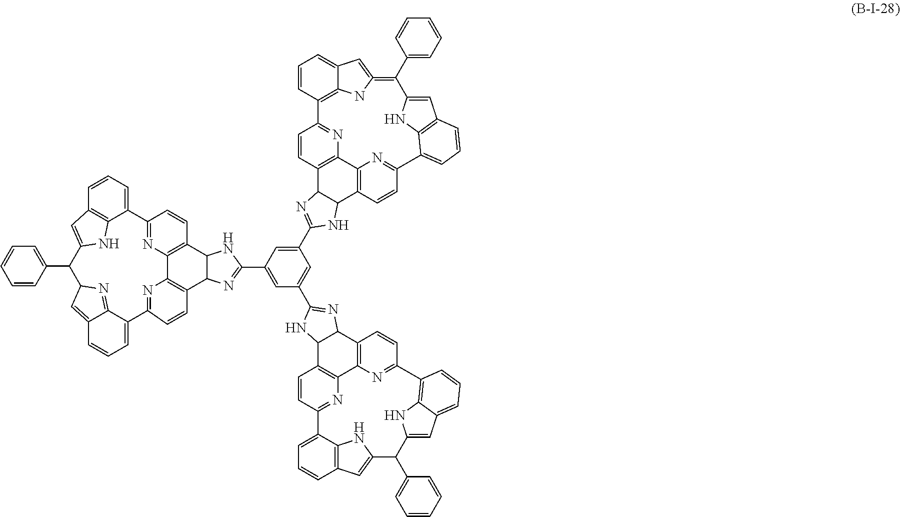

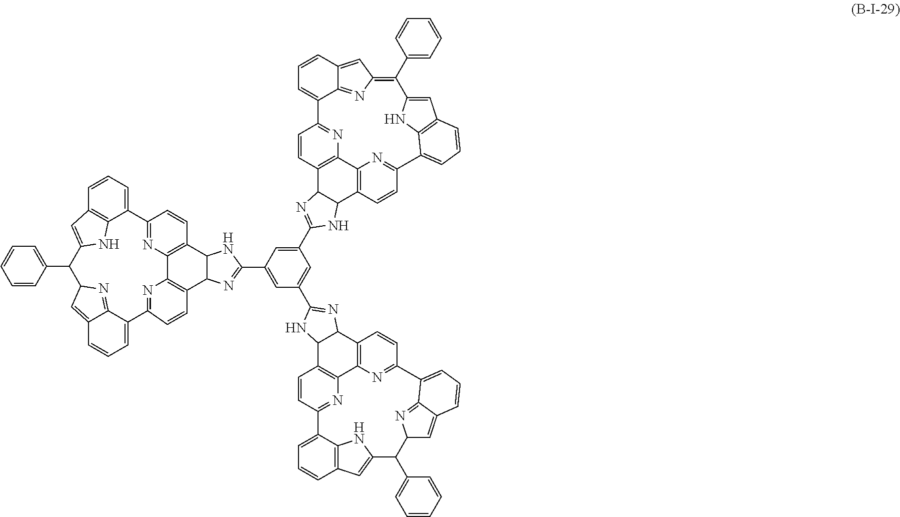

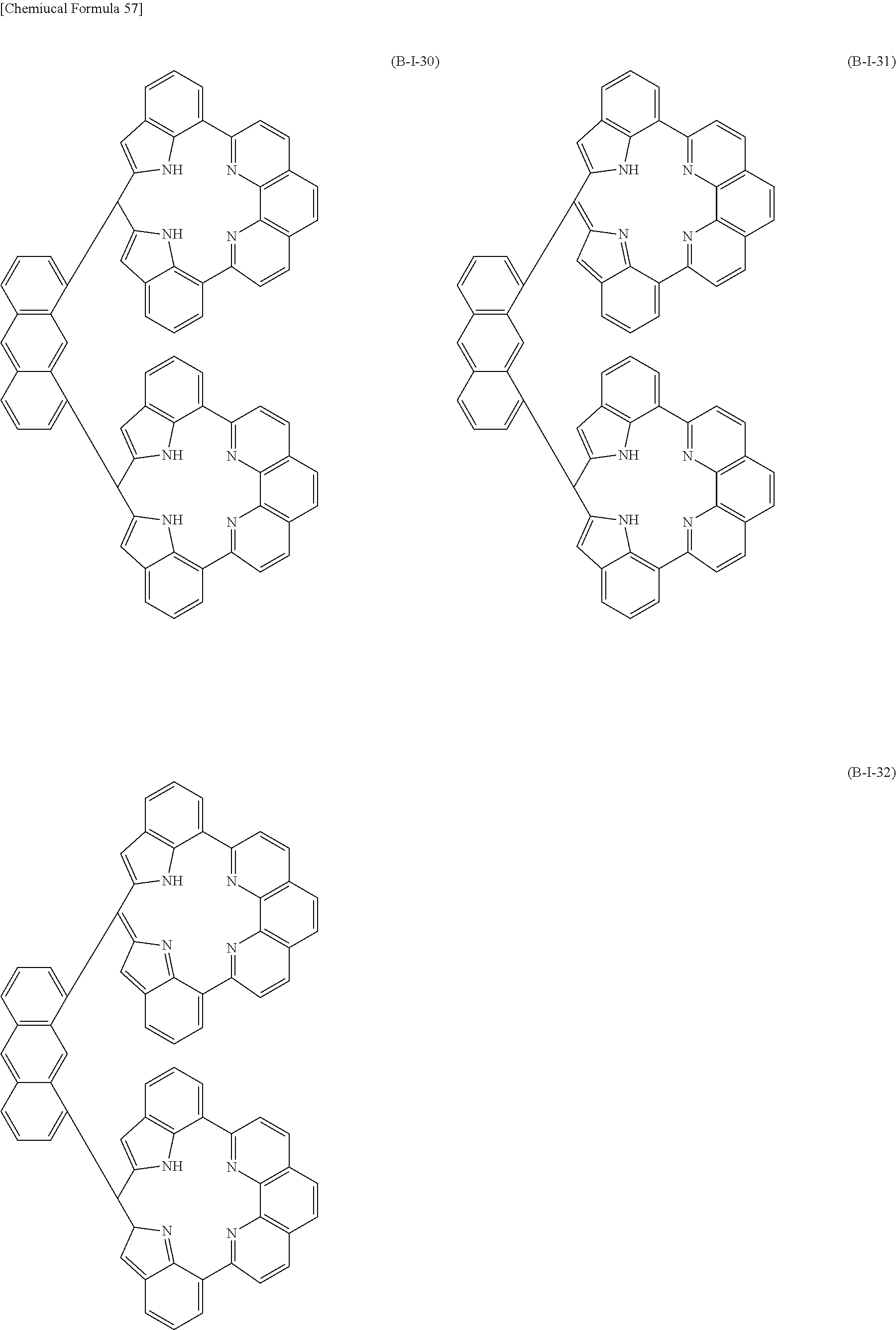

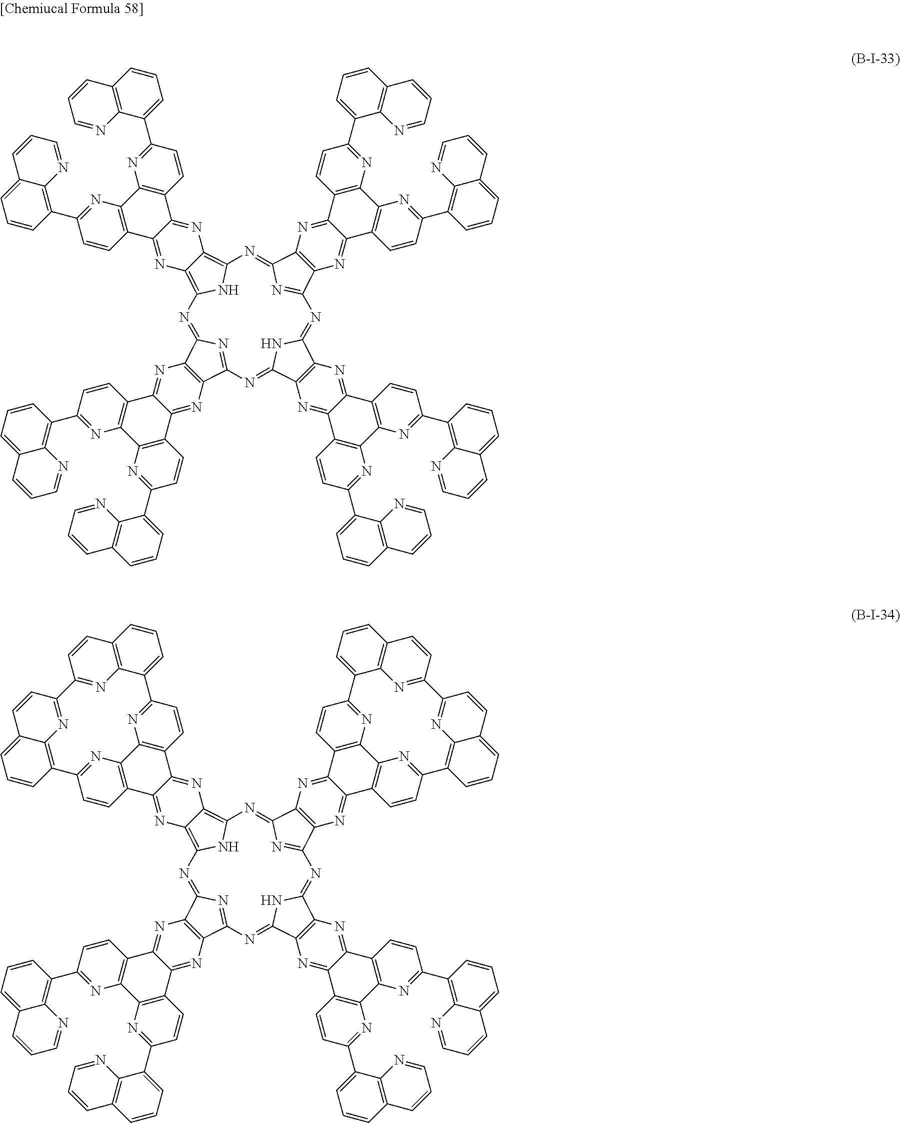

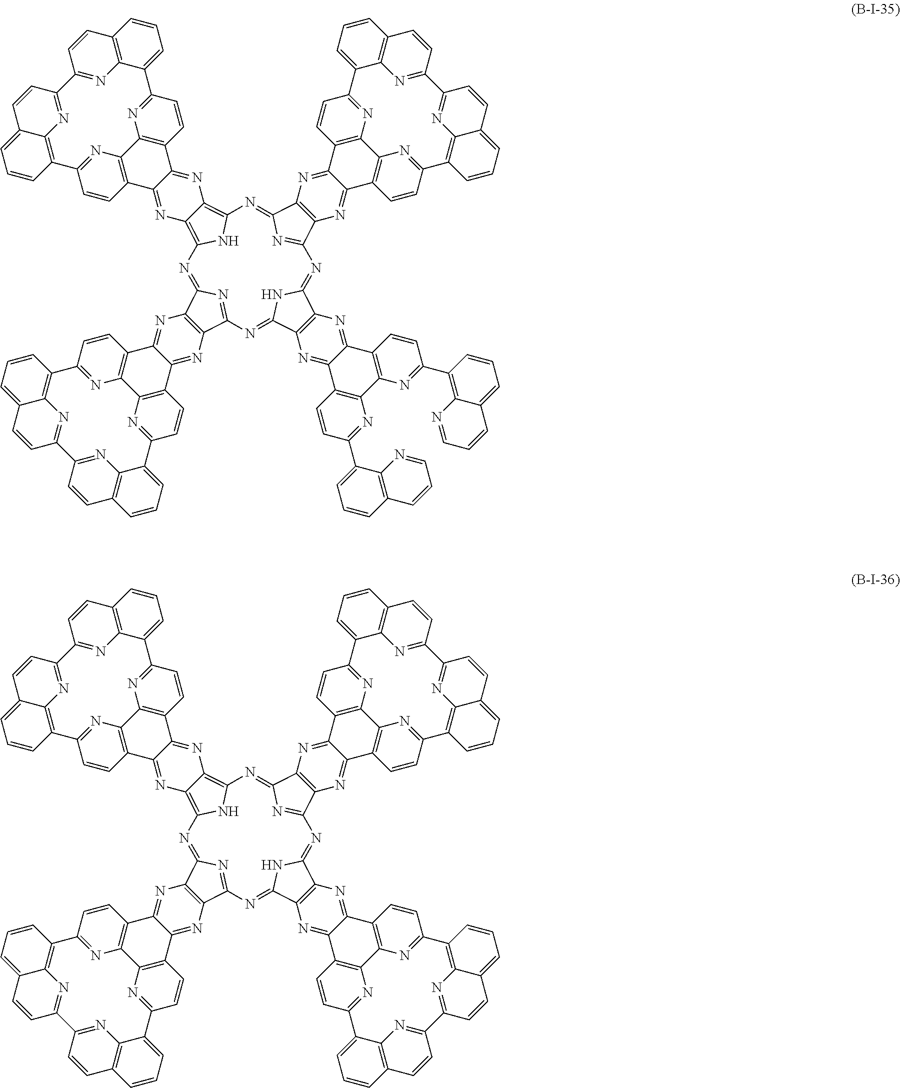

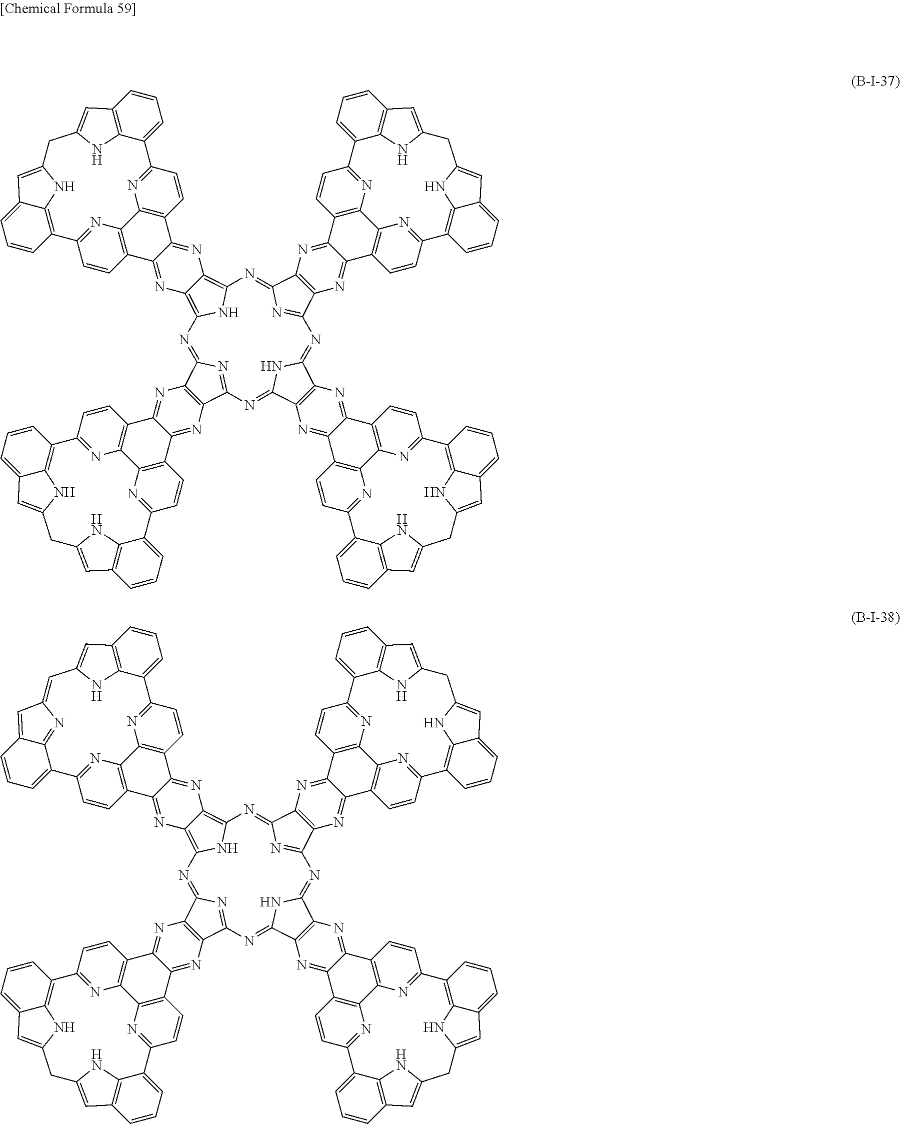

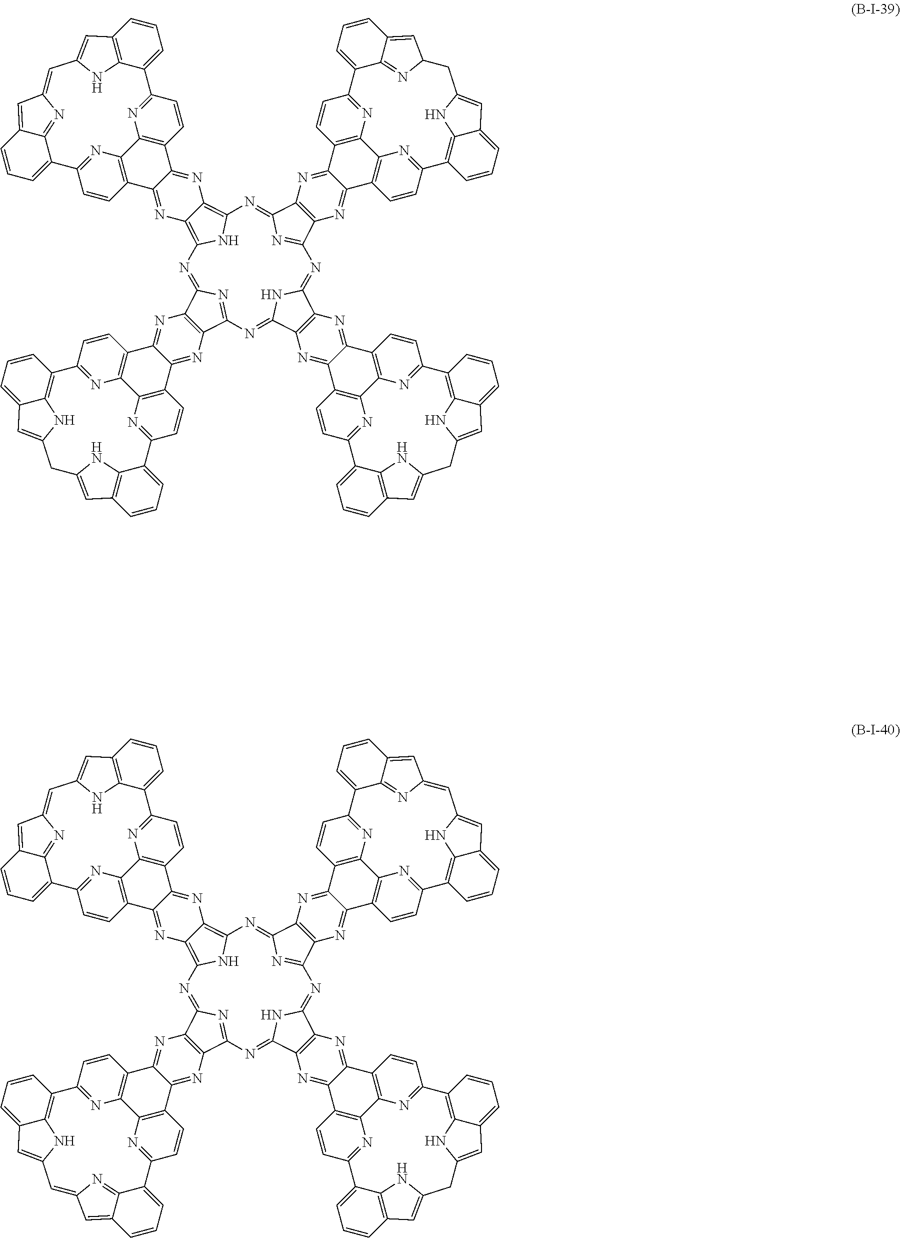

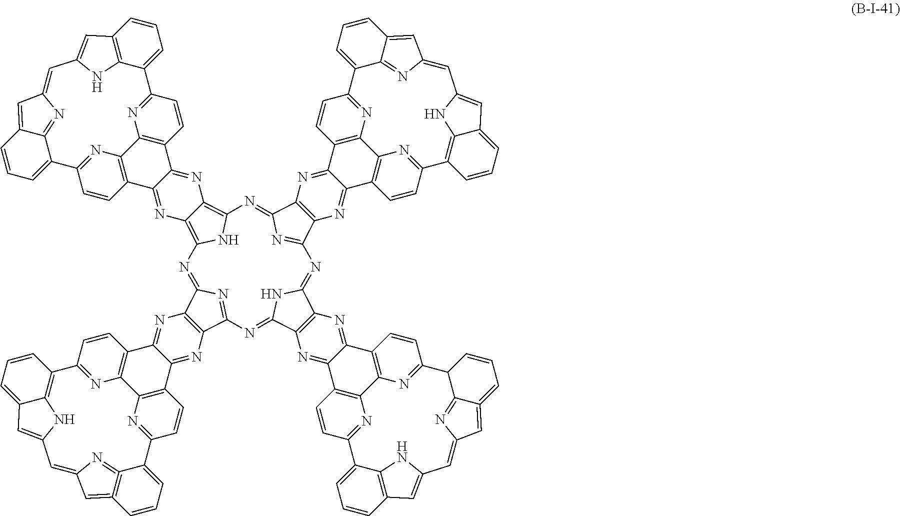

Further examples of the ligand of the polynuclear metal complex of the present embodiment include aromatic compounds having unit structures represented by general formulas (B-I-42) to (B-I-62) shown below. The ligand has 2 or more of these unit structures, and the 2 or more unit structures may be the same or different from each other. Hydrogen atoms in the formulas may be substituted with the substituents described above.

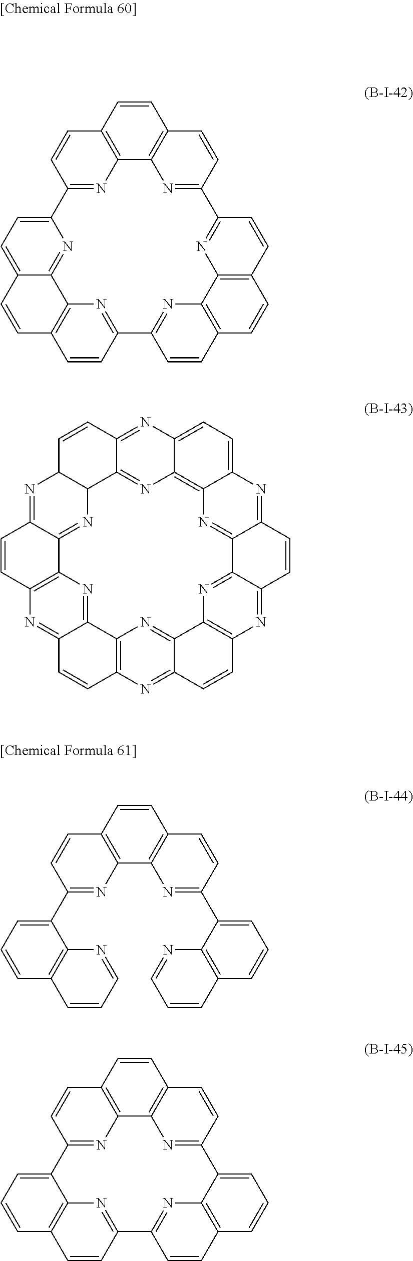

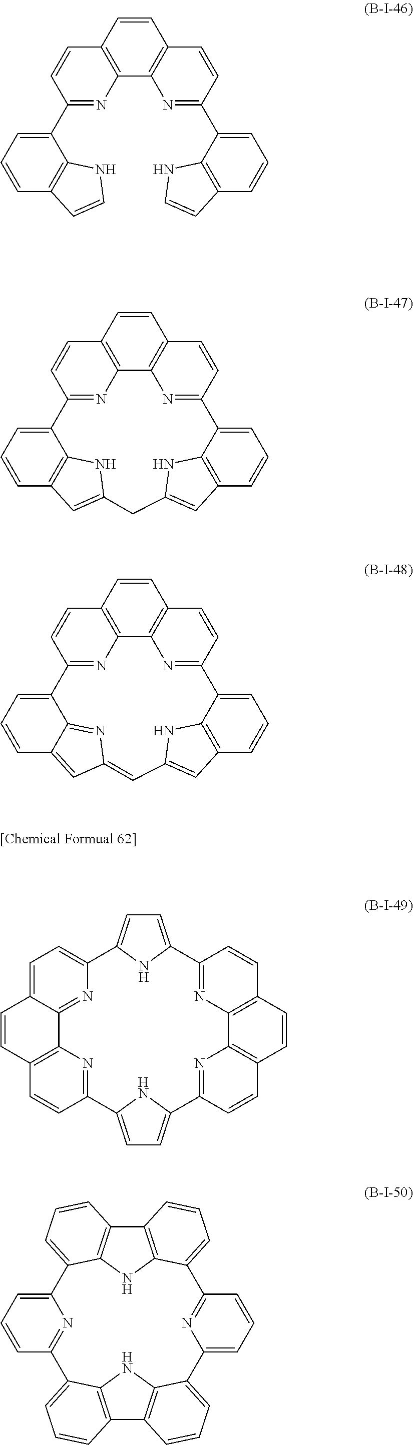

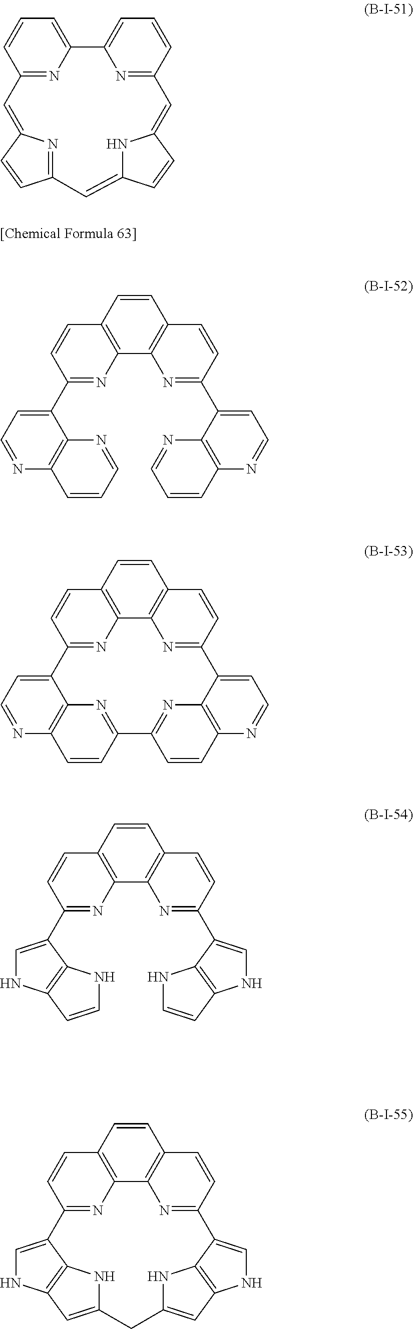

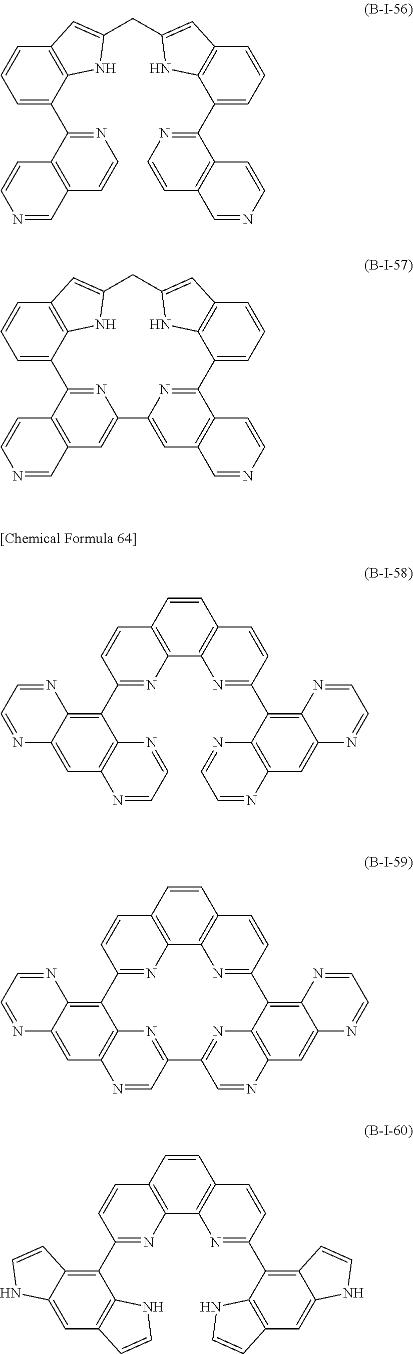

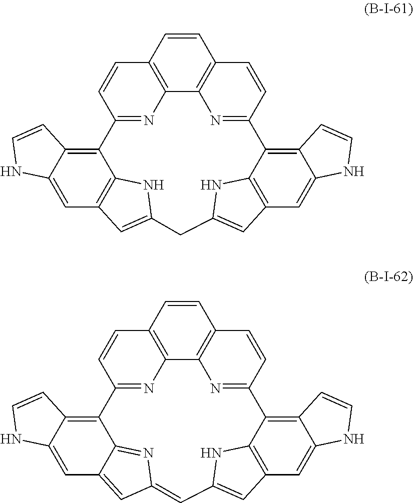

Examples of aromatic compounds which have the above unit structures and can be used as the ligand of the polynuclear metal complex of the present embodiment include compounds represented by general formulas (B-I-63) to (B-I-97) shown below. In these compounds, hydrogen atoms in the formulas may be substituted with the substituents described above, and 2 proximate hydrogen bonds may be removed to form a direct bond or a linking group.

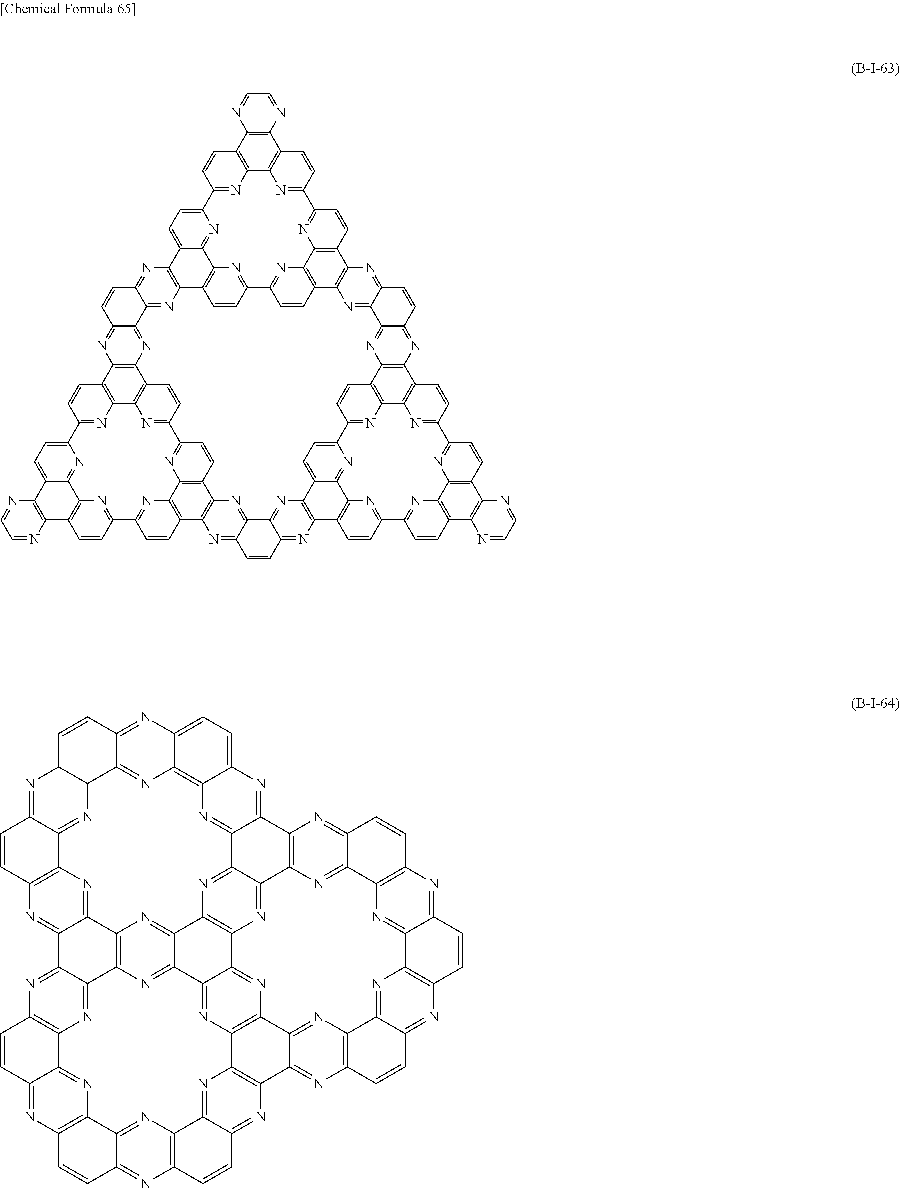

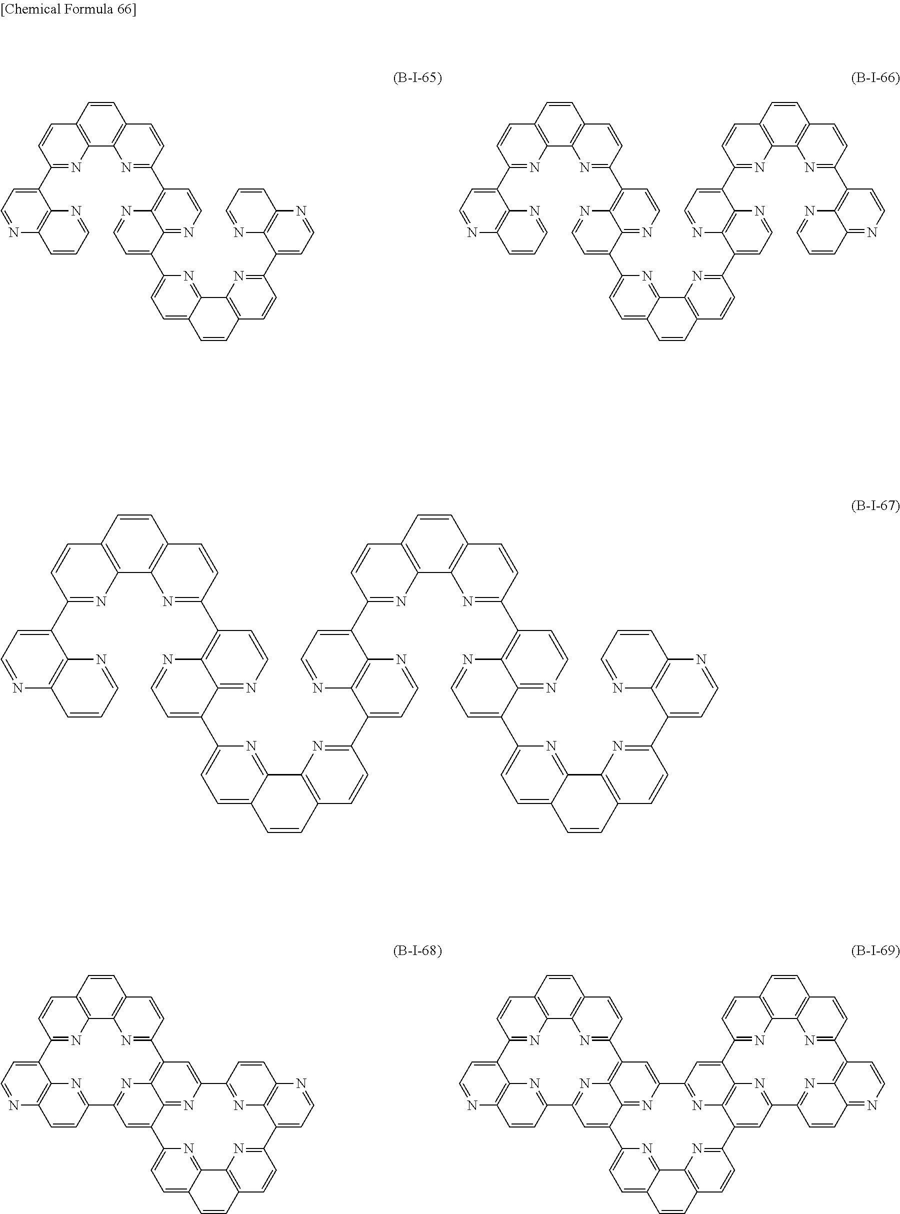

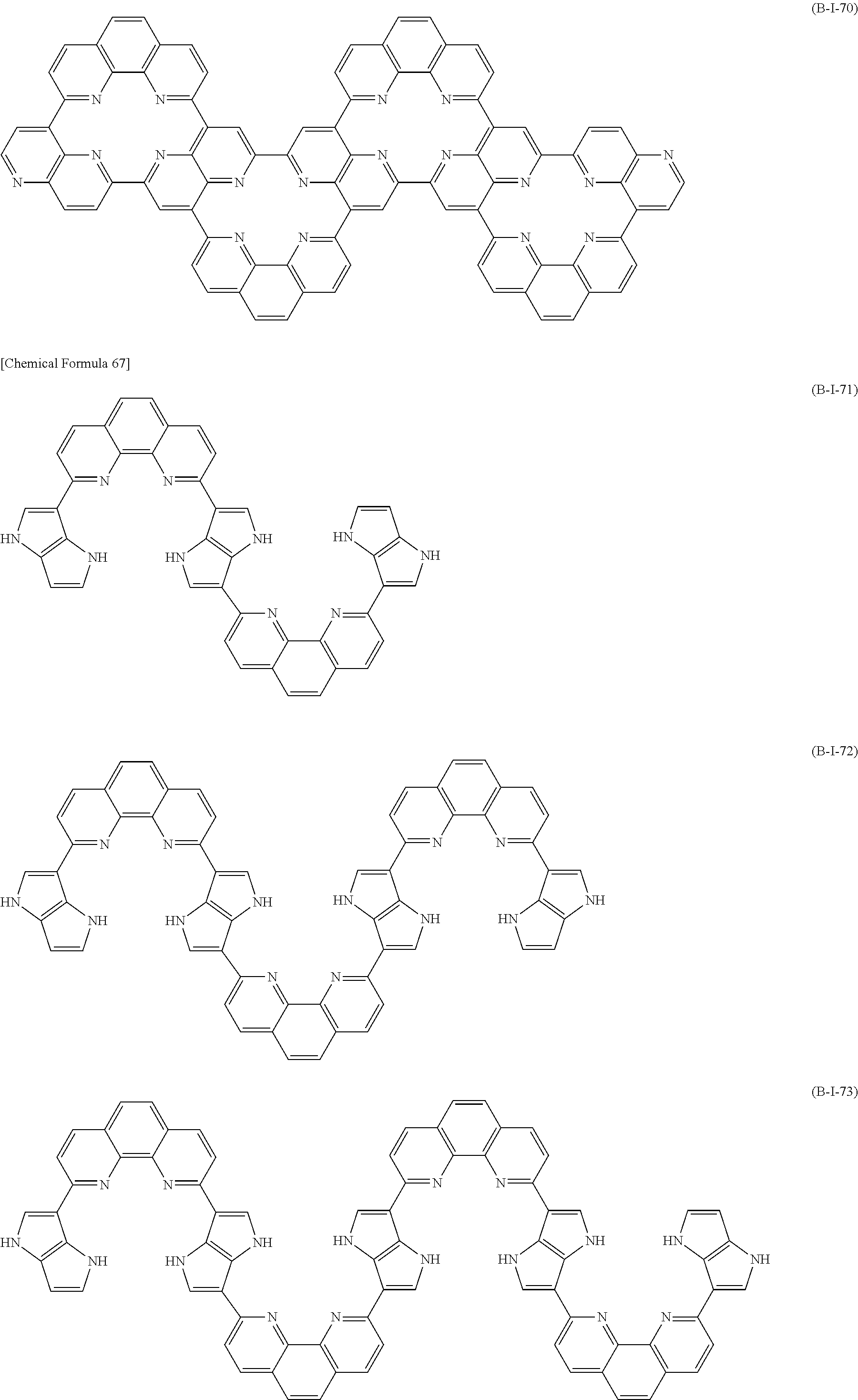

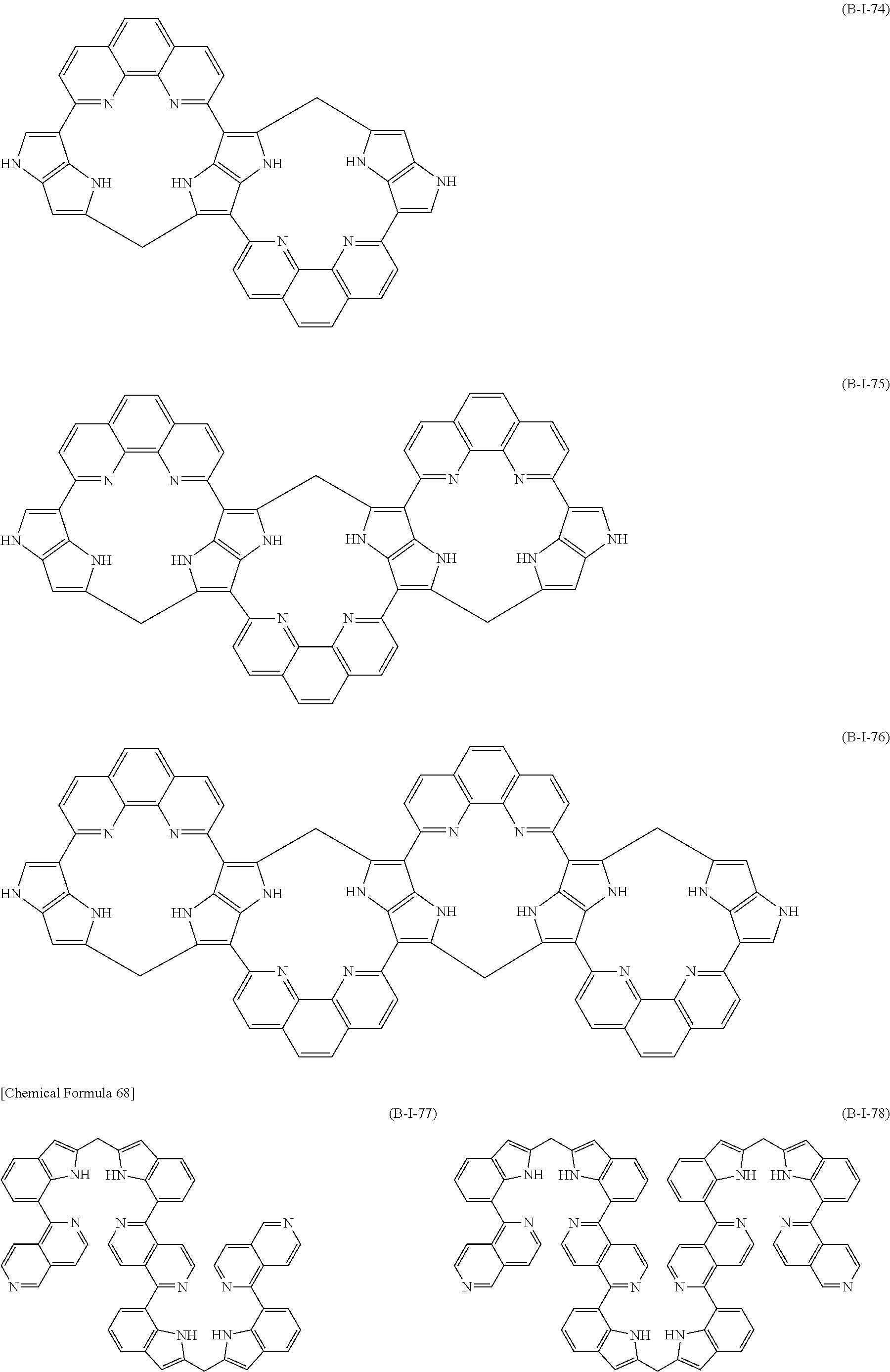

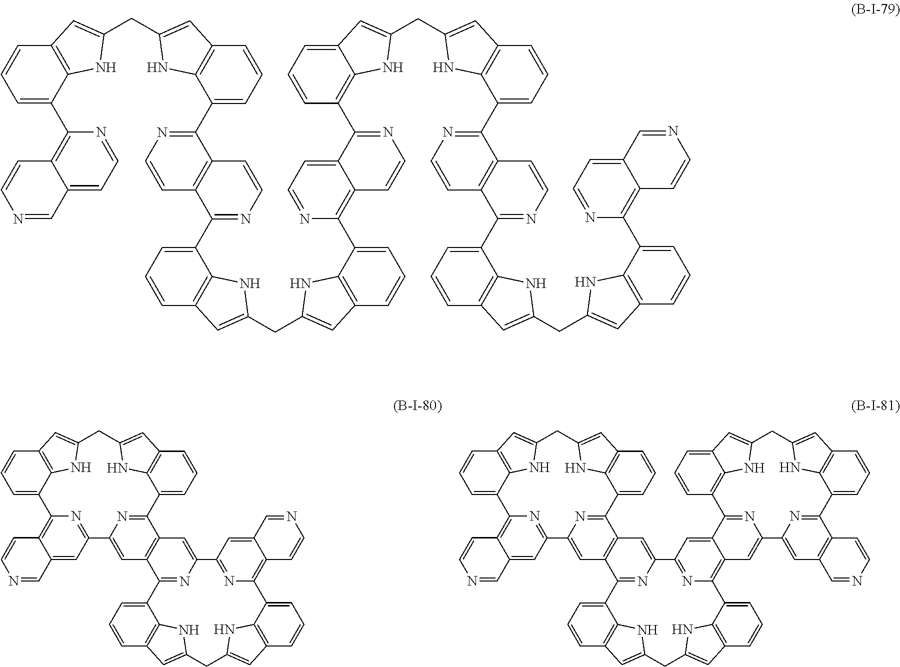

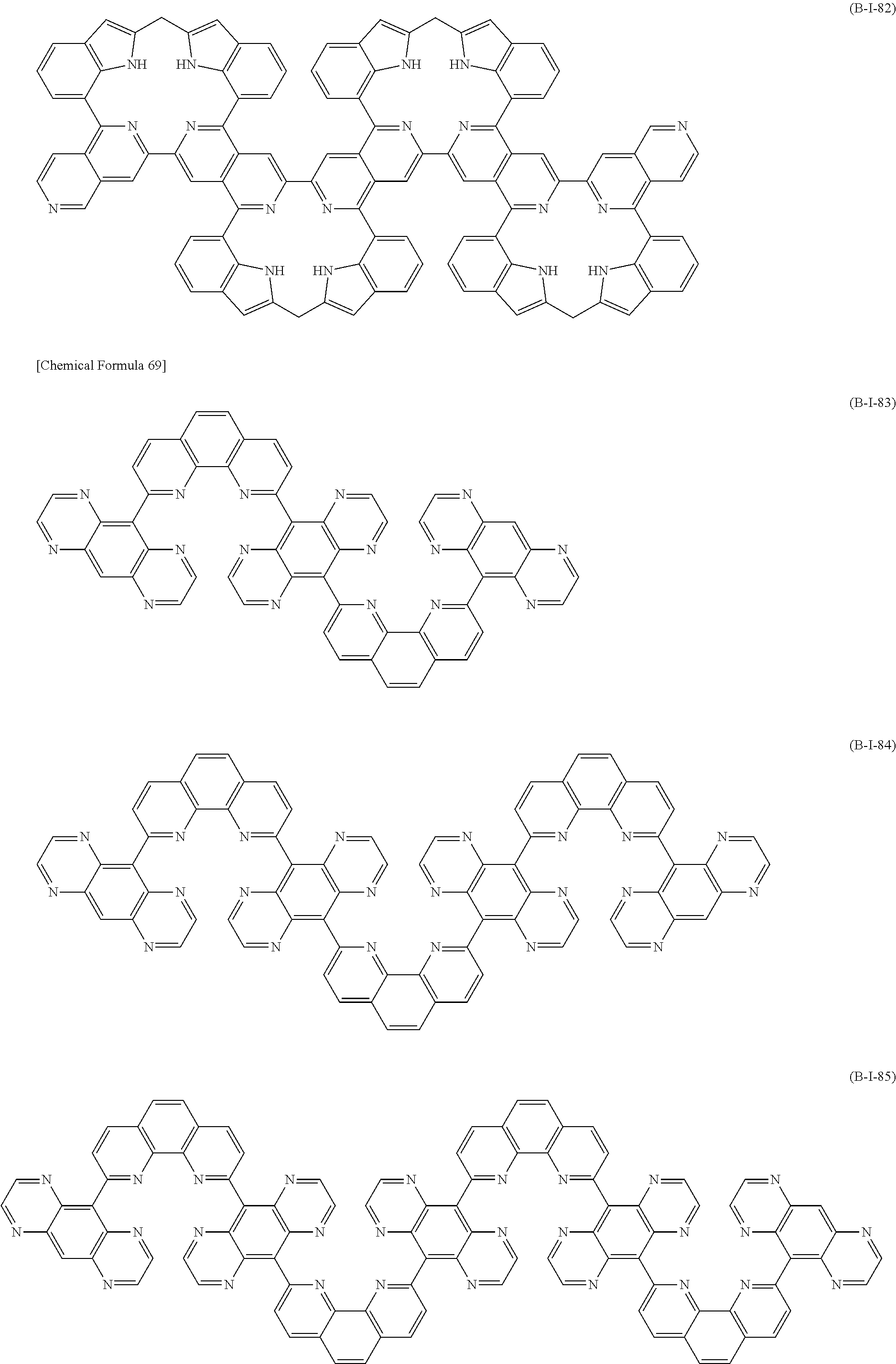

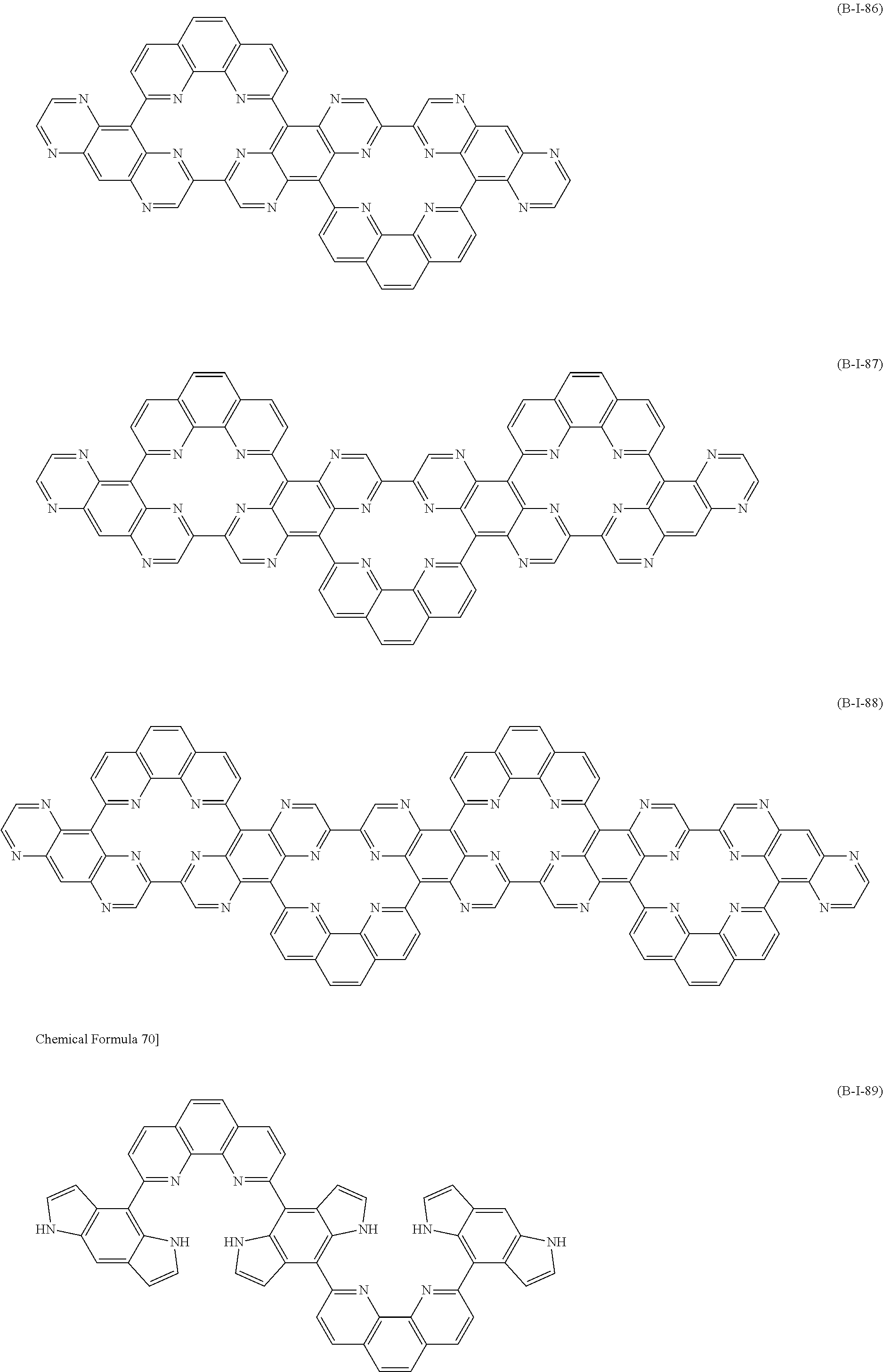

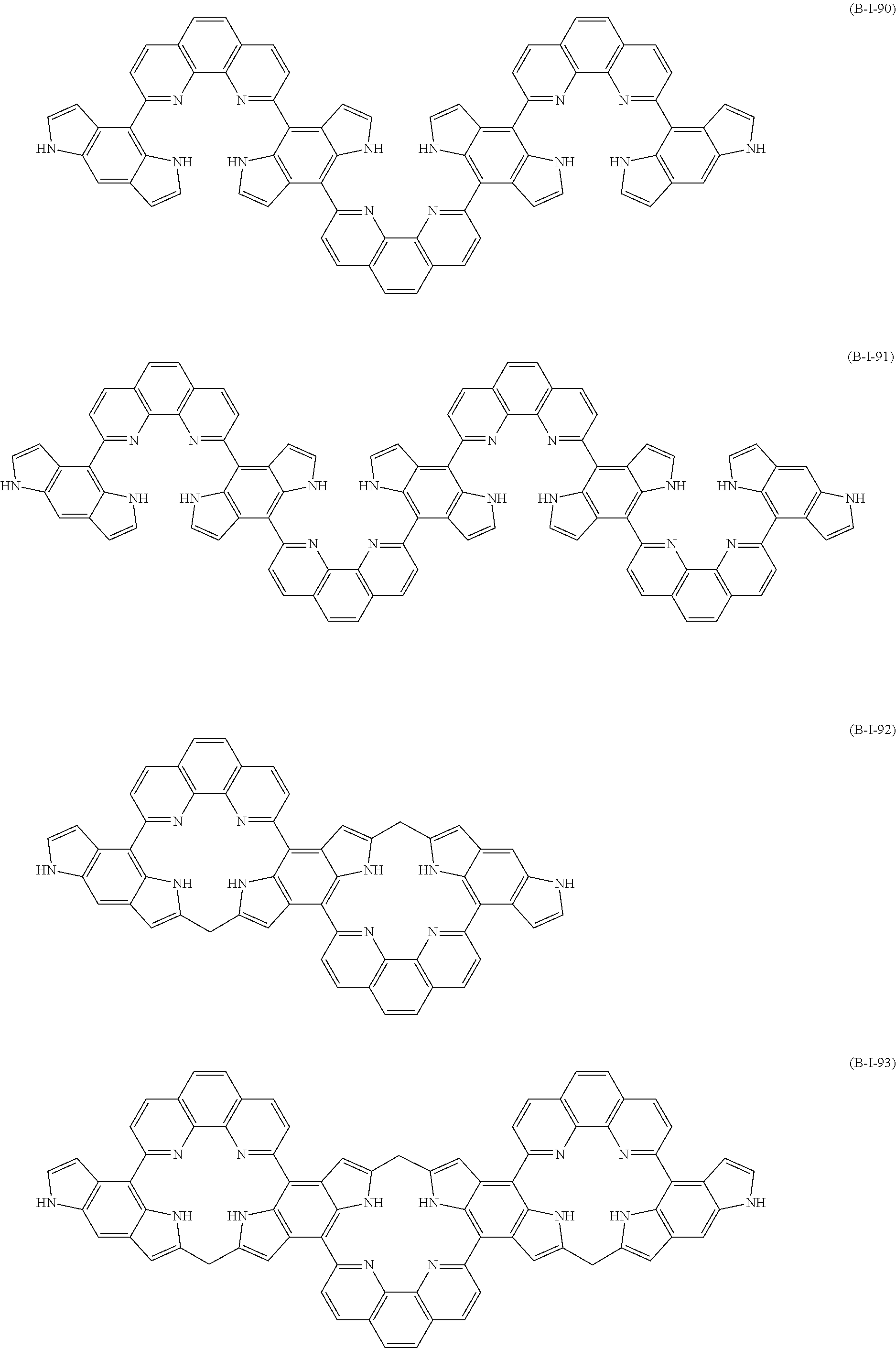

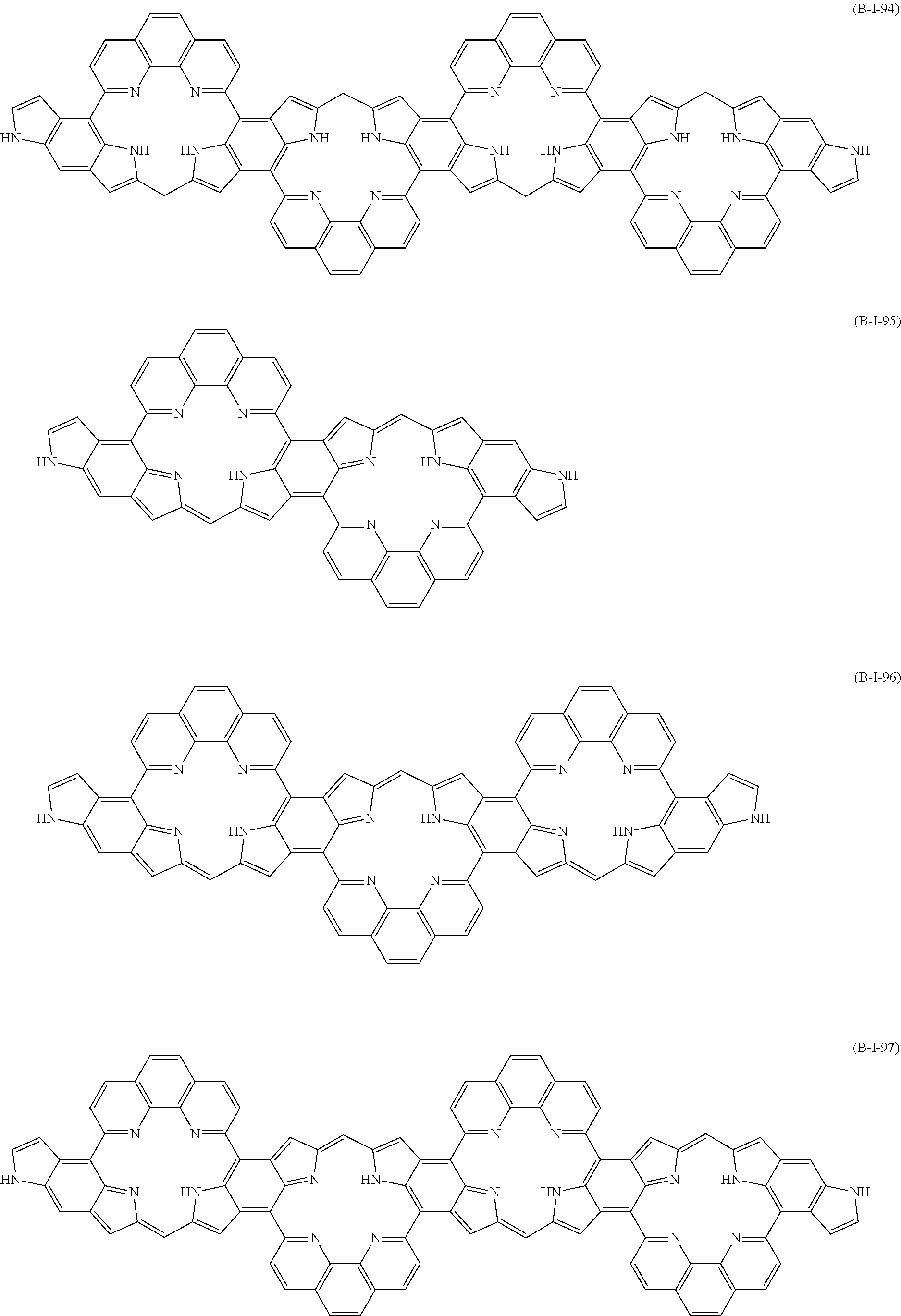

Moreover, still further examples of the ligand of the polynuclear metal complex of the present embodiment include polymer compounds having repeating units represented by general formulas (B-I-98) to (B-I-111) shown below. In these polymer compounds, hydrogen atoms in the formulas may be substituted with the substituents described above, and 2 proximate hydrogen bonds may be removed to form a direct bond or a linking group.

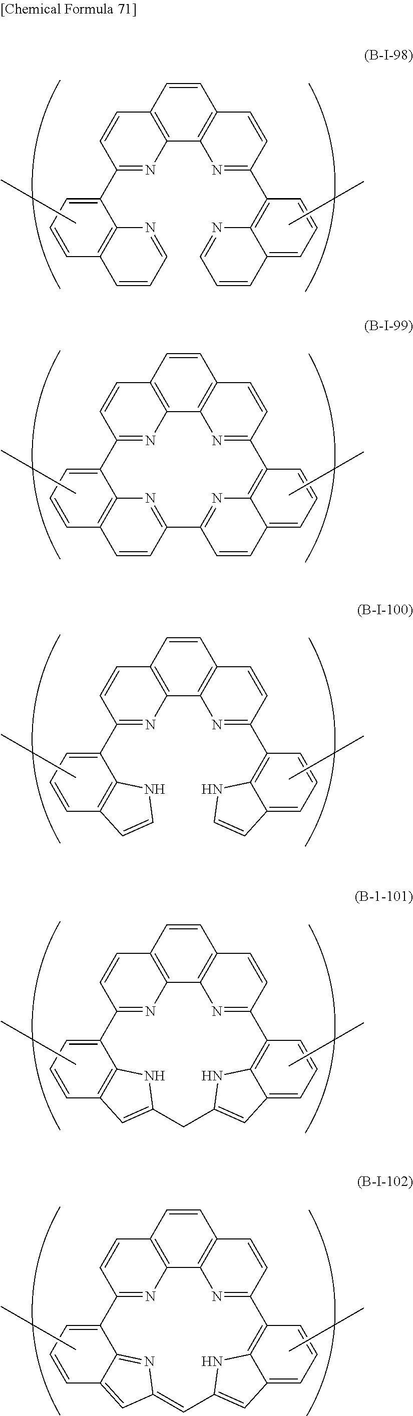

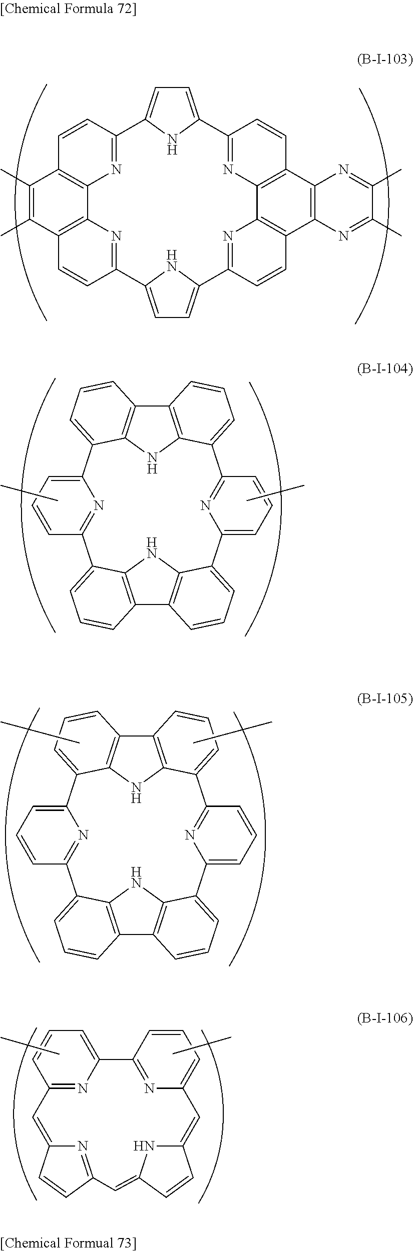

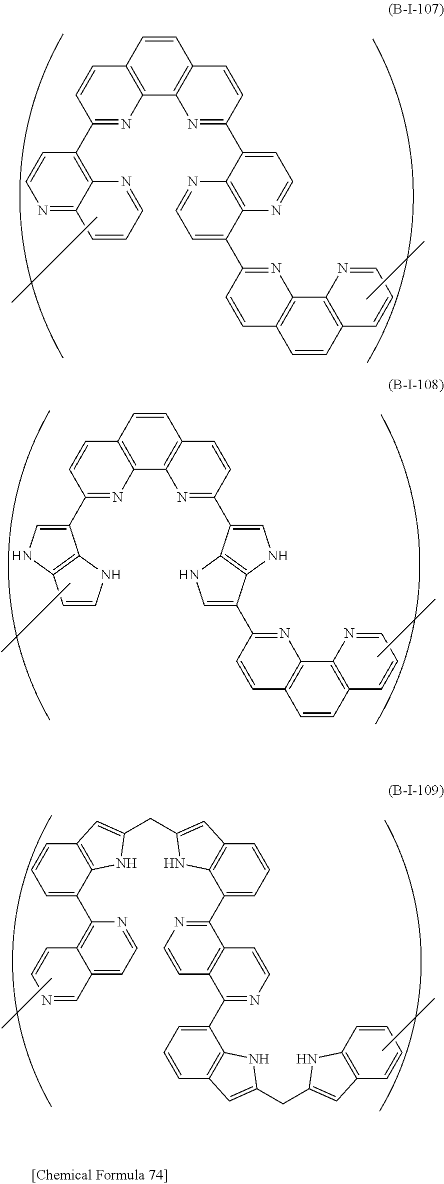

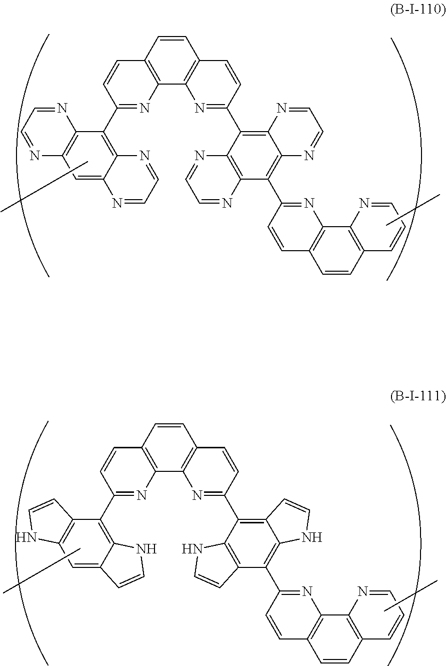

When the ligand of the polynuclear metal complex of the present embodiment is a polymer compound having the type of repeating unit described above, the polystyrene-equivalent number-average molecular weight of the polymer compound is preferably 1×10³ to 1×10⁸, and is more preferably 2×10³ to 1×10⁶. Further, the polystyrene-equivalent weight-average molecular weight of the polymer compound is preferably 2×10³ to 1×10⁸, and more preferably 3×10³ to 2×10⁶.

Moreover, it is particularly preferable that the polynuclear metal complex used in the cathode catalyst for an air secondary cell of the present embodiment has an aromatic compound represented by formula (XI) shown below as the ligand:

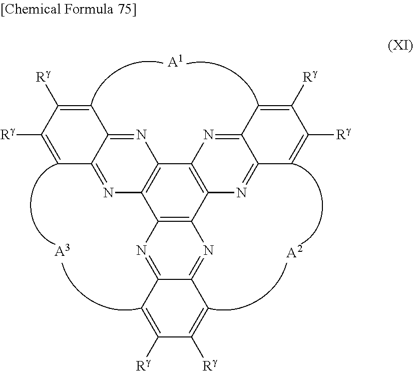

wherein R^{γ} represents a hydrogen atom or a substituent, when 2 or more R^{γ} represent substituents, each R^{γ} may be the same or different from each other, adjacent substituents may be mutually bonded to form a ring with the carbon atoms bonded thereto, and each 2 or more R^{γ} may be the same or different from each other; and each of A¹, A² and A³ independently represents a divalent organic group represented by any one of general formulas (B-7-a) to (B-7-e), (B-8-a) to (B-8-e), (B-9-a) to (B-9-e) and (B-10-a) to (B-10-e) shown above.

Examples of the aromatic compound represented by formula (XI) include the compounds represented by general formulas (B-I-112) to (B-I-116) shown below. Hydrogen atoms in the formulas may be substituted with the substituents described above.

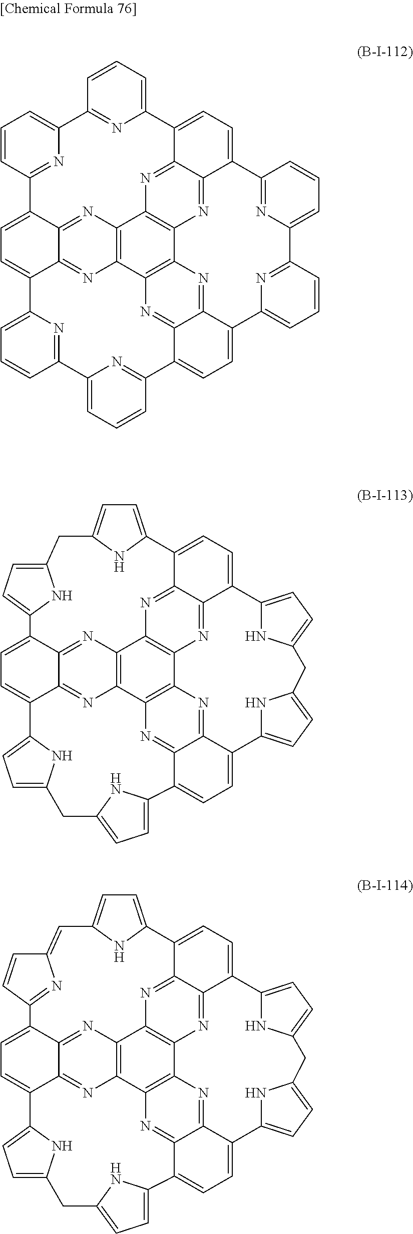

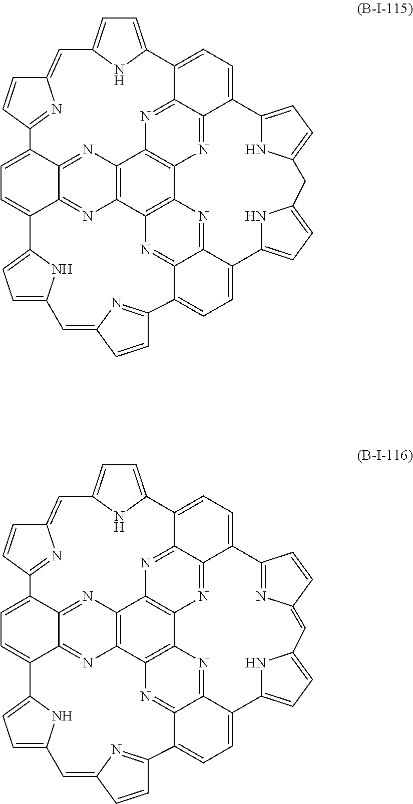

Examples of metal atoms or metal ions that can be used as the central metals of the second polynuclear metal complex include the metal atoms or ions of alkali metals, alkaline earth metals and transition metals, and transition metals belonging to the 4th period to the 6th period of the periodic table, and ions thereof are particularly preferable.

Specific examples include atoms and ions of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold and mercury. Among these, atoms and ions of titanium, vanadium, chromium, manganese, iron, cobalt, nickel, copper, zinc, zirconium, niobium, molybdenum, ruthenium, rhodium, palladium, silver, tantalum, tungsten, rhenium, osmium, iridium, platinum and gold are preferable, atoms and ions of titanium, vanadium, chromium, manganese, iron, cobalt, nickel, copper, zinc, zirconium, niobium, molybdenum, ruthenium, rhodium, palladium, and silver and the like are more preferable, and atoms and ions of vanadium, chromium, manganese, iron, cobalt, nickel, copper and zinc are particularly preferable. Further, the metal atoms or ions may be of a single type, or a combination of 2 or more types of metal atoms or metal ions may be used.

When the central metal is a metal ion, the valency of the metal ion is preferably 1 to 4, more preferably 2 to 4, and most preferably 2 or 3.

The metal ion usually has a positive electrical charge, and therefore the polynuclear metal complex of the present embodiment may include an anion to make the overall polynuclear metal complex electrically neutral. Examples of the counter ion include inorganic ions such as a fluoride ion, chloride ion, bromide ion, iodide ion, sulfide ion, oxide ion, hydroxide ion, hydride ion, sulfite ion, phosphate ion, cyanide ion, acetate ion, carbonate ion, sulfate ion, nitrate ion and bicarbonate ion, and organic ions such as a trifluoroacetate ion, thiocyanate ion, trifluoromethanesulfonate ion, acetylacetonate ion, tetrafluoroborate ion, hexafluorophosphate ion, tetraphenylborate ion, phenolate ion, and ions of picolinic acid and derivatives thereof, and preferred ions include a chloride ion, bromide ion, iodide ion, oxide ion, hydroxide ion, hydride ion, phosphate ion, cyanide ion, acetate ion, carbonate ion, sulfate ion, nitrate ion, acetylacetonate ion and tetraphenylborate ion. When 2 or more counter ions exist, the ions may be the same or different from each other.

Examples of the polynuclear metal complex of the present embodiment include polynuclear metal complexes represented by general formulas (B-II-1) to (B-II-76) shown below, and polymer compounds having a repeating unit represented by one of general formulas (B-II-77) to (B-II-89) shown below. Hydrogen atoms in the formulas may be substituted with the substituents described above. Further, the molecular weight of the polynuclear metal complex of the present embodiment conforms with the molecular weight of the aromatic compound described above.

In these polynuclear metal complexes, M in the formula represents a metal atom. The metal atom represented by M is the same as the metal atoms described above. When 2 or more M exist, these metals may be the same or different from each other. Further, the electrical charge of the polynuclear metal complex in each formula is omitted.

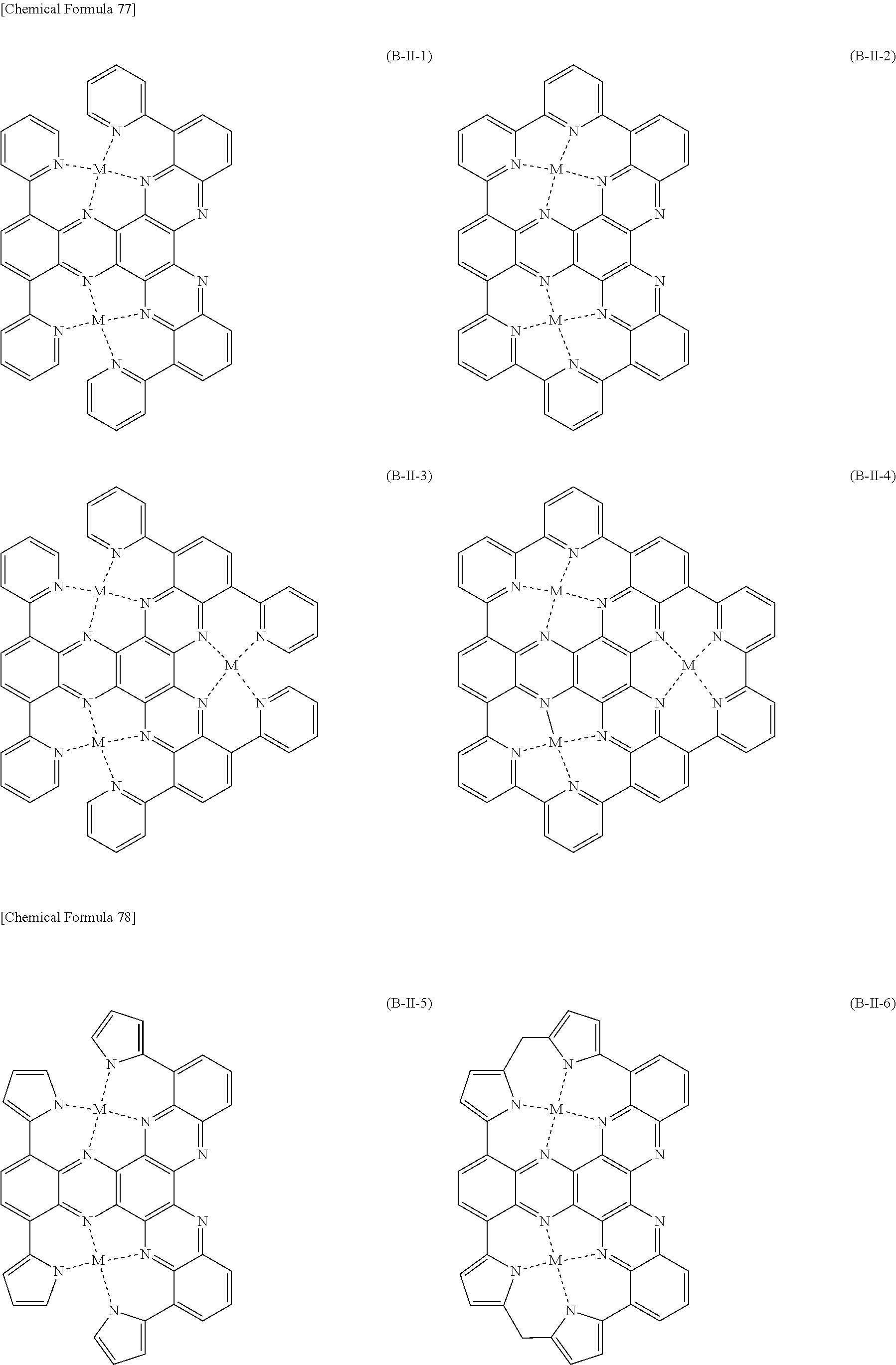

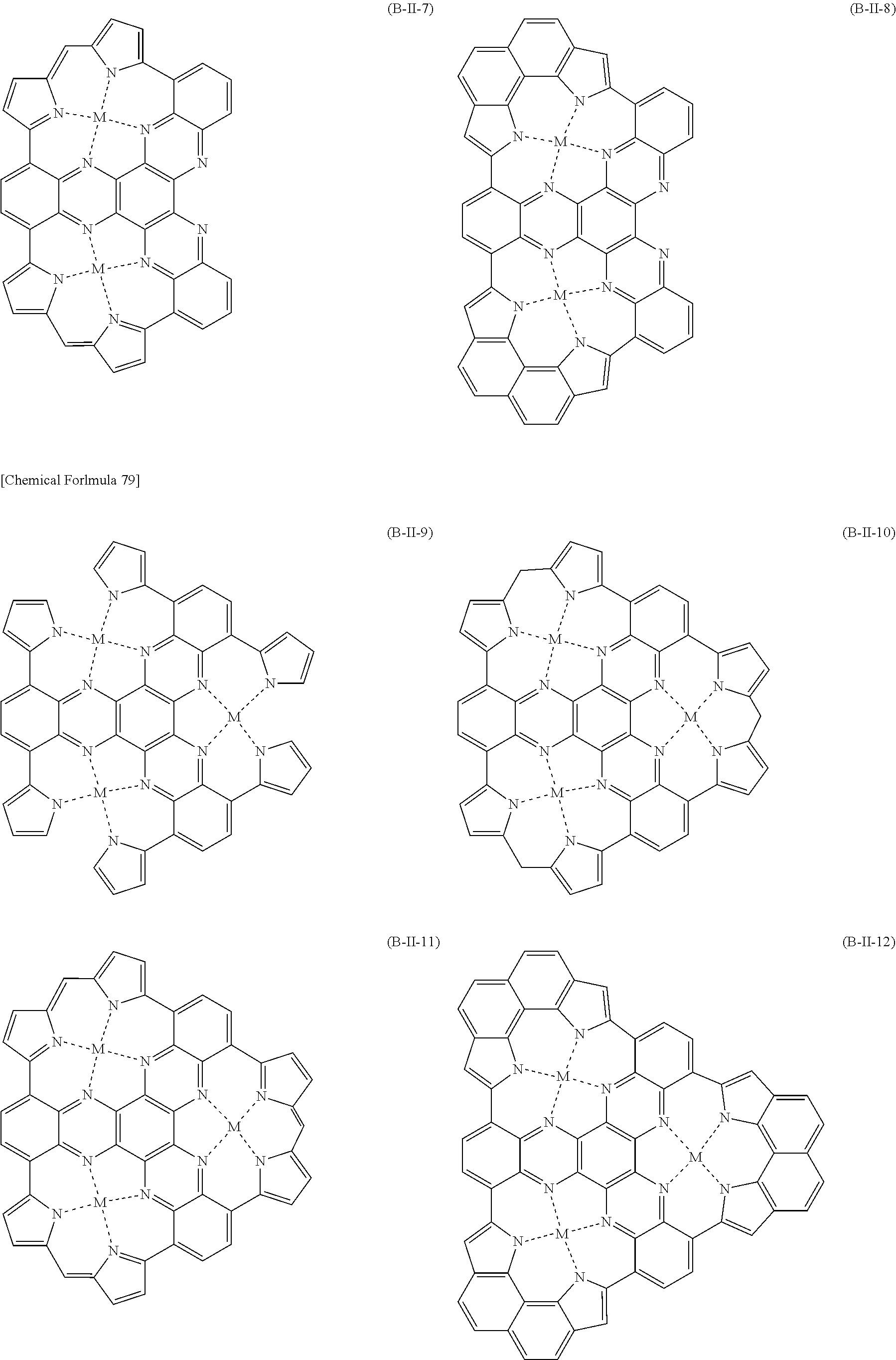

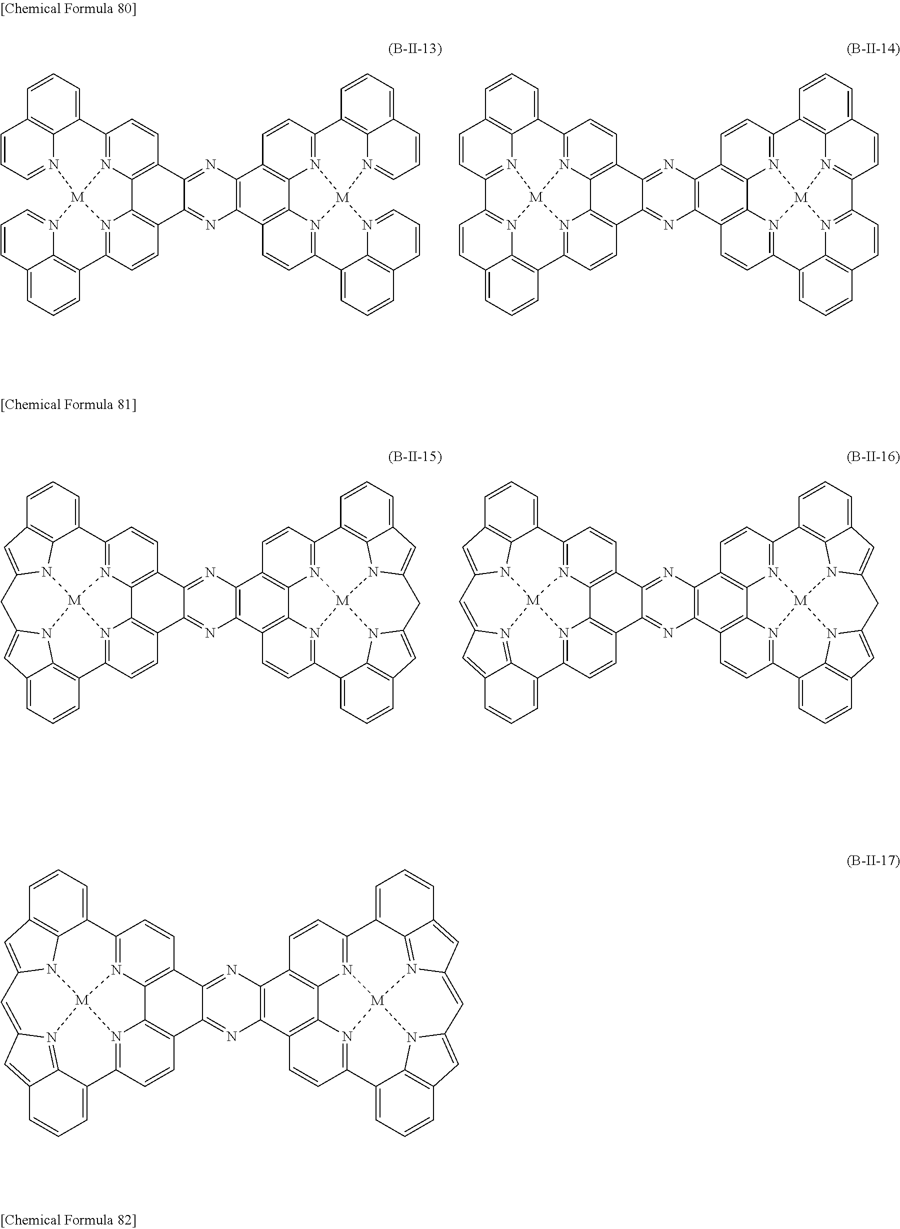

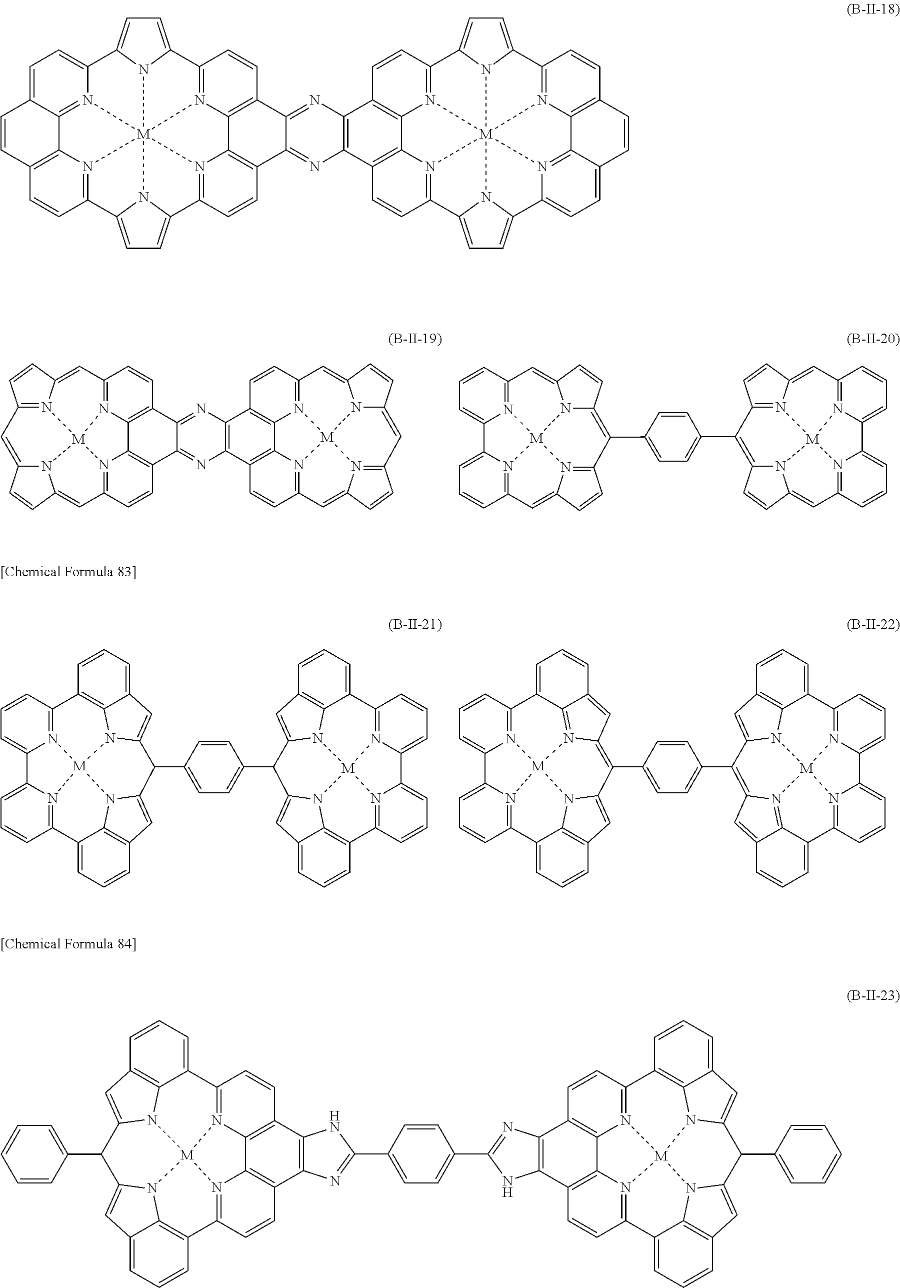

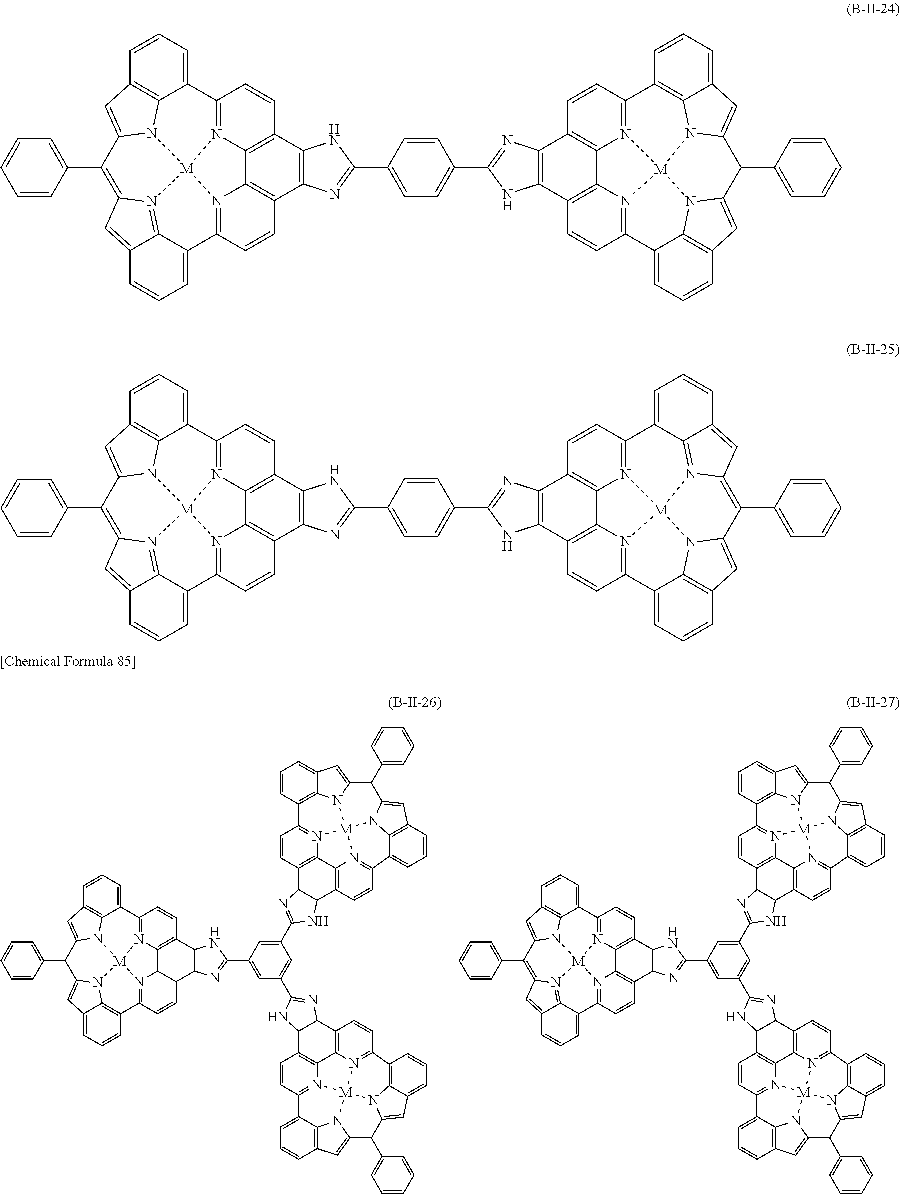

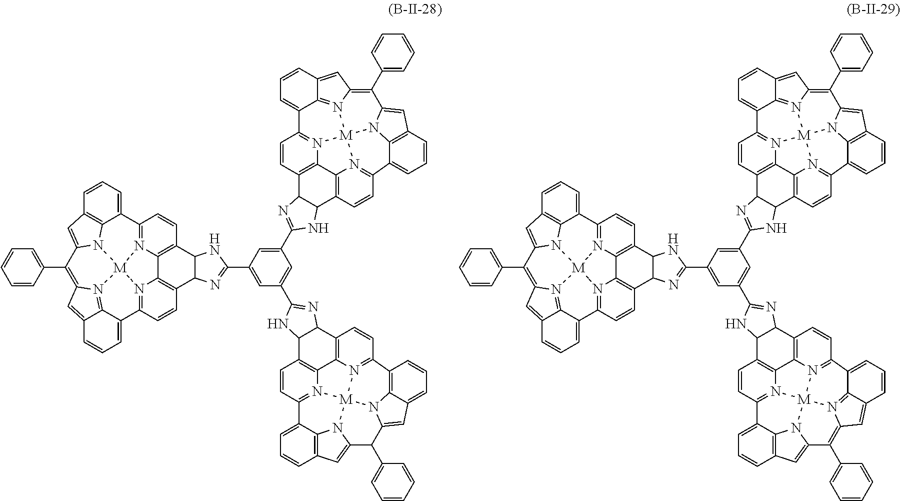

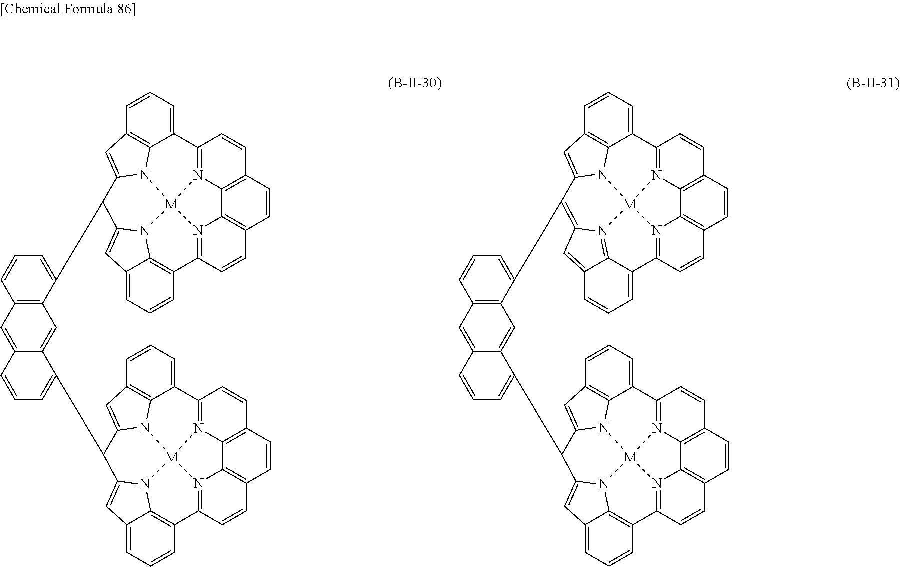

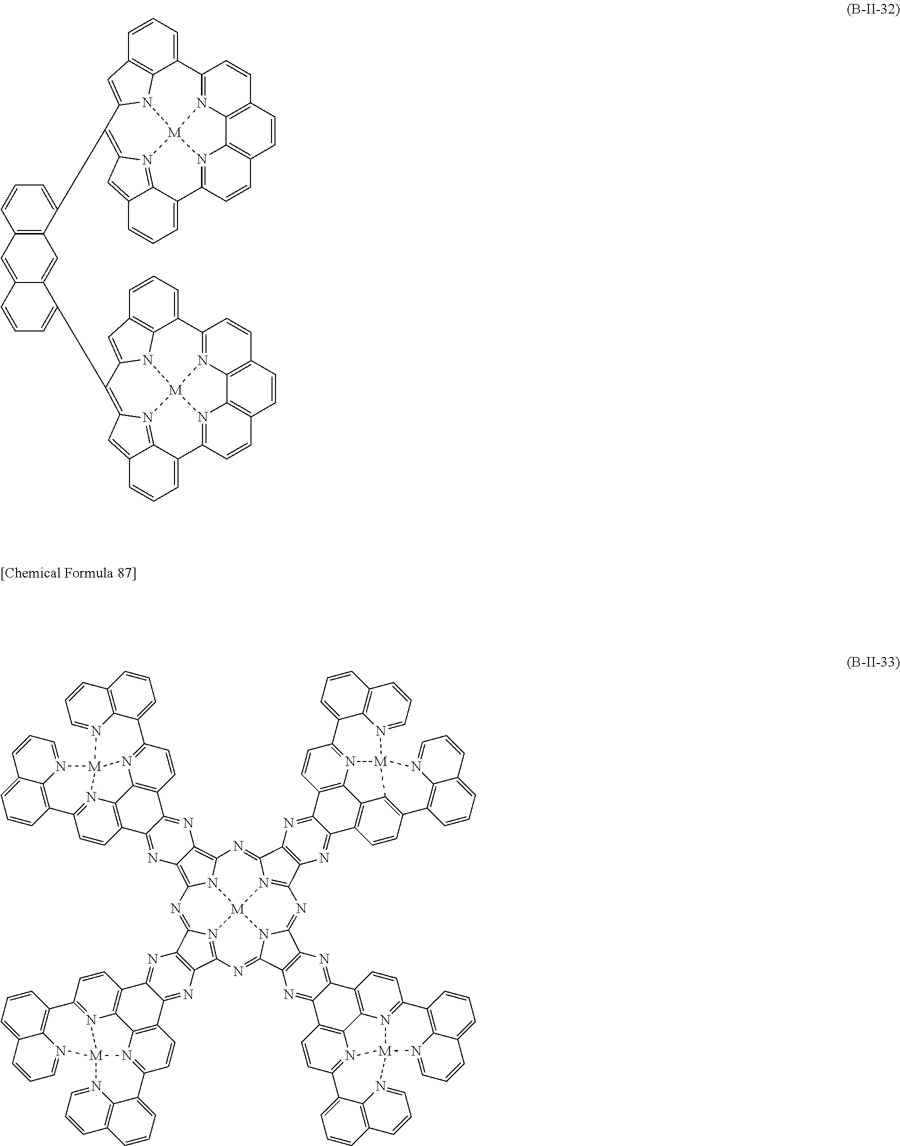

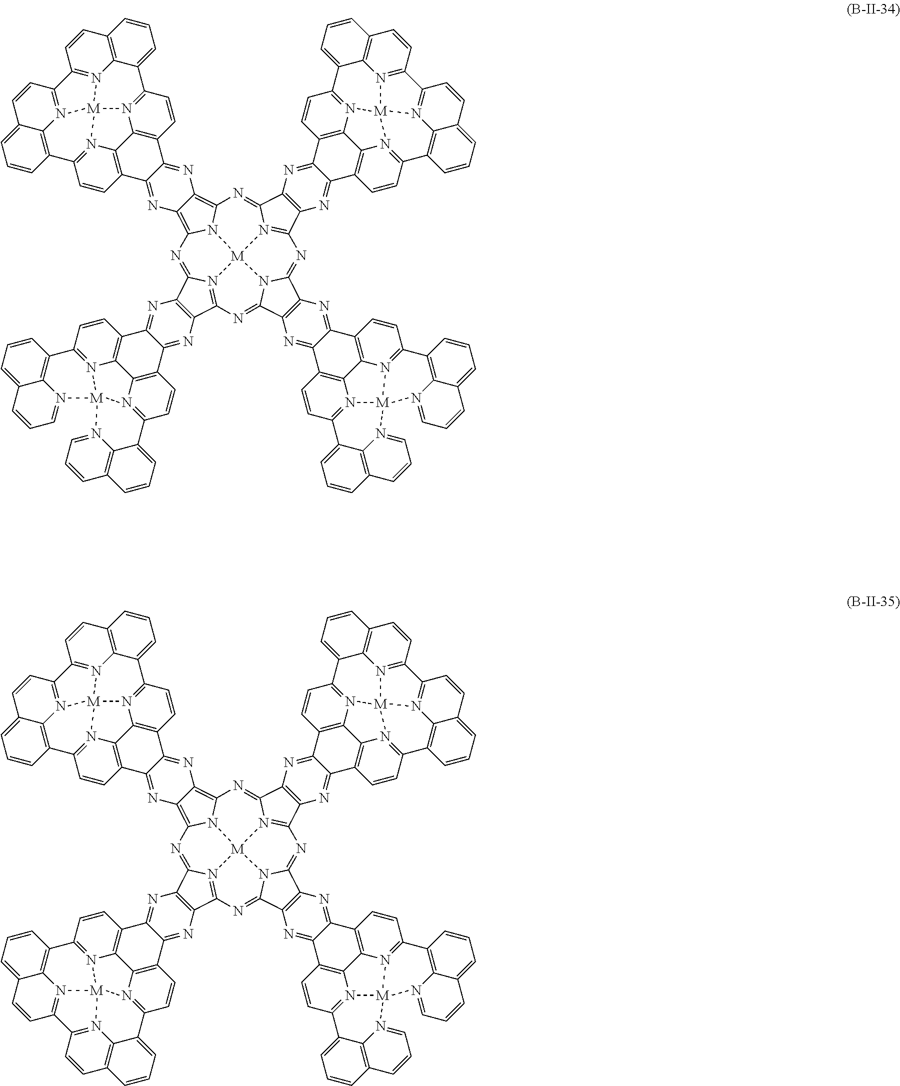

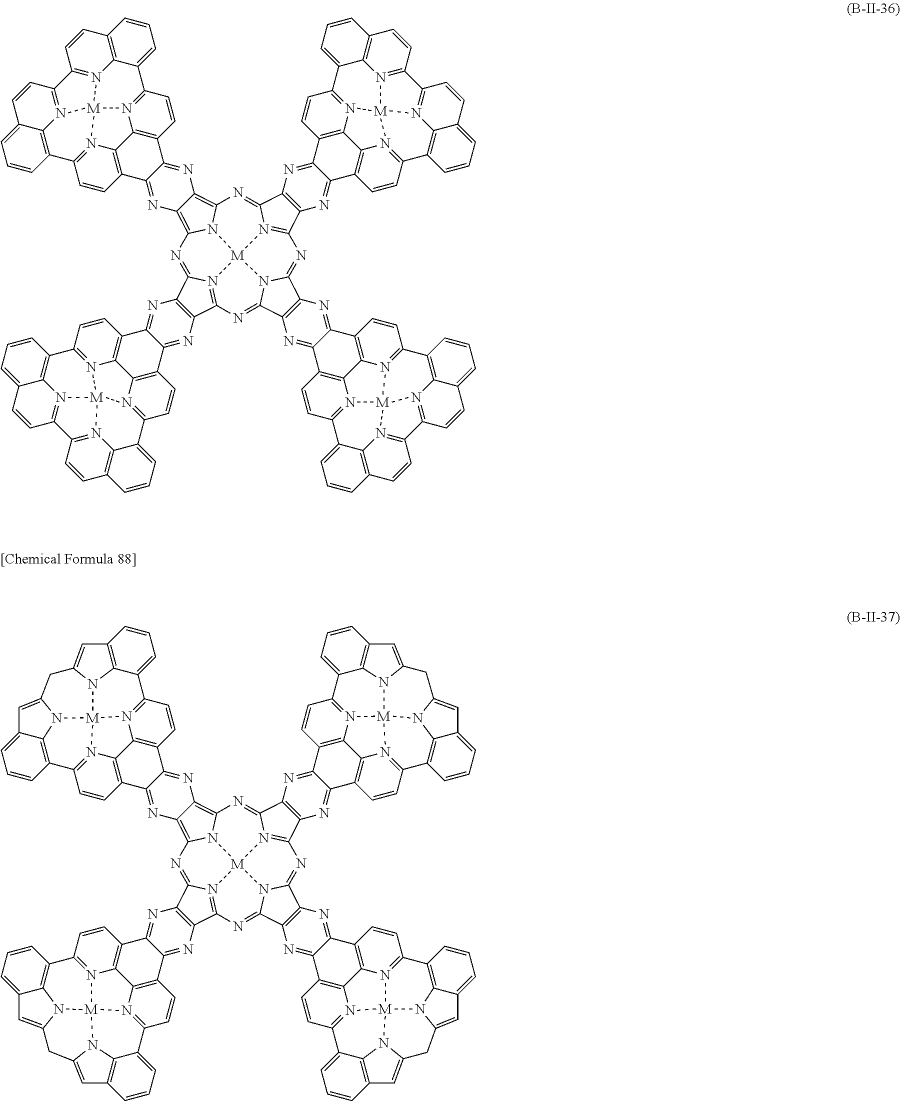

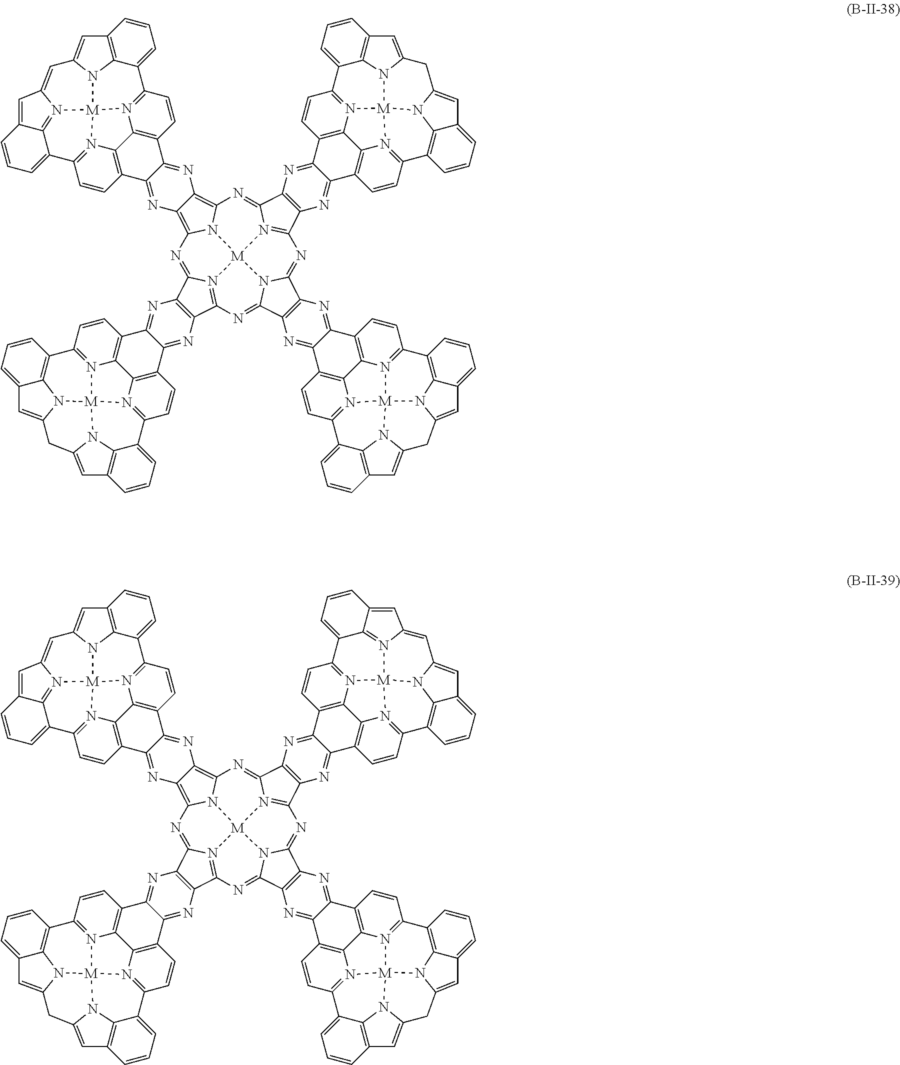

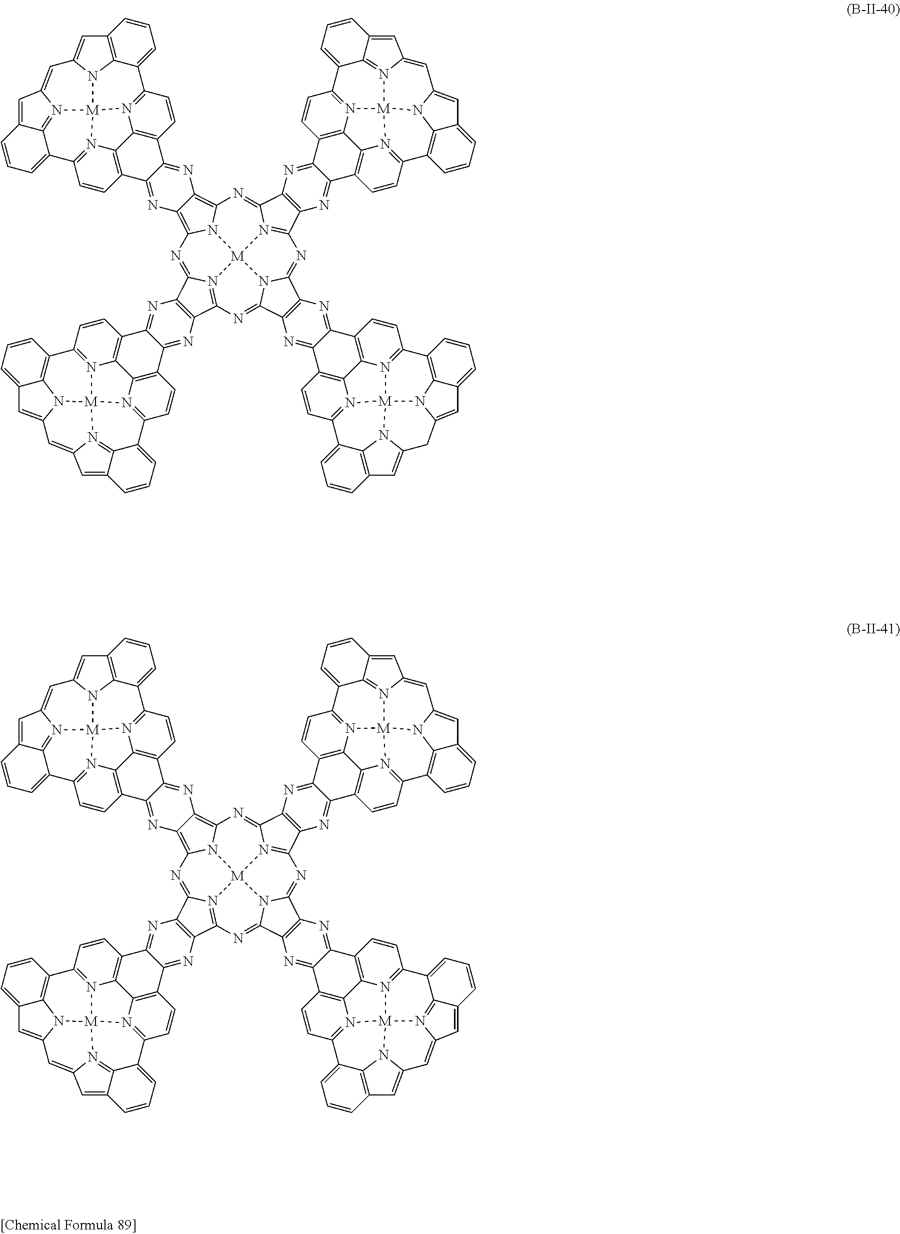

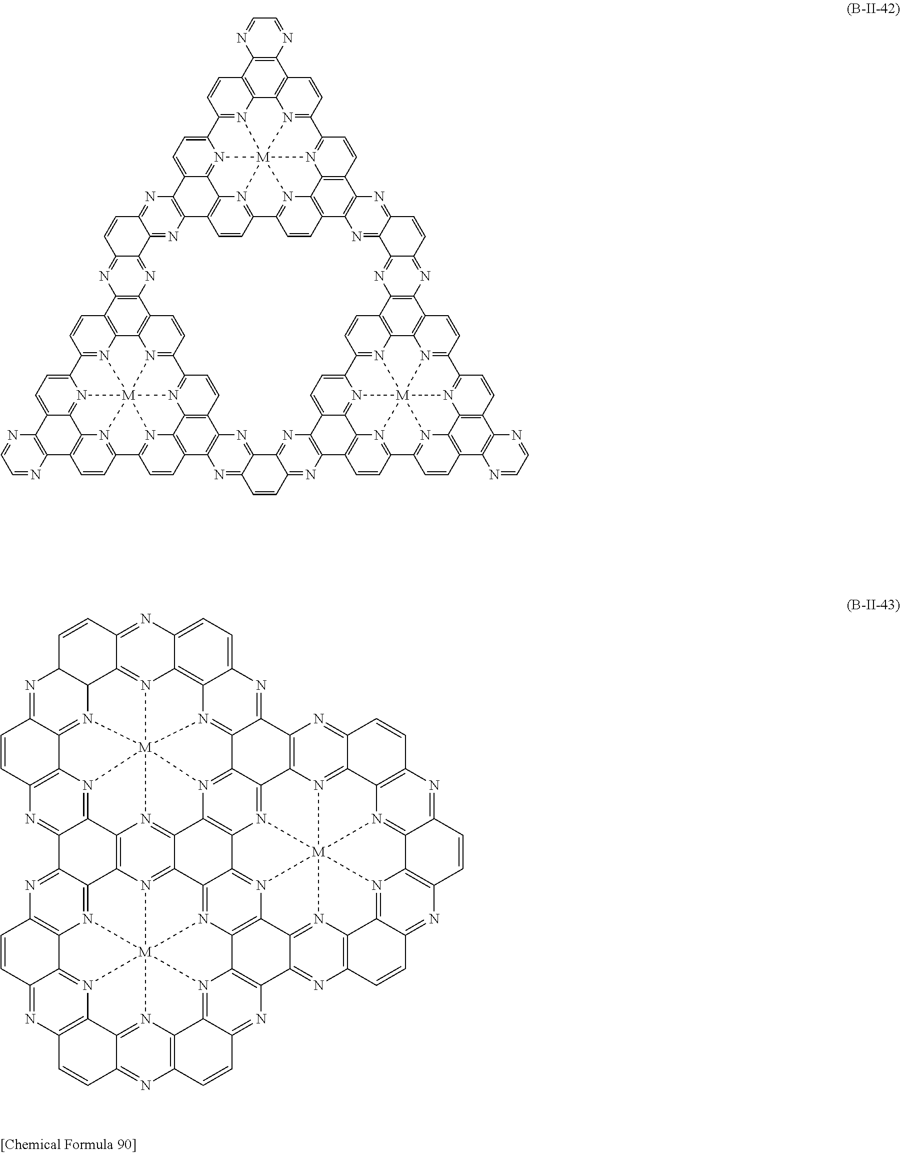

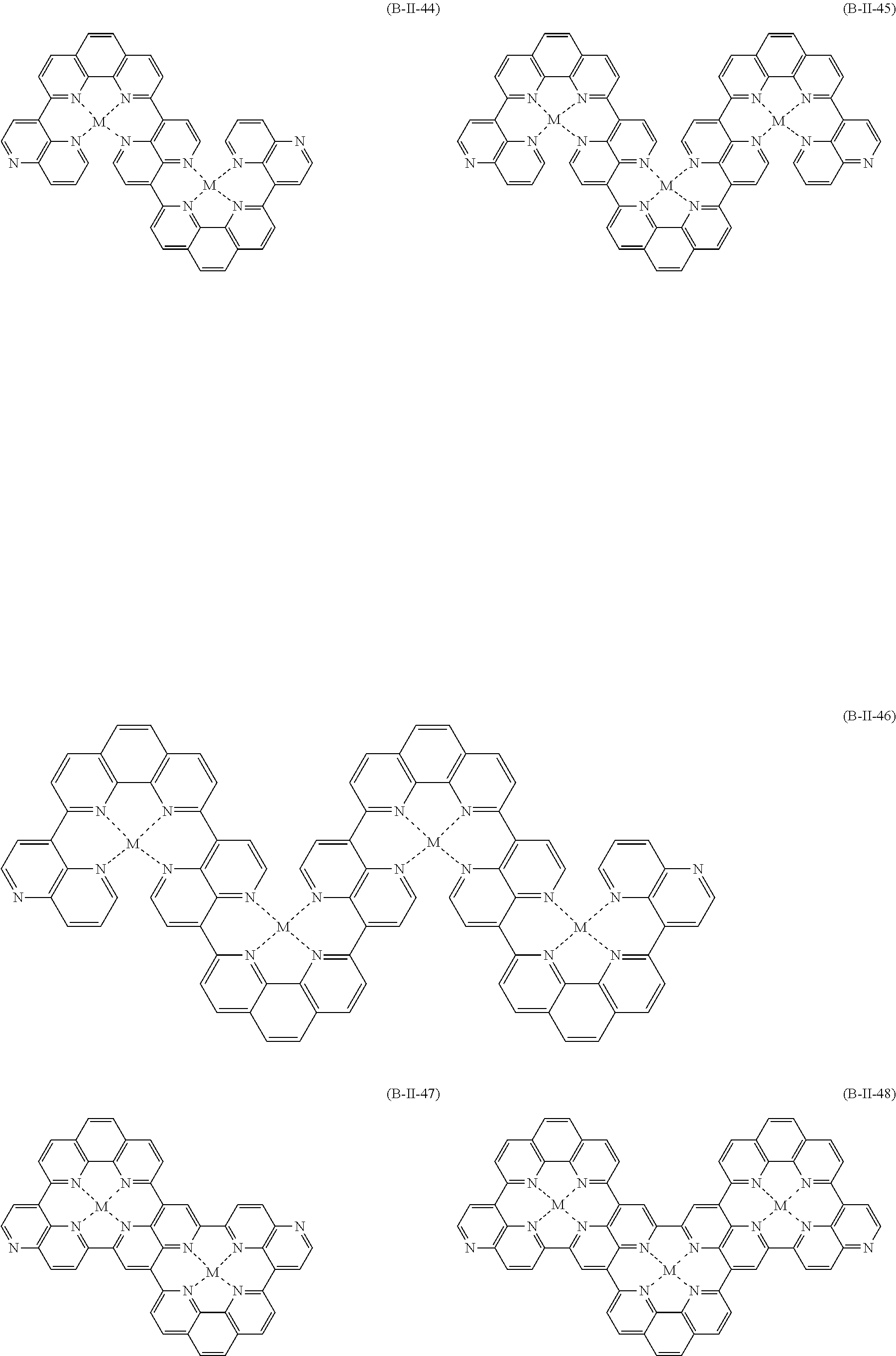

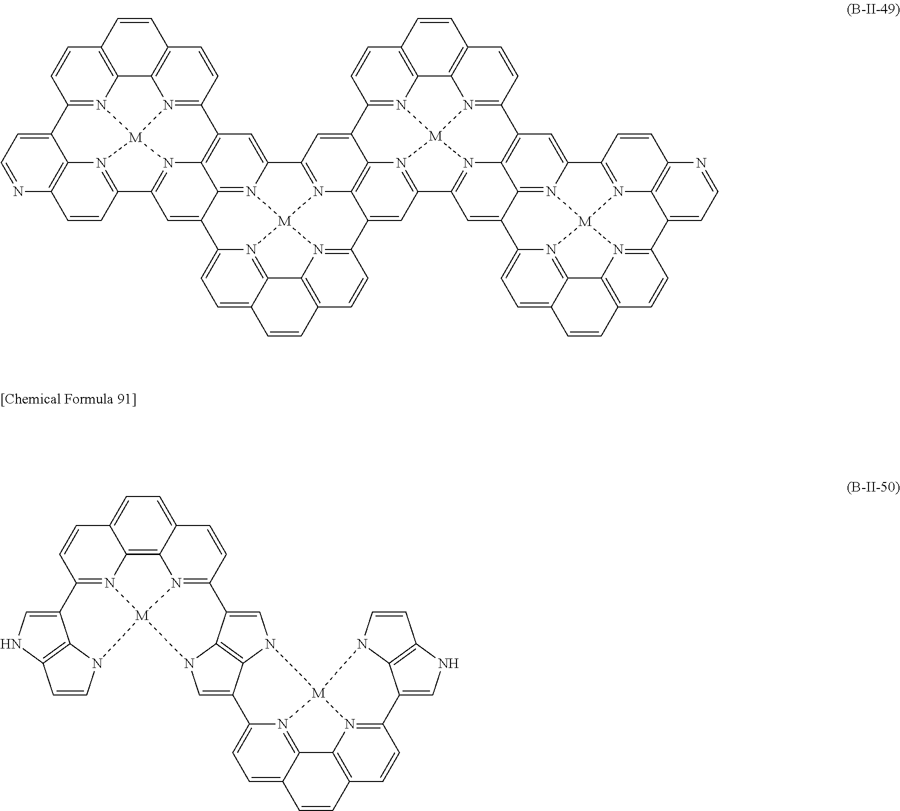

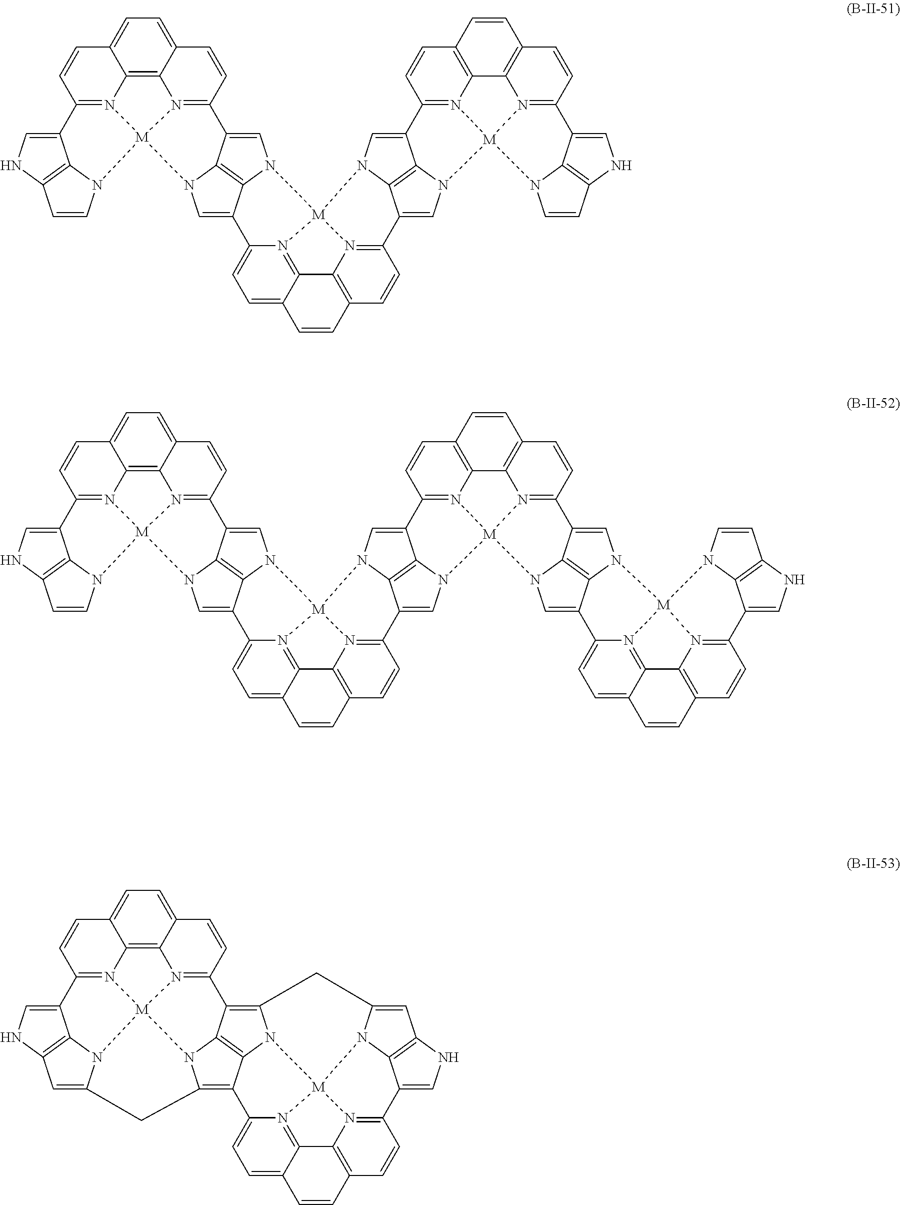

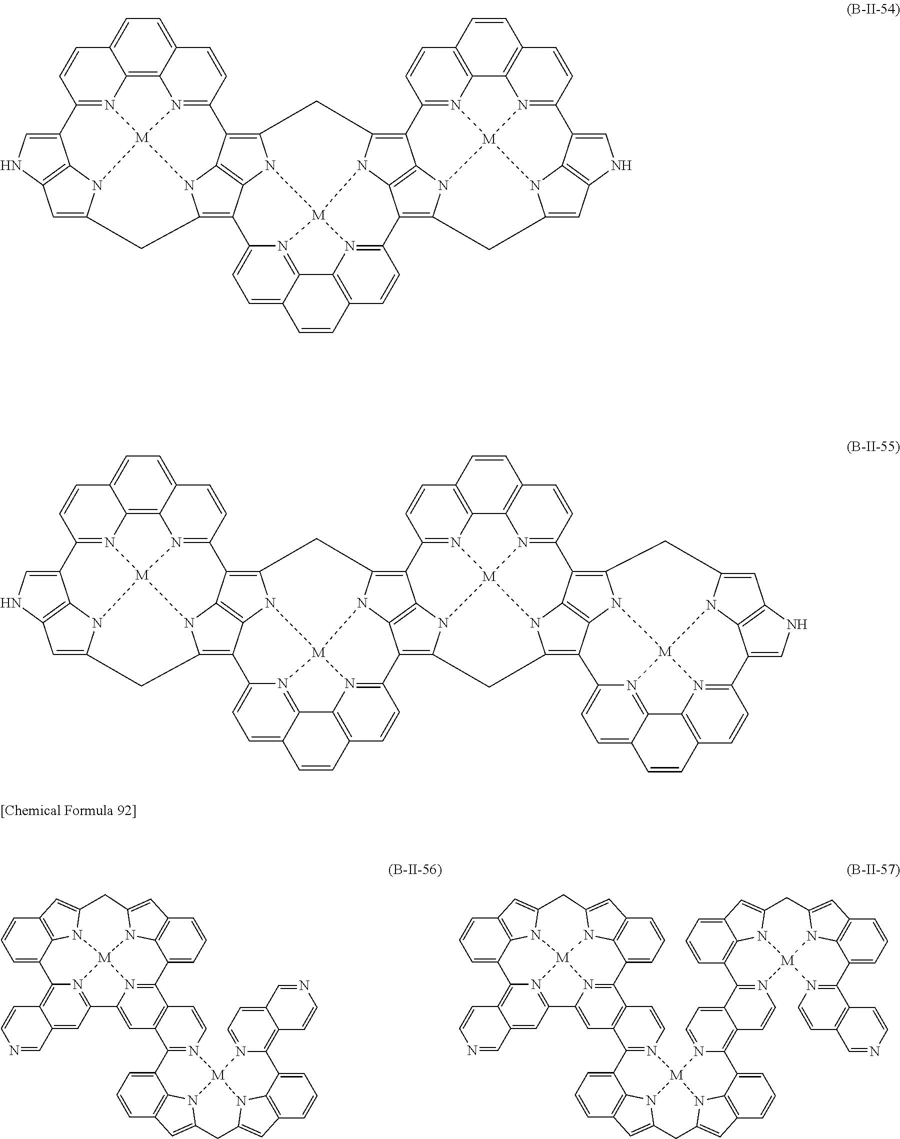

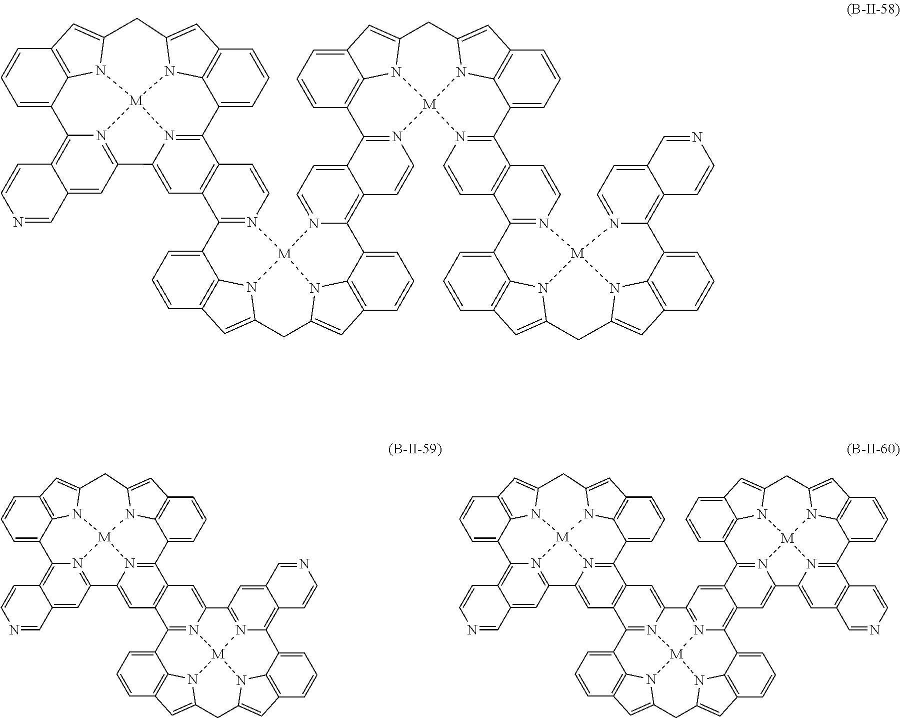

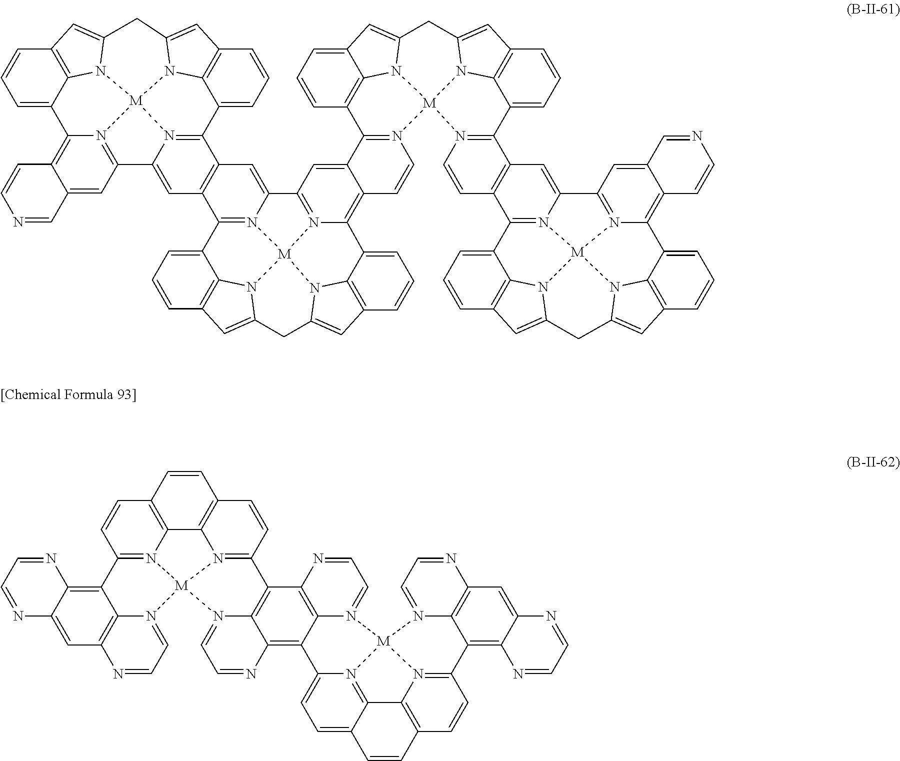

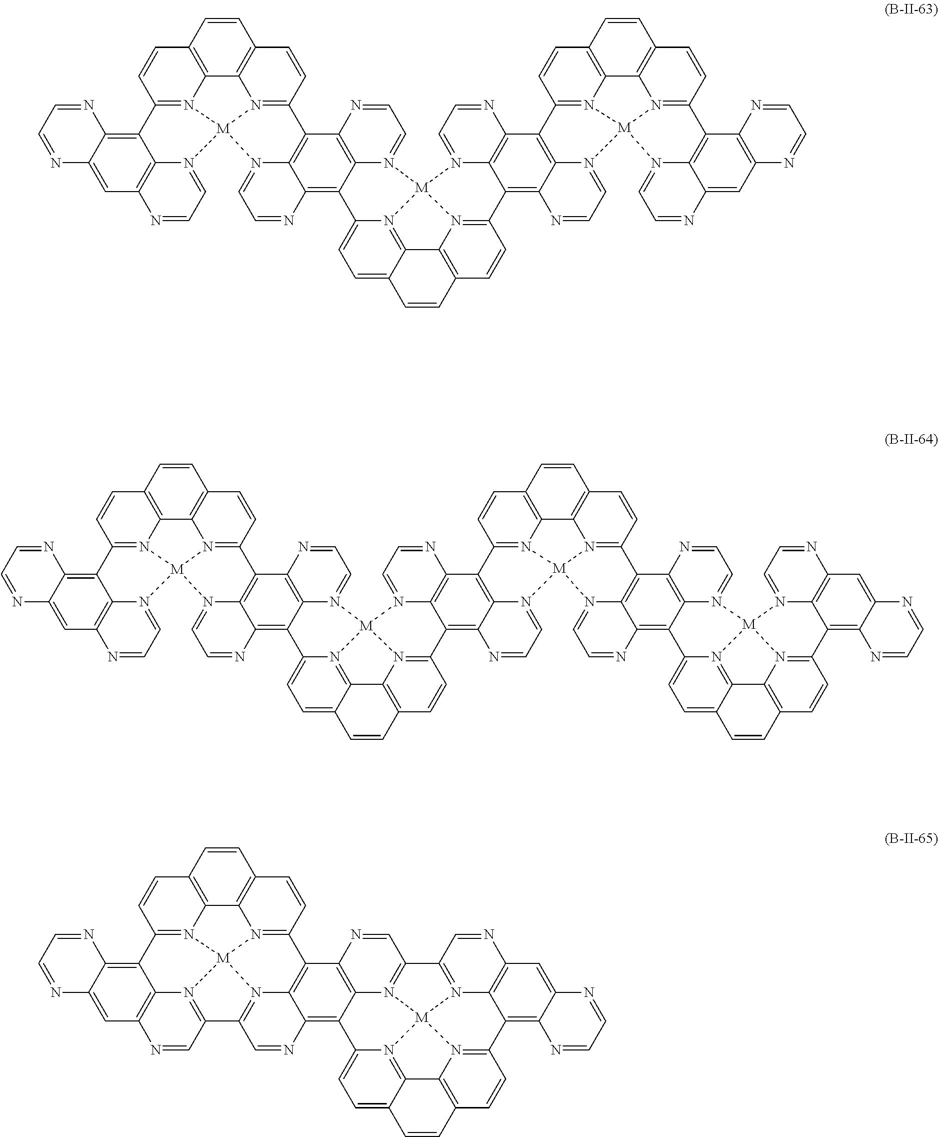

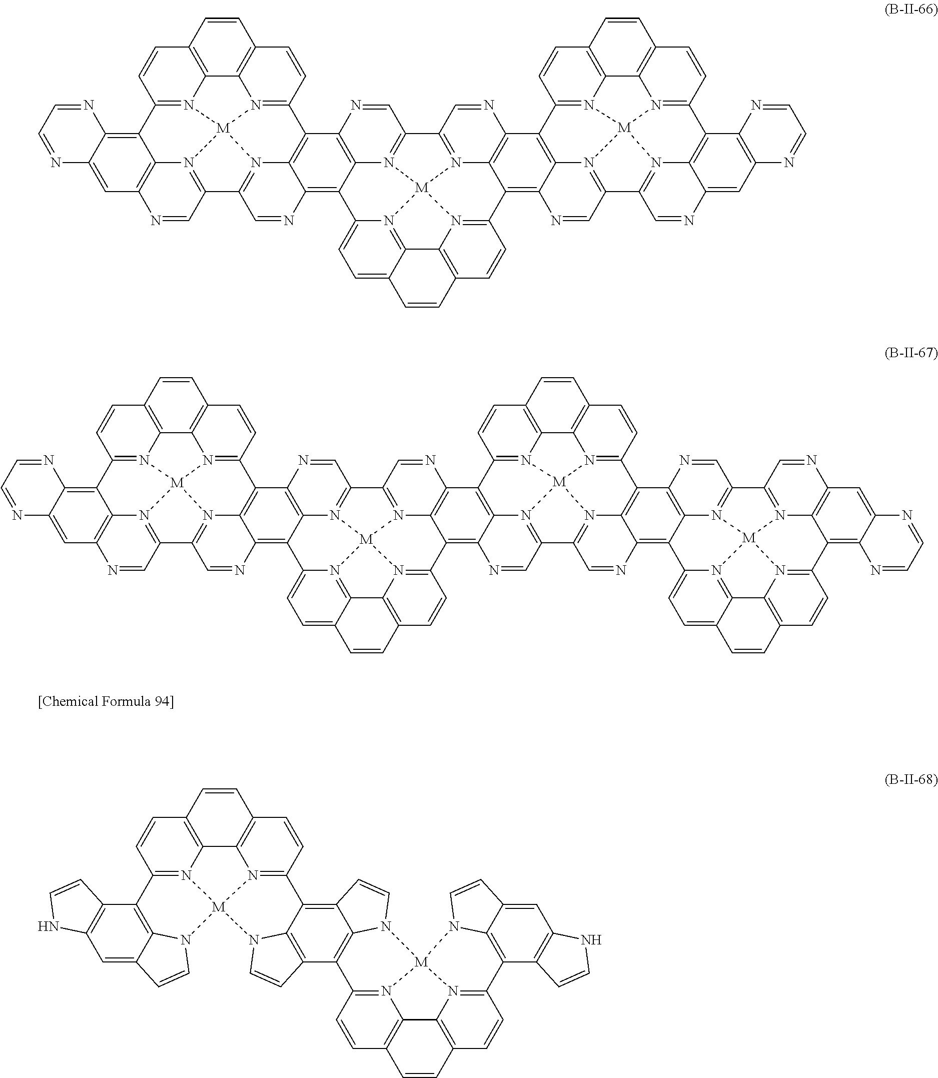

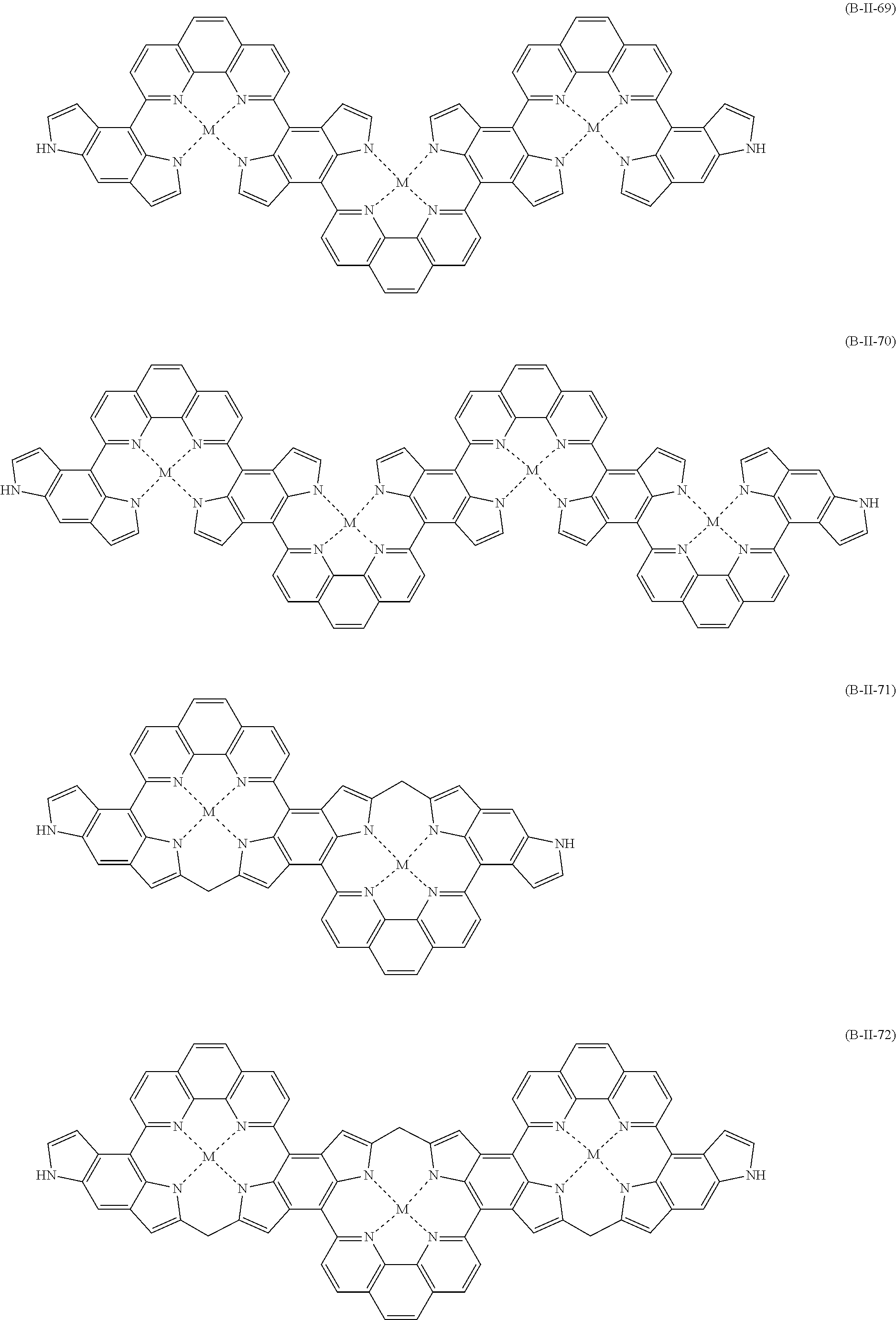

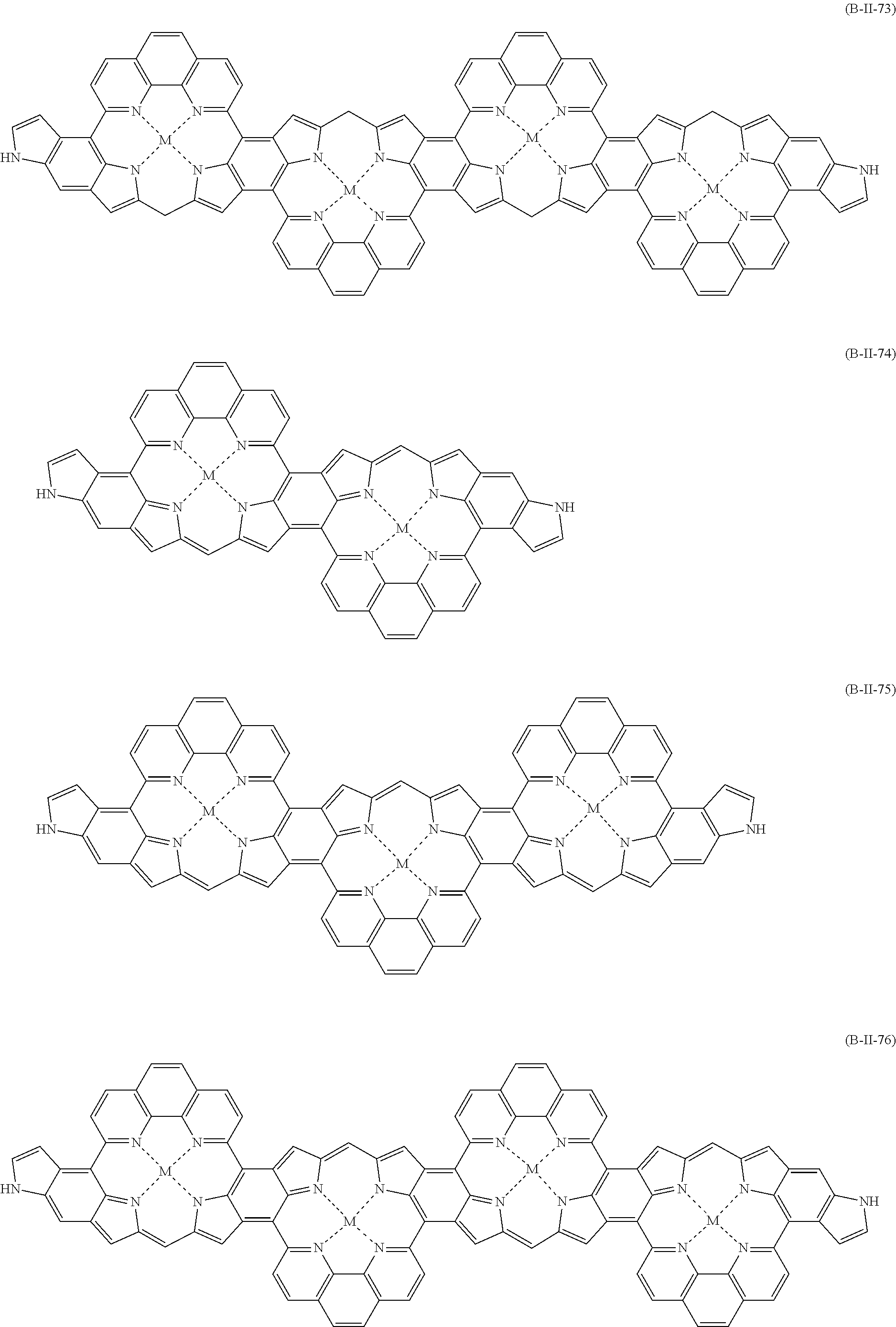

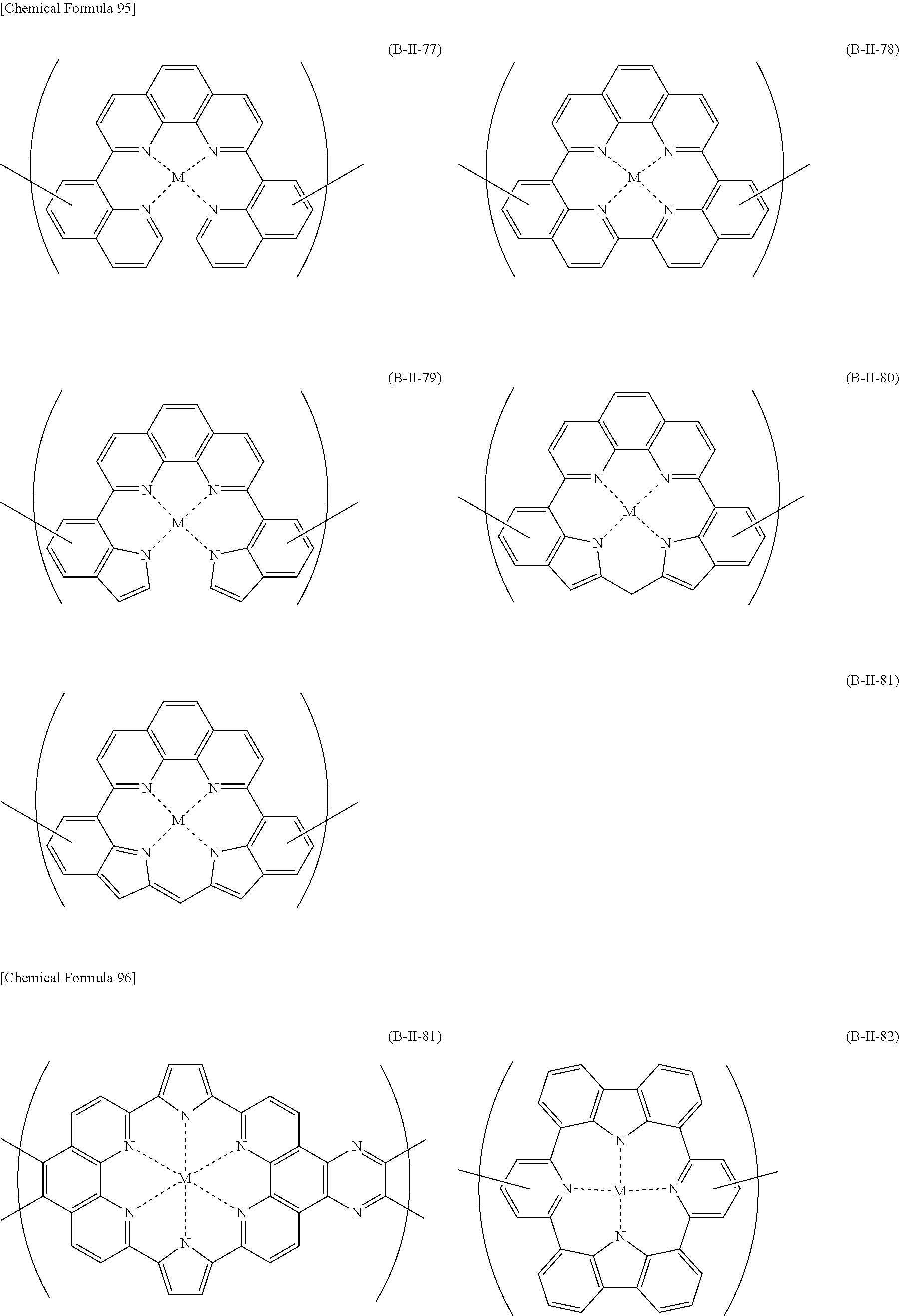

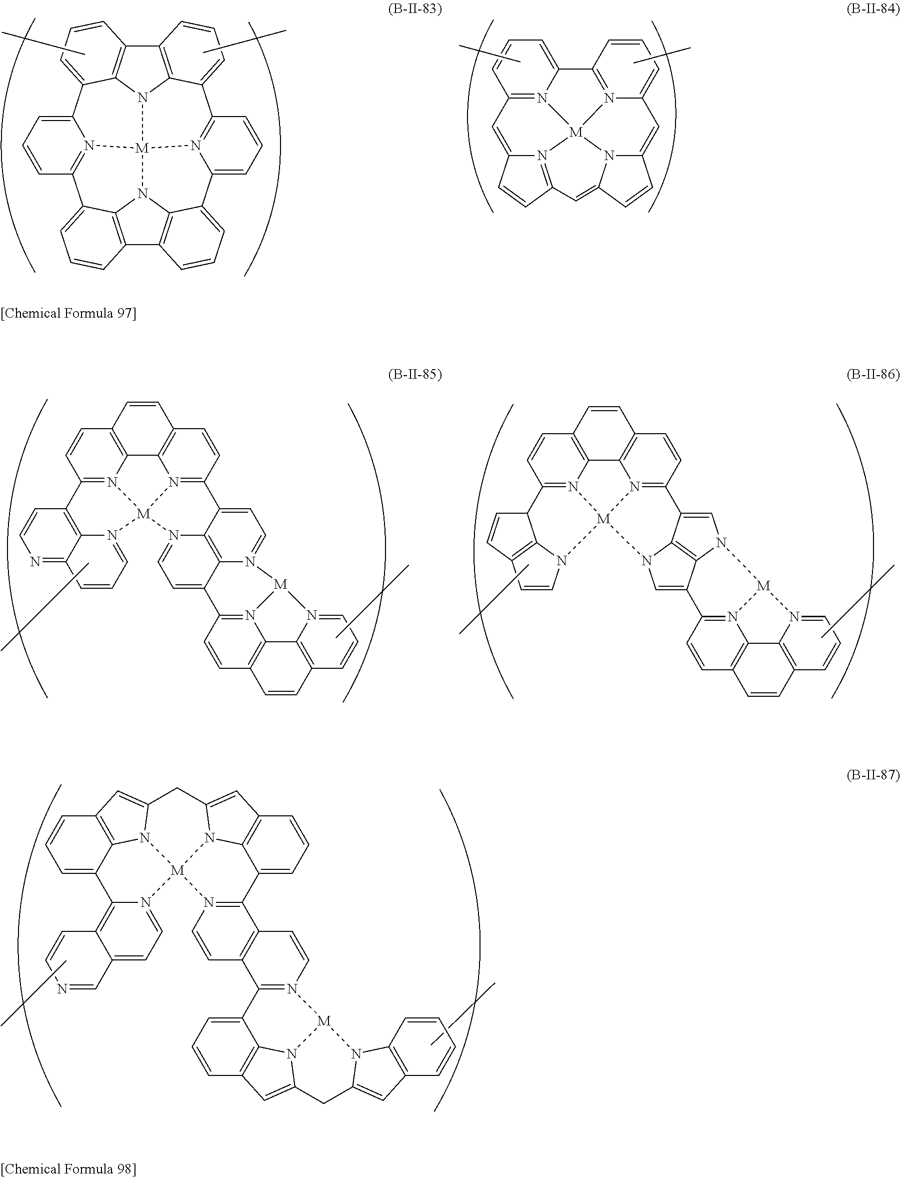

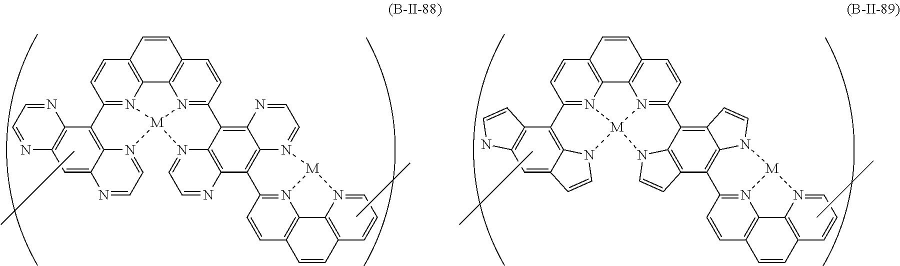

Furthermore, when producing the polynuclear metal complex of the present embodiment, by regulating the amount of metal atoms or metal ions that is reacted with the aforementioned aromatic compound, the functionality of the obtained polynuclear metal complex can be controlled. Methods of producing the polynuclear metal complex are described below.

Next is a description of a method of producing an aromatic compound that can be used as the ligand of the second polynuclear metal complex described above. The aromatic compound may be produced using any appropriate method, but can be produced, for example, by a condensation reaction between a diamine compound and hexaketocyclohexane in acetic acid, as shown in the following reaction equation (100).

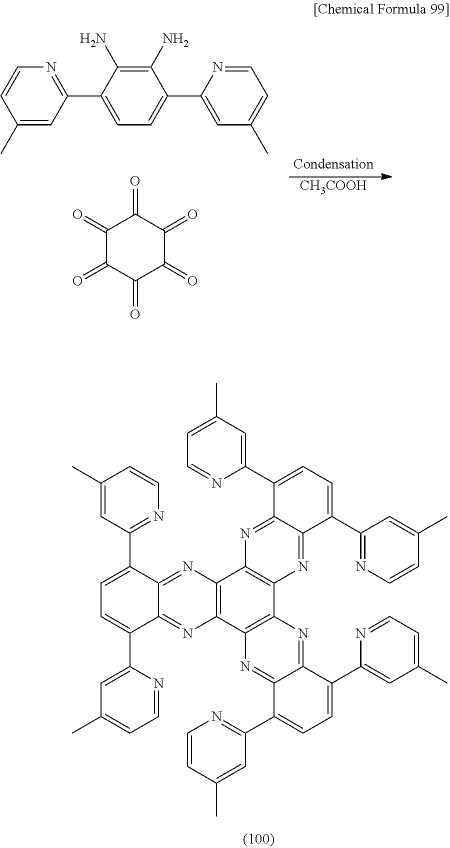

An aromatic compound that can be used as the ligand of the polynuclear metal complex of the present embodiment can also be produced, as illustrated by the following reaction equation (101), by introducing halogeno groups such as bromo groups in advance, and subsequently performing a cyclization. A reaction such as Yamamoto coupling or Ullmann coupling can be used for the cyclization reaction.

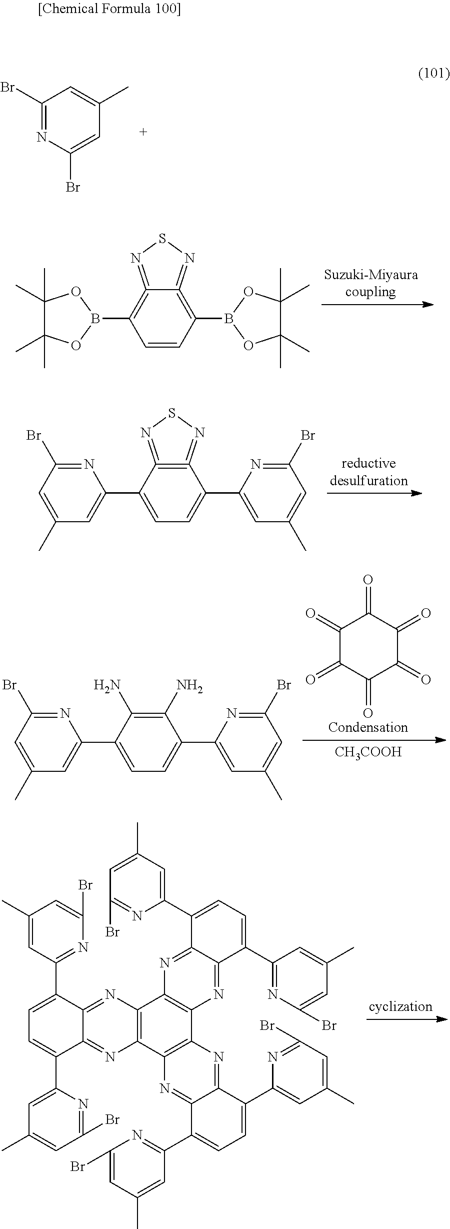

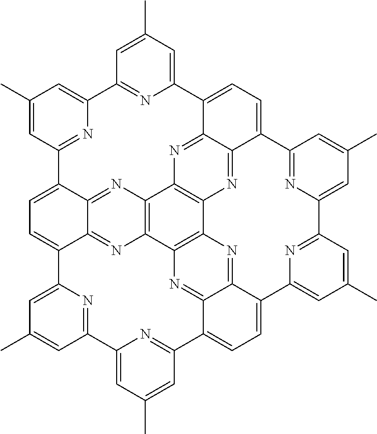

An aromatic compound that can be used as the ligand of the polynuclear metal complex of the present embodiment can also be produced, as illustrated by the following reaction equation (102), using the Suzuki-Miyaura coupling reaction.

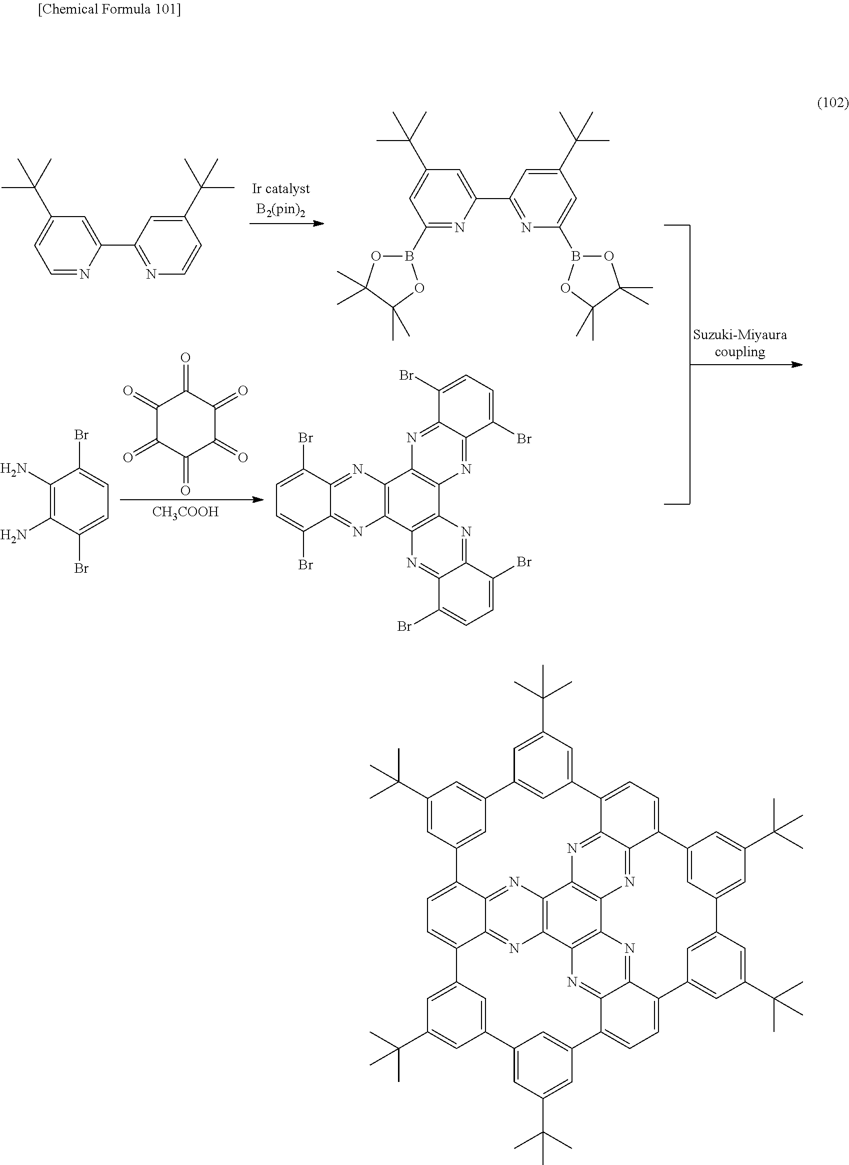

An aromatic compound that can be used as the ligand of the polynuclear metal complex of the present embodiment can also be produced, as illustrated by the following reaction equation (103), by using a reaction between a diketone compound and an ammonium salt. Further, an aromatic compound can also be produced by reacting a diketone compound and 1,2-diamino-1,2-dicyanoethylene, and then performing a cyclization reaction, as illustrated by the following reaction equation (104).

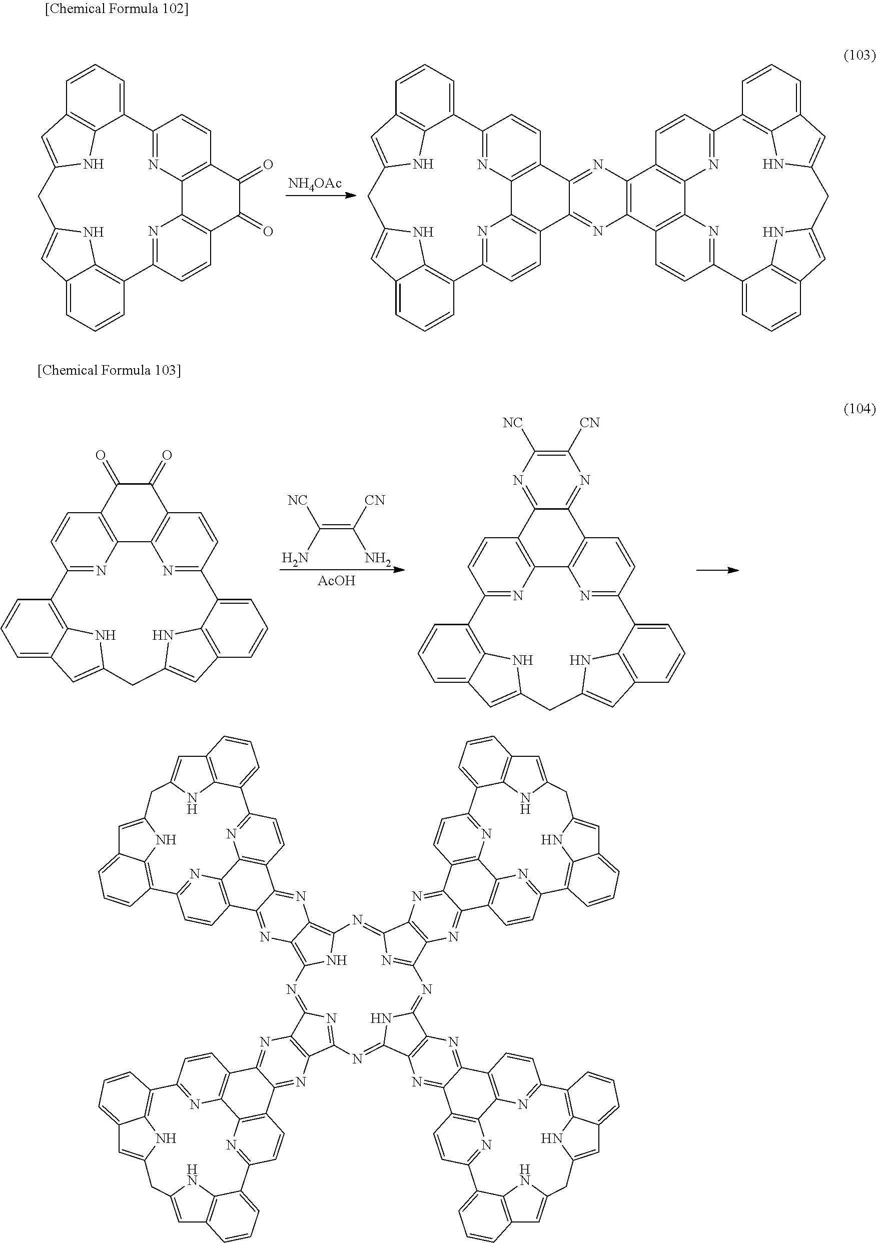

An aromatic compound that can be used as the ligand of the polynuclear metal complex of the present embodiment can also be produced, as illustrated by the following reaction equation (105), by using a coupling reaction or the like to introduce a boronic acid derivative of a nitrogen-containing aromatic compound such as pyrrole into a condensation reaction product of a diamine compound having halogeno groups such as bromo groups and hexaketocyclohexane.

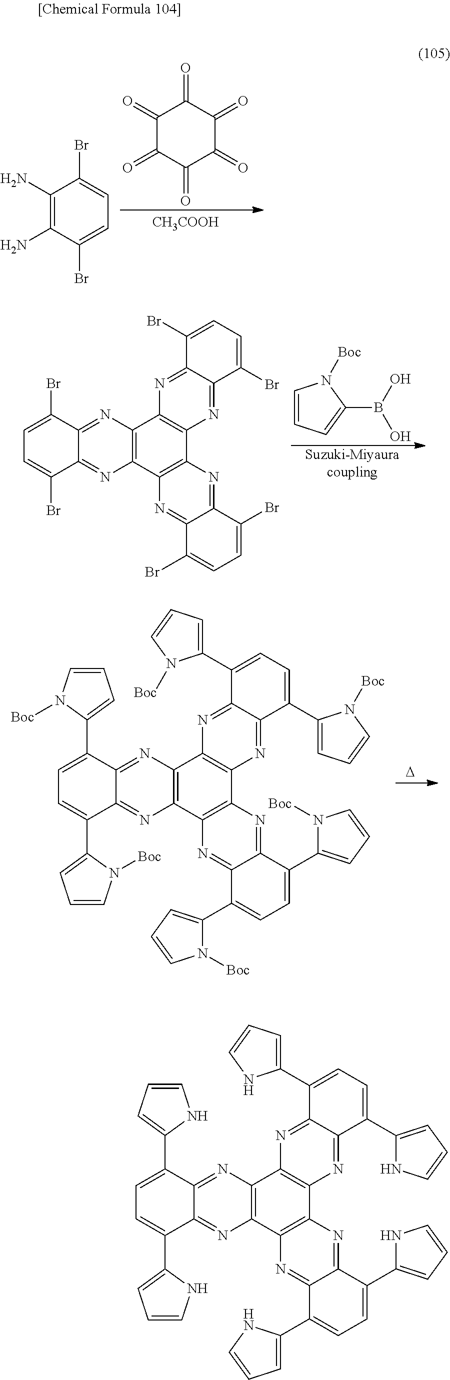

As illustrated in the following reaction equation (106), the compound obtained in the above reaction equation (105) may be reacted with an aldehyde to cause ring closing.

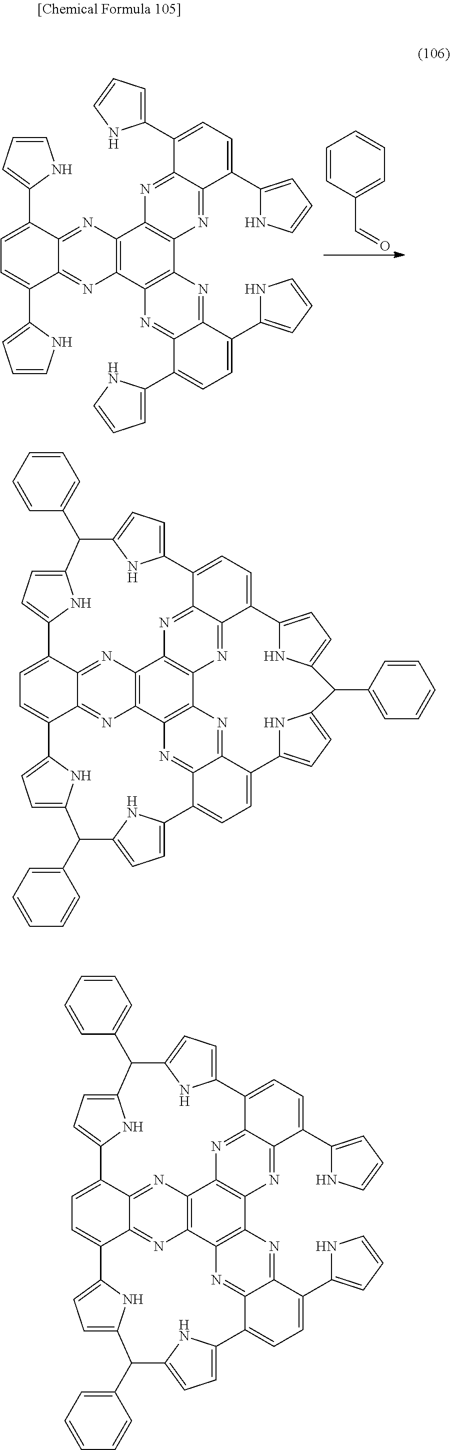

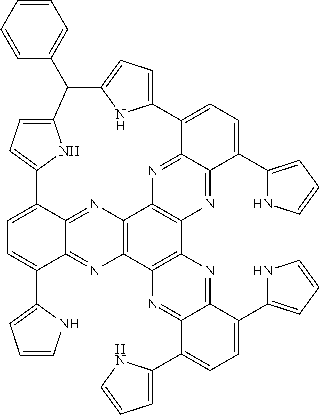 [SMILES: c1ccc(C2c3ccc([nH]3)-c3ccc(-c4ccc[nH]4)c4nc5c6nc7c(-c8ccc[nH]8)ccc(-c8ccc[nH]8)c7nc6c6nc7c(-c8ccc[nH]8)ccc(c7nc6c5nc34)-c3ccc2[nH]3)cc1]

The aromatic compounds having the types of structures shown above can be oxidized using a suitable oxidizing agent, as illustrated in the following reaction equation (107). As the oxidizing agent, 2,3-dichloro-5,6-dicyano-p-benzoquinone (DDQ) or oxygen or the like can be used. Further, by adjusting the amount added of the oxidizing agent and the reaction time, the extent of the reaction can be regulated.

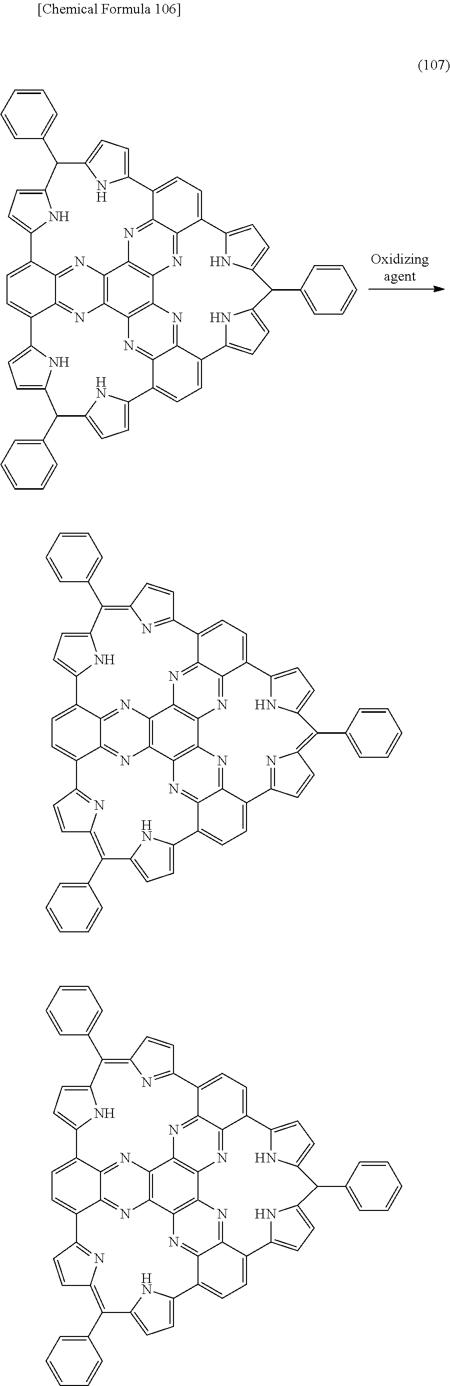 [SMILES: c1ccc(C2c3ccc([nH]3)-c3ccc4c5nc6c(nc35)c3nc5c(ccc7c5nc3c3nc5c(ccc(c5nc63)-c3ccc([nH]3)C(c3ccccc3)c3ccc-4[nH]3)-c3ccc([nH]3)C(c3ccccc3)c3ccc-7[nH]3)-c3ccc2[nH]3)cc1 ; C1=Cc2nc1c(-c1ccccc1)c1ccc([nH]1)c1ccc3c4nc(c(-c5ccccc5)c5ccc([nH]5)c5ccc6c7nc(c(-c8ccccc8)c8ccc([nH]8)c8ccc2c2nc9c%10nc1c3nc%10c1nc5c6nc1c9nc82)C=C7)C=C4 ; C1=Cc2nc1c(-c1ccccc1)c1ccc([nH]1)c1ccc3c4nc5c6nc7c(ccc8c9nc(c(-c%10ccccc%10)c%10ccc([nH]%10)c%10ccc2c2nc(c5nc41)c(nc%102)c6nc87)C=C9)-c1ccc([nH]1)C(c1ccccc1)c1ccc-3[nH]1]

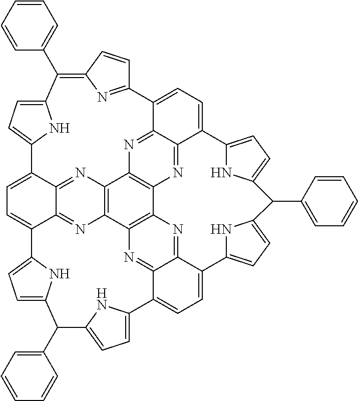 [SMILES: C1=Cc2nc1c(-c1ccccc1)c1ccc([nH]1)c1ccc3c4nc5c6nc7c(ccc8c7nc6c6nc7c(ccc2c7nc6c5nc41)-c1ccc([nH]1)C(c1ccccc1)c1ccc-8[nH]1)-c1ccc([nH]1)C(c1ccccc1)c1ccc-3[nH]1]

The aromatic compound that can be used the ligand of the polynuclear metal complex of the present embodiment may have a reactive group such as an ethynyl group. Introducing a reactive group is preferable, as it enables further improvement in the catalytic activity of the polynuclear metal complex. For example, a reactive group can be introduced by performing a reaction with an aldehyde having an ethynyl group, as illustrated in the following reaction equation (108).

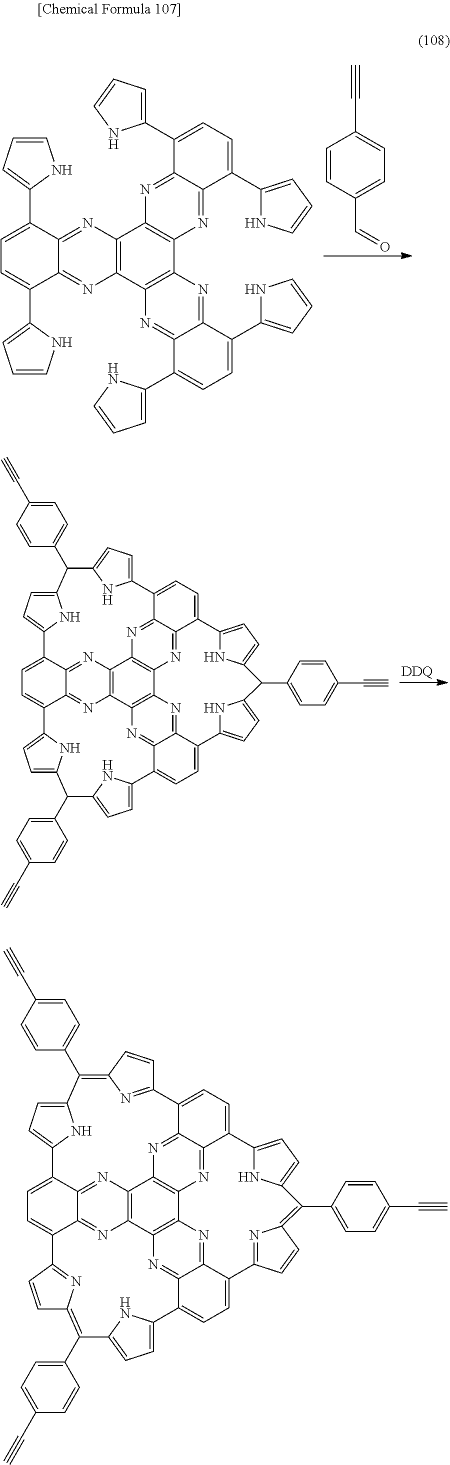

When ethynyl groups are introduced using the above reaction equation (108), the ethynyl groups may be protected with protective groups such as trimethylsilyl (TMS) groups, triethylsilyl (TES) groups, tert-butyldimethylsilyl (TBS or TBDMS) groups triisopropylsilyl (TIPS) groups or tert-butyldiphenylsilyl (TBDPS) groups or the like, and then following introduction into the nitrogen-containing aromatic compound, a deprotection may be performed by placing the compound in acidic conditions or reacting the compound with fluoride ions.

An aromatic compound that can be used as the ligand of the polynuclear metal complex of the present embodiment can also be produced as illustrated in the following reaction equation (109).

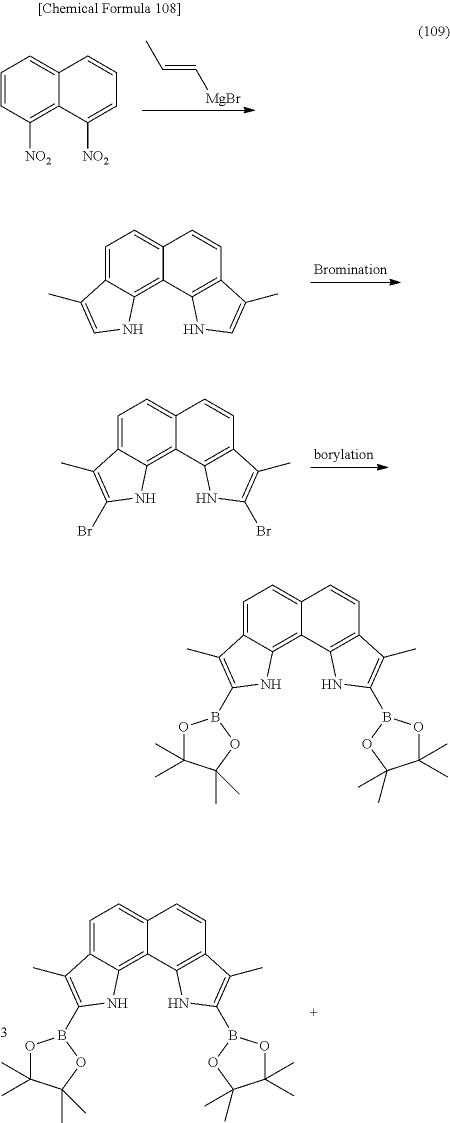

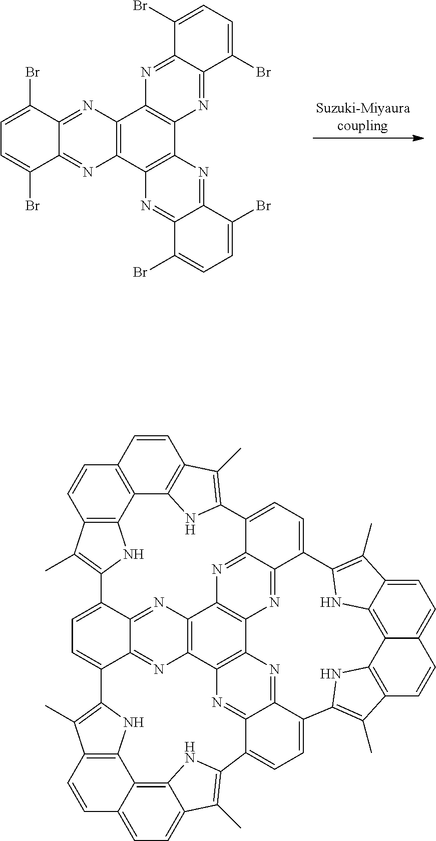 [SMILES: Brc1ccc(Br)c2nc3c(nc12)c1nc2c(Br)ccc(Br)c2nc1c1nc2c(Br)ccc(Br)c2nc31 ; Cc1c2ccc3ccc4c(C)c5[nH]c4c3c2[nH]c1c1ccc2c3[nH]c4c(ccc6ccc7c(C)c([nH]c7c64)c4ccc6c7[nH]c8c(ccc9ccc%10c(C)c([nH]c%10c98)c8ccc5c5nc9c%10nc1c2nc%10c1nc4c6nc1c9nc85)c7C)c3C]

Furthermore, as illustrated in the following reaction equation (110), an aromatic compound that can be used as the ligand of the polynuclear metal complex of the present embodiment may also be produced using, as a raw material, an aromatic compound which has one structure that forms a space surrounded by 4 or more nitrogen atoms being able to coordinate with a metal, and in which at least one of the nitrogen atoms is a nitrogen atom contained in a nitrogen-containing hetero 6-membered ring.

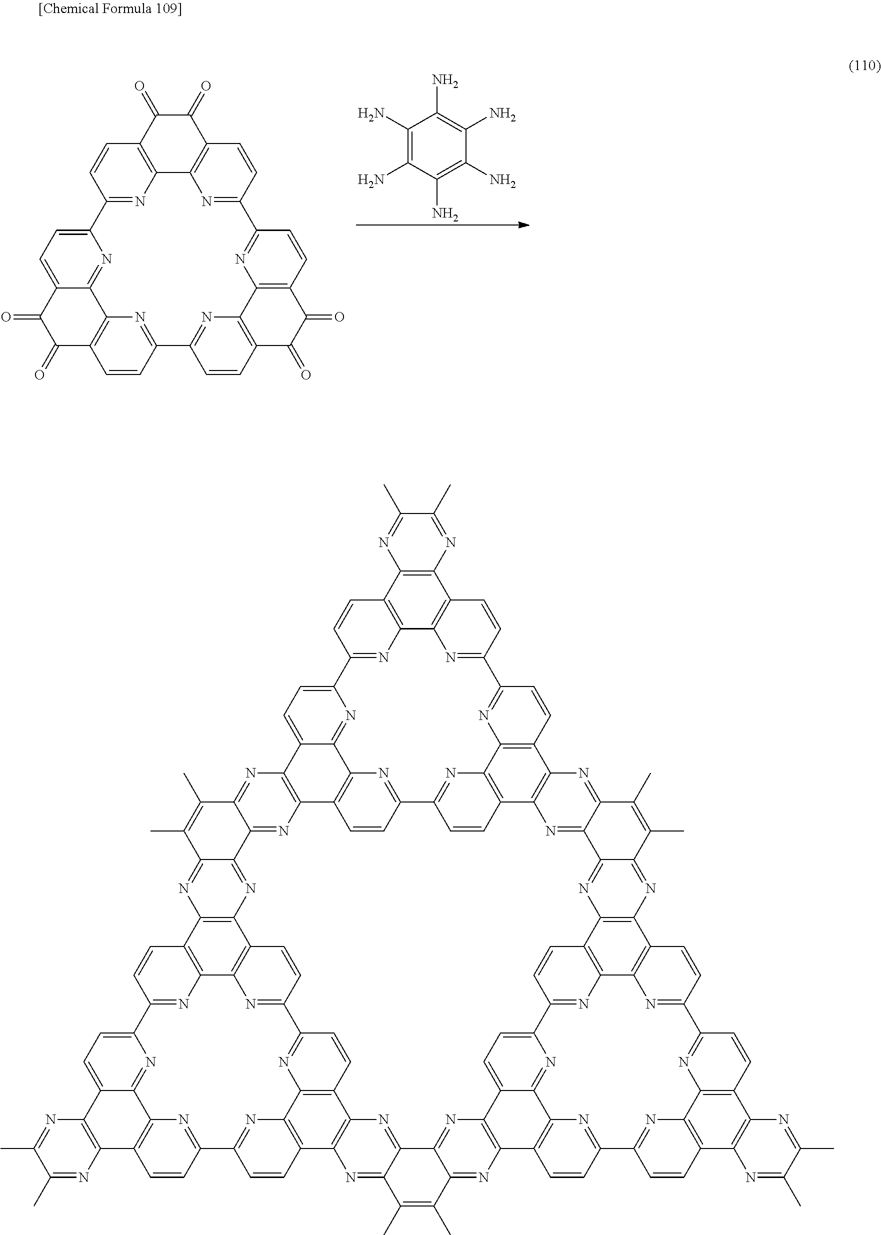

In the method of producing an aromatic compound that can be used as the ligand of the polynuclear metal complex of the present embodiment, compounds represented by general formulas (B-11) to (B-20), (B-22) and (B-23) can be used as the raw material for the aromatic compound that becomes the ligand of the polynuclear metal complex of the present embodiment. Further, the aromatic compound can also be produced by removing one or two or more hydrogen atoms or substituents from the structural formula represented by one of the general formulas (B-11) to (B-20), (B-22) and (B-23), and then coupling the resulting structures. Typically used coupling reactions can be used as the method for performing this coupling, and specific examples include the Suzuki-Miyaura coupling reaction and Mizoroki-Heck reaction which use palladium as a catalyst, the Yamamoto coupling reaction and Kumada-Tamao coupling reaction which use nickel as a catalyst, and the Ullmann reaction which uses copper as a catalyst.

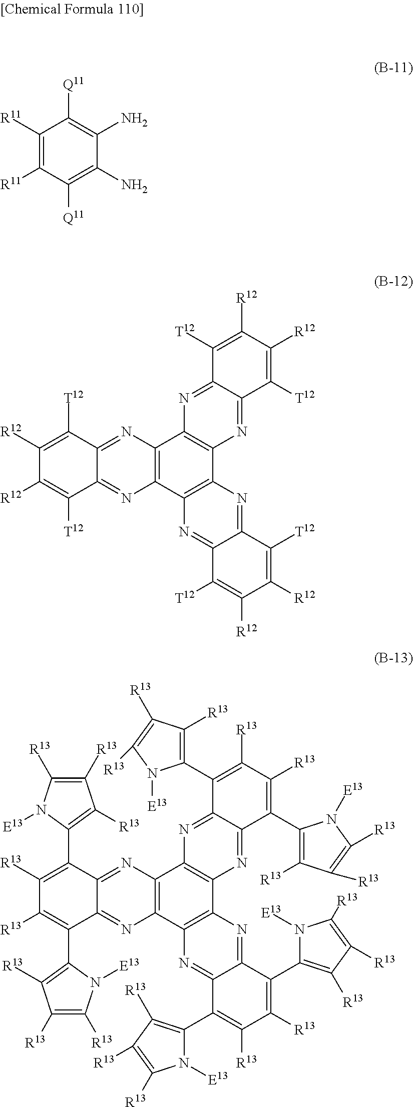

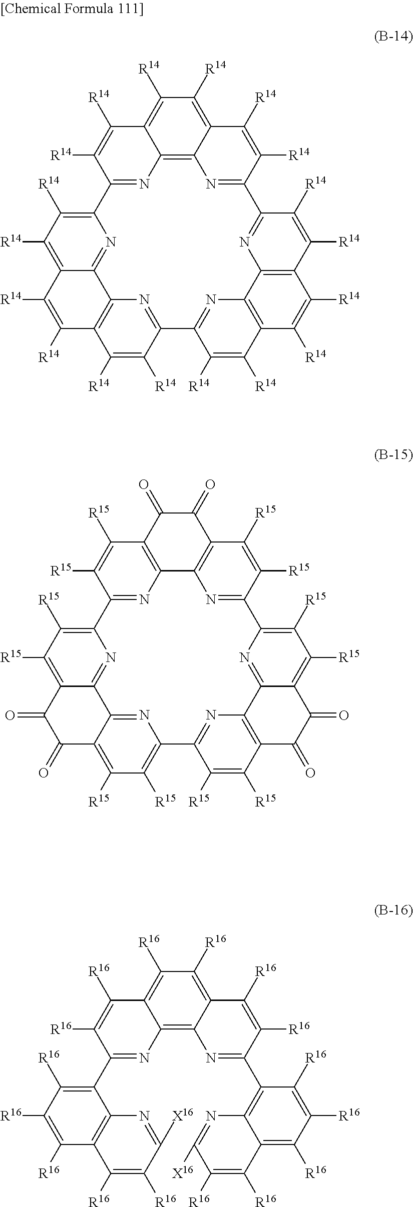

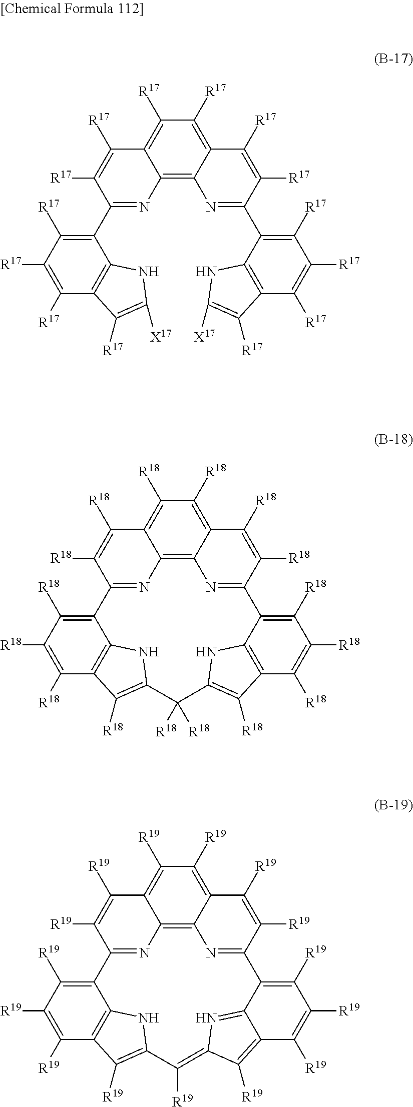

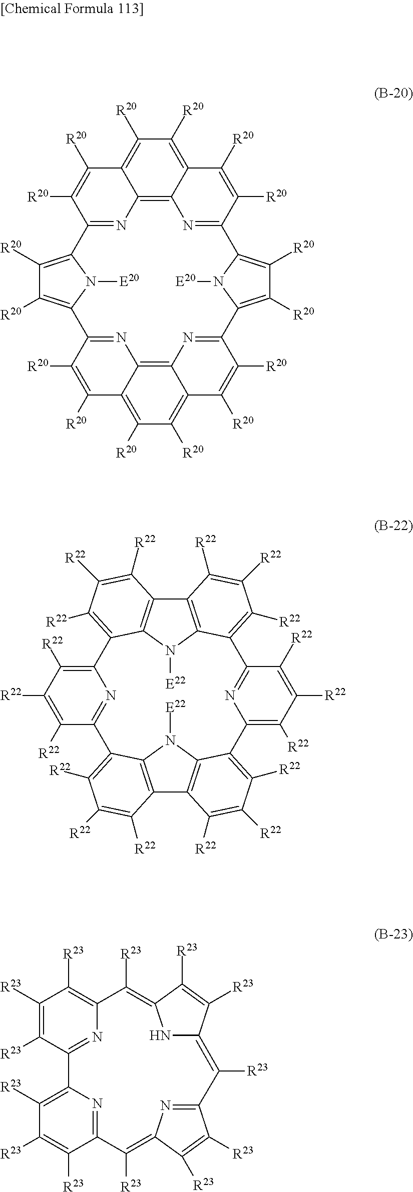

In general formulas (B-11) to (B-20), (B-22) and (B-23), each of R¹¹ to R²⁰, R²² and R²³ independently represents a hydrogen atom or a substituent, and adjacent substituents may be mutually bonded together to form a ring with the carbon atoms bonded thereto; Q¹¹ represents a nitrogen-containing aromatic hetero ring; T¹² represents a bromo group, chloro group or iodo group; each of E¹³, E²⁰ and E²² independently represents a hydrogen atom or a protective group; each of X¹⁶ and X¹⁷ independently represents a hydrogen atom or a halogeno group, or two X¹⁶ or two X¹⁷ may be mutually bonded to form a direct bond; and each 2 or more R¹¹ to R²⁰, R²², R²³, Q¹¹, T¹², E¹³, E²⁰, E²², X¹⁶ and X¹⁷ may be the same or different from each other.

The substituents represented by R¹¹ to R²⁰, R²² and R²³ are the same as the substituents described and listed above.

Q¹¹ represents a nitrogen-containing aromatic hetero ring, is preferably a pyridine ring, pyrazine ring, pyrimidine ring, pyridazine ring, 1,3,5-triazine ring, 1,2,4-triazine ring, 1,2,4,5-tetrazine ring, 1H-pyrrole ring, 2H-pyrrole ring, 3H-pyrrole ring, imidazole ring, pyrazole ring, 1,2,3-triazole ring, 1,2,4-triazole ring, oxazole ring, isoxazole ring, thiazole ring, isothiazole ring, 1,3,4-oxadiazole ring, 1,2,5-oxadiazole ring, 1,3,4-thiadiazole ring, 1,2,5-thiadiazole ring, or a polycyclic aromatic hetero ring having any of these ring structures, and is more preferably a pyridine ring, pyrazine ring, pyrimidine ring, pyridazine ring, 1H-pyrrole ring, 2H-pyrrole ring, 3H-pyrrole ring, imidazole ring, pyrazole ring, 1,2,3-triazole ring or 1,2,4-triazole ring, and is particularly preferably a pyridine ring, pyrazine ring, pyrimidine ring, pyridazine ring or 1H-pyrrole ring.

T¹² is preferably a bromo group or a chloro group, and is more preferably a bromo group.

Each of E¹³, E²⁰ and E²² independently represents a hydrogen atom or a protective group.

Examples of the protective group include alkoxycarbonyl groups such as a methoxycarbonyl group, ethoxycarbonyl group, 2,2,2-trichloroethoxycarbonyl group and tert-butoxycarbonyl (Boc) group, alkenyloxycarbonyl groups such as a vinyloxycarbonyl group, aralkyloxycarbonyl groups such as a benzyloxycarbonyl group and 9-fluorenylmethoxycarbonyl group, aralkyl groups which may be substituted such as a benzyl group and 4-methoxybenzyl group, acyl groups such as a formyl group, acetyl group, trifluoroacetyl group and benzoyl group, arylsulfonyl groups such as a p-toluenesulfonyl group and benzenesulfonyl group, and alkylsulfonyl groups such as a methanesulfonyl group, and a tert-butoxycarbonyl group is preferable.

The compound represented by general formula (B-11) can be produced, for example as illustrated in the following reaction equation (111), by reacting an o-diaminobenzene derivative and hexaketocyclohexane in acetic acid.

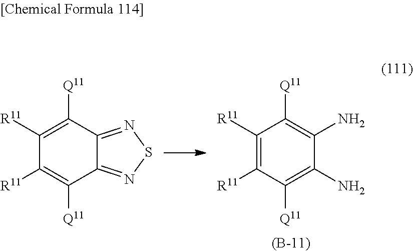

The compound represented by general formula (B-12) can be produced, for example as illustrated in the following reaction equation (112), by reacting an ortho-diaminobenzene derivative and hexaketocyclohexane in acetic acid.

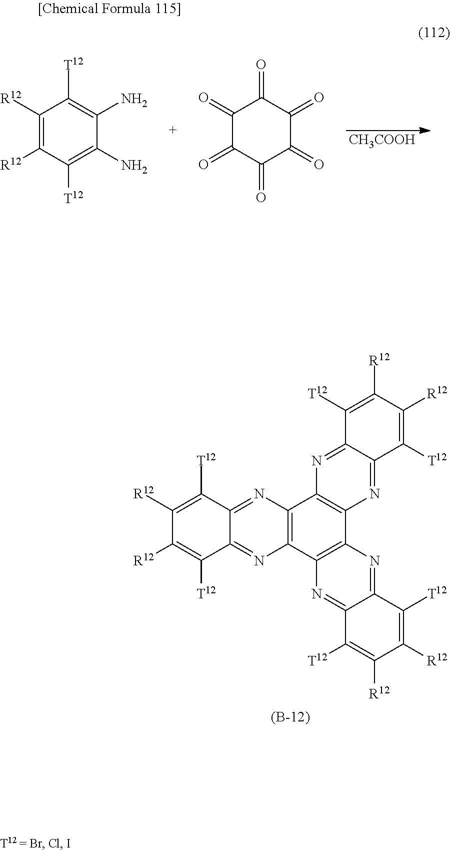

The compound represented by general formula (B-13) can be produced, for example as illustrated in the following reaction equation (113), by coupling the compound represented by general formula (B-12) with 6 molecules of a pyrrole boric acid. Examples of the coupling method include typical cross-coupling reactions, and Suzuki coupling is particularly preferable.

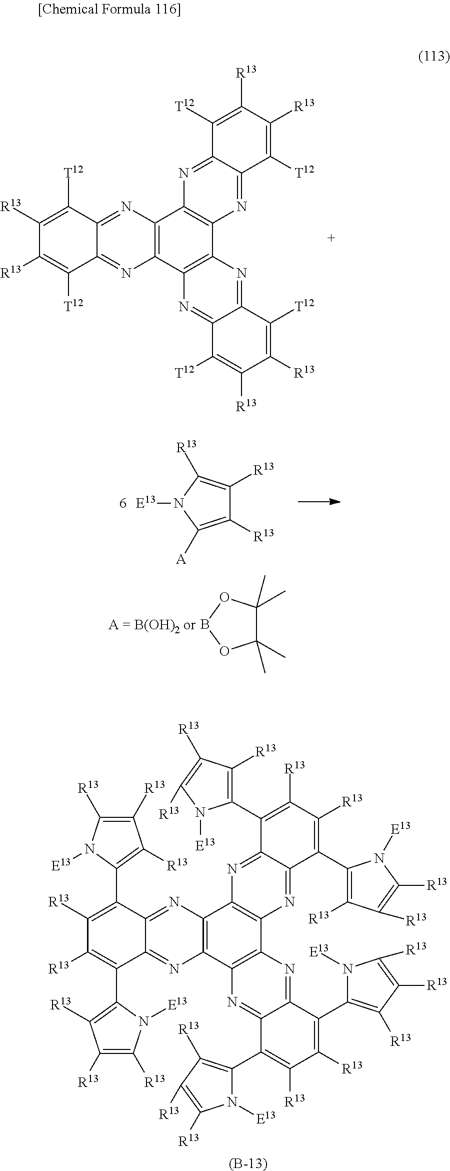

The compound represented by general formula (B-14) can be produced, for example as illustrated in the following reaction equation (114), by cyclically coupling 3 molecules of 2,9-dihalogeno-1,10-phenanthroline. Examples of the coupling method include Yamamoto coupling and Kumada-Tamao coupling which use nickel as a catalyst, and the Ullmann reaction which uses copper as a catalyst.

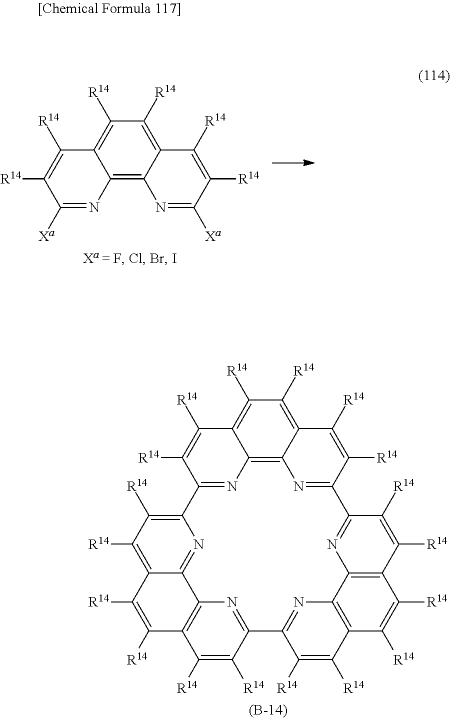

The compound represented by general formula (B-15) can be produced, for example as illustrated in the following reaction equation (115), by cyclically coupling 3 molecules of 2,9-dihalogeno-1,10-phenanthrolin-5,6-dione. Examples of the coupling method include Yamamoto coupling and Kumada-Tamao coupling which use nickel as a catalyst, and the Ullmann reaction which uses copper as a catalyst.

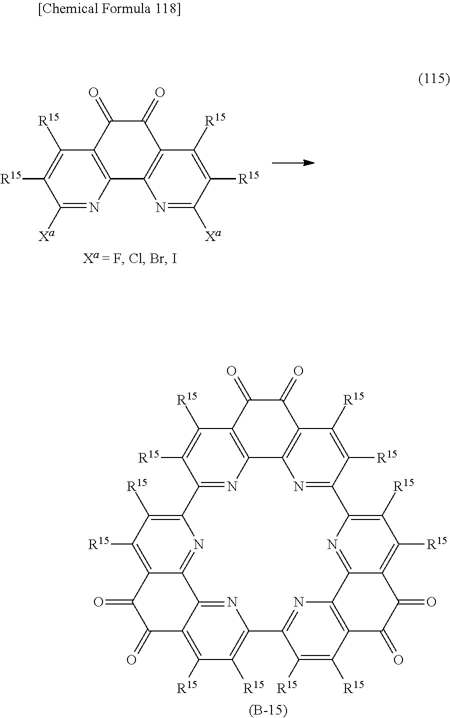

The compound represented by general formula (B-16) can be produced, for example as illustrated in the following reaction equation (116), by coupling 2,9-dihalogeno-1,10-phenanthroline with 2 molecules of a quinoline boric acid. Examples of the coupling method include typical cross-coupling reactions, and Suzuki coupling is particularly preferable.

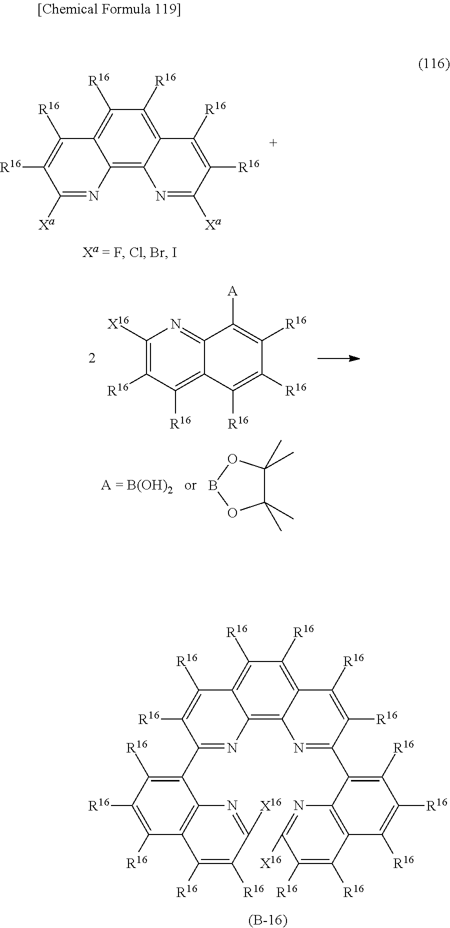

The compound represented by general formula (B-17) can be produced, for example as illustrated in the following reaction equation (117), by coupling 2,9-dihalogeno-1,10-phenanthroline with 2 molecules of an indole boric acid. Examples of the coupling method include typical cross-coupling reactions, and Suzuki coupling is particularly preferable.

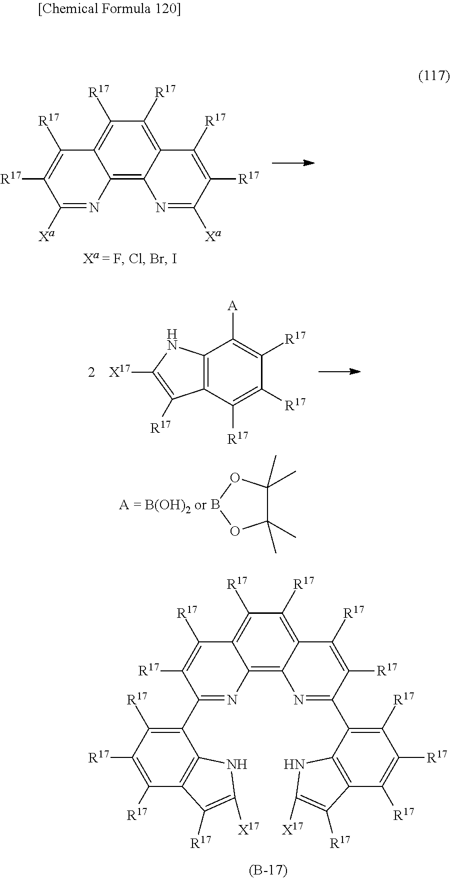

The compound represented by general formula (B-18) can be produced, for example as illustrated in the following reaction equation (118), by reacting a derivative of the compound represented by general formula (B-17) with an aldehyde or a ketone.

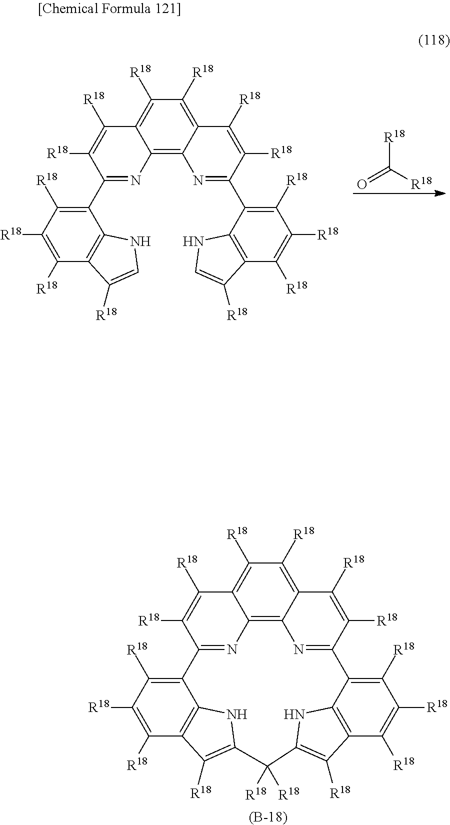

The compound represented by general formula (B-19) can be produced, for example as illustrated in the following reaction equation (119), by reacting a derivative of the compound represented by general formula (B-17) with an aldehyde in the presence of an oxidizing agent. As an alternative method of producing the compound represented by general formula (19), a method that involves oxidizing a derivative of the compound represented by general formula (B-18) with an oxidizing agent may be used.

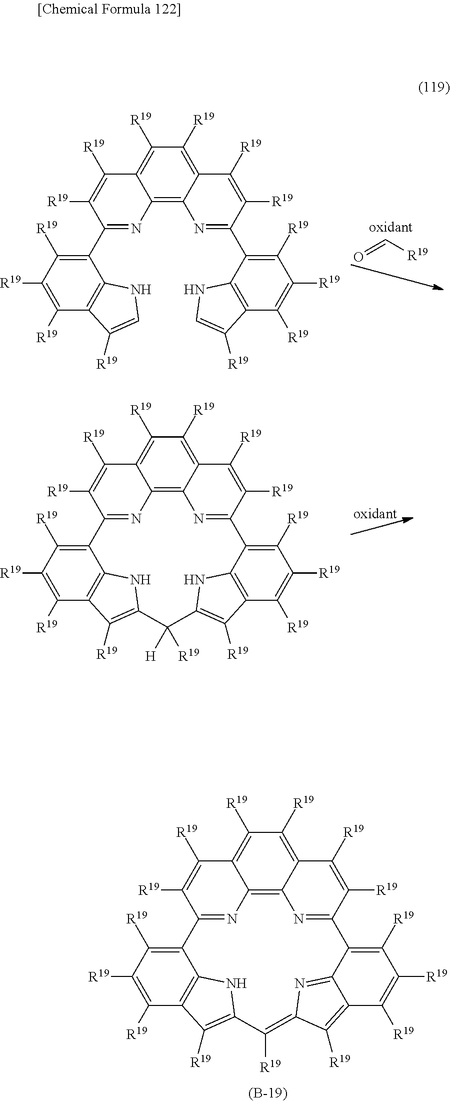

The compound represented by general formula (B-20) can be produced, for example as illustrated in the following reaction equation (120), by cyclically coupling 2 molecules of each of 2,9-dihalogeno-1,10-phenanthroline and a pyrrole boronic acid. Examples of the coupling method include typical cross-coupling reactions, and Suzuki coupling is preferable.

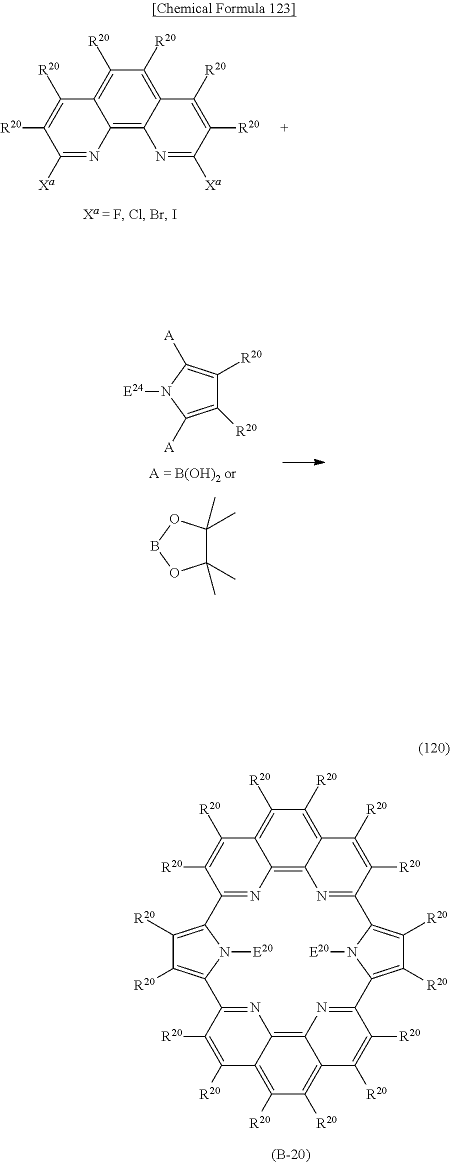

The compound represented by general formula (B-22) can be produced, for example, by cyclically coupling 2 molecules of each of a carbazole derivative and a pyrrole derivative. Examples of the coupling method include typical cross-coupling reactions, and Suzuki coupling is preferable.

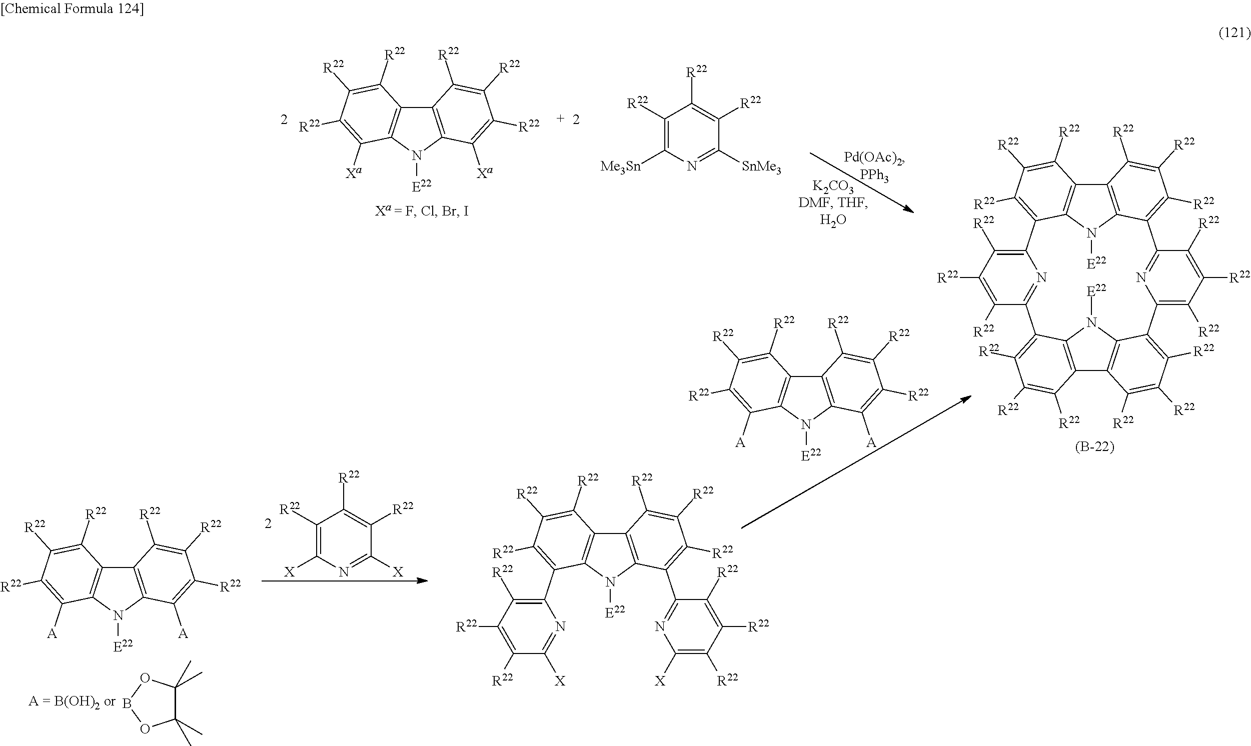

When the compound represented by general formula (B-11) is used as a raw material, then for example as illustrated in the following reaction equation (122), an aromatic compound that can be used as the ligand of the polynuclear metal complex of the present embodiment can be produced by reacting the compound represented by general formula (B-11) with hexaketocyclohexane in acetic acid.

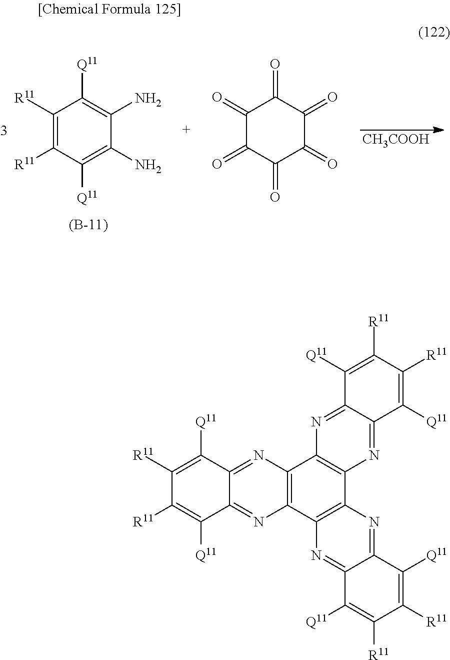

When the compound represented by general formula (B-12) is used as a raw material, then for example as illustrated in the following reaction equation (123), an aromatic compound that can be used as the ligand of the polynuclear metal complex of the present embodiment can be produced by bonding 6 nitrogen-containing aromatic hetero rings to the compound represented by general formula (B-12). Examples of the bonding method include cross-coupling reactions.

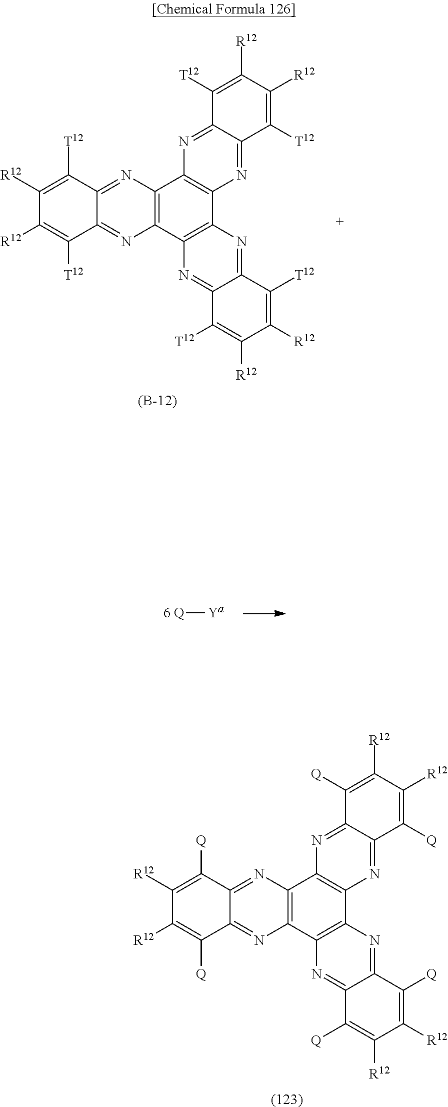

In the equation, Q represents a nitrogen-containing aromatic hetero ring, and Y^{a} represents a group suitable for cross-coupling such as a boryl group or stannyl group.

When the compound represented by general formula (B-13) is used as a raw material, then for example as illustrated in the following reaction equation (124), an aromatic compound that can be used as the ligand of the polynuclear metal complex of the present embodiment can be produced by removing the protective groups bonded to the nitrogen atoms of the compound represented by general formula (B-13). The deprotection method can use a typical deprotection operation, heating or microwave irradiation or the like.

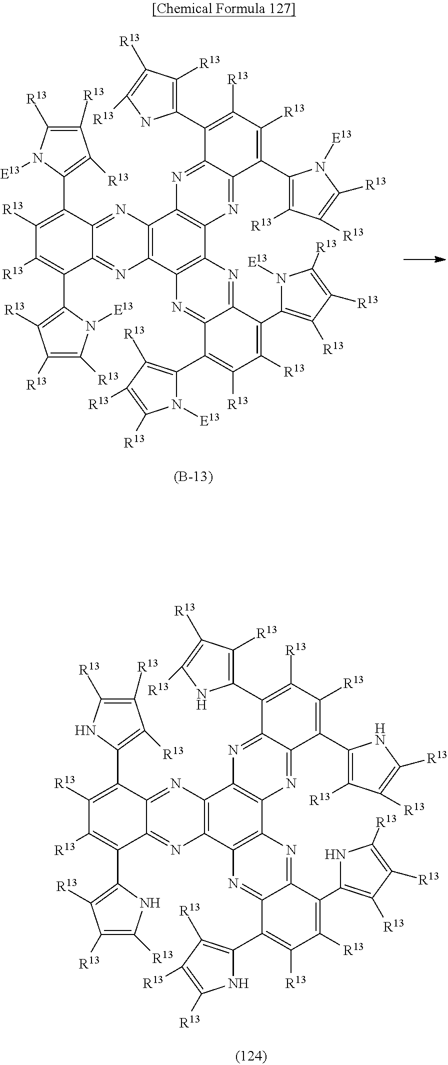

When the compound represented by general formula (B-17) is used as a raw material, then for example as illustrated in the following reaction equation (125), an aromatic compound that can be used as the ligand of the polynuclear metal complex of the present embodiment can be produced by synthesizing a compound represented by general formula (B-17-a), subsequently converting the compound to an oxo form using trifluoroacetic acid, and then reacting 2 molecules of the oxo form together with ammonium acetate.

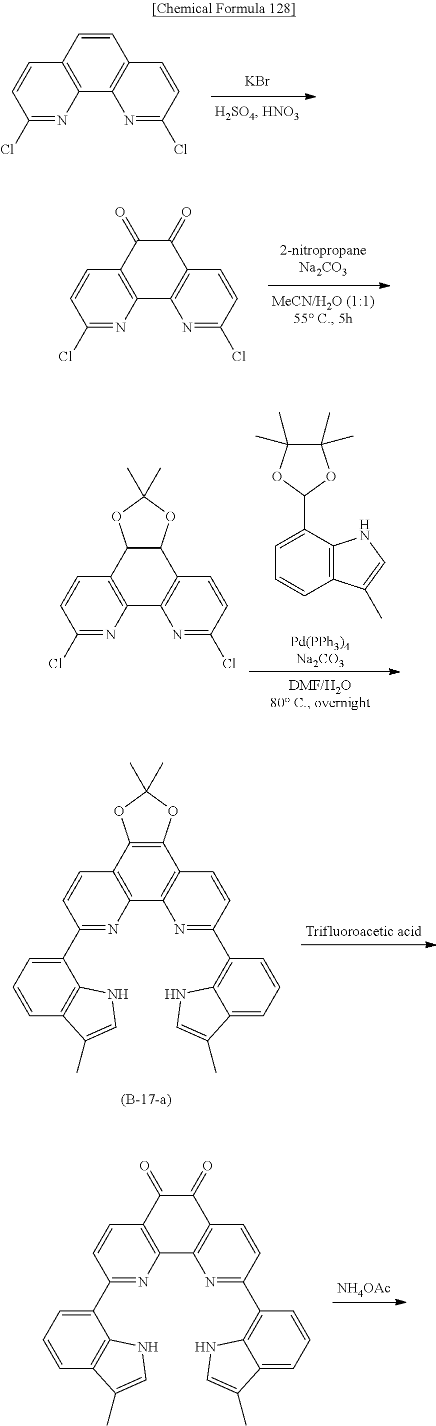

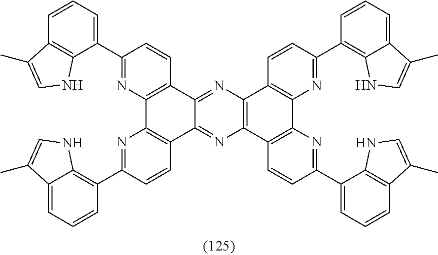

The above aromatic compound that can be used as the ligand of the polynuclear metal complex of the present embodiment may be further reacted to form a closed ring structure, as illustrated in the following reaction equation (126).

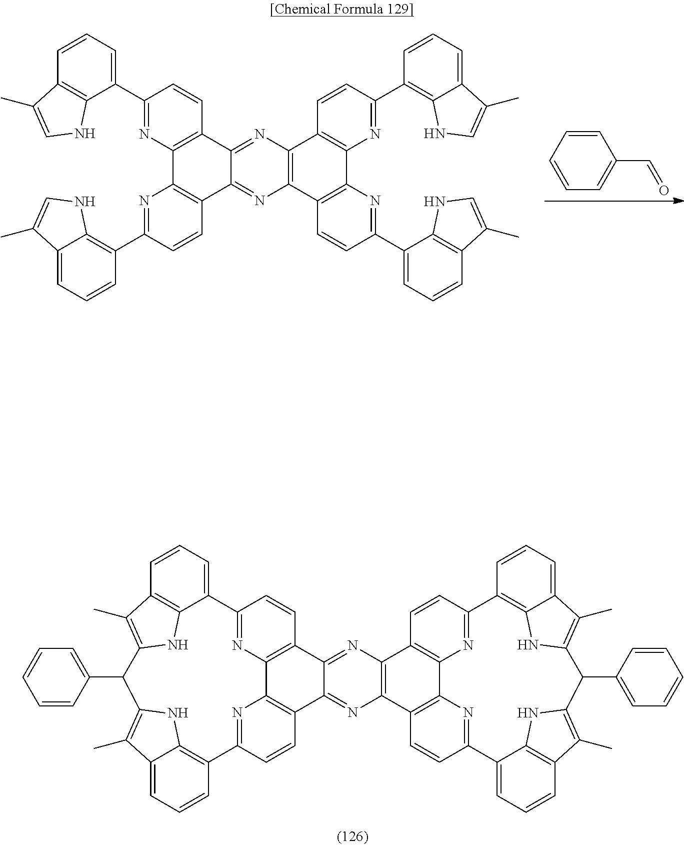

The above aromatic compound that can be used as the ligand of the polynuclear metal complex of the present embodiment can also be produced, for example as illustrated in the following reaction equation (127), via a compound represented by general formula (B-18-a).

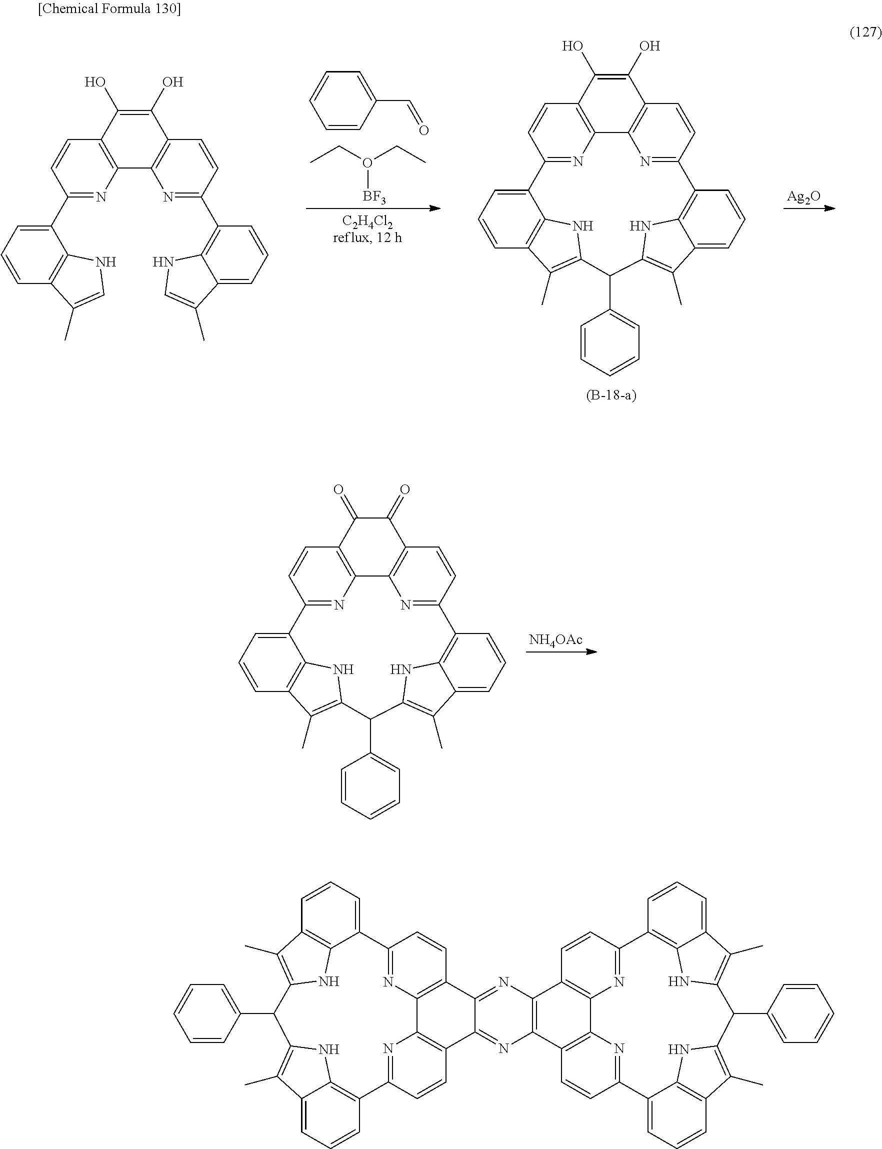

The above aromatic compound that can be used as the ligand of the polynuclear metal complex of the present embodiment may also be converted to an oxidized form using an oxidizing agent such as 2,3-dichloro-5,6-dicyano-p-benzoquinone (DDQ), as illustrated in the following reaction equation (128).

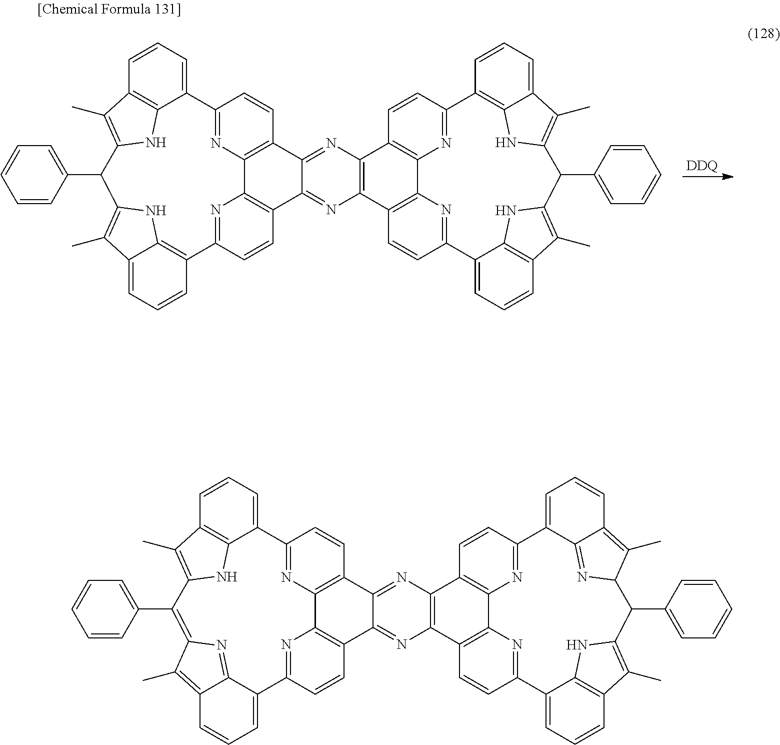

An aromatic compound that can be used as the ligand of the polynuclear metal complex of the present embodiment can be produced, for example as illustrated in the following reaction equation (129), by synthesizing a compound represented by general formula (B-18-b), and then performing a heat condensation.

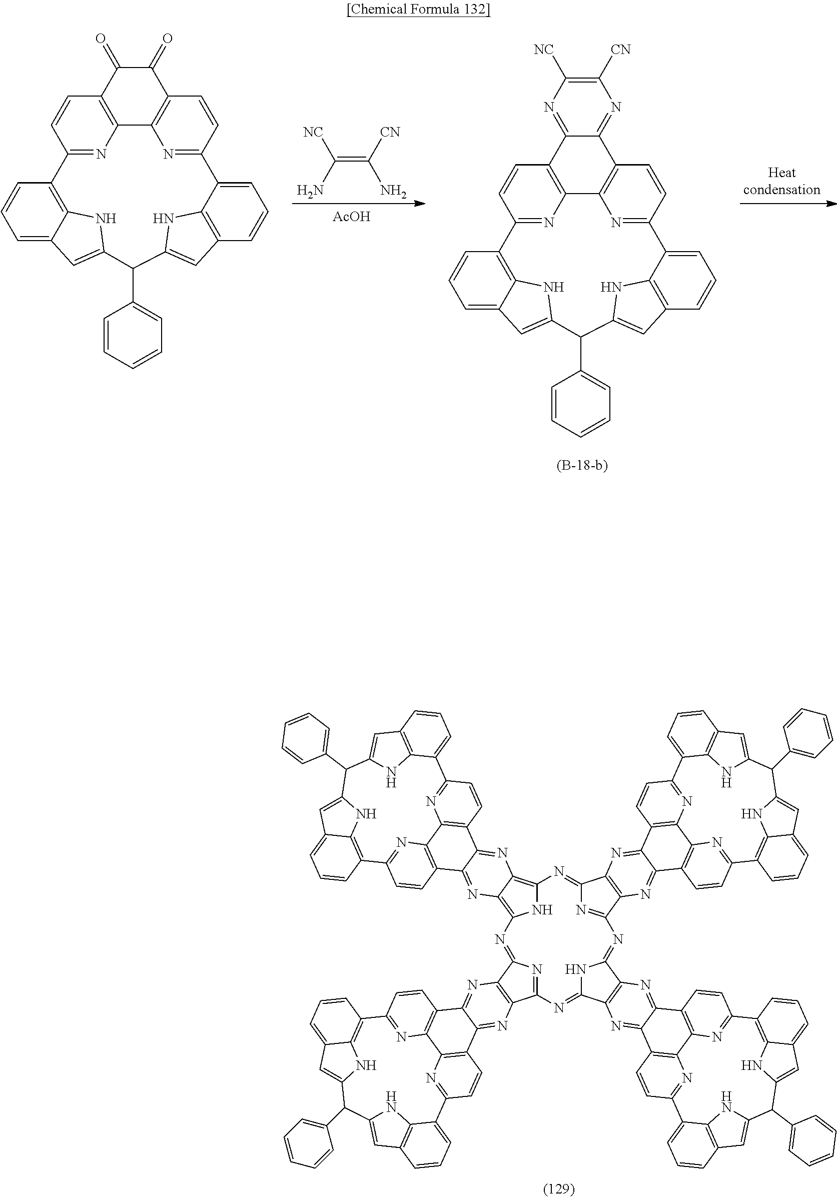

An aromatic compound that can be used as the ligand of the polynuclear metal complex of the present embodiment can be produced as a polymer compound having 2 or more nitrogen-containing aromatic hetero rings coupled together. One example is illustrated in the reaction equation (130) shown below:

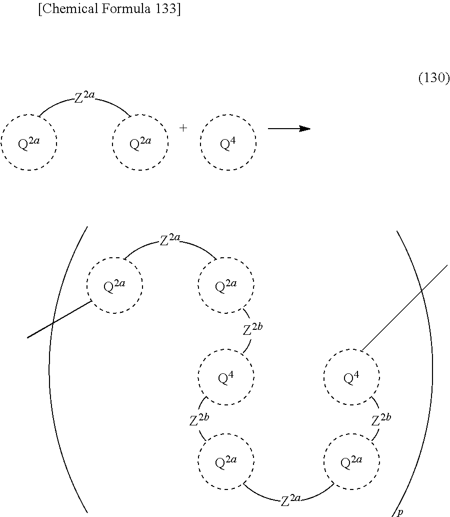

wherein p represents the number of repeating units.

In the above reaction equation, Q⁴ represents a nitrogen-containing aromatic hetero ring having 2 nitrogen atoms that are capable of coordination.

Specific examples thereof include the structural formulas shown below. Hydrogen atoms in these structural formulas may be substituted with the substituents described above.

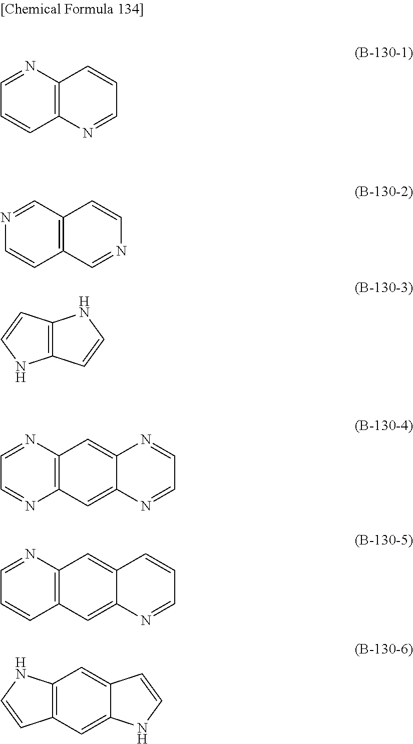

With respect to the reaction equation (130) mentioned above as a method of producing an aromatic compound of the present embodiment, a more specific reaction equation is illustrated in the reaction equation (131) shown below:

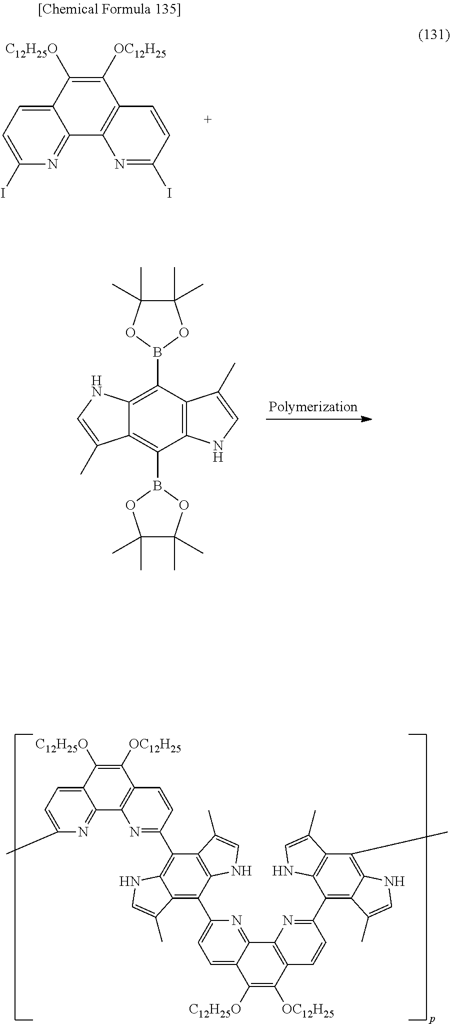

wherein p represents the number of repeating units.

The compounds that function as the raw materials in the above reaction can be synthesized in accordance with the following reaction equations (132) and (133) respectively.

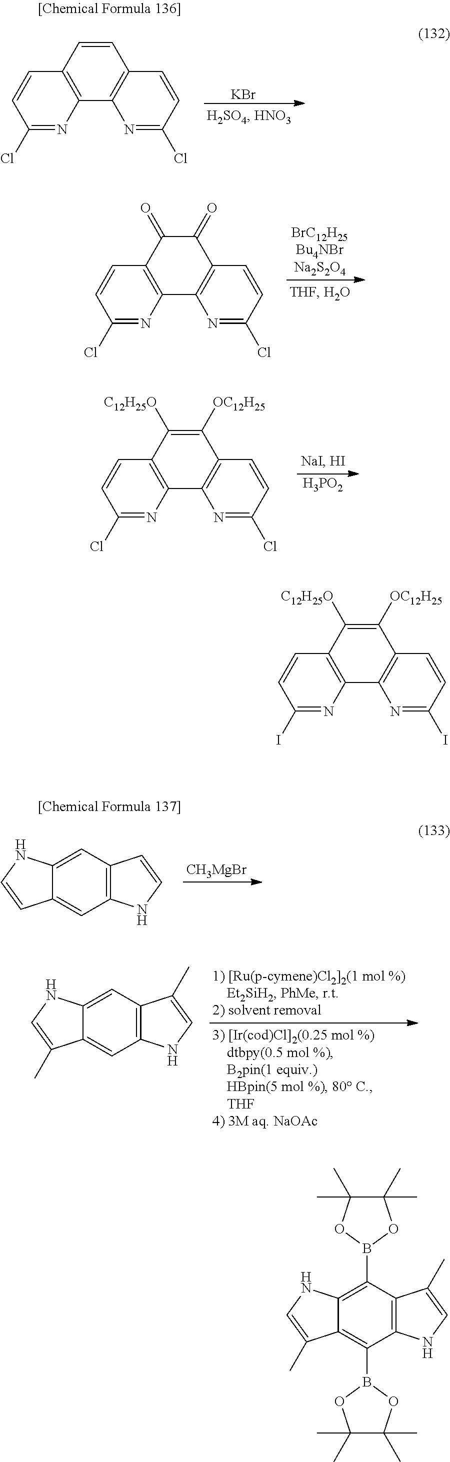

As illustrated in the following reaction equation (134), the aromatic compound obtained above can be reacted with an aldehyde to produce a polymer compound in which the structure that forms the space which accommodates the central metal is a closed ring structure.

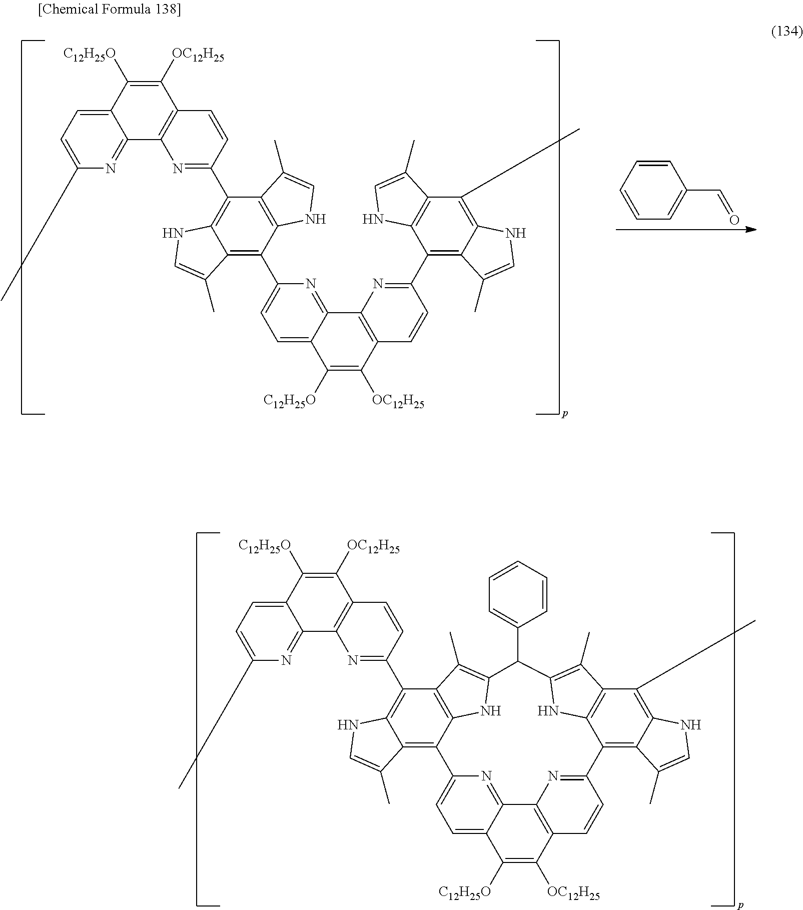

In the equation, p represents the number of repeating units.

The aforementioned aromatic compound may also be synthesized using a polymer compound produced in accordance with one of the following reaction equations (135) and (136):

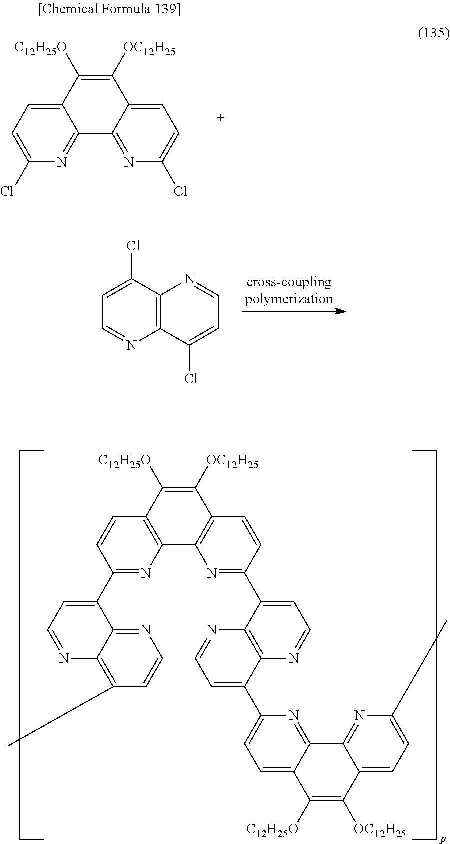

wherein p represents the number of repeating units.

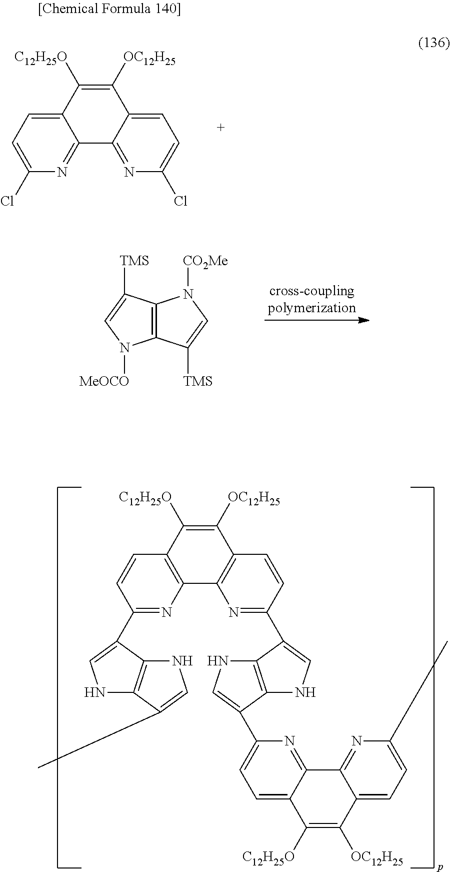

wherein p represents the number of repeating units.

An aromatic compound that can be used as the ligand of the polynuclear metal complex of the present embodiment can also be produced by synthesizing compounds having one of the structures described above, and then coupling the compounds.

A compound having the above structure can be produced, for example as illustrated in the following reaction equation (137), by coupling 2 or more nitrogen-containing aromatic hetero rings with a compound having 2 nitrogen-containing aromatic hetero rings. Examples of the coupling method include typical cross-coupling reactions.

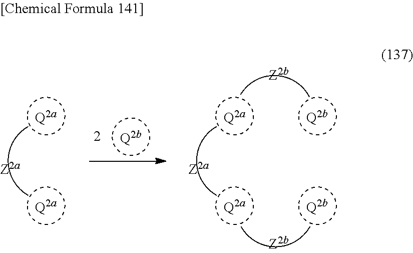

Further, as illustrated in the following reaction equation (138), the compound obtained in the above reaction equation (137) may be further reacted and cyclized.

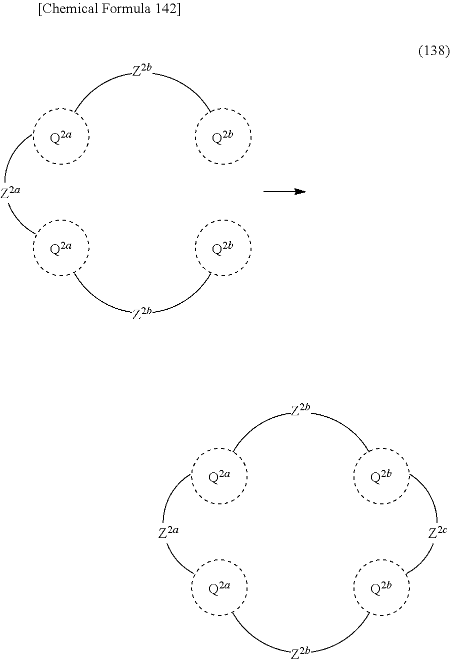

Furthermore, as illustrated in the following reaction equations (139) and (140), a compound having the structure described above can also be produced by cyclizing 2 or more compounds having 2 nitrogen-containing aromatic hetero rings.

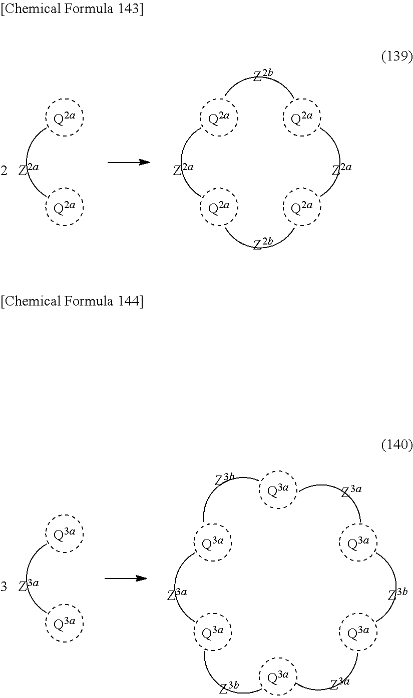

As illustrated in the following reaction equation, an aromatic compound of the present embodiment can also be produced by coupling a compound having a structure that forms the space which accommodates the central metal. An example of the coupling method is the method shown in the following reaction equation (141), in which a compound having halogeno groups is coupled by Yamamoto coupling.

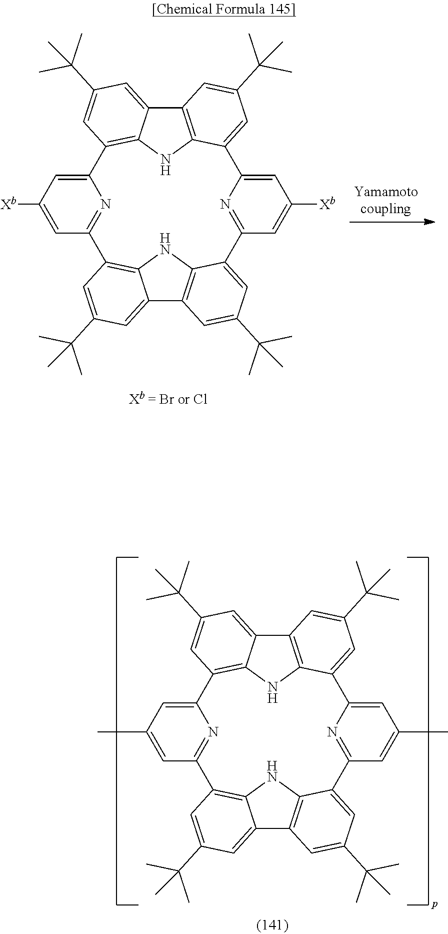

In the equation, p represents the number of repeating units.

Further, as illustrated in the following reaction equation (142), another example of the coupling method is a method in which a borate ester and a compound having halogeno groups are coupled by Suzuki coupling. The borate ester shown in reaction equation (142) can be produced, for example, with reference to the method disclosed in Journal of the American Chemical Society, 129, 15434 (2007).

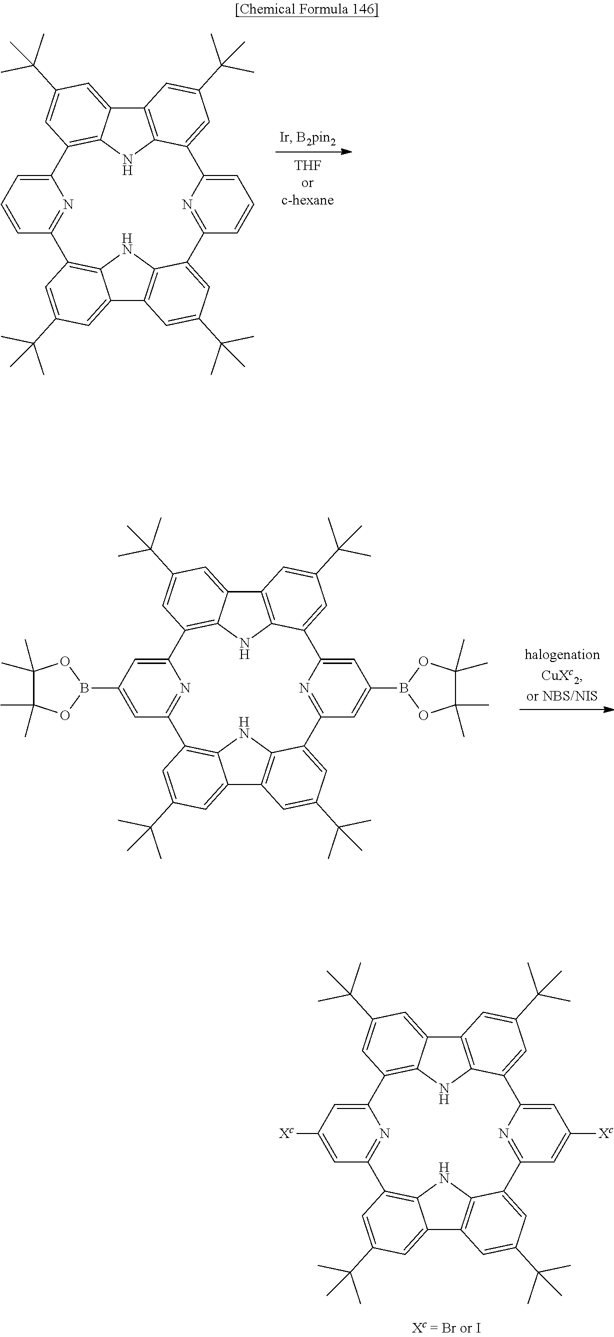

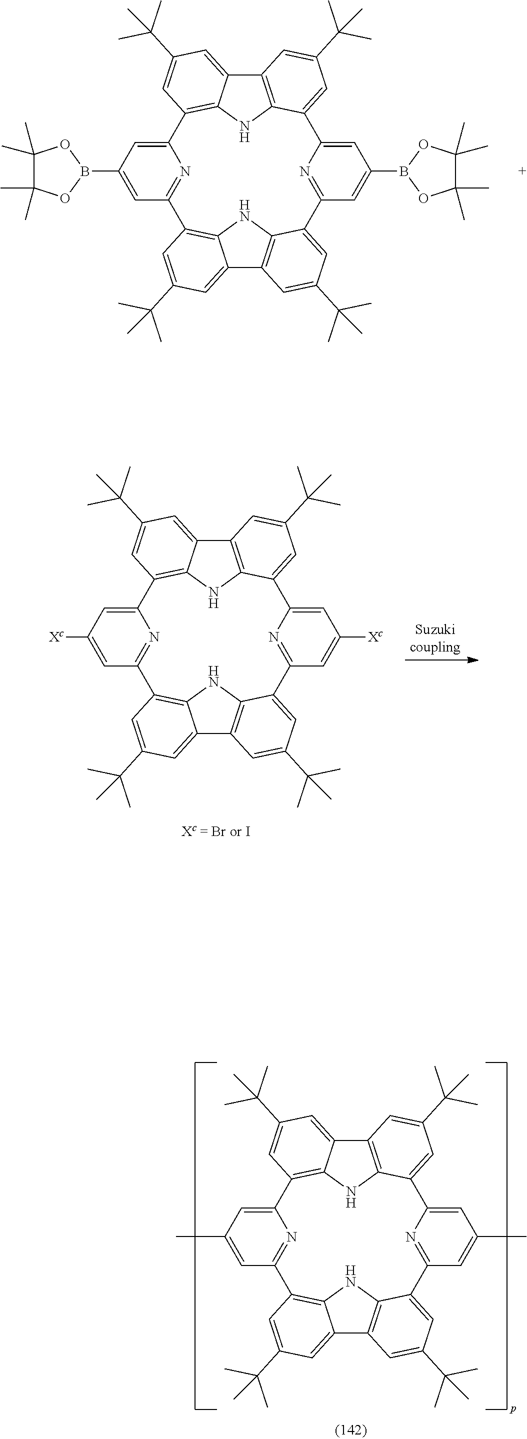

In the equation, p represents the number of repeating units.

The aromatic compound that can be used as the ligand of the polynuclear metal complex of the present embodiment may contain, in addition to the ligand that satisfies the aforementioned conditions (a) and (b), an organic group in which 1 or 2 or more hydrogen atoms have been removed from a compound having a molecular structure represented by one of the following formulas (B-24) to (B-29). The hydrogen atoms of the compounds represented by the following structural formulas (B-24) to (B-29) may be substituted with the substituents described above.

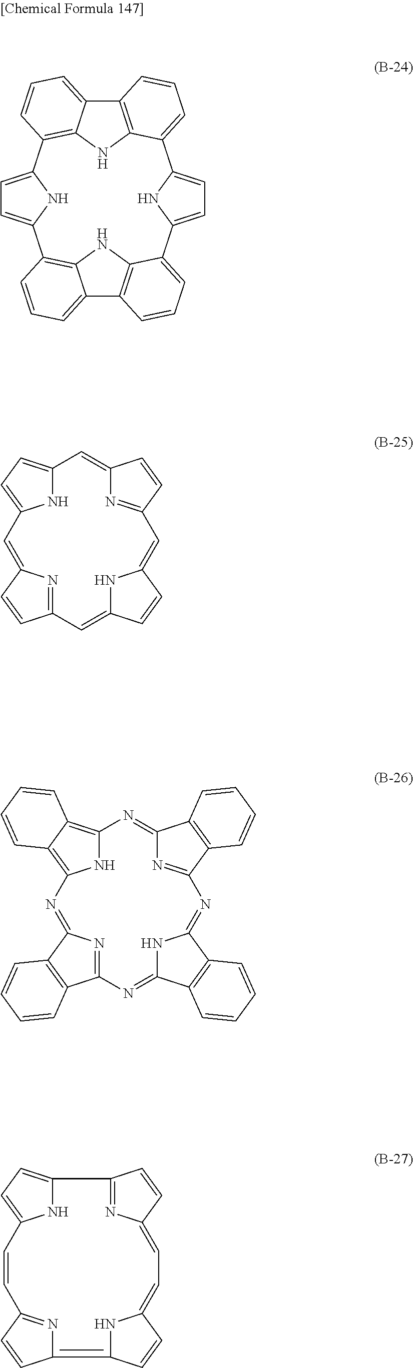 [SMILES: c1cc2c3ccc([nH]3)c3cccc4c5cccc(c6ccc([nH]6)c6cccc7c(c1)c2[nH]c67)c5[nH]c34 ; C1=Cc2cc3ccc(cc4nc(cc5ccc(cc1n2)[nH]5)C=C4)[nH]3 ; c1ccc2c(c1)-c1nc-2nc2[nH]c(nc3nc(nc4[nH]c(n1)c1ccccc41)-c1ccccc1-3)c1ccccc21 ; C1=Cc2nc1ccc1ccc([nH]1)c1nc(ccc3ccc2[nH]3)C=C1]

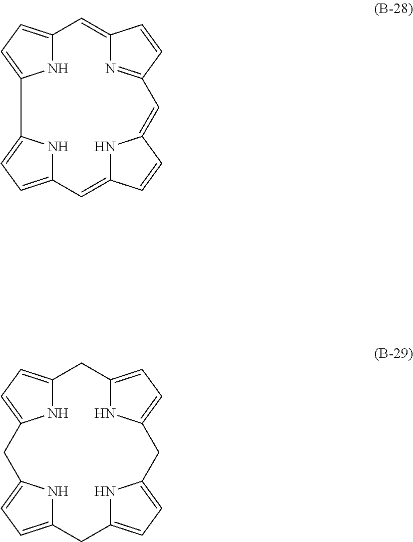 [SMILES: C1=Cc2cc3ccc([nH]3)c3ccc(cc4ccc(cc1n2)[nH]4)[nH]3 ; c1cc2[nH]c1Cc1ccc([nH]1)Cc1ccc([nH]1)Cc1ccc([nH]1)C2]

The compound represented by formula (B-24) can be produced, as illustrated in the following reaction equation (143), by cyclically coupling 2 molecules of each of a dihalogeno-carbazole and a pyrrole boronic acid. The coupling method can use a typical cross-coupling reaction, and Suzuki coupling is particularly preferable.

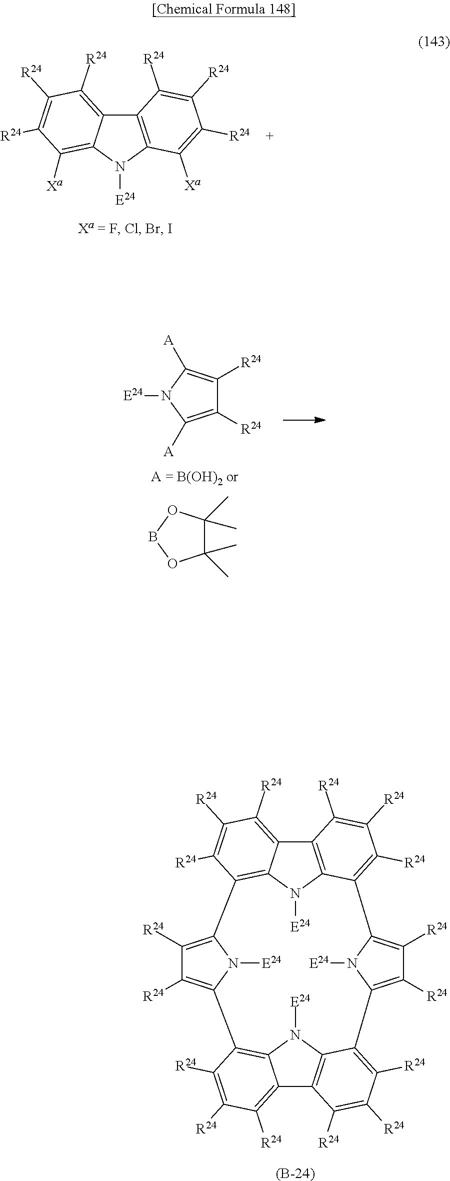

In the equation, R²⁴ represents a hydrogen atom or a substituent, adjacent substituents may be mutually bonded together to form a ring with the carbon atoms bonded thereto, and 2 or more E²⁴ may be the same or different from each other.

### (Method of Producing Polynuclear Metal Complex)

The polynuclear metal complex described above can be produced, for example in the manner described below, by a method having the steps of organochemically synthesizing a compound which becomes the ligand (hereinafter referred to as the “ligand compound”), and mixing the ligand compound with a reactant which imparts a transition metal atom or transition metal ion (hereinafter referred to as the “metal-imparting agent”).

The metal-imparting agent can use a salt having the aforementioned metal atom as a cation. The metal-imparting agent is preferably a chloride, bromide, iodide, acetate, nitrate, sulfate or carbonate.

In the first polynuclear metal complex described above, the metal-imparting agent is, for example, a metal salt formed from a combination of the transition metal atom M and the counter ion X¹ in the above general formulas (A-1) to (A-3). Preferred examples of M and X¹ are as described above, but a combination of manganese, iron, cobalt, nickel or copper as M, and an acetate ion, chloride ion or nitrate ion as X¹ is preferable, and cobalt acetate is particularly preferable. The metal-imparting agent may be anhydrous or a hydrate.

The step of mixing the ligand compound and the metal-imparting agent is performed in the presence of a suitable solvent.

Examples of solvents that can be used in the reaction (the reaction solvent) include water; organic acids such as acetic acid and propionic acid; amines such as ammonia water and triethylamine; alcohols such as methanol, ethanol, n-propanol, isopropyl alcohol, 2-methoxyethanol, 1-butanol and 1,1-dimethylethanol; ethylene glycol, diethyl ether, 1,2-dimethoxyethane, methyl ethyl ether, 1,4-dioxane and tetrahydrofuran (hereinafter referred to as THF); aromatic hydrocarbons such as benzene, toluene, xylene, mesitylene, durene and decalin; halogenated solvents such as dichloromethane, chloroform, carbon tetrachloride, chlorobenzene and 1,2-dichlorobenzene; and N,N′-dimethylformamide (hereinafter referred to as DMF), N,N′-dimethylacetamide, N-methyl-2-pyrrolidone, dimethyl sulfoxide, acetone, acetonitrile, benzonitrile, triethylamine, pyridine, pyrazine and diazabicyclo[2,2,2]octane. These solvents may be used individually, or a combination of two or more solvents may be used. Further, the solvent is preferably a solvent that can dissolve the aromatic compound that becomes the ligand and the metal-imparting agent.

The temperature for the mixing of the ligand compound and the metal-imparting agent is preferably −10° C. or more and 250° C. or less, more preferably 0° C. or more and 200° C. or less, and particularly preferably 0° C. or more and 150° C. or less.

Further the mixing time for the ligand compound and the metal-imparting agent is preferably 1 minute or more and 1 week or less, more preferably 5 minutes or more and 24 hours or less, and particularly preferably 1 hour or more and 12 hours or less. The mixing temperature and the mixing time are preferably adjusted with due consideration of the type of the ligand compound and the metal-imparting agent.

The generated polynuclear metal complex can be extracted from the solvent using an appropriate method selected from among conventional recrystallization methods, re-precipitation methods and chromatography methods, and at this time, a combination of 2 or more of these methods may be used. Depending on the type of solvent, the generated polynuclear metal complex may sometimes precipitate, and in such cases, the precipitated polynuclear metal complex may be isolated by filtration or the like, and then washed and dried.

### (Method of Producing Cathode Catalyst for Air Secondary Cell)

The cathode catalyst for an air secondary cell according to an embodiment of the present invention is produced using the above polynuclear metal complex. A single type of the polynuclear metal complex may be used alone, or a combination of two or more types may be used. Further, the polynuclear metal complex may be used alone, used in combination with another component, or used as a composition.

An example of the aforementioned other component is carbon. The other component may be a single component, or a combination of two or more components.

Examples of the aforementioned carbon include carbon blacks with brand names such as “Norit” (manufactured by Norit), “Ketchen Black” (manufactured by Lion Corporation), “Vulcan” (manufactured by Cabot Corporation), “Black Pearls” (manufactured by Cabot Corporation) and “Acetylene Black” (manufactured by Denki Kagaku Kogyo Kabushiki Kaisha); fullerene such as C60 and C70; carbon fibers such as carbon nanotubes, multi-wall carbon nanotubes, double-wall carbon nanotubes, single-wall carbon nanotubes and carbon nanohorns; and graphene and graphene oxide. A carbon black is preferable.

The carbon may be used in combination with a conductive polymer such as a polypyrrole or polyaniline.

A composition containing the polynuclear metal complex and carbon can be prepared by mixing these components.

In the composition, the amount of the polynuclear metal complex, when the amount of the composition is deemed to be 100 parts by weight, is preferably at least 1 part by weight, more preferably 5 parts by weight or more, and particularly preferably 10 parts by weight or more. Further the upper limit for the amount is preferably 70 parts by weight or less, more preferably 60 parts by weight or less, and particularly preferably 50 parts by weight or less. The upper limit and lower limit can be combined as appropriate.

In the aforementioned composition containing carbon, a polymer having a polynuclear metal complex residue (a structural unit derived from the polynuclear metal complex that acts as a precursor) may be used as the polynuclear metal complex (and hereinafter may be referred to as a “polynuclear metal complex polymer”).

The polynuclear metal complex polymer describes a polymer having a group with a structure in which 1 or more hydrogen atoms have been removed from the polynuclear metal complex described above, and all of the hydrogen atoms may be removed. Examples of the polynuclear metal complex include the polynuclear metal complexes described above.

There are no limitations on the polymer that functions as the main skeleton of the polynuclear metal complex polymer, and examples include conductive polymers, dendrimers, natural polymers, solid polymer electrolytes, polyethylene, polyethylene glycol and polypropylene. Conductive polymers and solid polymer electrolytes are preferable.

“Conductive polymer” is a generic term for polymer substances that exhibit metallic or semi-metallic electrical conductivity. Examples of the aforementioned conductive polymers include polyacetylene and derivatives thereof, polyparaphenylene and derivatives thereof, polyparaphenylenevinylene and derivatives thereof, polyaniline and derivatives thereof, polythiophene and derivatives thereof, polypyrrole and derivatives thereof, polyfluorene and derivatives thereof, polyfluorene and derivatives thereof, polycarbazole and derivatives thereof, polyindole and derivatives thereof, and copolymers of 2 or more types of these polymers, as disclosed in “Conductive Polymers” (written by Shinichi Yoshimura, published by Kyoritsu Shuppan Co., Ltd.) and “New Applications of Conducting Polymers” (edited by Yukio Kobayashi, published by CMC Publishing Co., Ltd.).

Examples of the aforementioned solid polymer electrolytes include perfluorosulfonic acid, and polymer compounds obtained by sulfonating a polyether ether ketone, polyimide, polyphenylene, polyarylene or polyarylene ether sulfone.

A composition containing the polynuclear metal complex polymer and carbon can be prepared by mixing these components.

In the composition, the amount of the polynuclear metal complex polymer, when the amount of the composition is deemed to be 100 parts by weight, is preferably at least 1 part by weight, more preferably 5 parts by weight or more, and particularly preferably 10 parts by weight or more. Further the upper limit for the amount is preferably 70 parts by weight or less, more preferably 60 parts by weight or less, and particularly preferably 50 parts by weight or less. The upper limit and lower limit can be combined as appropriate.

Examples of preferred cathode catalysts for an air secondary cell according to the present embodiment include cathode catalysts formed from compositions containing the polynuclear metal complex, or the polynuclear metal complex polymer and another component, including (1) cathode catalysts formed from the aforementioned polynuclear metal complex, (2) cathode catalysts formed from a composition containing the polynuclear metal complex and carbon, and (3) cathode catalysts formed from a composition containing the aforementioned polynuclear metal complex polymer and carbon.

Additional preferred cathode catalysts for an air secondary cell according to the present embodiment include cathode catalysts formed from heat-treated products of the polynuclear metal complex, or heat-treated products of compositions containing the polynuclear metal complex and another component, including (4) cathode catalysts formed from a heat-treated product of the aforementioned polynuclear metal complex, (5) cathode catalysts formed from a heat-treated product of a composition containing the polynuclear metal complex and carbon, and (6) cathode catalysts formed from a heat-treated product of a composition containing the aforementioned polynuclear metal complex polymer and carbon (namely, heat-treated products of the aforementioned (1) to (3)).

When an aforementioned heat treatment is performed, as a pretreatment, the treatment target substance is preferably dried for 6 hours or more under conditions including a temperature of 15 to 200° C. and a pressure of 1,333.22 Pa or less. This type of pretreatment can be performed, for example, using a vacuum dryer.

The heat treatment is preferably performed under a reducing gas atmosphere such as hydrogen or carbon monoxide; under an oxidizing gas atmosphere such as oxygen, carbon dioxide or water vapor; under an inert gas atmosphere such as nitrogen, helium, neon, argon, krypton or xenon; under a gas atmosphere of a nitrogen-containing compound such as ammonia or acetonitrile or the vapor thereof; or under a mixed gas atmosphere containing two or more of these gases.

Among these options, in the case of a reducing gas atmosphere, an atmosphere of hydrogen or a mixed gas atmosphere of hydrogen and an aforementioned inert gas is preferable, in the case of an oxidizing gas atmosphere, an atmosphere of oxygen or a mixed gas atmosphere of oxygen and an aforementioned inert gas is preferable, and in the case of an inert gas atmosphere, an atmosphere of nitrogen, neon, argon or a mixture of two or more of these gases is preferable.

Although there are no limitations on the pressure during the heat treatment, normal pressure or a pressure close to normal pressure, such as a pressure of 50.7 to 152.0 kPa (0.5 to 1.5 atmospheres) is preferable.

The temperature during the heat treatment is preferably at least 250° C., more preferably 300° C. or more, still more preferably 400° C. or more, and particularly preferably 500° C. or more. Further, the temperature is preferably 1,500° C. or less, more preferably 1,200° C. or less, and particularly preferably 1,000° C. or less. The upper limit and the lower limit can be combined as appropriate.

The time of the heat treatment can be set in accordance with the type of gas and the temperature and the like. For example, in the case of an atmosphere filled with the aforementioned gas and then sealed, or an atmosphere having the gas flowing therethrough, the temperature may be increased gradually from room temperature until the target temperature is reached, and the temperature then immediately lowered. However, it is preferable that after the target temperature has been reached, the target temperature or a temperature close to the target temperature is maintained for a predetermined period to cause gradual heating. This enables the durability of the obtained catalyst to be further improved. At this time, the time for which the temperature is maintained is preferably 1 hour to 100 hours, more preferably 1 to 40 hours, still more preferably 2 to 10 hours, and particularly preferably 2 to 3 hours.

Examples of the apparatus used for performing the above heat treatment include an oven, a furnace (such as a tubular furnace), and an IH hotplate.

The heat treatment may also be performed with the addition of an organic compound having a boiling point or melting point of 250° C. or higher, or an organic compound having a thermal polymerization initiation temperature of 250° C. or lower.

Examples of the organic compound having a boiling point or melting point of 250° C. or higher include carboxylic acid derivatives of aromatic compounds, such as perylene-3,4,9,10-tetracarboxylic dianhydride, 3,4,9,10-perylenetetracarboxylic diimide, 1,4,5,8-naphthalenetetracarboxylic dianhydride, 1,4,5,8-naphthalenetetracarboxylic diimide, 1,4,5,8-naphthalenetetracarboxylic acid, pyromellitic acid and pyromellitic dianhydride. These types of compounds are shown below in formulas (A-8-1) to (A-8-14).

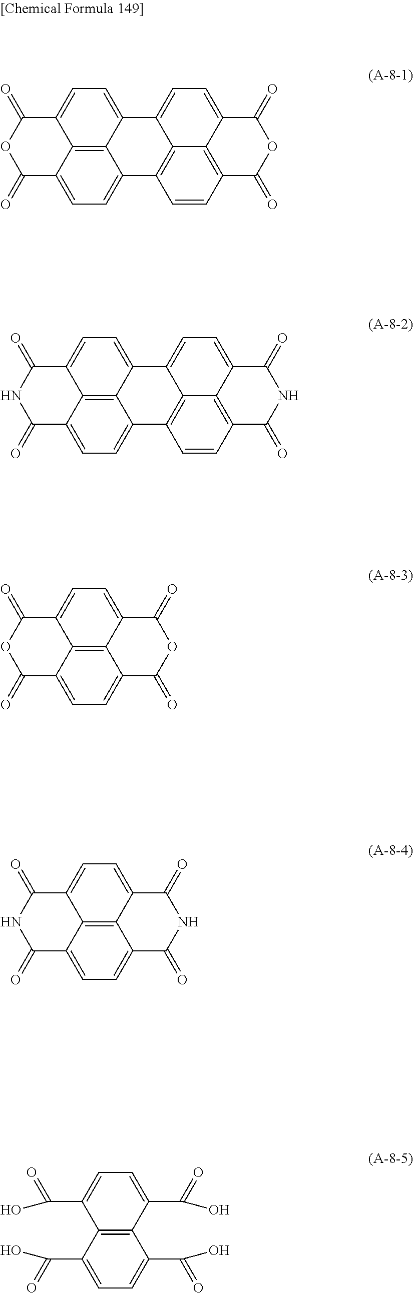 [SMILES: O=C1OC(=O)c2ccc3c4ccc5c6c(ccc(c7ccc1c2c73)c64)C(=O)OC5=O ; O=C1NC(=O)c2ccc3c4ccc5c6c(ccc(c7ccc1c2c73)c64)C(=O)NC5=O ; O=C1OC(=O)c2ccc3c4c(ccc1c24)C(=O)OC3=O ; O=C1NC(=O)c2ccc3c4c(ccc1c24)C(=O)NC3=O ; O=C(O)c1ccc(C(=O)O)c2c(C(=O)O)ccc(C(=O)O)c12]

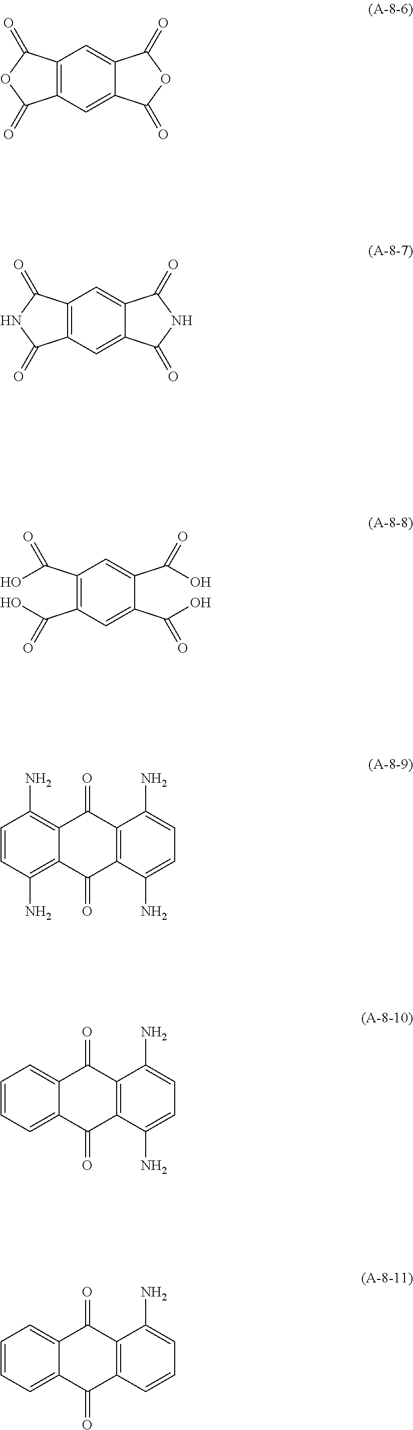 [SMILES: O=c1oc(=O)c2cc3c(=O)oc(=O)c3cc12 ; O=c1[nH]c(=O)c2cc3c(=O)[nH]c(=O)c3cc12 ; O=C(O)c1cc(C(=O)O)c(C(=O)O)cc1C(=O)O ; Nc1ccc(N)c2c1C(=O)c1c(N)ccc(N)c1C2=O ; Nc1ccc(N)c2c1C(=O)c1ccccc1C2=O ; Nc1cccc2c1C(=O)c1ccccc1C2=O]

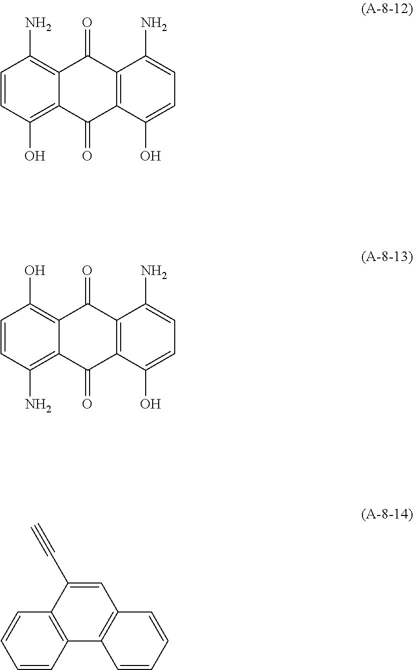

The organic compound having a thermal polymerization initiation temperature of 250° C. or lower is an organic compound having an aromatic ring and a double bond or a triple bond, and examples include acenaphthylene and derivatives thereof, and vinylnaphthalene and derivatives thereof, of which acenaphthylene and vinylnaphthalene are preferable.

The cathode catalyst for an air secondary cell described above exhibits both excellent oxygen reduction activity and excellent water oxidation activity.

### <Air Secondary Cell>

An air secondary cell of the present embodiment comprises the cathode catalyst for an air secondary cell of the embodiment described above in the cathode catalyst layer, uses at least one material selected from the group consisting of zinc, iron, aluminum, magnesium, lithium, hydrogen, and ions thereof as the anode active material, and preferably uses at least one material selected from the group consisting of zinc, iron, aluminum, magnesium, lithium and hydrogen as the anode active material.

In the air secondary cell of the present embodiment, one type of the aforementioned cathode catalyst may be used alone, or a combination of two or more types may be used.

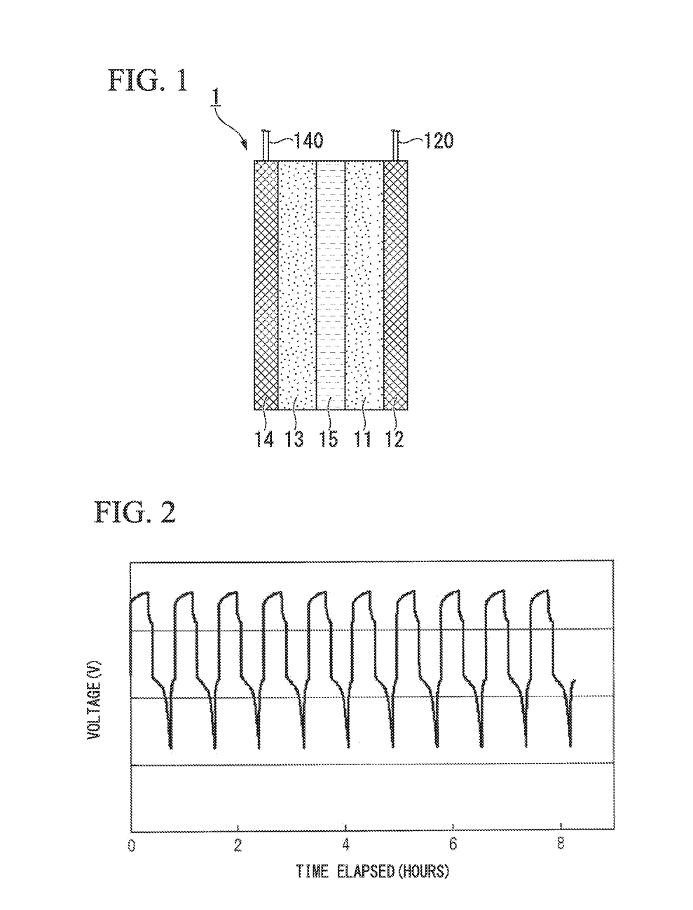

FIG. 1 is a schematic cross-sectional view illustrating one embodiment of the air secondary cell according to the present embodiment.

The illustrated air secondary cell 1 comprises a cathode catalyst layer 11 containing the aforementioned cathode catalyst, a cathode current collector 12, an anode active material layer 13, an anode current collector 14, an electrolyte 15, and a container (not shown in the figure) that houses these elements.

The cathode current collector 12 is disposed in contact with the cathode catalyst layer 11, and these elements constitute the cathode. Further, the anode current collector 14 is disposed in contact with the anode active material layer 13, and these elements constitute the anode. Further, a cathode terminal (lead) 120 is connected to the cathode current collector 12, and an anode terminal (lead) 140 is connected to the anode current collector 14.

The cathode catalyst layer 11 and the anode active material layer 13 are positioned facing each other, and the electrolyte 15 is positioned therebetween so as to make contact with both layers.

The air secondary cell according to the present embodiment is not limited to the structure illustrated here, and a portion of the structure may be modified depending on need.

The cathode catalyst layer 11 preferably comprises, besides the aforementioned cathode catalyst, a conductive material and a binder.

The conductive material may be any material that can improve the electrical conductivity of the cathode catalyst layer 11, but is preferably carbon. This carbon is the same as the carbon described and exemplified above as one of the aforementioned other components.

The conductive material may be used in combination with a conductive polymer such as a polypyrrole or polyaniline.

The binder is a material that bonds the cathode catalyst and the conductive material and the like to the cathode current collector 12, and examples include materials that are not soluble in the electrolyte solution used as the electrolyte 15. Fluororesins such as polytetrafluoroethylene (PTFE), tetrafluoroethylene-perfluoroalkyl vinyl ether copolymers, tetrafluoroethylene-hexafluoropropylene copolymers, tetrafluoroethylene-ethylene copolymers, polyvinylidene fluoride, polychlorotrifluoroethylene, and chlorotrifluoroethylene-ethylene copolymers are preferable.

There are no limitations on the amounts of the cathode catalyst, the conductive material and the binder in the cathode catalyst layer 11. In terms of further improving the catalytic activity of the cathode catalyst, the blend amount of the conductive material is preferably 0.5 to 30 parts by weight, more preferably 1 to 20 parts by weight, and particularly preferably 1 to 15 parts by weight, per 1 part by weight of the cathode catalyst, whereas the blend amount of the binder is preferably 0.1 to 10 parts by weight, more preferably 0.5 to 5 parts by weight, and particularly preferably 0.5 to 3 parts by weight, per 1 part by weight of the cathode catalyst.

In the cathode catalyst layer 11, each of the structural components of the cathode catalyst, the conductive material, and the binder and the like may use either a single material or a combination of two or more materials.

The material of the cathode current collector 12 may be any conductive material. Examples of preferred materials for the cathode current collector 12 include a metal mesh, metal sintered compact, carbon paper and carbon cloth.

Examples of the metal in the aforementioned metal mesh and metal sintered compact include simple metals such as nickel, chromium, iron and titanium, and alloys containing two or more of these metals, and nickel or a stainless steel (iron-nickel-chromium alloy) is preferable.

The anode active material in the anode active material layer 13 is preferably zinc, iron, aluminum, magnesium, lithium, lithium ions or hydrogen, is more preferably zinc, iron or hydrogen, and is most preferably zinc.

Examples of anodes containing zinc, iron, aluminum, magnesium or lithium as the active material include the anodes used in conventional zinc-air cells, iron-air cells, aluminum-air cells, magnesium-air cells and lithium-air cells. Further, an example of an anode containing hydrogen as the active material is an anode formed from a hydrogen storage alloy or the like that can release stored hydrogen.

In the anode active material layer 13, the structural components of the anode active material and the like may use either a single material or a combination of two or more materials.

The anode current collector 14 may be the same material as the cathode current collector 12.

The electrolyte 15 is preferably used in the form of an electrolyte solution prepared by dissolution in an aqueous solvent or a non-aqueous solvent.

The electrolyte for an aqueous solvent is preferably sodium hydroxide, potassium hydroxide or ammonium chloride. In this case, the concentration of the electrolyte in the electrolyte solution is preferably 1 to 99% by weight, more preferably 5 to 60% by weight, and particularly preferably 5 to 40% by weight.

The container houses the cathode catalyst layer 11, the cathode current collector 12, the anode active material layer 13, the anode current collector 14 and the electrolyte 15. Examples of the material of the container include resins such as polystyrene, polyethylene, polypropylene, polyvinyl chloride and ABS resin, and metals that do not react with the contents such as the cathode catalyst layer 11.

In the air secondary cell 1, a separate oxygen diffusion film may also be provided. The oxygen diffusion film is preferably provided on the outside of the cathode current collector 12 (on the opposite side to the cathode catalyst layer 11). By employing this structure, oxygen (air) is supplied preferentially to the cathode catalyst layer 11 via the oxygen diffusion film.

The oxygen diffusion film may be any film capable of favorably transmitting oxygen (air), and examples include a nonwoven fabric or porous film made of resin, wherein examples of the resin include polyolefins such as polyethylene and polypropylene, and fluororesins such as polytetrafluoroethylene and polyvinylidene fluoride.

In the air secondary cell 1, in order to prevent short-circuits caused by contact between the cathode and the anode, a separator may be provided therebetween.

The separator may be formed from any insulating material that enables movement of the electrolyte 15 therethrough, and examples include a nonwoven fabric or porous film made of resin, wherein examples of the resin include polyolefins such as polyethylene and polypropylene, and fluororesins such as polytetrafluoroethylene and polyvinylidene fluoride. Further, when the electrolyte 15 is used in the form of an aqueous solution, the use of a hydrophilically treated material as the resin is preferable.

The air secondary cell of the present embodiment is useful, for example, as an electric power source for electric vehicles, a domestic electric power source, or a compact electric power source for use in mobile equipment such as cellular telephones and portable personal computers.

### EXAMPLES

The present invention is described below in further detail using specific examples. However, the present invention is in no way limited by the examples illustrated below.

The compounds used in the examples were as follows. Further, in the following description, the units “M” used for concentration represent “mol/L”.

Propionic acid: manufactured by Wako Pure Chemical Industries, Ltd., anhydrous methanol and anhydrous dichloromethane: manufactured by Wako Pure Chemical Industries, Ltd., cobalt acetate tetrahydrate: manufactured by Sigma-Aldrich Co. LLC., silica gel (Wakogel C300): manufactured by Wako Pure Chemical Industries, Ltd.

### Level 1

### Synthesis of Polynuclear Metal Complexes

### Synthesis Example 1

A ligand compound (C) was synthesized via a compound (A) and a compound (B), in accordance with reaction equations (200) to (202) shown below. Then, using the ligand compound (C) and a metal-imparting agent, a polynuclear metal complex (D) was synthesized in accordance with reaction equation (203) shown below.

### (Synthesis of Compound (A))

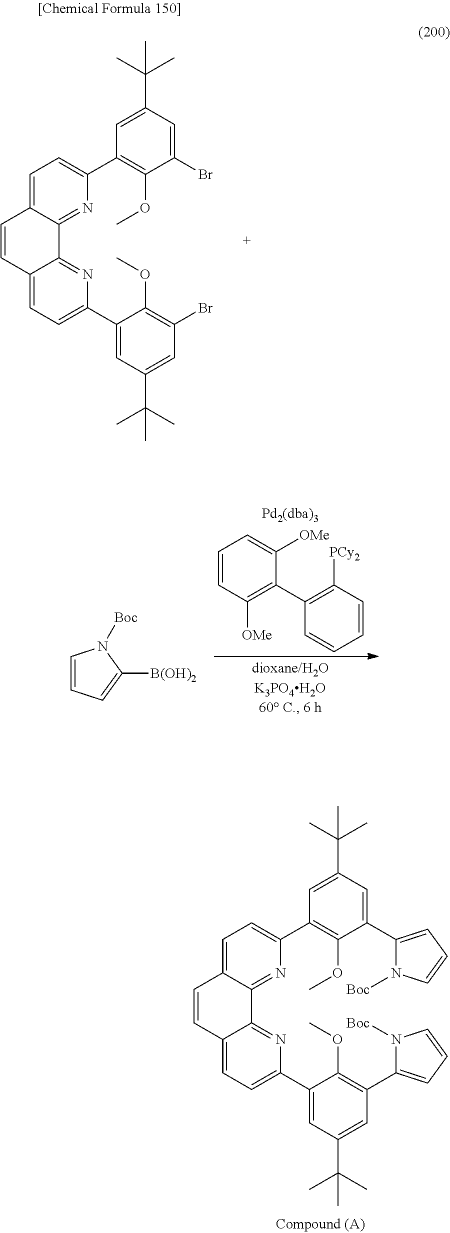

In the equation, Boc represents a tert-butoxycarbonyl group, and dba represents dibenzylideneacetone.

Following replacement of the atmosphere inside a reaction container with an argon gas atmosphere, 3.945 g of 2,9-(3′-bromo-5′-tert-butyl-2′-methoxyphenyl)-1,10-phenanthroline (synthesized in accordance with the method disclosed in Tetrahedron, 1999, 55, 8377), 3.165 g of 1-N-Boc-pyrrole-2-boronic acid, 0.138 g of tris(benzylideneacetone)dipalladium, 0.247 g of 2-dicyclohexylphosphino-2′,6′-dimethoxybiphenyl and 5.527 g of potassium phosphate were added to and dissolved in a mixed solvent containing 200 mL of dioxane and 20 mL of water, and the resulting solution was then stirred at 60° C. for 6 hours. Following completion of the reaction, the solution was allowed to cool by standing, distilled water and chloroform were added, and the organic layer was extracted. The thus obtained organic layer was concentrated, and a black residue was obtained. This residue was purified using a silica gel column to obtain the compound (A). Identification data for the obtained compound (A) are shown below.

¹H-NMR (300 MHz, CDCl₃): δ (ppm)=1.34 (s, 18H), 1.37 (s, 18H), 3.30 (s, 6H), 6.21 (m, 2H), 6.27 (m, 2H), 7.37 (m, 2H), 7.41 (s, 2H), 7.82 (s, 2H), 8.00 (s, 2H), 8.19 (d, J=8.6 Hz, 2H), 8.27 (d, J=8.6 Hz, 2H).

### (Synthesis of Compound (B))

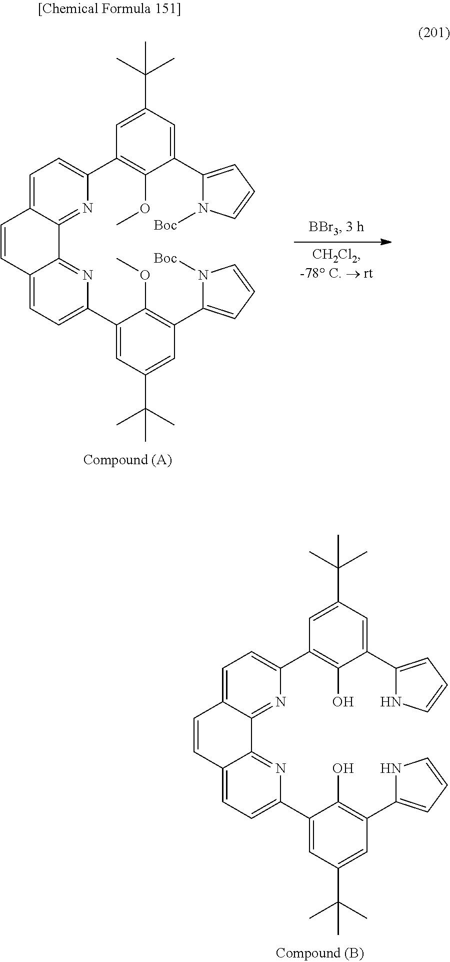

In the equation, Boc represents a tert-butoxycarbonyl group.

Following replacement of the atmosphere inside a reaction container with a nitrogen gas atmosphere, 0.904 g of the compound (A) was dissolved in 10 mL of anhydrous dichloromethane. Next, with the obtained dichloromethane solution cooled to −78° C., 8.8 mL of boron tribromide (1.0 M dichloromethane solution) was added dropwise slowly to the solution. Following completion of the dropwise addition, the reaction mixture was stirred for 10 minutes, and was then stirred continuously while the temperature was allowed to return to room temperature. After 3 hours, the reaction liquid was cooled to 0° C., a saturated aqueous solution of sodium bicarbonate was added, chloroform was added, and the organic layer was extracted and concentrated. The thus obtained brown residue was purified using a silica gel column to obtain the compound (B). Identification data for the obtained compound (B) are shown below.

¹H-NMR (300 MHz, CDCl₃): δ (ppm)=1.40 (s, 18H), 6.25 (m, 2H), 6.44 (m, 2H), 6.74 (m, 2H), 7.84 (s, 2H), 7.89 (s, 2H), 7.92 (s, 2H), 8.35 (d, J=8.4 Hz, 2H), 8.46 (d, J=8.4 Hz, 2H), 10.61 (s, 2H), 15.88 (s, 2H).

### (Synthesis of Ligand Compound (C))

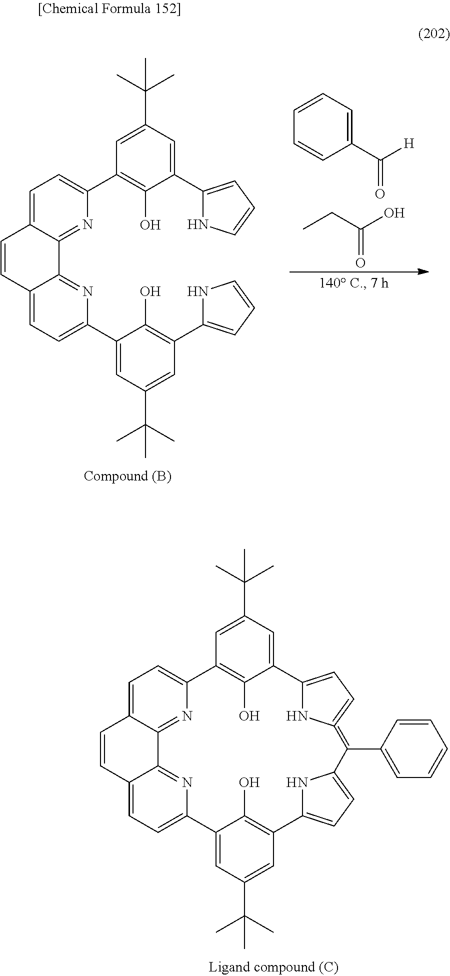

In a reaction container, 0.061 g of the compound (B) and 0.012 g of benzaldehyde were dissolved in 5 mL of propionic acid, and the resulting solution was heated at 140° C. for 7 hours. Subsequently, the propionic acid was removed by distillation from the obtained reaction solution, and the resulting black residue was purified using a silica gel column to obtain the ligand compound (C). Identification data for the obtained ligand compound (C) are shown below.

¹H-NMR (300 MHz, CDCl₃): δ (ppm)=1.49 (s, 18H), 6.69 (d, J=4.8 Hz, 2H), 7.01 (d, J=4.8 Hz, 2H), 7.57 (m, 5H), 7.90 (s, 4H), 8.02 (s, 2H), 8.31 (d, J=8.1 Hz, 2H), 8.47 (d, J=8.1 Hz, 2H).

### (Synthesis of Polynuclear Metal Complex (D))

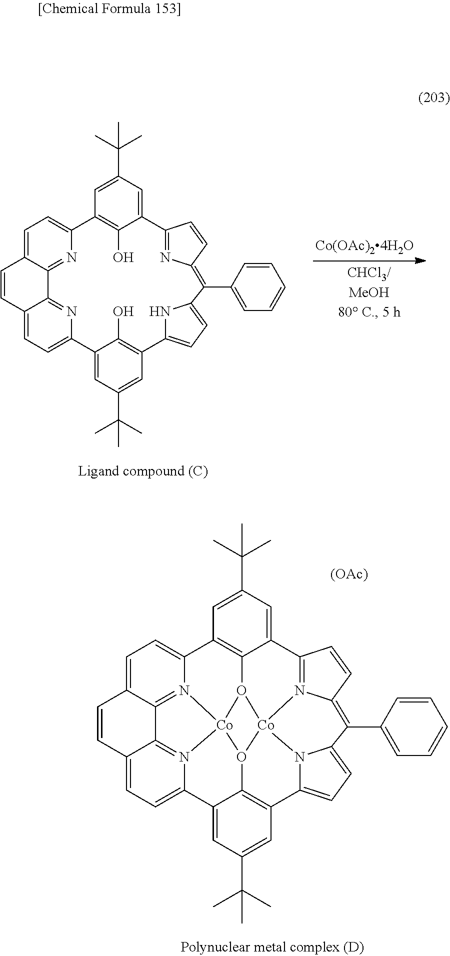

In the equation, Ac represents an acetyl group and Me represents a methyl group.

Following replacement of the atmosphere inside a reaction container with a nitrogen gas atmosphere, 0.045 g of the ligand compound (C) and a mixed solution of 3 mL of methanol and 3 mL of chloroform containing 0.040 g of cobalt acetate tetrahydrate were mixed, and then stirred for 5 hours while heating at 80° C. The thus obtained solution was concentrated to dryness, yielding a blue solid. By washing this solid in water, the polynuclear metal complex (D) was obtained. In the polynuclear metal complex (D) within the above reaction equation, “OAc” indicates the existence of 1 equivalent of acetate ion as a counter ion. Identification data for the obtained polynuclear metal complex (D) are shown below.

ESI-MS [M+.]: m/z=866.0

### Synthesis Example 2

A polynuclear metal complex (E) was synthesized in accordance with reaction equation (204) shown below.

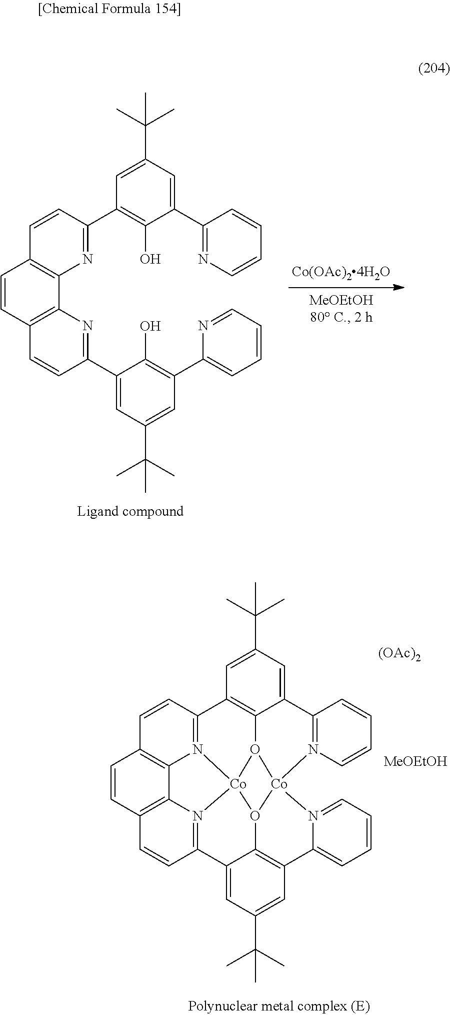

In the equation, Ac represents an acetyl group and MeOEOH represents 2-methoxyethanol.

The ligand compound that functions as a raw material was synthesized in accordance with the method disclosed in Tetrahedron, Vol. 55, p. 8377 (1999).

Subsequently, following replacement of the atmosphere inside a reaction container with a nitrogen gas atmosphere, 200 mL of a 2-methoxyethanol (MeOEtOH) solution containing 1.388 g of the ligand compound and 1.245 g of cobalt acetate tetrahydrate was placed in a 500 mL round-bottom flask and stirred for 2 hours while heating at 80° C. to produce a brown solid. This brown solid was filtered, washed with 20 mL of 2-methoxyethanol, and dried, yielding the polynuclear metal complex (E) (yield: 1.532 g, 74%). In the polynuclear metal complex (E) in the above reaction equation, “(OAc)₂” indicates the existence of 2 equivalents of acetate ions as counter ions, and “MeOEtOH” indicates the existence of a 2-methoxyethanol molecule as a ligand. Identification data for the obtained polynuclear metal complex (E) are shown below.

Elemental analysis (%): C₄₉H₅₀Co₂N₄O₈

(calculated values) C, 62.56; H, 5.36; N, 5.96; Co, 12.53

(measured values) C, 62.12; H, 5.07; N, 6.03; Co, 12.74

### Synthesis Example 3

A ligand compound (H) was synthesized via a compound (F) and a compound (G), in accordance with reaction equations (205) to (207) shown below. Then, using the ligand compound (H) and a metal-imparting agent, a polynuclear metal complex (I) was synthesized in accordance with reaction equation (208) shown below.

### (Synthesis of Compound (F))

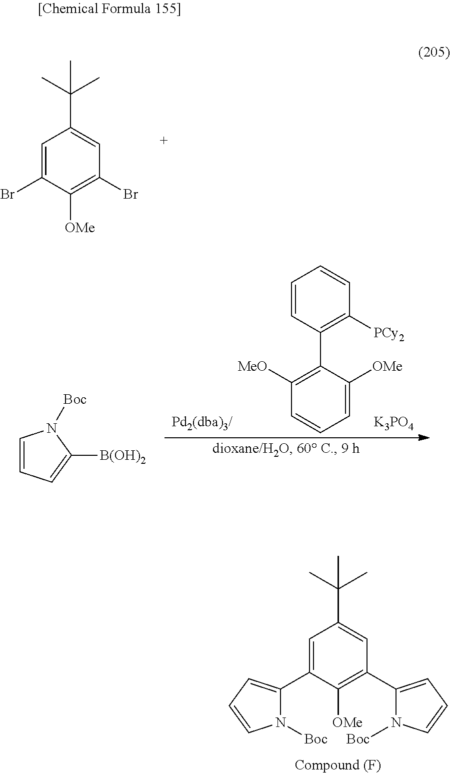

In a reaction container, 0.547 g of 2,6-dibromo-4-tert-butylanisole, 0.844 g of 1-N-Boc-pyrrole-2-boronic acid, 0.138 g of tris(benzylideneacetone)dipalladium, 0.247 g of 2-dicyclohexylphosphino-2′,6′-dimethoxybiphenyl and 5.527 g of potassium phosphate were dissolved in a mixed solvent containing 200 mL of dioxane and 20 mL of water, and the resulting solution was then stirred at 60° C. for 9 hours. Following completion of the reaction, the solution was allowed to cool by standing, distilled water and chloroform were added, and the organic layer was extracted. The thus obtained organic layer was concentrated, and a black residue was obtained. This residue was purified using a silica gel column to obtain the compound (F). Identification data for the obtained compound (F) are shown below.

¹H-NMR (300 MHz, CDCl₃): δ (ppm)=1.30 (s, 18H), 1.31 (s, 9H), 3.19 (s, 3H), 6.19 (m, 2H), 6.25 (m, 2H), 7.22 (s, 2H), 7.38 (m, 2H).

### (Synthesis of Compound (G))

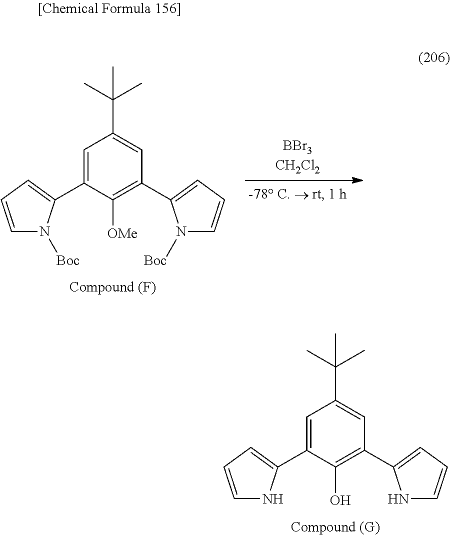 [SMILES: COc1c(-c2cccn2C(=O)OC(C)(C)C)cc(C(C)(C)C)cc1-c1cccn1C(=O)OC(C)(C)C ; CC(C)(C)c1cc(-c2ccc[nH]2)c(O)c(-c2ccc[nH]2)c1]

Following replacement of the atmosphere inside a reaction container with a nitrogen gas atmosphere, 0.453 g of the compound (F) was dissolved in 15 mL of anhydrous dichloromethane. Next, with the obtained dichloromethane solution cooled to −78° C. in a dry ice/acetone bath, 5.4 mL of boron tribromide (1.0 M dichloromethane solution) was added dropwise slowly to the solution. Following completion of the dropwise addition, the reaction mixture was stirred for 10 minutes, and the container was then removed from the dry ice/acetone bath and stirred continuously while the temperature was allowed to return to room temperature. After 1 hour, a saturated aqueous solution of NaHCO₃ was added to perform a neutralization, and the resulting mixture was extracted 3 times into chloroform. The thus obtained organic layer was concentrated, and the resulting black residue was purified using silica gel to obtain the compound (G). Identification data for the obtained compound (G) are shown below.

¹H-NMR (300 MHz, CDCl₃): δ (ppm)=1.34 (s, 9H), 6.35 (m, 2H), 6.40 (s, 1H), 6.55 (m, 2H), 6.93 (m, 2H), 7.36 (s, 2H), 9.15 (s, 2H).

### (Synthesis of Ligand Compound (H))

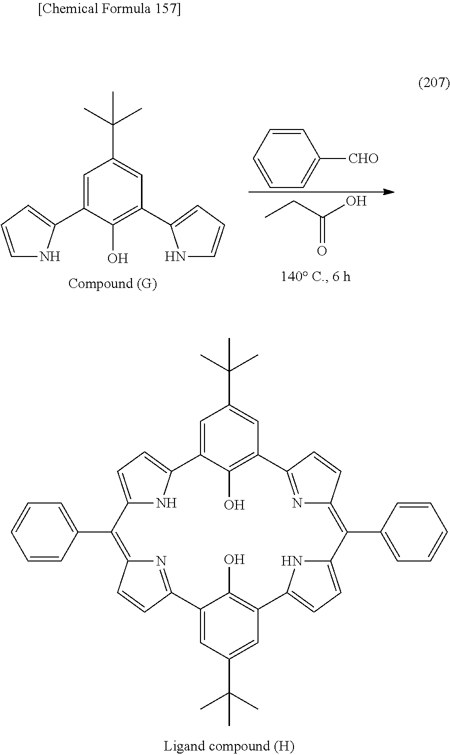

In a reaction container, 0.051 g of the compound (G) and 0.019 g of benzaldehyde were dissolved in 20 mL of propionic acid, and the resulting solution was heated at 140° C. for 7 hours. Subsequently, the propionic acid was removed by distillation, and the resulting black residue was purified using silica gel to obtain the ligand compound (H). Identification data for the obtained ligand compound (H) are shown below.

¹H-NMR (300 MHz, CDCl₃): δ (ppm)=1.38 (s, 18H), 6.58 (d, J=3.8 Hz, 4H), 6.92 (d, J=3.8 Hz, 4H), 7.49 (m, 10H), 7.71 (s, 4H), 12.75 (br, 4H).

### (Synthesis of Polynuclear Metal Complex (I))

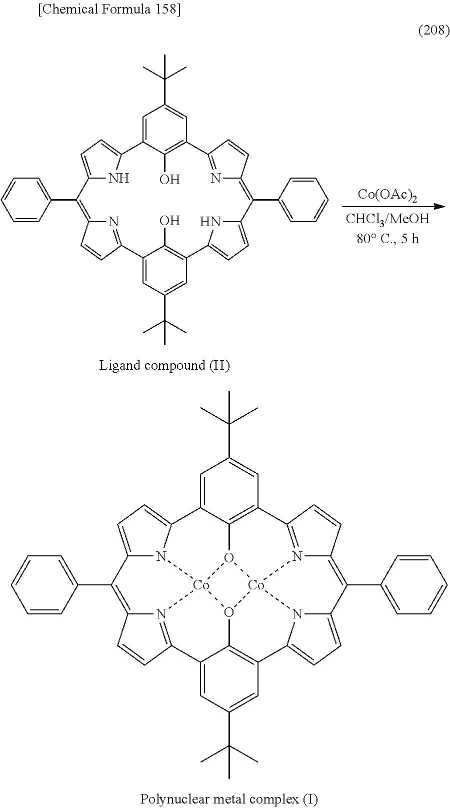

Following replacement of the atmosphere inside a reaction container with a nitrogen gas atmosphere, 0.057 g of the ligand compound (H) and a mixed solution of 4 ml of methanol and 6 ml of chloroform containing 0.047 g of cobalt acetate tetrahydrate were stirred for 5 hours while heating at 80° C. The thus obtained solution was concentrated to dryness, yielding a purple solid. By washing this solid in water, the polynuclear metal complex (I) was obtained. Identification data for the obtained polynuclear metal complex (I) are shown below.

ESI-MS [M.]+: m/z=846.0

### Synthesis Example 4

A ligand compound (K) was synthesized in accordance with reaction equation (209) shown below. Then, using the ligand compound (K) and a metal-imparting agent, a polynuclear metal complex (L) was synthesized in accordance with reaction equation (210) shown below.

### (Synthesis of Ligand Compound (K))

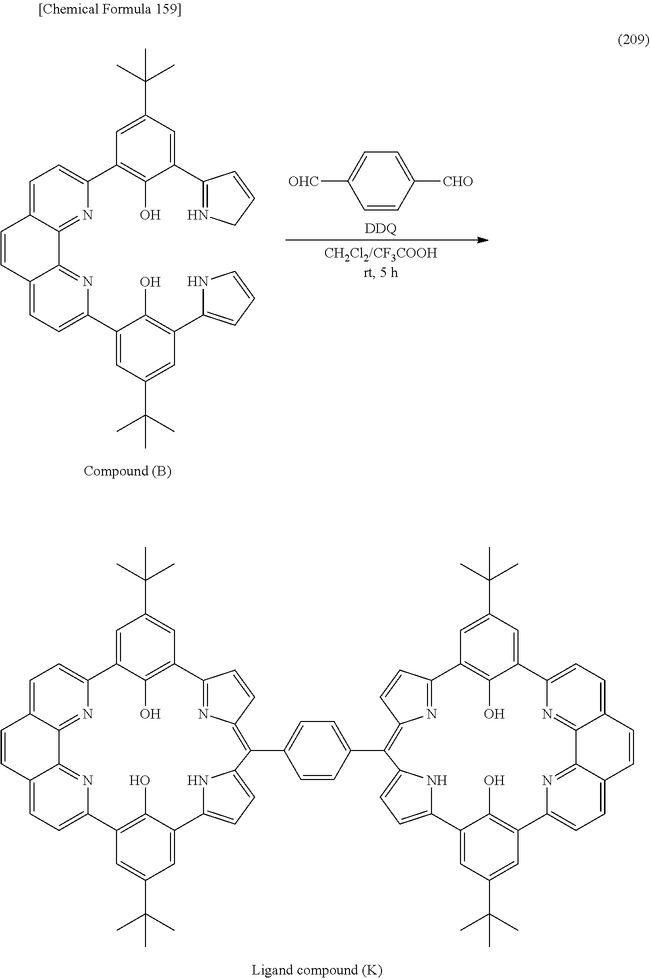

In a reaction container, 0.13 g (1 mmol) of terephthalaldehyde and 1.21 g (2 mmol) of the compound (B) were dissolved in 300 ml of dichloromethane, and 0.2 ml of trifluoroacetic acid was added. Following stirring at room temperature for 20 hours, 0.49 g (2 mmol) of chloranil was added, and stirring was continued at room temperature for a further 28 hours. The thus obtained insoluble matter was collected by filtration and washed with 100 ml of chloroform, the resulting residue was suspended in 300 ml of methanol, and the thus obtained insoluble matter was collected by filtration to obtain 1.23 g of a crude product. This crude product was dissolved in 400 ml of dimethylformamide and filtered through a membrane filter, and the solvent was then removed by distillation under reduced pressure using a vacuum pump. The obtained residue was added to 500 ml of methanol, and following dispersion using ultrasonic waves, the insoluble matter was collected by filtration to obtain the ligand compound (K). Identification data for the obtained ligand compound (K) are shown below.

MS (FD) measured value (m/z): 1307, theoretical value: 1307.

### (Synthesis of Polynuclear Metal Complex (L))

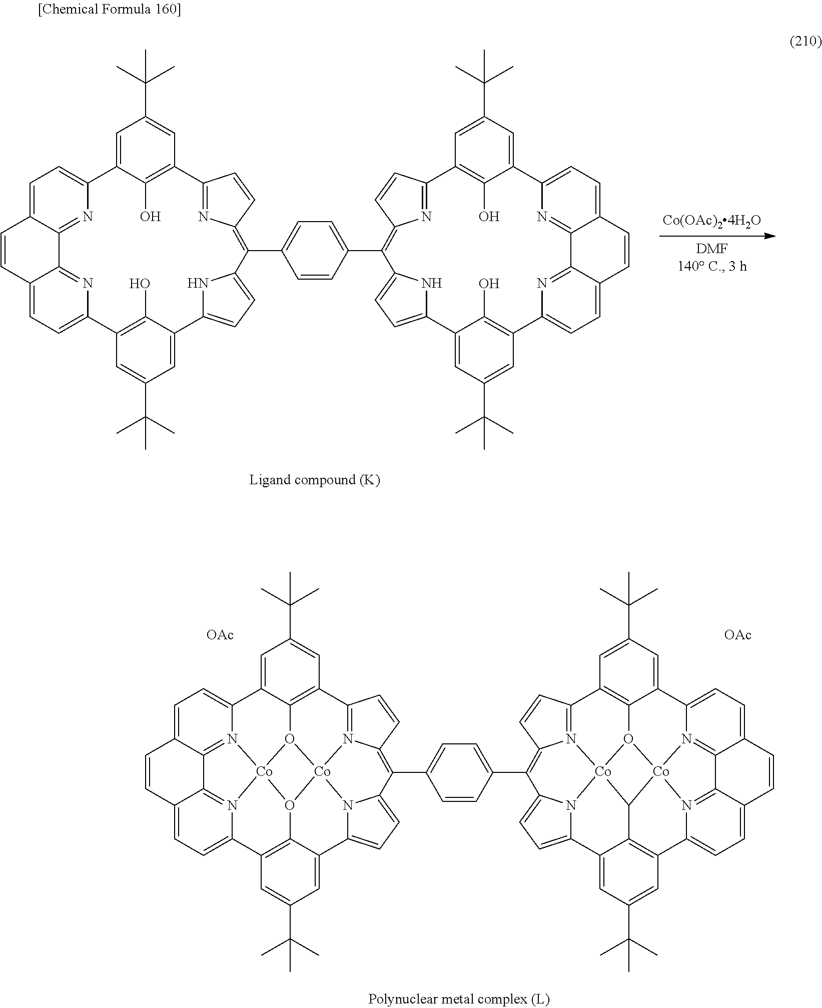

Following replacement of the atmosphere inside a reaction container with a nitrogen gas atmosphere, 0.040 g of the ligand compound (K) and 20 mL of a dimethylformamide solution containing 0.040 g of cobalt acetate tetrahydrate were stirred for 3 hours while heating at 140° C. The thus obtained solution was concentrated to dryness, yielding a blue solid. By washing this solid in water, the polynuclear metal complex (L) was obtained.

### Synthesis Example 5

A phenol compound (M) and a diamine were stirred for 3 hours at 60° C. in a chloroform/ethanol mixed solution containing cobalt acetate tetrahydrate, thus synthesizing a polynuclear metal complex (N) in accordance with reaction equation (211) shown below. The phenol compound (M) that functions as a raw material was synthesized on the basis of the method disclosed in Tetrahedron, 1999, 55, 8377.

### (Synthesis of Polynuclear Metal Complex (N))

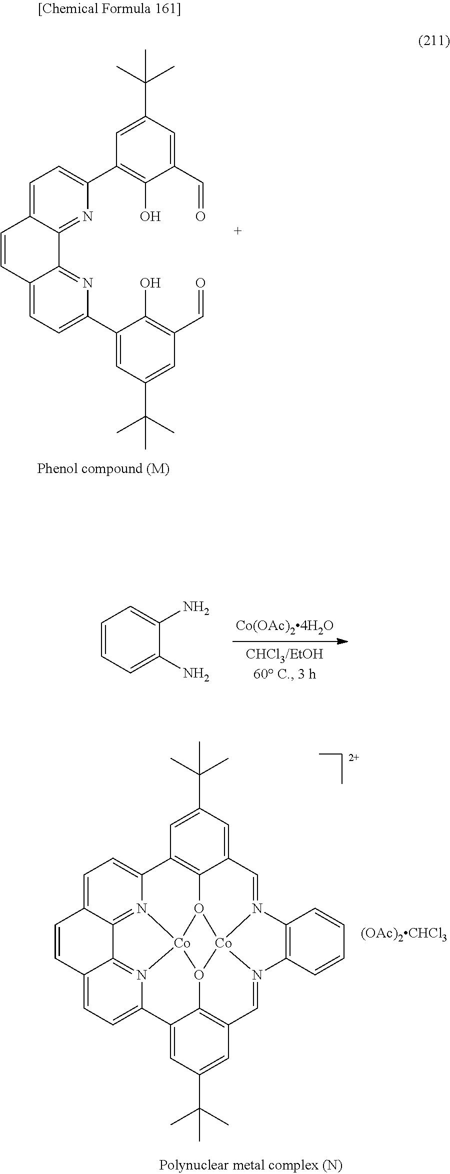

Following replacement of the atmosphere inside a reaction container with a nitrogen gas atmosphere, a mixed solution of 5 ml of chloroform and 5 ml of ethanol containing 0.199 g of cobalt acetate tetrahydrate and 0.213 g of the phenol compound (M) was placed in a 50 mL round-bottom flask and stirred at 60° C. To this solution was gradually added 5 ml of an ethanol solution containing 0.043 g of o-phenylenediamine. Refluxing the resulting mixture for 3 hours produced a brownish red precipitate. This precipitate was collected by filtration and dried to obtain the polynuclear metal complex (N) (yield: 0.109 g, 28%). Identification data for the obtained polynuclear metal complex (N) are shown below.

Elemental analysis (%): C₄₅H₄₁Cl₃Co₂N₄O₆

(calculated values) C, 56.41; H, 4.31; N, 5.85.

(measured values) C, 58.28; H, 4.81; N, 5.85.

ESI-MS [M-CH₃COO]⁺: 779.0

### Synthesis Example 6

By refluxing and stirring a phenol compound and a diamine in an ethanol solution containing cobalt chloride hexahydrate for 2 hours, a polynuclear metal complex (O) was synthesized in accordance with reaction equation (212) shown below.

### (Synthesis of Polynuclear Metal Complex (O))

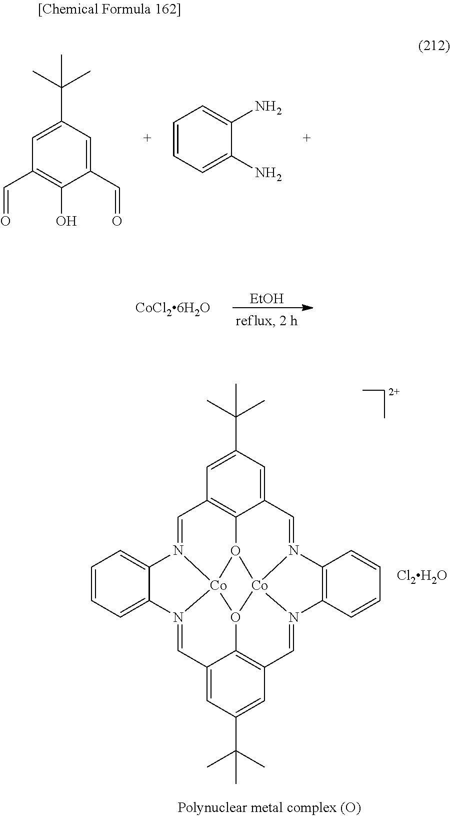

Following replacement of the atmosphere inside a reaction container with a nitrogen gas atmosphere, 10 ml of an ethanol solution containing 0.476 g of cobalt chloride hexahydrate and 0.412 g of 4-tert-butyl-2,6-diformylphenol was placed in a 50 mL round-bottom flask and stirred at room temperature. To this solution was gradually added 5 ml of an ethanol solution containing 0.216 g of o-phenylenediamine. Refluxing the resulting mixture for 2 hours produced a brownish red precipitate. This precipitate was collected by filtration and dried to obtain the polynuclear metal complex (O) (yield: 0.465 g, 63%). Identification data for the obtained polynuclear metal complex (O) are shown below.

Elemental analysis (%): C₃₆H₃₈Cl₂CO₂N₄O₄

(calculated values) C, 55.47; H, 4.91; N, 7.19.

(measured values) C, 56.34; H, 4.83; N, 7.23.

### <Production of Cathode Catalysts for Air Secondary Cells>

### Example 1

### Production of Cathode Catalyst (1)

A cathode catalyst (1) was produced by supporting the polynuclear metal complex (D) on carbon. Specifically, 2 mg of the polynuclear metal complex (D) and 8 mg of carbon (product name: Ketchen Black EC600JD, manufactured by Lion Corporation) were mixed together in methanol, and following irradiation with ultrasonic waves for 15 minutes, the solvent was removed by distillation using an evaporator, and the product was dried overnight under reduced pressure of 200 Pa, yielding the cathode catalyst (1).

### Example 2

### Production of Cathode Catalyst (2)

The polynuclear metal complex (E) and carbon (product name: Ketchen Black EC600JD, manufactured by Lion Corporation) were mixed in a weight ratio of 1:4, and following stirring in ethanol at room temperature for 15 minutes, the mixture was dried at room temperature and under a reduced pressure of 200 Pa for 12 hours. By heating the obtained composition at 800° C. for 2 hours under a nitrogen stream of 200 mL/minute using a tubular furnace having a furnace tube made of quartz, a cathode catalyst (2) (heat treated product) was obtained.

### Examples 3 to 7

### Production of Cathode Catalysts (3) to (7)

The same operations as Example 1 were performed using the polynuclear metal complex (E), the polynuclear metal complex (I), the polynuclear metal complex (L), the polynuclear metal complex (N) and the polynuclear metal complex (O) to obtain a cathode catalyst (3), a cathode catalyst (4), a cathode catalyst (5), a cathode catalyst (6) and a cathode catalyst (7) respectively.

### Comparative Example 1

### Production of Cathode Catalyst (R1)

Manganese dioxide (manufactured by Sigma-Aldrich Co. LLC., production code: 203750) and carbon (product name: Ketchen Black EC600JD, manufactured by Lion Corporation) were mixed in a weight ratio of 1:4, and following stirring in ethanol at room temperature for 15 minutes, the mixture was dried at room temperature and under a reduced pressure of 200 Pa for 12 hours to obtain a cathode catalyst (R1).

### <Evaluation of Cathode Catalysts for Air Secondary Cells>

### (Evaluation of Oxygen Reduction Activity)

The cathode catalysts obtained above (cathode catalysts (1) to (7) and (R1)) were evaluated for oxygen reduction activity using a rotating disk electrode. Specifically, evaluation was performed as follows.

For the electrode, a disk electrode in which the disk portion was glassy carbon (diameter: 6.0 mm) was used.

To a sample bottle containing 1 mg of the cathode catalyst was added 1 mL of a 0.5% by weight solution of Nafion (registered trademark) (a solution prepared by diluting a 5% by weight solution of Nafion (registered trademark) 10-fold with ethanol), and the sample was dispersed by irradiation with ultrasonic waves for 15 minutes. Subsequently, 7.2 μL of the thus obtained suspension was dripped onto the disk portion of the electrode described above and dried, and was then dried for 3 hours in a dryer heated to 80° C. to obtain a measurement electrode.

Using this measurement electrode, the electric current value of the oxygen reduction reaction was measured using the measurement apparatus and measurement conditions described below. Measurement of the electric current value was conducted in a state saturated with nitrogen gas (under a nitrogen gas atmosphere) and in a state saturated with oxygen gas (under an oxygen gas atmosphere), and the value obtained by subtracting the electric current value obtained for the measurement under the nitrogen gas atmosphere from the electric current value obtained for the measurement under the oxygen gas atmosphere was recorded as the electric current value of the oxygen reduction reaction. The current density was determined by dividing this electric current value by the surface area of the measurement electrode. The results are shown in Table 1.

The current density is the value relative to a silver/silver chloride electrode when the voltage was −0.8 V.

### (Measurement Apparatus)

RRDE-1 Rotating Ring/Disk Electrode System manufactured by Nikko Keisoku

ALS model 701C dual electrochemical analyzer

### (Measurement Conditions)

Cell solution: 0.1 mol/L aqueous solution of potassium hydroxide (oxygen saturation or nitrogen saturation)

Solution temperature: 25° C.

Reference electrode: silver/silver chloride electrode (saturated potassium chloride)

Counter electrode: platinum wire

Sweep rate: 10 mV/second

Electrode rotational rate: 1600 rpm

### (Evaluation of Water Oxidation Activity)

For each of the cathode catalysts obtained above (cathode catalysts (1) to (7) and (R1)), a measurement electrode was fabricated in the same manner as that described for the evaluation of the oxygen reduction activity, and this measurement electrode was used to measure the electric current value of the water oxidation reaction using the measurement apparatus and measurement conditions described below. Measurement of the electric current value was conducted in a state saturated with nitrogen gas, and the current density was determined by dividing this electric current value by the surface area of the measurement electrode. The results are shown in Table 1. The current density is the value relative to a silver/silver chloride electrode when the voltage was 1 V.

### (Measurement Apparatus)

RRDE-1 Rotating Ring/Disk Electrode System manufactured by Nikko Keisoku

ALS model 701C dual electrochemical analyzer

### (Measurement Conditions)

Cell solution: 1 mol/L aqueous solution of sodium hydroxide (nitrogen saturation)

Solution temperature: 25° C.

Reference electrode: silver/silver chloride electrode (saturated potassium chloride)

Counter electrode: platinum wire

Sweep rate: 10 mV/second

Electrode rotational rate: 900 rpm

### (Catalytic Activity Evaluation Results)

TABLE 1

| | | | Current density | |
|---|---|---|---|---|
| | | | (mA/cm²) | |
| | | | Oxygen | Water |
| | | | reduction | oxidation |
| | Cathode catalyst | | activity | activity |
| Example 1 | Cathode | Polynuclear metal | 5.1 | 106 |
| | catalyst (1) | complex (D)/carbon | | |
| | | (1/4 weight ratio) | | |
| Example 2 | Cathode | Polynuclear metal | 4.4 | 84 |
| | catalyst (2) | complex (E)/carbon | | |
| | | (1/4 weight ratio), | | |
| | | heat treated product | | |
| Example 3 | Cathode | Polynuclear metal | 4.0 | 51 |
| | catalyst (3) | complex (E)/carbon | | |
| | | (1/4 weight ratio) | | |
| Example 4 | Cathode | Polynuclear metal | 4.6 | 103 |
| | catalyst (4) | complex (I)/carbon | | |
| | | (1/4 weight ratio) | | |
| Example 5 | Cathode | Polynuclear metal | 5.1 | 79 |
| | catalyst (5) | complex (L)/carbon | | |
| | | (1/4 weight ratio) | | |
| Example 6 | Cathode | Polynuclear metal | 5.0 | 72 |
| | catalyst (6) | complex (N)/carbon | | |
| | | (1/4 weight ratio) | | |
| Example 7 | Cathode | Polynuclear metal | 4.7 | 70 |
| | catalyst (7) | complex (O)/carbon | | |
| | | (1/4 weight ratio) | | |
| Comparative | Cathode | Manganese dioxide/ | 2.9 | 24 |
| Example 1 | catalyst (R1) | carbon (1/4 weight | | |
| | | ratio) | | |

As is evident from Table 1, the cathode catalysts (1) to (7) of the present invention were markedly superior to the cathode catalyst (R1) in both oxygen reduction activity and water oxidation activity.

### Production of Air Secondary Cells

### Example 8

### Production of Air Secondary Cell Cathode (1)

In an agate mortar, the polynuclear metal complex (D) as a cathode catalyst (1 part by weight), Acetylene Black (manufactured by Denki Kagaku Kogyo Kabushiki Kaisha) as a conductive material (10 parts by weight), a PTFE powder (manufactured by Daikin Industries, Ltd.) as a binder (1 part by weight), and ethanol as a dispersion solvent (5 drops from a pipette) were mixed together and then used to form a thin film, thus obtaining a cathode catalyst layer (1).

Subsequently, the obtained cathode catalyst layer (1) was sandwiched from both sides with a water repellent PTFE sheet and a stainless steel mesh, and crimping was then performed using a press machine to obtain an air secondary cell cathode (1).

### (Production of Anode (1))

A hydrogen storage alloy that functions as an anode was extracted using the following method. An AA rechargeable nickel hydride cell (Eneloop (registered trademark), manufactured by Sanyo Electric Co., Ltd., HR-3UTGA) was connected to a charge-discharge tester (manufactured by Toyo System Co., Ltd., product name: TOSCAT-3000U), and was charged until the cell voltage reached 1.0 V. The nickel hydride cell was then disassembled, and the hydrogen storage alloy was extracted.

The hydrogen storage alloy was sandwiched between porous metal bodies (Celmet #8, manufactured by Toyama Sumitomo Electric Industries, Ltd.) and then pressed with a press machine, thus obtaining an anode (1).

### (Production of Air Secondary Cell (1))

Following installation of the air secondary cell cathode (1) and the anode (1) obtained above in a container, an 8.0 M aqueous solution of potassium hydroxide was injected into the container as the electrolyte, thus obtaining an air secondary cell (1) of the structure illustrated in FIG. 1.

### <Air Secondary Cell Performance Evaluation>

### (Charge-Discharge Cycle Test)

The air secondary cell (1) obtained above was connected to a charge-discharge tester (manufactured by Toyo System Co., Ltd., product name: TOSCAT-3000U), and a charge-discharge cycle test was performed. The charge-discharge cycle was performed by conducting the following steps 1 to 4 in the sequence shown, and this cycle was repeated 10 times. The results of measuring the voltage during this time are illustrated in FIG. 2.

Step 1: Charge for 20 minutes at constant current of 3 mA.

Step 2: Rest for 5 minutes.

Step 3: Discharge at constant current of 3 mA. Move to step 4 when the voltage reaches 0.5 V.

Step 4: Rest for 5 minutes.

As illustrated in FIG. 2, the air secondary cell (1) exhibited satisfactory charge-discharge performance.

### Example 9

### Production of Air Secondary Cell Cathode (2)

In an agate mortar, the cathode catalyst (2) as a cathode catalyst and a conductive material (10 parts by weight), a PTFE powder (manufactured by Daikin Industries, Ltd.) as a binder (1 part by weight), and ethanol as a dispersion solvent (5 drops from a pipette) were mixed together and then used to form a thin film, thus obtaining a cathode catalyst layer (2).

Subsequently, the obtained cathode catalyst layer (2) was sandwiched from both sides with a water repellent PTFE sheet and a stainless steel mesh, and crimping was then performed using a press machine to obtain an air secondary cell cathode (2).

With the exception of replacing the cathode catalyst layer (1) from Example 8 with the cathode catalyst (2), an air secondary cell was fabricated and then evaluated in the same manner as that described for Example 8.

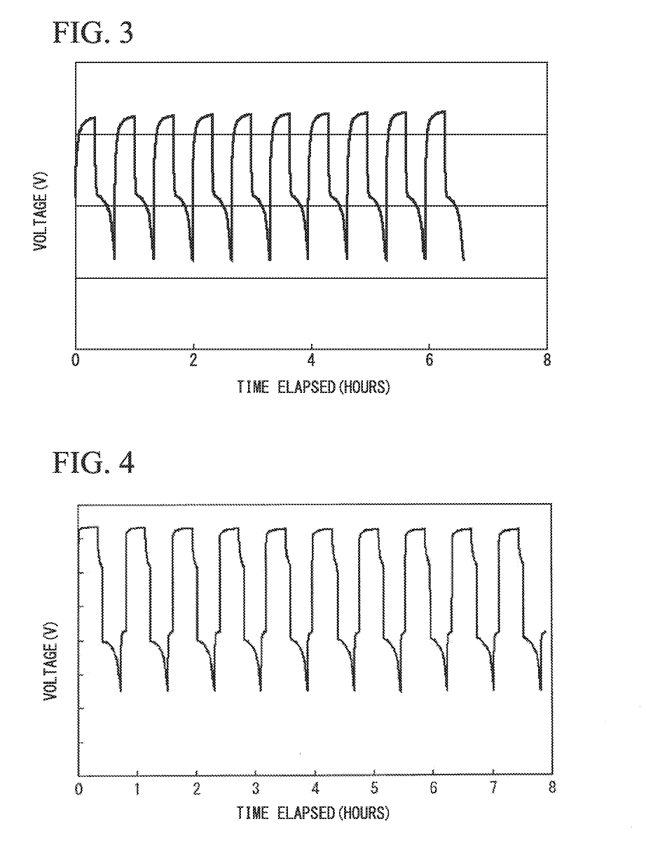

As illustrated in FIG. 3, the air secondary cell (1) exhibited satisfactory charge-discharge performance.

### Level 2

### Synthesis of Polynuclear Metal Complexes

### Synthesis Example 7

A ligand compound 4 was synthesized via a compound 1, a compound 2 and a compound 3, in accordance with reaction equations (300) and (301) shown below. Then, using the ligand compound 4 and a metal-imparting agent, a polynuclear metal complex MC1 was synthesized in accordance with reaction equation (302) shown below.

### (Synthesis of Compound 3)

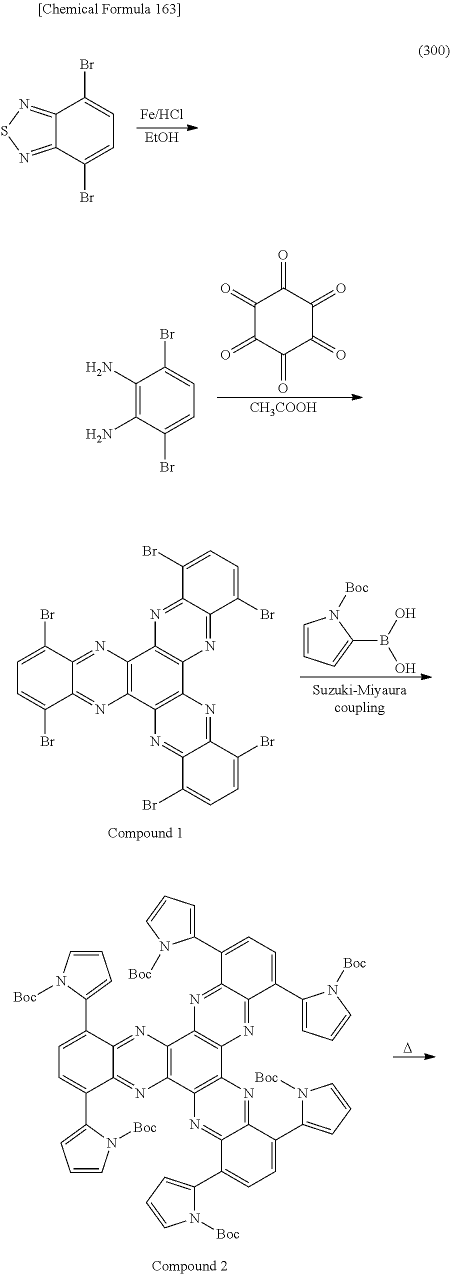

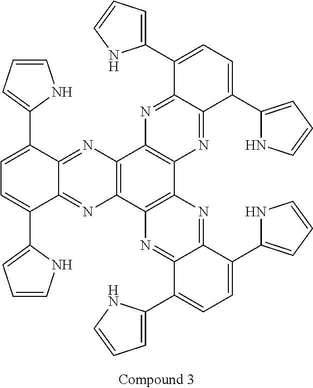 [SMILES: c1c[nH]c(-c2ccc(-c3ccc[nH]3)c3nc4c(nc23)c2nc3c(-c5ccc[nH]5)ccc(-c5ccc[nH]5)c3nc2c2nc3c(-c5ccc[nH]5)ccc(-c5ccc[nH]5)c3nc42)c1]

First, the compound 1 that functions as a raw material was synthesized using the following method.

1,4-dibromo-2,3-diaminobenzene was synthesized in accordance with the method disclosed in the literature (Journal of Organic Chemistry, 2006, 71, 3350). Subsequently, 10 mL of an acetic acid solution containing 0.600 g (2.256 mmol) of 1,4-dibromo-2,3-diaminobenzene was heated to 50° C. in a flask, and the gas inside the flask was then substituted with argon gas over a period of one hour. Following the addition of 0.234 g (0.752 mmol) of hexaketocyclohexane to the thus obtained solution, the mixture was heated at 110° C. for 10 hours. The thus obtained reaction liquid was poured into ice water, and the reaction mixture was then made alkaline by adding an aqueous solution of sodium hydroxide. As a result, a light green product was obtained as a precipitate, and following collection of the precipitate by filtration, the precipitate was washed sequentially with water and dichloromethane, yielding 0.499 g of the compound 1.

In order to obtain the quantity required for the next step, the above operation was repeated a number of times. Identification data for the obtained compound 1 are shown below.

MS (FD, 8 kV) measured values (m/z): 857.5 (M⁺), 429.7 (M²⁺), theoretical value: 857.57 (M⁺)

MS (Maldi-T of, TCNQ): m/z 858 (M⁺)

Next, the compound 1 obtained above was used to synthesize the compound 2.

In a flask, 4.516 g (21.4 mmol) of 1-N-Boc-pyrrole-2-boronic acid, 0.048 g of Aliquat 336 (registered trademark, product name) and 14.88 g (0.107 mol) of potassium carbonate were added to a mixed solution of 100 mL of THF and 40 mL of toluene containing 1.835 g (2.140 mmol) of the compound 1, and the gas inside the flask was then substituted with argon gas over a period of one hour.

To the thus obtained reaction liquid was added 0.890 g (0.771 mmol) of tetrakis(triphenylphosphine)palladium (0), and following subsequent heating at 95° C. for 72 hours, 12 mL of deaerated water was added, and heating was continued for a further 2 days, thus obtaining a crude product. This crude product was purified using a silica gel column (developing solvent: ethyl acetate/dichloromethane/hexane), yielding 2.745 g of the compound 2. Identification data for the obtained compound 2 are shown below.

MS (FD, 8 kV) measured value (m/z): 1374.5, theoretical value: 1374.59

Subsequently, the compound 2 obtained above was heated to remove the protective groups from the pyrrole groups, thus obtaining the compound 3.

By heating 0.340 g of the compound 2 at 180° C. for 30 minutes under a reduced pressure of 20 Pa, the compound 3 was obtained. Identification data for the obtained compound 3 are shown below.

MS (FD, 8 kV) measured values (m/z): 386.6 (M²⁺), 774.0 (M⁺), theoretical values: 387.14 (M²⁺), 774.27 (M⁺),

MS (Maldi-T of, TCNQ): m/z 775 (M⁺), 1549 (2M⁺)

### (Synthesis of Ligand Compound 4)

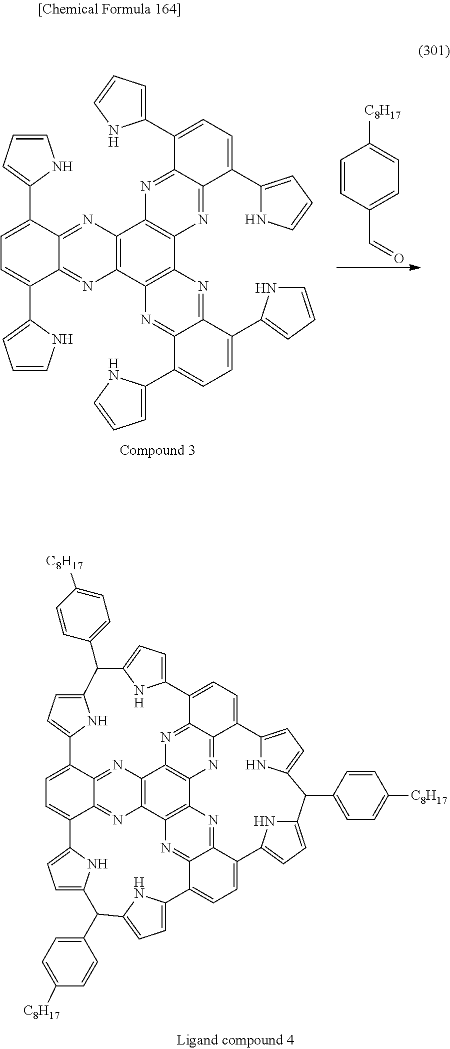

In a flask, 0.207 g (0.267 mmol) of the compound 3 was added to a mixed solution containing 1 mL of trifluoromethanesulfonic acid, 1.5 mL of p-n-octylbenzaldehyde and 3 mL of dichloromethane, and the gas inside the flask was then substituted with argon gas. The thus obtained solution was placed in a microwave reaction apparatus, and reacted at 50 W for 2 hours. Ammonium hydroxide was added to the obtained reaction liquid, the organic layer was washed with water, the obtained organic layer was then evaporated to dryness using an evaporator, and the residue was then washed sequentially with water and hexane, thus obtaining 0.349 g (0.254 mmol) of the ligand compound 4 in a yield of 95%. Identification data for the obtained ligand compound 4 are shown below.

MS (FD, 8 kV) measured value (m/z): 1375.5 (M⁺), theoretical value: 1375.74 (M⁺)

MS (Maldi-T of, TCNQ): m/z 1373 (M⁺), 2746 (2M⁺)

### (Synthesis of Polynuclear Metal Complex MC1)

The polynuclear metal complex MC1 was synthesized in accordance with reaction equation (302) shown below.

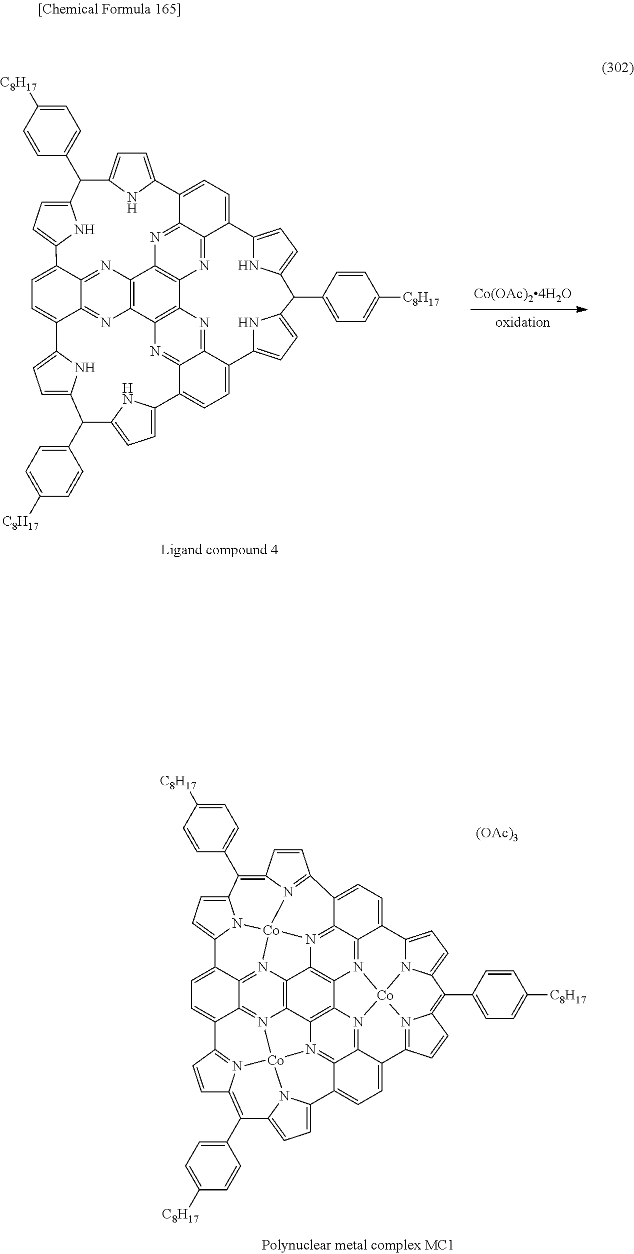

A microwave test tube was charged with 0.125 g (0.091 mmol) of the ligand compound 4 and 0.079 g (0.318 mmol) of cobalt acetate tetrahydrate, 5 mL of N,N′-dimethylformamide (hereinafter sometimes referred to as DMF) was added to the test tube, and a microwave apparatus was used to perform a reaction at 200° C. and an output of 200 W for 2 hours. The thus obtained reaction liquid was poured into 25 mL of ice water, and the generated precipitate was collected by filtration and washed sequentially with water and hexane, yielding the polynuclear metal complex MC1. Identification data for the obtained polynuclear metal complex MC1 are shown below.

MS (Maldi-T of, TCNQ) measured values (m/z): 1543 (M⁺), 1569 (M⁺+CN⁻), 1595 (M⁺+2CN⁻), 1621 (M⁺+3CN⁻), theoretical value: 1543.5 (M⁺)

### Synthesis Example 8

A ligand compound 5 was synthesized in accordance with reaction equation (303) shown below. Then, using the ligand compound 5 and a metal-imparting agent, a polynuclear metal complex MC2 was synthesized in accordance with reaction equation (304) shown below.

### (Synthesis of Ligand Compound 5)

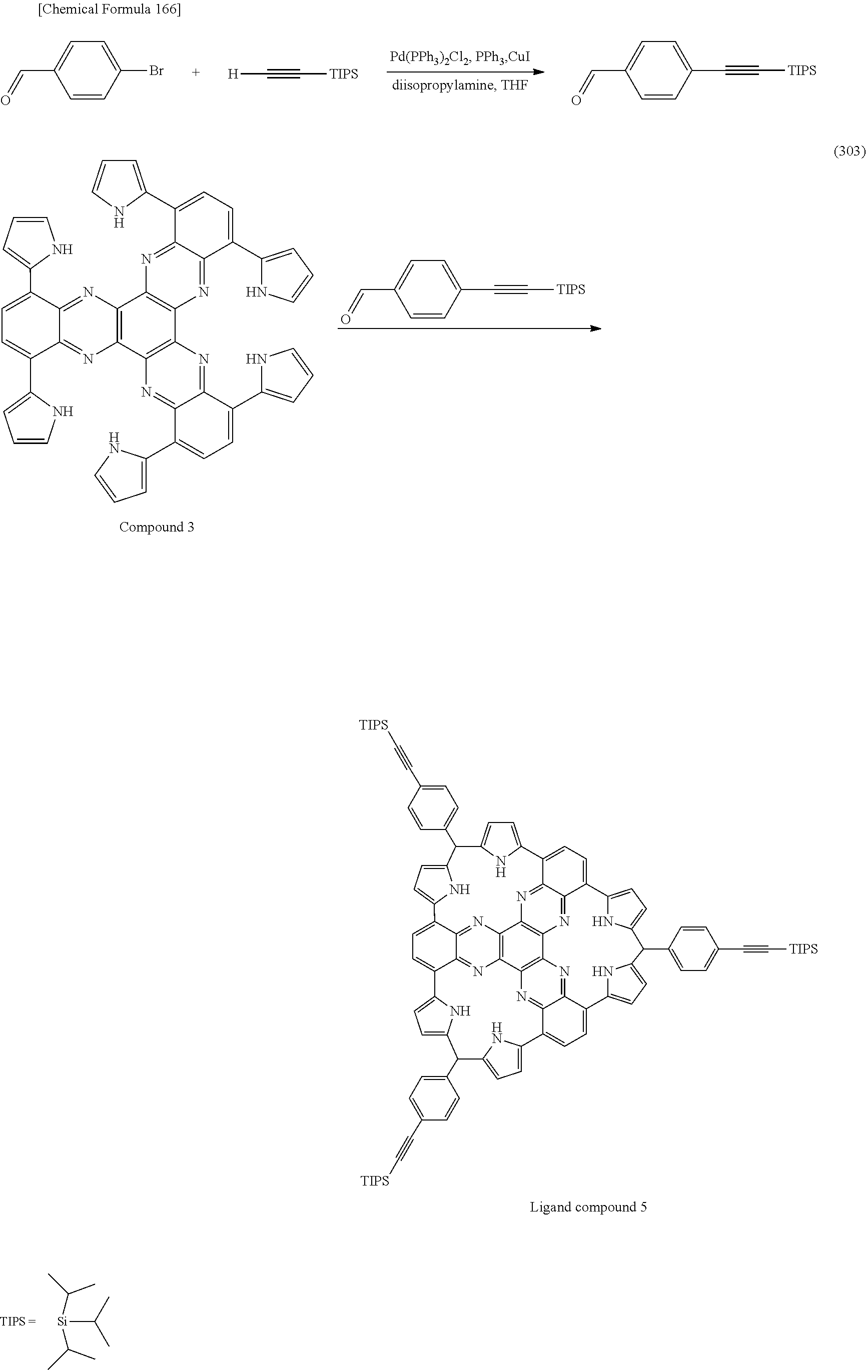

First, the 4-((triisopropyl)ethynyl)benzaldehyde which functions as a raw material was synthesized using the following method.

Following replacement of the atmosphere inside a reaction container with an argon gas atmosphere, 1 g (5.40 mmol) of 4-bromobenzaldehyde, 38 mg (0.054 mmol) of dichlorobis(triphenylphosphine)palladium (II) (represented by Pd(PPh₃)₂Cl₂), 10 mg (0.054 mmol) of copper (I) iodide, and 33 mg (0.129 mmol) of triphenylphosphine (represented by PPh₃) were dissolved in a mixed solution of 4 mL of THF and 16 mL of diisopropylamine. The obtained reaction mixture was stirred at 60° C. for 30 minutes, 1.45 mL (6.49 mmol) of ethynyltriisoproylsilane was then added, and stirring was continued for a further 2 hours. Following removal of the solvent from the resulting reaction liquid using an evaporator, the crude product was purified using a silica gel column (developing solvent: hexane/dichloromethane) to obtain 4-((triisopropyl)ethynyl)benzaldehyde. The weight obtained was 1.3 g, and the yield was 84%. Identification data for the obtained 4-((triisopropyl)ethynyl)benzaldehyde are shown below.

¹H-NMR (CD₂Cl₂, 300 MHz, 25° C.): δ (ppm)=1.14 (s, 21H), 7.64 (d, ³J=8.3 Hz, 2H), 7.81 (d, ³J=8.3 Hz, 2H), 10.00 (s, 1H).

¹³C-NMR (CD₂Cl₂, 75 MHz, 25° C.): δ (ppm)=11.7, 18.8, 95.9, 106.3, 129.7, 129.9, 132.8, 136.1, 191.6.

Next, the ligand compound 5 was synthesized using the following method.

In a flask, 308.0 mg (0.40 mmol) of the compound 3 and 683.3 mg (2.38 mmol) of 4-((triisopropyl)ethynyl)benzaldehyde were dispersed in a mixed solution of 12 mL of dichloromethane and 4 mL of THF, 2 mL of trifluoroacetic acid was then added, and the gas inside the flask was substituted with argon gas. The thus obtained reaction liquid was placed in a microwave test tube, and using a microwave apparatus, a reaction was performed at 85° C. and an output of 50 W for 6 hours. The obtained reaction liquid was concentrated, and methanol was added to the resulting concentrate, yielding the crude product as a precipitate. Subsequently, a Soxhlet extractor using acetone as the solvent was used to purify the obtained crude product, thus yielding the ligand compound 5. The quantity obtained was 234 mg, and the yield was 45%. Identification data for the obtained ligand compound 5 are shown below.

¹H-NMR(C₃D₂F₆O+0.1% C₂DF₃O₂, 500 MHz, 25° C.): δ (ppm)=1.09 (s, 9H), 1.10 (s, 54H), 6.06 (d, 6H, ³J=4.8 Hz), 6.15 (d, 6H, ³J=4.8 Hz), 6.55 (s, 6H), 7.00 (d, 6H, ³J=8.2 Hz), 7.43 (d, 6H, ³J=8.2 Hz).

¹³C-NMR(C₃D₂F₆O+0.1% C₂DF₃O₂, 125 MHz, 25° C.): δ (ppm)=9.2, 15.3, 95.3, 103.5, 127.6, 128.8, 130.0, 131.8, 133.9, 135.2, 143.5, 144.1, 146.9, 149.9.

MS (Maldi-T of) measured value (m/z): 1576.94, theoretical value: 1578.77.

### (Synthesis of Polynuclear Metal Complex MC2)

The polynuclear metal complex MC2 was synthesized in accordance with reaction equation (304) shown below.

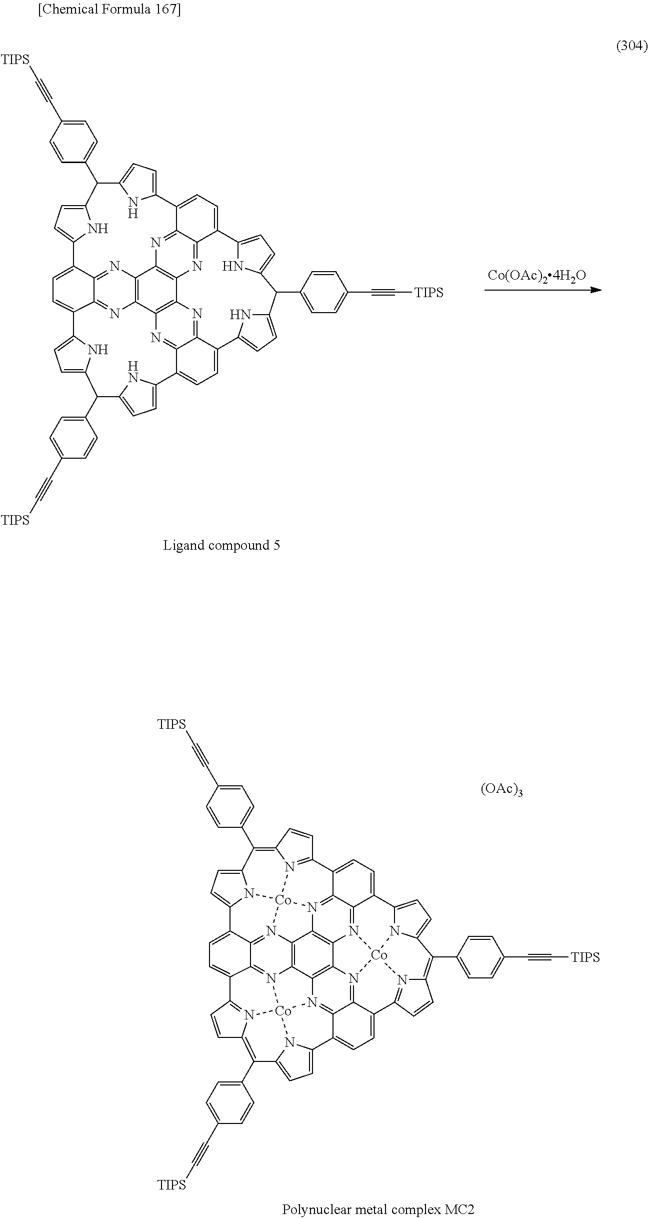

The compound 5, and 3 equivalents of cobalt acetate tetrahydrate relative to the amount of the compound 5 were placed in a microwave test tube, 5 mL of DMF was added, and a microwave apparatus was used to perform a reaction at 200° C. and an output of 200 W for 2 hours. The thus obtained reaction liquid was poured into ice water, and the generated precipitate was collected by filtration and washed sequentially with water and hexane, yielding the polynuclear metal complex MC2. Identification data for the obtained polynuclear metal complex MC2 are shown below.

MS (Maldi-T of, TCNQ) measured value (m/z): 1748 (M⁺), theoretical value: 1747.5 (M⁺)

### Synthesis Example 9

A ligand compound 7 was synthesized in accordance with reaction equations (305), (306) and (307) shown below.

The 2,6-dibromo-4-chloropyridine that functions as a raw material was synthesized in accordance with the method disclosed in the literature (European Journal of Organic Chemistry, 2009, 1781 to 1795), and was synthesized via reaction equation (305) shown below.

Then, using the ligand compound 7 and a metal-imparting agent, a polynuclear metal complex MC3 was synthesized in accordance with reaction equation (308) shown below.

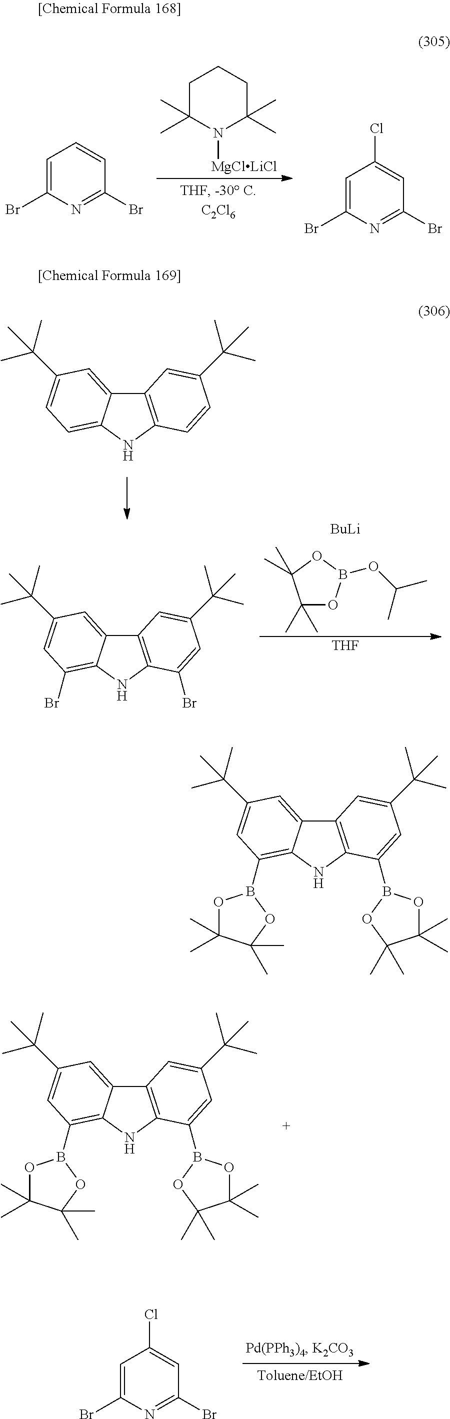

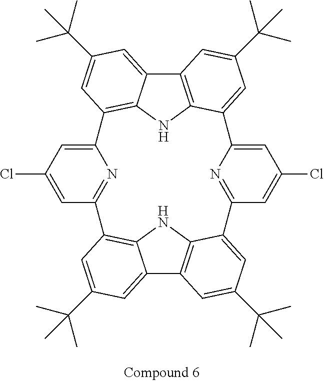 [SMILES: CC(C)(C)c1cc2c3cc(Cl)cc(n3)c3cc(C(C)(C)C)cc4c5cc(C(C)(C)C)cc(c6cc(Cl)cc(n6)c6cc(C(C)(C)C)cc7c(c1)c2[nH]c67)c5[nH]c34]

Following replacement of the atmosphere inside a reaction container with an argon gas atmosphere, 5 g (21 mmol) of 2,6-dibromopyridine was dissolved in 20 mL of anhydrous THF, and the solution was cooled to −30° C. To this solution was added dropwise 32 mL of a 1M THF solution of 2,2,6,6-tetramethylpiperidinylmagnesium chloride lithium chloride (32 mmol), and the resulting mixture was stirred at −30° C. for 30 minutes. To the thus obtained reaction liquid was added 10 mL of a THF solution containing 7.5 g (32 mmol) of dissolved hexachloroethane, and the reaction solution was then warmed to room temperature with continuous stirring. A saturated aqueous solution of ammonium chloride was added to the obtained reaction mixture to halt the reaction, and ethyl acetate was then added. The thus obtained organic layer was extracted, the water layer was extracted twice with ethyl acetate, and the combined organic layer was washed with a saline solution. Subsequently, the washed organic layer was dried over magnesium sulfate and filtered, and the solvent was then removed from the filtrate by distillation. The thus obtained residue was purified using a silica gel column (developing solvent: hexane/dichloromethane) and then recrystallized from ethanol, yielding 2,6-dibromo-4-chloropyridine. The quantity obtained was 1.8 g, and the yield was 32%. Identification data for the obtained 2,6-dibromo-4-chloropyridine are shown below.

¹H-NMR (CD₂Cl₂, 300 MHz, 25° C.): δ (ppm)=7.53 (s, 2H).

¹³C-NMR (CD₂Cl₂, 75 MHz, 25° C.): δ (ppm)=127.6, 141.2, 146.8.

MS (FD) measured value (m/z): 268.9, theoretical value: 268.8

Next, 3,6-di-tert-butyl-1,8-bis(4,4,5,5-tetramethyl-1,3,2-dioxaborolan-2-yl)-9H-carbazole was synthesized by the following method.

To a solution prepared by dissolving 5 g (11.5 mmol) of 1,8-dibromocarbazole in 250 mL of deaerated THF was added, at 0° C., 7.8 mL of n-butyllithium (1.6 M hexane solution, 12.5 mmol). After stirring for 1 hour, carbon dioxide gas was bubbled through the reaction liquid while it was warmed to room temperature. Following removal of the solvent from the thus obtained reaction liquid by distillation, the resulting residue was dissolved in 250 mL of deaerated THF. Next, 29.4 mL of tert-butyllithium (1.7 M pentane solution, 49.9 mmol) was added gradually to the reaction solution at −78° C., and the resulting mixture was then stirred at 0° C. for 3 hours. The thus obtained reaction liquid was once again cooled to −78° C., 11.6 mL (57.5 mmol) of 2-isopropyloxytetramethyldioxaborolane was added, and the thus obtained reaction liquid was warmed gradually to room temperature. The resulting reaction liquid was then cooled to 0° C., a 1 M aqueous solution of hydrochloric acid was added, and following hydrolysis, ethyl acetate was added. The obtained organic layer was washed sequentially with a 1 M aqueous solution of sodium hydroxide and a 1 M aqueous solution of sodium bicarbonate, and was then dried over magnesium sulfate. The solvent was removed by distillation using an evaporator, and the residue was recrystallized from warm hexane to obtain 3,6-di-tert-butyl-1,8-bis(4,4,5,5-tetramethyl-1,3,2-dioxaborolan-2-yl)-9H-carbazole. The quantity obtained was 2.7 g, and the yield was 50%. Identification data for the obtained compound are shown below.

¹H-NMR (CD₂Cl₂, 300 MHz, 25° C.): δ (ppm)=1.47 (s, 42H), 7.85 (d, 2H), 8.24 (d, 2H), 9.99 (s, 1H).

¹³C-NMR (CD₂Cl₂, 75 MHz, 25° C.): δ (ppm)=24.9, 31.8, 34.5, 83.76, 119.9, 121.7, 129.8, 140.9, 143.6.

Next, the compound 6 was synthesized by the following method.

In a flask, 608.68 mg (1.12 mmol) of 3,6-di-tert-butyl-1,8-bis(4,4,5,5-tetramethyl-1,3,2-dioxaborolan-2-yl)-9H-carbazole, 307.93 mg (1.12 mmol) of 2,6-dibromo-4-chloropyridine, and 25 mg (0.02 mmol) of Pd(PPh₃)₄ were dissolved in 1,000 mL of toluene, 400 mL of ethanol and 60 mL of a 2 M aqueous solution of potassium carbonate were added to the solution, and the gas inside the flask was then substituted 3 times with argon gas. The thus obtained reaction mixture was stirred at 85° C. for 3 days. Following removal of the solvent by distillation using an evaporator, the resulting residue was dissolved in dichloromethane, and the thus obtained organic layer was washed with water, subsequently washed with a saline solution, and then dried over magnesium sulfate. The obtained organic layer was then filtered, and the solvent was removed from the filtrate by distillation to obtain a crude product. This crude product was purified using a silica gel column (developing solvent: hexane/dichloromethane), and recrystallized from warm hexane, yielding the compound 6. The quantity obtained was 40 mg, and the yield was 5%. Identification data for the obtained compound 6 are shown below.

¹H-NMR (CD₂Cl₂, 300 MHz, 25° C.): δ (ppm)=1.52 (s, 36H), 7.61 (d, 4H, ⁴J=1.79 Hz), 7.72 (s, 4H), 8.28 (t, 4H, ⁴J=1.69 Hz), 9.59 (s, 2H, —NH).

¹³C-NMR (CD₂Cl₂, 75 MHz, 25° C.): δ (ppm)=32.1, 35.1, 117.9, 122.5, 122.9, 124.9, 126.0, 136.1, 143.7, 146.3, 161.2.

MS (Maldi-T of) measured value (m/z): 776.90, theoretical value: 776.34

### (Synthesis of Ligand Compound 7)

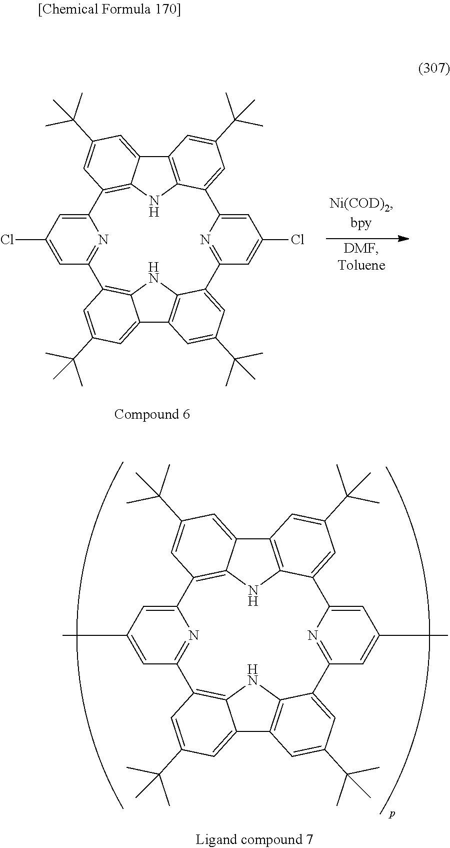

In the equation, p represents the number of repeating units.

In a flask, 22 mg (0.08 mmol) of bis[1,5-cyclooctadiene]nickel(0) (Ni(COD)₂), 9 mg (0.08 mmol) of 1,5-cyclooctadiene, 12 mg (0.08 mmol) of 2,2-bipyridine (bpy) were dissolved in a mixed solution containing 0.3 mL of DMF and 0.45 mL of toluene, and the resulting solution was stirred at 60° C. for 30 minutes. Then, 0.2 mL of a toluene solution prepared by dissolving 30 mg (0.04 mmol) of the compound 6 was added, and the obtained reaction liquid was stirred at 60° C. for 3 days. Methanol was then added to the obtained reaction liquid, and the generated precipitate was collected by filtration to obtain the ligand compound 7. Identification data for the obtained ligand compound 7 are shown below.

Mn (number-average molecular weight)=3,272.83 g/mol

Mw (weight-average molecular weight)=13,693.00 g/mol

PDI (polydispersity index)=4.18

### (Synthesis of Polynuclear Metal Complex MC3)

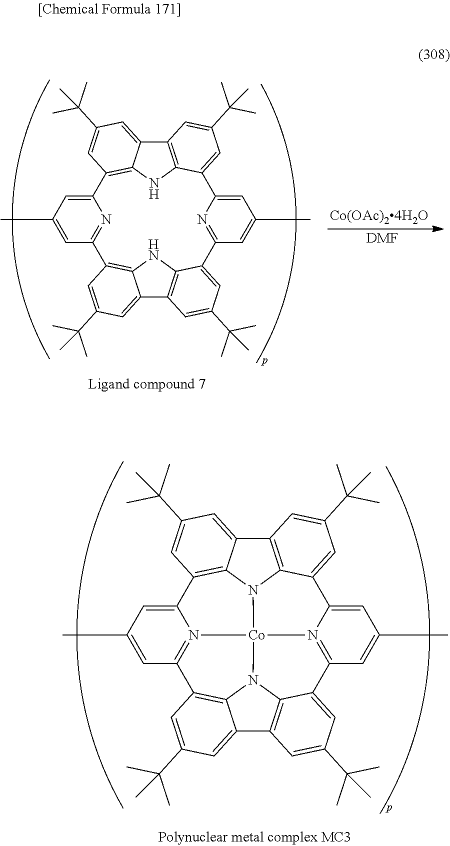

In the equation, p represents the number of repeating units.

Following reaction of the ligand compound 7 with an excess of cobalt acetate tetrahydrate in DMF, the obtained reaction liquid was poured into ice water, and the generated precipitate was collected by filtration and washed sequentially with water and hexane to obtain the polynuclear metal complex MC3.

### Synthesis Example 10

A ligand compound 9 was synthesized via a compound 8, in accordance with reaction equation (309) shown below. Then, using the ligand compound 9 and a metal-imparting agent, a polynuclear metal complex MC4 was synthesized in accordance with reaction equation (310) shown below.

### (Synthesis of Ligand Compound 9)

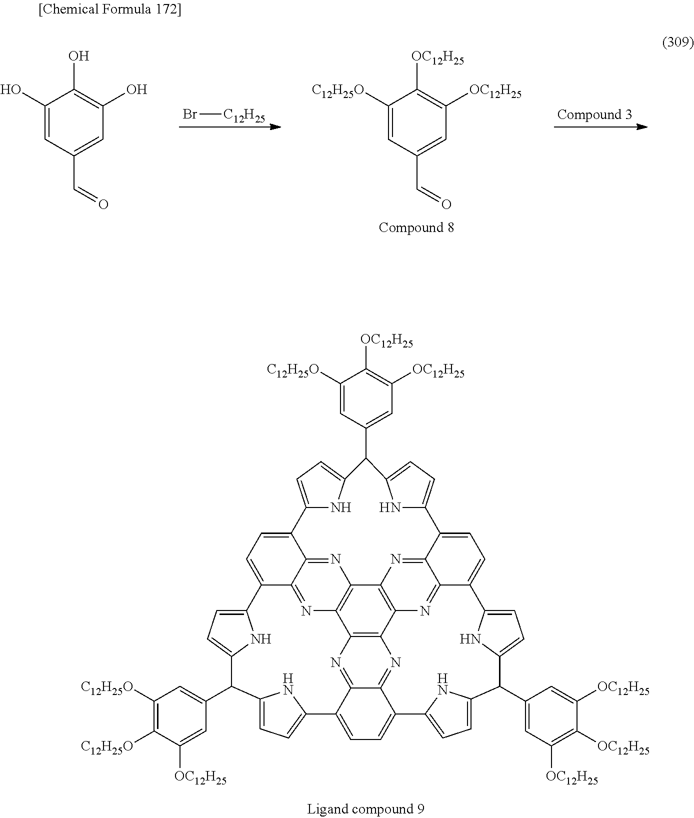

In a flask, 1.0 g (5.9 mmol) of 3,4,5-trihydroxybenzaldehyde, 8.7 g (35 mmol) of 1-bromododecane, 2.4 g (17.4 mmol) of potassium carbonate and 60 mg (0.35 mmol) of potassium iodide were dissolved in 35 mL of dimethylformamide, and the thus obtained reaction mixture was stirred at 70° C. for 18 hours. The resulting reaction solution was left to stand to cool to room temperature, and water was then added to halt the reaction. Subsequently, an extraction was performed with dichloromethane, and the obtained organic layer was dried over magnesium sulfate. The thus obtained organic layer was filtered, and the solvent was removed from the filtrate by distillation to obtain a crude product. This crude product was purified using a silica gel column (developing solvent: hexane/dichloromethane=3/1), thus obtaining the compound 8. The quantity obtained was 3.5 g, and the yield was 90%. Identification data for the obtained compound 8 are shown below.

¹H-NMR (CD₂Cl₂, 300 MHz, 25° C.): δ (ppm)=0.89 (t, 9H, ²J=6.7 Hz), 1.28 (m, 54H), 1.77 (m, 6H), 4.03 (t, 6H, ²J=6.5 Hz), J=6.4 Hz), 7.08 (s, 2H), 9.82 (s, 1H).

¹³C-NMR (CD₂Cl₂, 75 MHz, 25° C.): δ (ppm)=14.2, 23.0, 29.4, 30.8, 30.9, 32.01, 122.1, 126.1, 126.9, 130.7, 135.5, 140.6, 142.5, 145.4, 191.6.

Subsequently, the ligand compound 9 was synthesized by the operations described below. In a flask, 100 mg (0.13 mmol) of the compound 3 and 383 mg (0.56 mmol) of the compound 8 were dispersed in a mixed solution containing 4 mL of dichloromethane and 2 mL of THF, 0.5 mL of trifluoroacetic acid was added, and the gas inside the flask was substituted with argon gas. The thus obtained reaction liquid was placed in a microwave test tube, and using a microwave apparatus, a reaction was performed at 85° C. and an output of 50 W for 18 hours. Following concentration of the resulting reaction liquid, methanol was added and a crude product was obtained as a precipitate. Subsequently, a Soxhlet extractor using acetone as the solvent was used to purify the obtained precipitate, thus yielding the ligand compound 9. The quantity obtained was 250 mg, and the yield was 71%. Identification data for the obtained ligand compound 9 are shown below.

¹H-NMR (C₃D₂F₆O+0.1% C₂DF₃O₂, 500 MHz, 25° C.): δ (ppm)=0.84 (t, 27H, ²J=6.8 Hz), 1.24 (m, 144H), 1.43 (m, 18H), 1.75 (m, 18H), 3.89 (t, 12H, ²J=6.1 Hz), 4.12 (t, 6H, ²J=6.8 Hz), 6.12 (d, 6H, ³J=4.7 Hz), 6.18 (d, 6H, ³J=4.7 Hz), 6.37 (s, 6H), 6.59 (s, 6H).

MS (Maldi-T of, TCNQ) measured value (m/z): 2693.08 (M⁺), theoretical value: 2696.01 (M⁺)

### (Synthesis of Polynuclear Metal Complex MC4)

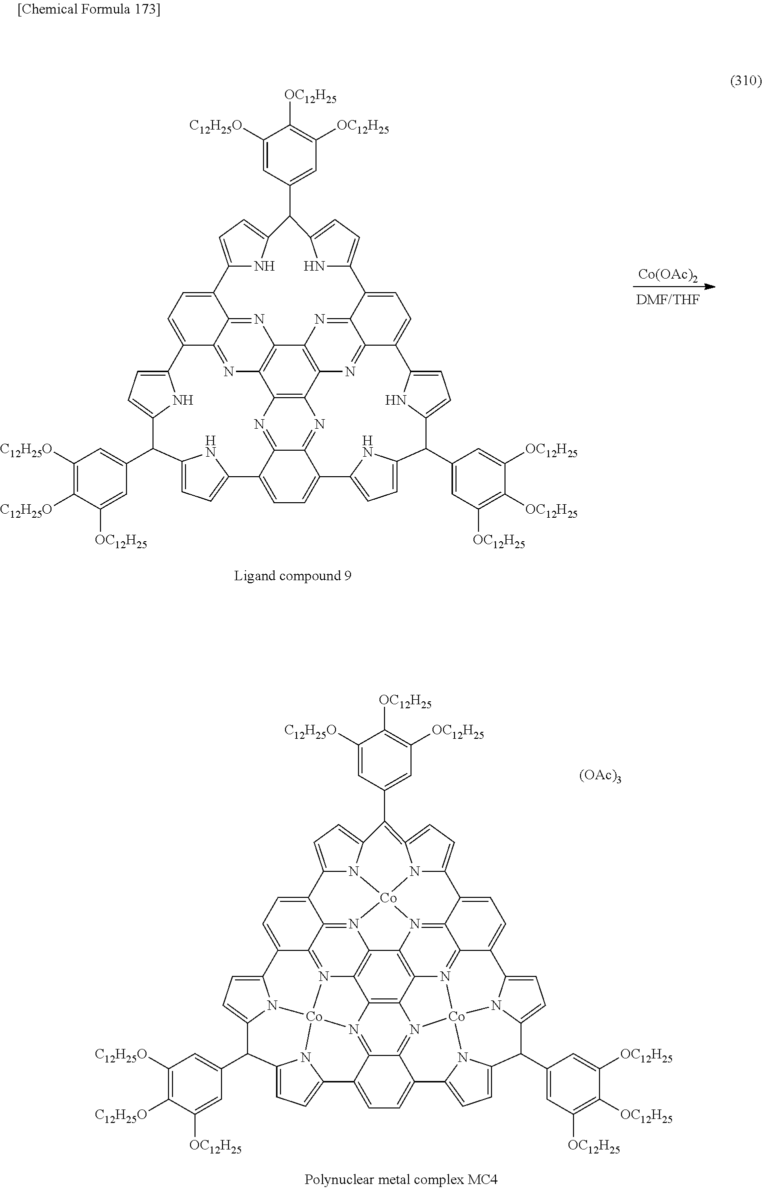

A microwave test tube was charged with 0.305 g (0.13 mmol) of the compound 8 and 0.14 g (0.78 mmol) of anhydrous cobalt acetate, 8 mL of DMF and 4 mL of THF were added, and a reaction was performed at 180° C. for 2 hours using a microwave apparatus. The thus obtained reaction liquid was poured into 25 mL of ice water, and the generated precipitate was collected by filtration and dried, yielding 0.35 g of the polynuclear metal complex MC4. Identification data for the obtained polynuclear metal complex MC4 are shown below.

MS (Maldi-T of, TCNQ) measured value (m/z): 2865.01 (M⁺), theoretical value: 2866.76 (M⁺)

### Synthesis Example 11

A ligand compound 11 was synthesized via a compound 10, in accordance with reaction equation (311) shown below. Then, using the ligand compound 11 and a metal-imparting agent, a polynuclear metal complex MC5 was synthesized in accordance with reaction equation (312) shown below.

### (Synthesis of Ligand Compound 11)

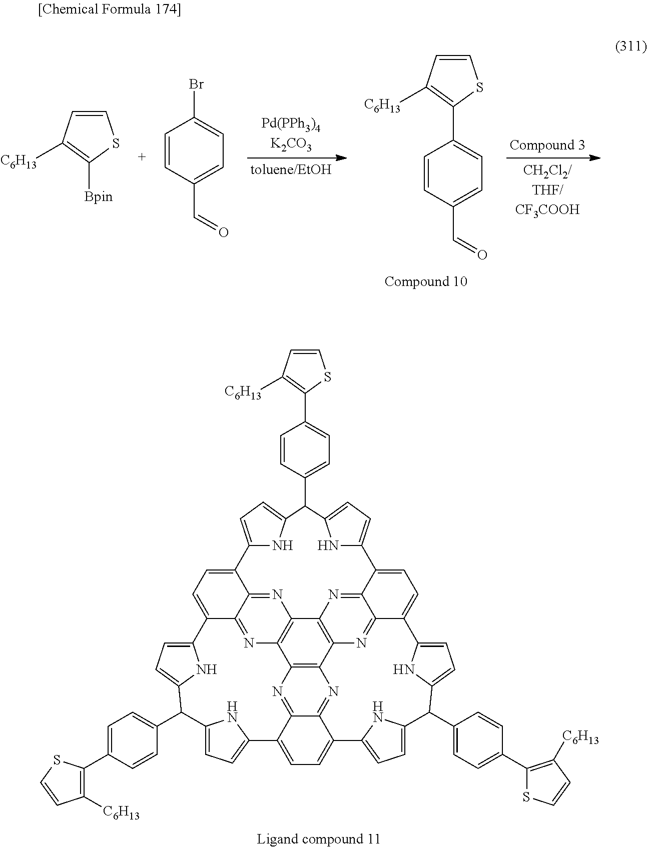

Following replacement of the atmosphere inside a reaction container with an argon gas atmosphere, 1.0 g (5.4 mmol) of 4-bromobenzaldhyde and 1.4 g (8.2 mmol) of 2-(3-hexylthiophen-2-yl)-4,4,5,5-tetramethyl-1,3,2-dioxaborolane were dissolved in 10 mL of anhydrous toluene, and then 5 ml of ethanol, 5 ml of a 2 M aqueous solution of potassium carbonate, and 300 mg of palladium were added. The obtained reaction mixture was stirred at 85° C. for 16 hours. The resulting reaction solution was left to stand to cool to room temperature, and the solvent was then removed by distillation using an evaporator. The obtained residue was extracted into dichloromethane, and the obtained organic layer was washed sequentially with water and a saline solution, and then dried over magnesium sulfate. The thus obtained organic layer was filtered, and the solvent was removed from the resulting filtrate by distillation to obtain a crude product. This crude product was purified using a silica gel column (developing solvent: hexane/dichloromethane=3/1) to obtain the compound 10. The quantity obtained was 817 mg, and the yield was 55%. Identification data for the obtained compound 10 are shown below.

¹H-NMR (CD₂Cl₂, 300 MHz, 25° C.): δ (ppm)=0.89 (t, 3H), 1.23 to 1.41 (m, 6H), 1.60 to 1.70 (m, 4H), 1.75 (m, 18H), 2.64 (t, 2H, ³J=7.5 Hz), 7.02 (s, 1H), 7.35 (s, 1H), 7.75 (d, 2H, ²J=8.4 Hz), 7.87 (d, 2H, ²J=8.4 Hz), 9.97 (s, 1H).

¹³C-NMR (CD₂Cl₂, 75 MHz, 25° C.): δ (ppm)=14.2, 23.0, 29.4, 30.8, 30.9, 32.01, 122.1, 126.1, 126.9, 130.7, 135.5, 140.6, 142.5, 145.4, 191.6.

Subsequently, the ligand compound 11 was synthesized by the operations described below. In a flask, 120 mg (0.15 mmol) of the compound 3 and 230 mg (0.85 mmol) of the compound 10 were dispersed in a mixed solution containing 4 mL of dichloromethane and 2 mL of THF, 0.5 mL of trifluoroacetic acid was added, and the gas inside the flask was substituted with argon gas. The thus obtained reaction liquid was placed in a microwave test tube, and using a microwave apparatus, a reaction was performed at 70° C. for 2 days. Following concentration of the resulting reaction liquid, methanol was added to the concentrate and a crude product was obtained as a precipitate. Subsequently, a Soxhlet extractor using acetone as the solvent was used to purify the obtained precipitate, thus yielding the ligand compound 11. The quantity obtained was 150 mg, and the yield was 65%. Identification data for the obtained ligand compound 11 are shown below.

MS (Maldi-T of, TCNQ) measured value (m/z): 1533.03 (M⁺), theoretical value: 1530.56 (M⁺)

### (Synthesis of Polynuclear Metal Complex MC5)

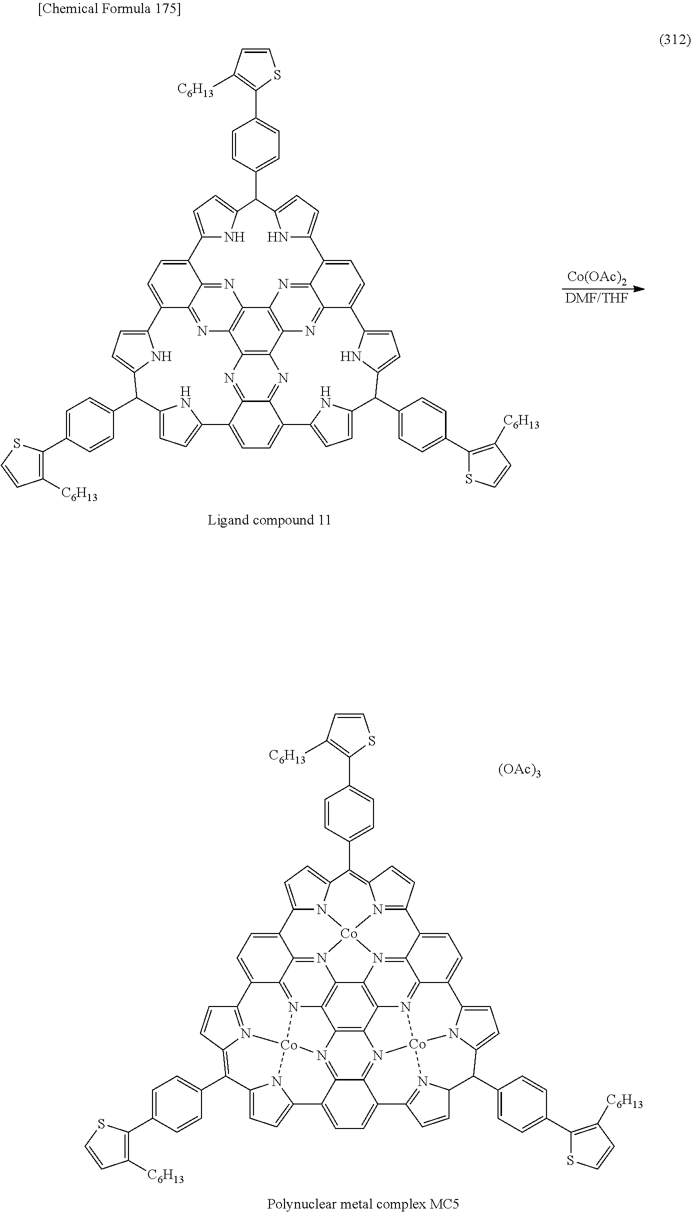

A microwave test tube was charged with 0.203 g (0.13 mmol) of the ligand compound 11 and 0.14 g (0.78 mmol) of anhydrous cobalt acetate, 10 mL of DMF and 3 mL of THF were added, and a reaction was performed at 60° C. for 2 days using a microwave apparatus. The thus obtained reaction liquid was poured into 25 mL of ice water, and the generated precipitate was collected by filtration and dried, yielding 0.22 g of the polynuclear metal complex MC5. Identification data for the obtained polynuclear metal complex MC5 are shown below.

MS (Maldi-T of, TCNQ) measured value (m/z): 1703.77 (M⁺), theoretical value: 704.34 (M⁺)

### Synthesis Example 12

Using the ligand compound 4 and a metal-imparting agent, a polynuclear metal complex MC6 was synthesized in accordance with reaction equation (313) shown below.

### (Synthesis of Polynuclear Metal Complex MC6)

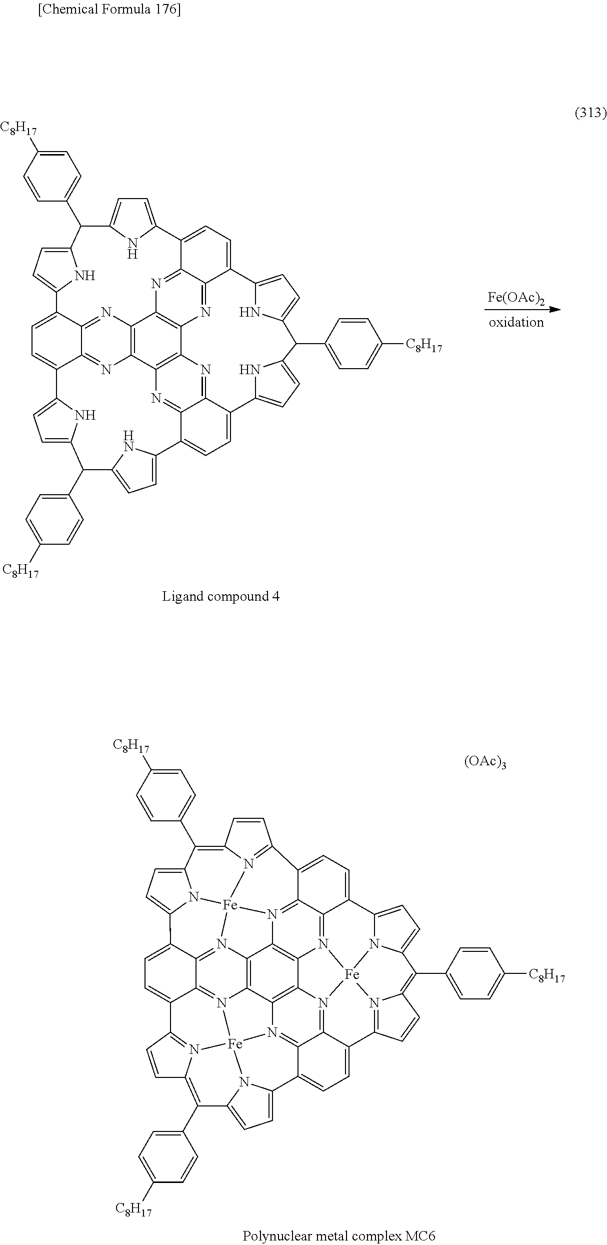

A microwave test tube was charged with 0.133 g (0.097 mmol) of the ligand compound 4 and 0.053 g (0.304 mmol) of iron (II) acetate, 5 mL of DMF was added, and using a microwave apparatus, a reaction was performed at 200° C. and an output of 200 W for 4 hours. The thus obtained reaction liquid was poured into 25 mL of ice water, and the generated precipitate was collected by filtration and washed sequentially with water, hexane and diethyl ether, yielding the polynuclear metal complex MC6. Identification data for the obtained polynuclear metal complex MC6 are shown below.

MS (Maldi-T of, TCNQ) measured value (m/z): 1534 (M⁺), theoretical value: 1534.48 (M⁺)

A microwave test tube was charged with 0.10 g (0.073 mmol) of the ligand compound 4 and 0.053 g (0.21 mmol) of manganese (II) acetate tetrahydrate, 5 mL of DMF was added, and using a microwave apparatus, a reaction was performed at 200° C. and an output of 200 W for 4 hours. The thus obtained reaction liquid was poured into 25 mL of ice water, and the generated precipitate was collected by filtration and washed sequentially with water and hexane, yielding a polynuclear metal complex MC7.

### Production of Cathode Catalysts for Air Secondary Cells

### Example 10

### Production of Cathode Catalyst (10)

The polynuclear metal complex MC1 and carbon (product name: Ketchen Black EC600JD, manufactured by Lion Corporation) were mixed in a weight ratio of 1:4, and following stirring in methanol at room temperature for 15 minutes, the mixture was dried at room temperature and under a reduced pressure of 200 Pa for 12 hours to obtain a cathode catalyst 10.

### Examples 11 to 15

### Production of Cathode Catalysts 11 to 15

With the exception of replacing the polynuclear metal complex MC1 from Example 10 with the polynuclear metal complex MC2 (Example 11), the polynuclear metal complex MC3 (Example 12), the polynuclear metal complex MC4 (Example 13), the polynuclear metal complex MC5 (Example 14) or the polynuclear metal complex MC6 (Example 15) respectively, a cathode catalyst 11, a cathode catalyst 12, a cathode catalyst 13, a cathode catalyst 14 or a cathode catalyst 15 was prepared, an electrode was fabricated, and the oxygen reduction activity was evaluated in the same manner as that described for Example 10. The results obtained are shown in Table 2.

### Comparative Example 2

Manganese dioxide (manufactured by Sigma-Aldrich Co. LLC., production code: 203750) and carbon (product name: Ketchen Black EC600JD, manufactured by Lion Corporation) were mixed in a weight ratio of 1:4, and following stirring in ethanol at room temperature for 15 minutes, the mixture was dried at room temperature and under a reduced pressure of 200 Pa for 12 hours to obtain a cathode catalyst R2.

### <Evaluation of Cathode Catalysts for Air Secondary Cells>

### (Evaluation of Oxygen Reduction Activity)

The cathode catalysts obtained above (cathode catalysts 10 to 15 and cathode catalyst R2) were evaluated for oxygen reduction activity using a rotating disk electrode. Specifically, evaluation was performed as follows.

For the electrode, a disk electrode in which the disk portion was glassy carbon (diameter: 6.0 mm) was used.

To a sample bottle containing 1 mg of the cathode catalyst was added 1 mL of a 0.5% by weight solution of Nafion (registered trademark) (a solution prepared by diluting a 5% by weight solution of Nafion (registered trademark) 10-fold with ethanol), and the sample was dispersed by irradiation with ultrasonic waves for 15 minutes. Subsequently, 7.2 μL of the thus obtained suspension was dripped onto the disk portion of the electrode described above and dried, and was then dried for 3 hours in a dryer heated to 80° C. to obtain a measurement electrode.

Using this measurement electrode, the electric current value of the oxygen reduction reaction was measured using the measurement apparatus and measurement conditions described below. Measurement of the electric current value was conducted in a state saturated with nitrogen gas (under a nitrogen gas atmosphere) and in a state saturated with oxygen gas (under an oxygen gas atmosphere), and the value obtained by subtracting the electric current value obtained for the measurement under the nitrogen gas atmosphere from the electric current value obtained for the measurement under the oxygen gas atmosphere was recorded as the electric current value of the oxygen reduction reaction. The current density was determined by dividing this electric current value by the surface area of the measurement electrode. The results are shown in Table 2.

The current density is the value relative to a silver/silver chloride electrode when the voltage was −0.8 V.

### (Measurement Apparatus)

RRDE-1 Rotating Ring/Disk Electrode System manufactured by Nikko Keisoku

ALS model 701C dual electrochemical analyzer

### (Measurement Conditions)

Cell solution: 0.1 mol/L aqueous solution of potassium hydroxide (oxygen saturation or nitrogen saturation)

Solution temperature: 25° C.

Reference electrode: silver/silver chloride electrode (saturated potassium chloride)

Counter electrode: platinum wire

Sweep rate: 10 mV/second

Electrode rotational rate: 1600 rpm

### (Evaluation of Water Oxidation Activity)

For each of the cathode catalysts obtained above (cathode catalysts 10 to 15 and cathode catalyst R2), a measurement electrode was fabricated in the same manner as that described for the evaluation of the oxygen reduction activity, and this measurement electrode was used to measure the electric current value of the water oxidation reaction using the measurement apparatus and measurement conditions described below. Measurement of the electric current value was conducted in a state saturated with nitrogen gas, and the current density was determined by dividing this electric current value by the surface area of the measurement electrode. The results are shown in Table 2. The current density is the value relative to a silver/silver chloride electrode when the voltage was 1 V.

### (Measurement Apparatus)

RRDE-1 Rotating Ring/Disk Electrode System manufactured by Nikko Keisoku

ALS model 701C dual electrochemical analyzer

### (Measurement Conditions)

Cell solution: 1 mol/L aqueous solution of sodium hydroxide (nitrogen saturation)

Solution temperature: 25° C.

Reference electrode: silver/silver chloride electrode (saturated potassium chloride)

Counter electrode: platinum wire

Sweep rate: 10 mV/second

Electrode rotational rate: 900 rpm

TABLE 2

| | | Current density (mA/cm²) | |
|---|---|---|---|
| | | Oxygen | Water |
| | Cathode catalyst | reduction activity | oxidation activity |
| Example 10 | Cathode catalyst 10 | 6.1 | 210 |
| Example 11 | Cathode catalyst 11 | 4.0 | 56 |
| Example 12 | Cathode catalyst 12 | 3.6 | 42 |
| Example 13 | Cathode catalyst 13 | 3.4 | 45 |
| Example 14 | Cathode catalyst 14 | 3.0 | 64 |
| Example 15 | Cathode catalyst 15 | 5.5 | 63 |
| Comparative | Cathode catalyst R2 | 2.9 | 25 |
| Example 2 | | | |

### Charge-Discharge Tests in Air Secondary Cells

### Example 16

### Fabrication of Cathode Catalyst Layer J1

The polynuclear metal complex MC1 as a cathode catalyst, Acetylene Black as a conductive material, and a PTFE powder as a binder were mixed together in a ratio of polynuclear metal complex MC1:Acetylene Black:PTFE=1:10:1 (weight ratio), 5 drops of ethanol were added from a pipette, and following mixing of these components in an agate mortar, a thin film was formed, thus obtaining a cathode catalyst layer J1.

The cathode catalyst layer J1 was sandwiched from both sides with a water repellent PTFE sheet and a stainless steel mesh, and crimping was then performed using a press machine to obtain a cathode for an air secondary cell.

A hydrogen storage alloy that functions as an anode was extracted using the following method. An AA rechargeable nickel hydride cell (Eneloop (registered trademark), manufactured by Sanyo Electric Co., Ltd., HR-3UTGA) was connected to a charge-discharge tester (manufactured by Toyo System Co., Ltd., product name: TOSCAT-3000U), and was charged until the cell voltage reached 1.0 V. The nickel hydride cell was then disassembled, and the hydrogen storage alloy was extracted.

The hydrogen storage alloy was sandwiched between porous metal bodies (Celmet #8, manufactured by Toyama Sumitomo Electric Industries, Ltd.) and then pressed with a press machine to prepare an anode, and this anode was then connected to a charge-discharge tester (manufactured by Toyo System Co., Ltd., product name: TOSCAT-3000U), and a charge-discharge cycle test was performed using an 8.0 M aqueous solution of potassium hydroxide as the electrolyte.

The charge-discharge cycle test was conducted by performing 10 repetitions of the following steps 1 to 4.

Step 1: Charge for 20 minutes at constant current of 3 mA.

Step 2: Rest for 5 minutes.

Step 3: Discharge at constant current of 3 mA. Move to step 4 when the voltage reaches 0.5 V.

Step 4: Rest for 5 minutes.

FIG. 4 is a graph illustrating the results of the charge-discharge cycle test of an air secondary cell using the cathode for an air secondary cell of Example 16. As illustrated in the figure, in the air secondary cell using the polynuclear metal complex MC1 of the present invention, charging and discharging were able to be repeated favorably, and no deterioration in physical properties was observed even after repeated charging and discharging.

### Example 17, Example 18

The polynuclear metal complex MC4 or the polynuclear metal complex MC5 as a cathode catalyst, Ketchen Black as a conductive material, and a PTFE powder as a binder were mixed together in a ratio of polynuclear metal complex MC4 or polynuclear metal complex MC5:Ketchen Black:PTFE=1:10:1 (weight ratio), 5 drops of ethanol were added from a pipette, and following mixing of these components in an agate mortar, a thin film was formed, thus obtaining a cathode catalyst layer J2 (Example 17) or a cathode catalyst layer J3 (Example 18).

Using the same measurement method as Example 16, evaluations were performed with the number of charge-discharge cycles set to 3.

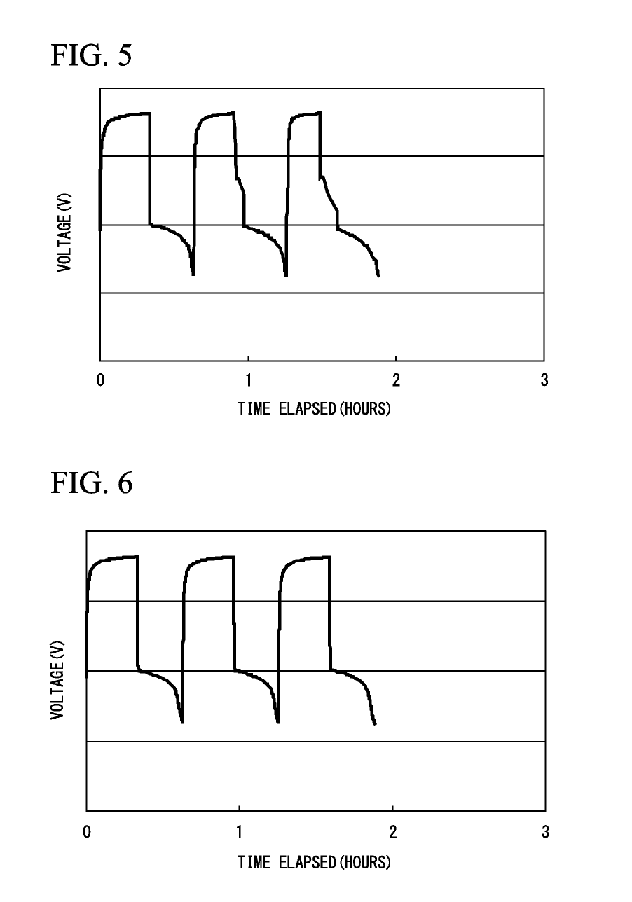

FIG. 5 and FIG. 6 are graphs illustrating the results of the charge-discharge cycle tests of the air secondary cells of Example 17 and Example 18 respectively. As illustrated in the figures, in the air secondary cells using the polynuclear metal complex MC4 and the polynuclear metal complex MC5 of the present invention, charging and discharging were able to be repeated favorably, and no deterioration in physical properties was observed even after repeated charging and discharging.

### Example 19

### Fabrication of Cathode Catalyst Layer J4

The polynuclear metal complex (D) and the polynuclear metal complex MC1 as cathode catalysts, Ketchen Black as a conductive material, and a PTFE powder as a binder were mixed together in a ratio of polynuclear metal complex (D):polynuclear metal complex MC1:Ketchen Black:PTFE=1:1:10:1 (weight ratio), 5 drops of ethanol were added from a pipette, and following mixing of these components in an agate mortar, a thin film was formed, thus obtaining a cathode catalyst layer J4.

An evaluation was performed in the same manner as Example 16, with the number of charge-discharge cycles set to 3.

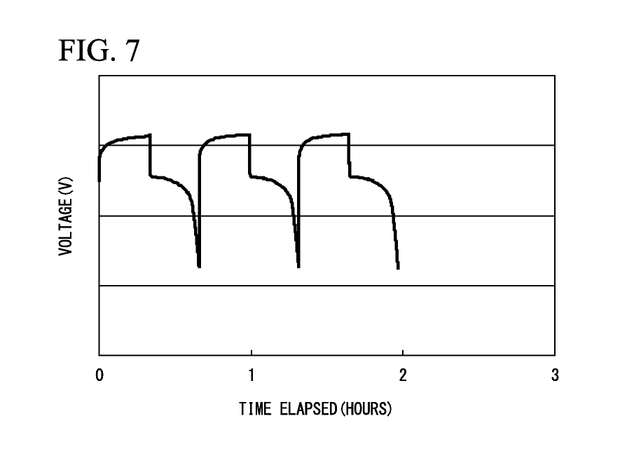

FIG. 7 is a graph illustrating the results of the charge-discharge cycle test of the air secondary cell of Example 19. As illustrated in the figure, in the air secondary cell using both the polynuclear metal complex (D) and the polynuclear metal complex MC1 of the present invention, charging and discharging were able to be repeated favorably, and no deterioration in physical properties was observed even after repeated charging and discharging.

The above examples confirmed the applicability of the present invention.

### DESCRIPTION OF THE REFERENCE SIGNS

1: Air secondary cell
11: Cathode catalyst layer
12: Cathode current collector
120: Cathode terminal
13: Anode active material layer
14: Anode current collector
140: Anode terminal
15: Electrolyte

### INDUSTRIAL APPLICABILITY

The present invention can be used in the energy field as a n air secondary cell.

1. A cathode catalyst for an air secondary cell comprising a polynuclear metal complex.

2. The cathode catalyst for the air secondary cell according to claim 1, wherein the polynuclear metal complex comprises 2 or more central metals and a ligand that bonds to the central metals by means of a coordination bond, and
the ligand is an organic compound including 2 or more structures within the molecule, each structure having a space surrounded by 4 or more atoms being able to coordinate with the central metal, in which the 4 or more atoms are at least one type of atom selected from the group consisting of a nitrogen atom, an oxygen atom and a sulfur atom, and being able to accommodate the central metal in the space, and the 2 or more structures may be the same or different from each other.

3. The cathode catalyst for the air secondary cell according to claim 1, wherein the number of the central metals of the polynuclear metal complex is 2 to 6.

4. The cathode catalyst for the air secondary cell according to claim 1, wherein the central metal of the polynuclear metal complex is a transition metal atom belonging to the 4th period to the 6th period of the periodic table, or an ion thereof.

5. The cathode catalyst for the air secondary cell according to claim 1, wherein the polynuclear metal complex is a polynuclear metal complex represented by general formula (A-1) shown below: 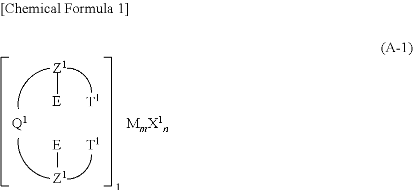
wherein Z¹ represents a trivalent organic group, 2 or more Z¹ may be the same or different from each other; E represents an oxygen atom or a sulfur atom, where 2 or more E may be the same or different from each other; Q¹ represents a divalent organic group having at least 2 nitrogen atoms; T¹ represents an organic group having a nitrogen atom, 2 or more T¹ may be the same or different from each other, and 2 or more T¹ may be mutually bonded; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other.

6. The cathode catalyst for the air secondary cell according to claim 5, wherein T¹ represents an organic group having a nitrogen-containing aromatic hetero ring.

7. The cathode catalyst for the air secondary cell according to claim 5, wherein the polynuclear metal complex represented by general formula (A-1) is a polynuclear metal complex represented by general formula (A-2) shown below: 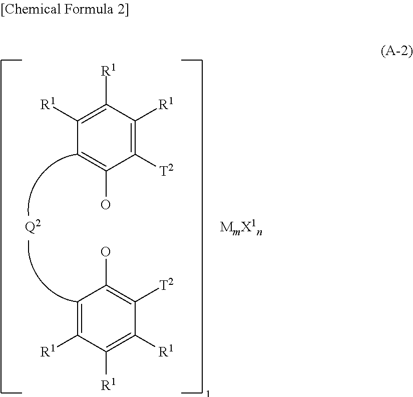
wherein R¹ represents a hydrogen atom or a substituent, 2 or more R¹ may be the same or different from each other, and adjacent R¹ substituents may be mutually bonded together to form a ring with the carbon atoms bonded thereto; Q² represents a divalent organic group having at least 2 nitrogen atoms; T² represents an organic group having a nitrogen atom, 2 or more T² may be the same or different from each other, and 2 or more T² may be mutually bonded; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other.

8. The cathode catalyst for the air secondary cell according to claim 7, wherein T² represents an organic group having a nitrogen-containing aromatic hetero ring.

9. The cathode catalyst for the air secondary cell according to claim 7, wherein the polynuclear metal complex represented by general formula (A-2) is a polynuclear metal complex represented by general formula (A-3) shown below: 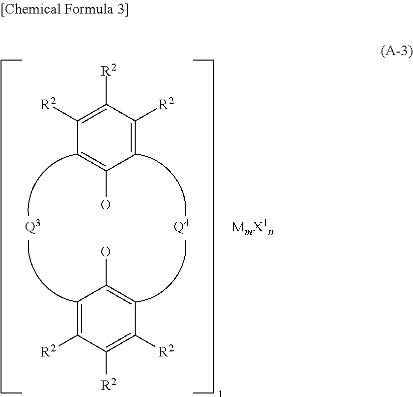
wherein R² represents a hydrogen atom or a substituent, 2 or more R² may be the same or different from each other, and adjacent R² substituents may be mutually bonded together to form a ring with the carbon atoms bonded thereto; each of Q³ and Q⁴ independently represents a divalent group represented by general formula (A-3-1), (A-3-2), (A-3-3), (A-3-4), (A-3-5) or (A-3-6) shown below; 1 represents an integer of 1 or more, and when 1 represents 2 or more, 2 or more of the general formula to which 1 is appended may be the same or different from each other; M represents a transition metal atom or a transition metal ion; m represents an integer of 2 or more, and 2 or more M may be the same or different from each other; X¹ represents a counter ion or a neutral molecule; n represents an integer of 0 or more, and when n represents 2 or more, 2 or more X¹ may be the same or different from each other; 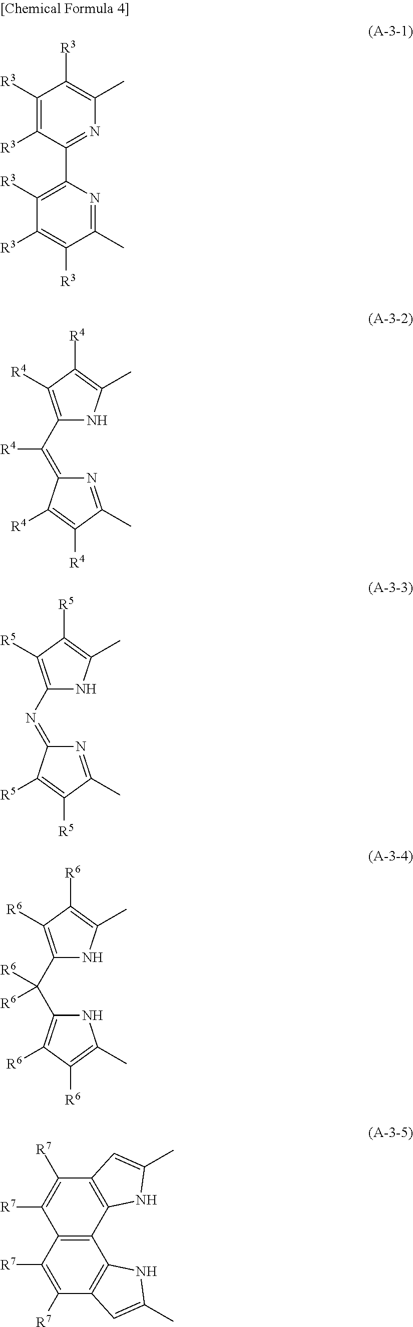 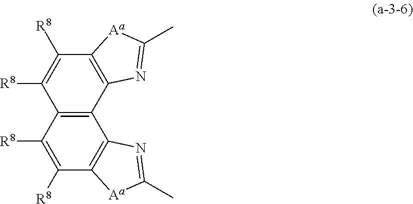
wherein each of R³, R⁴, R⁵, R⁶, R⁷ and R⁸ independently represents a hydrogen atom or a substituent, each 2 or more R³, R⁴, R⁵, R⁶, R⁷ and R⁸ may be the same or different from each other, and each 2 or more R³, R⁴, R⁵, R⁶, R⁷ and R⁸ may be mutually bonded together to form a ring with the carbon atom(s) bonded thereto; A^{a} represents a divalent group represented by formula (A-3-a) or (A-3-b) shown below, or general formula (A-3-c) shown below, and 2 or more A^{a} may be the same or different from each other; 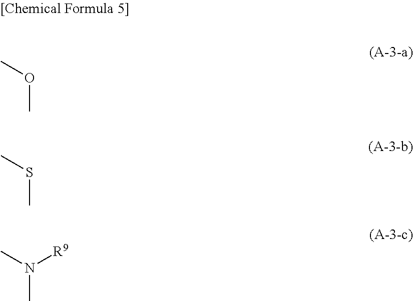
wherein R⁹ represents a hydrogen atom or a hydrocarbyl group.

10. The cathode catalyst for the air secondary cell according to claim 5, wherein M represents one or more selected from the group consisting of vanadium, chromium, manganese, iron, cobalt, nickel and copper.

11. The cathode catalyst for the air secondary cell according to claim 5, wherein m is 2.

12. The cathode catalyst for the air secondary cell according to claim 1, wherein the polynuclear metal complex comprises 2 or more central metals and a ligand that bonds to the central metals by means of a coordination bond, and
the ligand is an aromatic compound satisfying the requirements of (a) and (b) shown below:
(a) the aromatic compound has two or more structures within the molecule, each structure having a space surrounded by 4 or more nitrogen atoms being able to coordinate with the central metal, and being able to accommodate the central metal in the space, and the 2 or more structures may be the same or different from each other, and
(b) at least one nitrogen atom constituting the structure is a nitrogen atom contained in a nitrogen-containing hetero 6-membered ring.

13. The cathode catalyst for the air secondary cell according to claim 12, wherein the structure satisfies the requirement represented by equation (A) shown below, with respect to the number “n” of nitrogen atoms constituting the structure, and an average distance r (Å) between the center of the space and the center of each nitrogen atom constituting the structure.
0<r/n≦0.7 (A)

14. The cathode catalyst for the air secondary cell according to claim 13, wherein the relationship between the number “n” of nitrogen atoms constituting the structure and the average distance r satisfies the requirement represented by equation (B) shown below.
0.2≦r/n≦0.6 (B)

15. The cathode catalyst for the air secondary cell according to claim 12, wherein with respect to the structure, the number “n” of nitrogen atoms constituting the structure is 4 or more and 6 or less.

16. The cathode catalyst for the air secondary cell according to claim 12, wherein the relationship between the weight “W_{C}” of all carbon atoms constituting the ligand and the weight “W_{N}” of all nitrogen atoms constituting the ligand satisfies the requirement represented by equation (C) shown below.
0<W_{N}/W_{C}≦1.1 (C)

17. The cathode catalyst for the air secondary cell according to claim 12, wherein the structure is an aromatic compound represented by general formula (B-1) shown below: 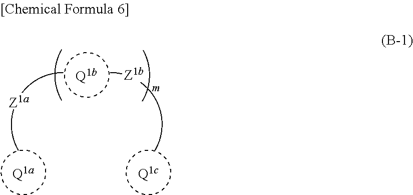
wherein m represents an integer of 1 or more; each of Q^{1a}, Q^{1b} and Q^{1c} independently represents a nitrogen-containing aromatic hetero ring which may have a substituent, Q^{1a}, Q^{1b} and Q^{1c} contain the 4 or more nitrogen atoms being able to coordinate with the central metal, in the case of 2 or more Q^{1b}, these Q^{1b} may be the same or different from each other, and at least one of Q^{1a}, Q^{1b} and Q^{1c} represents a nitrogen-containing hetero 6-membered ring; each of Z^{1a} and Z^{1b} independently represents a direct bond or a linking group, and in the case of 2 or more Z^{1b}, these Z^{1b} may be the same or different from each other; each of Q^{1a} and Q^{1b}, and Q^{1b} and Q^{1c} may be combined together to form a polycyclic aromatic hetero ring; when m represents an integer of 2 or more and Z^{1b} represents a direct bond, 2 adjacent Q^{1b} may be combined together to form a polycyclic aromatic hetero ring; Q^{1a} and Q^{1c} may be directly bonded, may be mutually bonded via a linking group, or may be combined together to form a polycyclic aromatic hetero ring.

18. The cathode catalyst for the air secondary cell according to claim 17, wherein in formula (B-1), m represents 2 or 4.

19. The cathode catalyst for the air secondary cell according to claim 17, wherein
each of Q^{1a}, Q^{1b} and Q^{1c} independently represents a ring selected from the group consisting of a pyridine ring, pyrazine ring, pyrimidine ring, pyridazine ring, 1,3,5-triazine ring, 1,2,4-triazine ring, 1,2,4,5-tetrazine ring, 1H-pyrrole ring, 2H-pyrrole ring, 3H-pyrrole ring, imidazole ring, pyrazole ring, 1,2,3-triazole ring, 1,2,4-triazole ring, oxazole ring, isoxazole ring, thiazole ring, isothiazole ring, 1,3,4-oxadiazole ring, 1,2,5-oxadiazole ring, 1,3,4-thiadiazole ring, 1,2,5-thiadiazole ring, and polycyclic aromatic hetero rings having any of these ring structures, and
the ring may have a substituent.

20. The cathode catalyst for the air secondary cell according to claim 17, wherein the organic group consisting of Q^{1a} and Q^{1b}, which are two nitrogen-containing aromatic hetero rings, or Q^{1b} and Q^{1c}, which are two nitrogen-containing aromatic hetero rings, and a direct bond or a linking group mutually bonding the two nitrogen-containing aromatic hetero rings is a divalent organic group represented by any one of general formulas (B-4-a) to (B-4-c), (B-5-a) to (B-5-d), and (B-6-a) to (B-6-d) shown below: 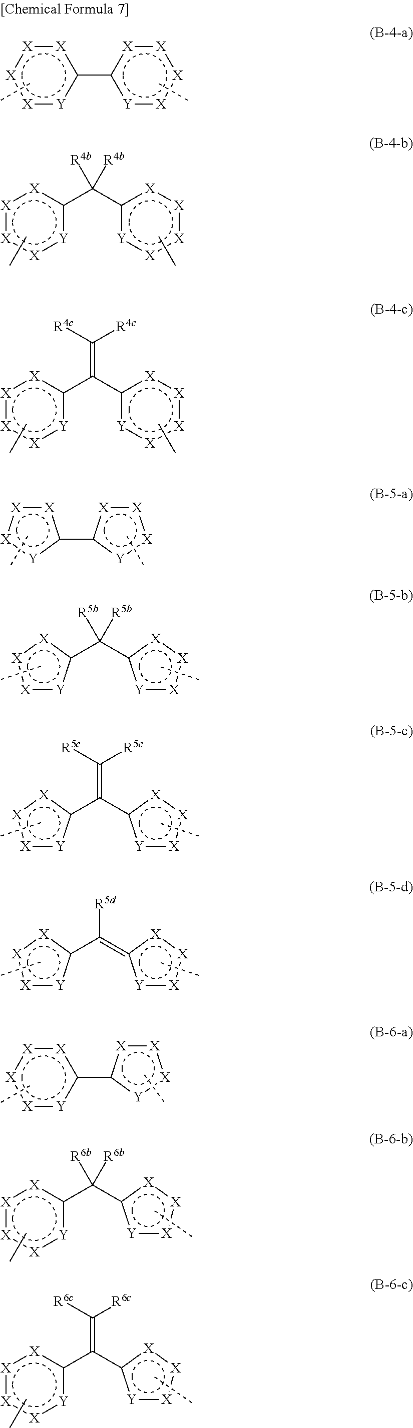 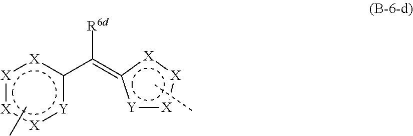
wherein X represents ═C(R^{α})—, —N(R^{β})—, ═N—, —O—, —S— or —Se—; Y represents —N(H)— or ═N—; each of R^{4b}, R^{4c}, R^{5b}, R^{5c}, R^{5d}, R^{6b}, R^{6c}, R^{6d}, R^{α} and R^{β} independently represents a hydrogen atom or a substituent, and mutually adjacent substituents may be mutually bonded together to form a ring with the carbon atom(s) bonded thereto; and each 2 or more X, Y, R^{4b}, R^{4c}, R^{5b}, R^{5c}, R^{6b} and R^{6C} may be the same or different from each other.

21. The cathode catalyst for the air secondary cell according to claim 20, wherein the organic group consisting of Q^{1a} and Q^{1b}, which are two nitrogen-containing aromatic hetero rings, or Q^{1b} and Q^{1c}, which are two nitrogen-containing aromatic hetero rings, and a direct bond or a linking group mutually bonding the two nitrogen-containing aromatic hetero rings is a divalent organic group represented by any one of general formulas (B-7-a) to (B-7-e), (B-8-a) to (B-8-e), (B-9-a) to (B-9-e) and (B-10-a) to (B-10-e) shown below: 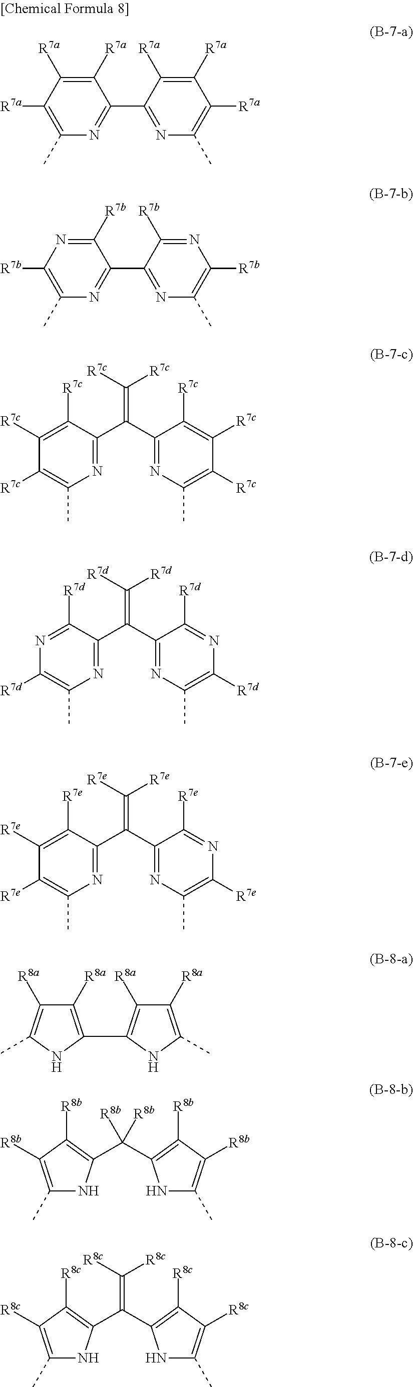 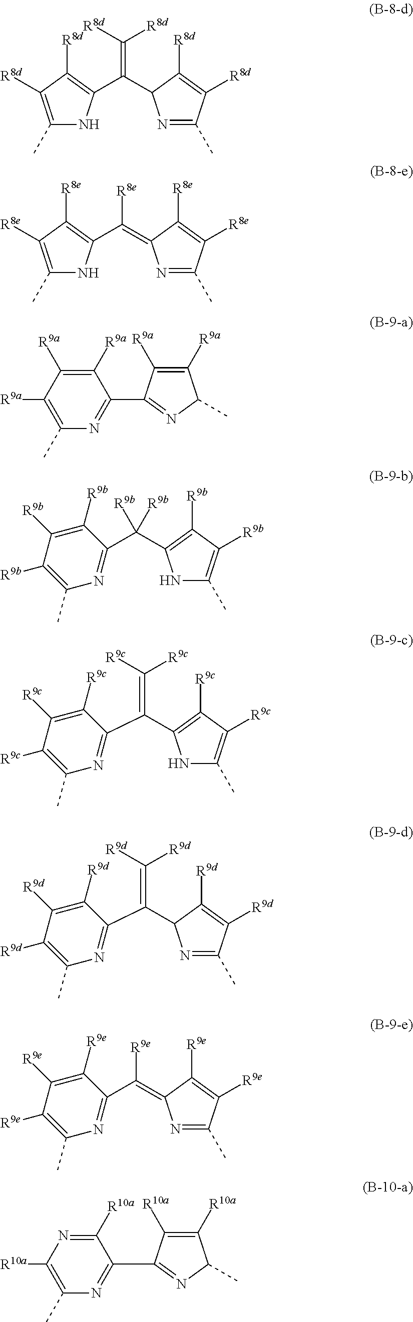 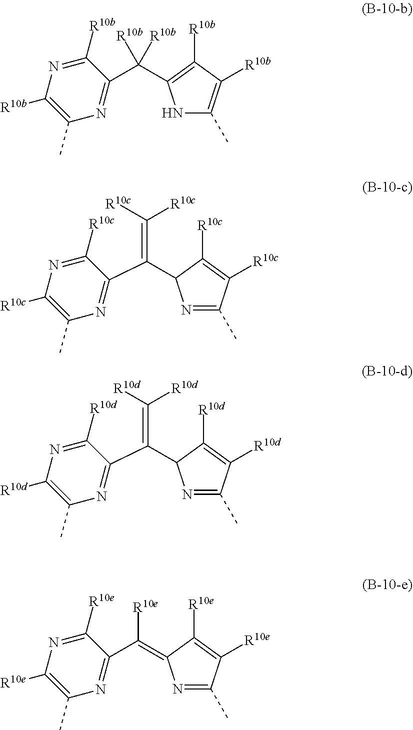
wherein each of R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} independently represents a hydrogen atom or a substituent, and mutually adjacent substituents may be mutually bonded together to form a ring with the carbon atom(s) bonded thereto; and each 2 or more R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} may be the same or different from each other.

22. The cathode catalyst for the air secondary cell according to claim 12, wherein the ligand is an aromatic compound represented by general formula (XI) shown below: 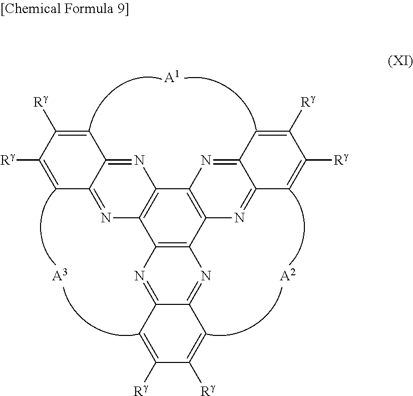
wherein R^{γ} represents a hydrogen atom or a substituent, each 2 or more R^{γ} may be the same or different from each other, when 2 or more R^{γ} represent substituents, each R^{γ} may be the same or different from each other, and adjacent substituents may be mutually bonded to form a ring with the carbon atoms bonded thereto; and each of A¹, A² and A³ independently represents a divalent organic group represented by any one of general formulas (B-7-a) to (B-7-e), (B-8-a) to (B-8-e), (B-9-a) to (B-9-e) and (B-10-a) to (B-10-e) shown below: 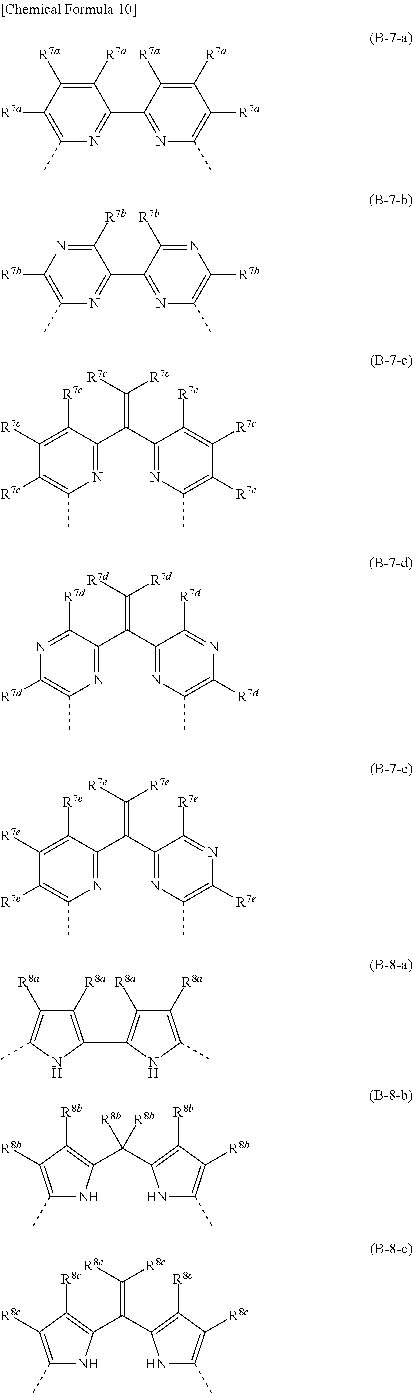 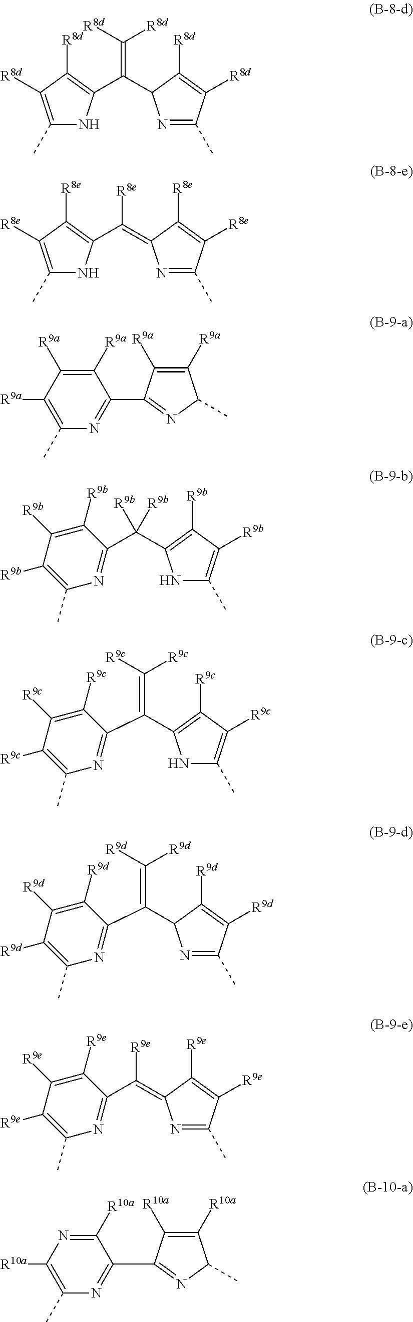 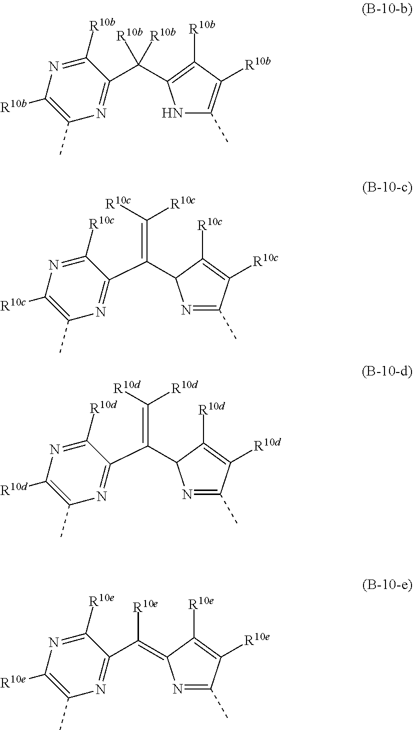
wherein each of R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} independently represents a hydrogen atom or a substituent, and mutually adjacent substituents may be mutually bonded together to form a ring with the carbon atom(s) bonded thereto; and each 2 or more R^{7a}, R^{7b}, R^{7c}, R^{7d}, R^{7e}, R^{8a}, R^{8b}, R^{8c}, R^{8d}, R^{8e}, R^{9a}, R^{9b}, R^{9c}, R^{9d}, R^{9e}, R^{10a}, R^{10b}, R^{10c}, R^{10d} and R^{10e} may be the same or different from each other.

23. The cathode catalyst for the air secondary cell according to claim 12, wherein the central metal is a transition metal atom belonging to the 4th period to the 6th period of the periodic table, or an ion thereof.

24. The cathode catalyst for the air secondary cell according to claim 12, wherein the number of the central metals is 2 to 4.

25. The cathode catalyst for the air secondary cell according to claim 1, wherein the cathode catalyst comprises a composition containing the polynuclear metal complex and carbon.

26. The cathode catalyst for the air secondary cell according to claim 1, wherein the cathode catalyst comprises a composition containing a polymer having a residue of the polynuclear metal complex and carbon.

27. The cathode catalyst for the air secondary cell according to claim 1, wherein the material that forms the cathode catalyst is a modified material obtained by heating the polynuclear metal complex, the composition containing the polynuclear metal complex and carbon, or the composition containing the polymer having a residue of the polynuclear metal complex and carbon at 300° C. or more and 1,200° C. or less.

28. An air secondary cell comprising the cathode catalyst for the air secondary cell according to claim 1 in a cathode catalyst layer, and comprising at least one selected from the group consisting of zinc, iron, aluminum, magnesium, lithium, hydrogen, and ions thereof as an anode active material.
